(19) United States
(12) Patent Application Publication
(10) Pub. No.: US 2026/0337744 A1
(43) Pub. Date: Oct. 29, 2026

(54) RAPID HEAT TREATMENT PRODUCTION LINE OF STRIP STEEL

(71) Applicant: BAOSHAN IRON & STEEL CO., LTD., Shanghai (CN)

(72) Inventors: Liyang ZHANG, Shanghai (CN); Jun LI, Shanghai (CN); Lixiang ZHANG, Shanghai (CN); Jian WANG, Shanghai (CN); Huafei LIU, Shanghai (CN); Junfei WANG, Shanghai (CN); Baoping ZHANG, Shanghai (CN); Wei XIONG, Shanghai (CN); Yimin LIU, Shanghai (CN); Fengzhi LU, Shanghai (CN); Jiazi WANG, Shanghai (CN); Zhangsheng WU, Shanghai (CN); Zhaotang WAN, Shanghai (CN); Chao WANG, Shanghai (CN); Yanhui WANG, Shanghai (CN); Guangkui HU, Shanghai (CN); Hongwei QIAN, Shanghai (CN)

(73) Assignee: BAOSHAN IRON & STEEL CO., LTD., Shanghai (CN)

(21) Appl. No.: 19/110,168

(22) PCT Filed: Sep. 15, 2023
(86) PCT No.: PCT/CN2023/119209

§ 371 Date: Apr. 9, 2025

(30) Foreign Application Priority Data
Sep. 15, 2022 (CN) 202211122144.5
Sep. 15, 2022 (CN) 202211122150.0
Sep. 15, 2022 (CN) 202211122167.6
Sep. 15, 2022 (CN) 202211122170.8
Sep. 15, 2022 (CN) 202211122193.9
Sep. 15, 2022 (CN) 202211122426.5
Sep. 15, 2022 (CN) 202211122427.X
Sep. 15, 2022 (CN) 202211122486.7
Sep. 15, 2022 (CN) 202211122488.6
Sep. 15, 2022 (CN) 202211122533.8
Sep. 15, 2022 (CN) 202211122619.0
Sep. 15, 2022 (CN) 202211122659.5
Sep. 15, 2022 (CN) 202211122803.5
Sep. 15, 2022 (CN) 202211122876.4
Sep. 15, 2022 (CN) 202211131552.7
Sep. 15, 2022 (CN) 202211131566.9

(51) Int. Cl. C23C 2/00; C23C 2/06; C23C 2/20; C23C 2/28

(52) U.S. Cl. CPC C23C 2/004; C23C 2/06; C23C 2/20; C23C 2/285; C23C 2/29

(57) ABSTRACT

Provided are a production line for the rapid hot galvanization of a strip steel, a production line for the rapid annealing of a strip steel, an ultra-short-process production line of an ultrahigh-strength strip steel, a flexible production line suitable for various high-strength strip steels and a dual use production line for the continuous annealing or hot galvanization of a high-strength strip steel. An injection straight fire preheating device, an injection radiant tube preheating device and/or a jet radiation composite heating/soaking device of the present invention are used in the production lines, such that rapid heating can be realized.

### TECHNICAL FIELD

The present disclosure relates to a production line for rapid heat treatment of strip steel.

### BACKGROUND ART

In a processing line for strip steel, one common process involves the use of direct fire heating, preferably using clean natural gas for direct fire heating to prevent unclean combustion exhaust gas from contaminating the strip steel surface, and using direct fire combustion exhaust gas to preheat the strip steel directly. Another common process involves the use of radiant tube heating, with radiant tube combustion exhaust gas used to preheat the strip steel. The prior art technologies have the following deficiencies:

If direct fire heating is used, the temperature of the direct fire combustion exhaust gas emitted after preheating the strip steel is still relatively high, usually exceeding 800° C., and sometimes exceeding 850° C. When the temperature exceeds 850° C., it is usually necessary to add cold air to control the temperature of the exhaust gas emitted at 850° C. or lower before offline reutilization. Higher exhaust gas temperature indicates more heat energy loss. As it can be seen, in this process, the primary online utilization rate of thermal energy is low, and the steam or hot water generated in offline reutilization is often not fully consumed in this unit. As a result, it's difficult to balance the energy in this area. The direct fire combustion exhaust gas contacts the strip steel directly, and the contact time is long. In addition, the excess fuel gas in the direct fire combustion exhaust gas needs to be subjected to secondary combustion in the preheating section, and the secondary combustion flame is often an oxidizing flame. This limits inevitably the increase in the preheating temperature of the strip steel. Otherwise, it is easy to form an excessively thick oxide layer on the surface of the strip steel. Especially for high-strength steel and ultra-high-strength steel, as strengthening alloying elements such as Si and Mn are added to the substrate, the surface of the strip steel is more prone to enrichment of strengthening alloying elements than products of ordinary strength, which will cause surface quality problems. Therefore, the strip steel can usually be preheated to a preheating temperature of only about 250° C., and the preheating effect is poor. If radiant tube heating is used, the temperature of the combustion exhaust gas emitted after preheating the strip steel is still relatively high, usually exceeding 350° C. when producing high-temperature annealing materials. It is necessary to add a boiler or a superheated water heating device to reutilize the waste heat of the combustion exhaust gas. In this case, the economic efficiency is reduced significantly, and the footprint of equipment is large. In addition, the proportion of energy utilized directly on the strip steel is low. That is, a large amount of heat is still taken away by the exhaust gas after preheating the strip steel (the higher the temperature of the exhaust gas after preheating the strip steel, the more heat it takes away), and the combustion heat is not fully transferred to the strip steel (that is, the primary utilization rate of energy is low). Additionally, the temperature of the preheated strip steel is limited. Usually, the temperature of the preheated strip steel can hardly exceed 250° C.

### SUMMARY

The present disclosure is aimed to configure a series of production lines using a new direct fire preheating device, a new radiant tube preheating device and/or a jet-radiation composite heating device to achieve rapid heat treatment, etc.

### Rapid Production Line for Hot-Dip Galvanized Strip Steel

One object of the present disclosure is to provide a rapid production line for hot-dip galvanized strip steel, which can achieve the following purposes: when direct fire heating is used, the waste heat of direct fire combustion exhaust gas is fully utilized, and the strip steel can be quickly preheated to a temperature of at least 350° C. At the same time, the direct fire combustion exhaust gas is prevented from directly contacting the strip steel in the preheating furnace for a long time, thereby avoiding formation of an excessively thick oxide layer on the surface of the strip steel. When direct fire heating is not used, a new heating technology is used to fully utilize the waste heat of the combustion exhaust gas, and the waste heat of the combustion exhaust gas is basically transferred to the strip steel, thereby improving the primary utilization rate of thermal energy, and allowing for direct discharge of the combustion exhaust gas after fully heating the strip steel, without adding a boiler or a superheated water heating device for reutilization, significantly reducing investment and footprint.

To achieve the above object, the technical solution of the present disclosure is:

A rapid production line for hot-dip galvanized strip steel, including the following stations in sequence: uncoiling—welding—inlet looper—washing—central continuous post-processing—outlet looper—temper rolling—coiling; wherein:
the central continuous post-processing station includes in sequence a preheating section, a heating section, a soaking section, a slow cooling section, a high hydrogen cooling section, a reheating section, a uniform holding section, a secondary reheating section, a furnace nose section, a zinc pot section, an air knife section, a post-plating cooling section and a final water cooling section;
a jet direct fire preheating device or a jet-radiation composite heating device is used in the preheating section;
a direct fire heating section and/or a radiant tube heating section is used for the heating section;
a radiant tube soaking section or a jet-radiation composite soaking section is used for the soaking section;
a longitudinal magnetic induction heating device is used in both the reheating section and the secondary reheating section to heat the strip steel quickly.

The jet direct fire preheating device utilizes the combustion exhaust gas from the direct fire heating section to heat a recycled nitrogen-hydrogen protective gas, and then the nitrogen-hydrogen protective gas is jetted onto the upper and lower surfaces of the strip steel to achieve forced convection heat exchange.

In the jet-radiation composite heating section and the soaking section, in addition to the use of the radiation of a radiant tube to heat the strip steel, the combustion exhaust gas of the radiant tube is also used to heat a recycled nitrogen-hydrogen protective gas, and then the nitrogen-hydrogen protective gas is jetted onto the upper and lower surfaces of the strip steel to achieve forced convection heat exchange.

Preferably, an alloying heating section and an alloying soaking section are provided between the air knife section and the post-plating cooling section, so that the hot-dip galvanizing is hot-dip galvannealing.

Preferably, a mobile post-plating rapid cooling section which can be switched online/offline is provided behind the air knife in the central continuous post-processing station, and the mobile post-plating rapid cooling section is provided in parallel with the alloying heating section.

Preferably, the washing station is provided before the inlet looper station.

Preferably, washing stations are provided before and after the inlet looper station respectively.

Preferably, a central looper is provided before the temper rolling station and after the central continuous post-processing station.

Preferably, a finishing station is provided between the coiling station and the outlet looper station, and the strip steel is coiled after finishing.

Preferably, a tension levelling station is provided between the temper rolling station and the outlet looper station, and the strip steel may be subjected to tension levelling treatment before entering the outlet looper.

Preferably, a surface post-treatment station such as that for passivation or anti-fingerprint treatment is provided between the temper rolling station and the outlet looper station, and the strip steel may be subjected to surface treatment such as passivation or anti-fingerprint treatment before entering the outlet looper.

Preferably, both a tension levelling station and a surface post-treatment station such as that for passivation or anti-fingerprint treatment are provided between the temper rolling station and the outlet looper station, and the strip steel may be subjected to tension levelling and/or surface treatment such as passivation or anti-fingerprint treatment before entering the outlet looper.

For a pure zinc hot-dip galvanizing unit used to produce a pure zinc hot-dip galvanized product, when direct fire heating is utilized, the rapid production line for hot-dip galvanized strip steel designed according to the present disclosure includes the following stations: uncoiling-welding-inlet looper-washing-central continuous post-processing-outlet looper-temper rolling-coiling, wherein the central continuous post-processing station includes in sequence a jet direct fire preheating section, a direct fire heating section, a radiant tube heating section, a radiant tube soaking section or a jet-radiation composite soaking section, a slow cooling section, a high hydrogen cooling section, a reheating section, a uniform holding section, a secondary reheating section, a furnace nose section, a zinc pot section, an air knife section, a post-plating cooling section and a final water cooling section.

In the jet direct fire preheating section, the combustion exhaust gas from the direct fire heating section is used to heat a recycled nitrogen-hydrogen protective gas, and then the nitrogen-hydrogen protective gas is jetted onto the upper and lower surfaces of the strip steel to achieve forced convection heat exchange.

A longitudinal magnetic induction heating device is used in both the reheating section and the secondary reheating section to heat the strip steel quickly.

When direct fire heating is not utilized, the rapid production line for hot-dip galvanized strip steel designed according to the present disclosure includes the following stations: uncoiling-welding-inlet looper-central continuous post-processing-outlet looper-temper rolling-coiling, wherein the central continuous post-processing station includes in sequence a jet-radiation composite heating section, a radiant tube heating section, a radiant tube soaking section or a jet-radiation composite soaking section, a slow cooling section, a high hydrogen cooling section, a reheating section, a uniform holding section, a secondary reheating section, a furnace nose section, a zinc pot section, an air knife section, a post-plating cooling section and a final water cooling section.

In the jet-radiation composite heating section and the soaking section, in addition to the use of the radiation of a radiant tube to heat the strip steel, the combustion exhaust gas of the radiant tube is also used to heat a recycled nitrogen-hydrogen protective gas, and then the nitrogen-hydrogen protective gas is jetted onto the upper and lower surfaces of the strip steel to achieve forced convection heat exchange.

A longitudinal magnetic induction heating device is used in both the reheating section and the secondary reheating section to heat the strip steel quickly.

In the design of the production line according to the present disclosure:

For a hot-dip galvannealing unit used to produce a hot-dip galvannealed product, when direct fire heating is used, the rapid production line for hot-dip galvannealed strip steel includes the following stations: uncoiling—welding—inlet looper—central continuous post-processing—outlet looper—temper rolling—coiling; wherein:
the central continuous post-processing station includes in sequence a jet direct fire preheating section, a direct fire heating section, a radiant tube heating section, a radiant tube soaking section, a slow cooling section, a high hydrogen cooling section, a reheating section, a uniform holding section, a secondary reheating section, a furnace nose section, a zinc pot section, an air knife section, an alloying heating section, an alloying soaking section, a post-plating cooling section and a final water cooling section.

In the jet direct fire preheating section, the combustion exhaust gas from the direct fire heating section is used to heat a recycled nitrogen-hydrogen protective gas, and then the nitrogen-hydrogen protective gas is jetted onto the upper and lower surfaces of the strip steel to achieve forced convection heat exchange.

A longitudinal magnetic induction heating device is used in both the reheating section and the secondary reheating section to heat the strip steel quickly.

When direct fire heating is not used, the rapid production line for hot-dip galvannealed strip steel designed in the present disclosure includes the following stations: uncoiling—welding—inlet looper—central continuous post-processing—outlet looper—temper rolling—coiling; wherein:
the central continuous post-processing station includes in sequence a jet-radiation composite heating section, a radiant tube heating section, a radiant tube soaking section, a slow cooling section, a high hydrogen cooling section, a reheating section, a uniform holding section, a secondary reheating section, a furnace nose section, a zinc pot section, an air knife section, an alloying heating section, an alloying soaking section, a post-plating cooling section and a final water cooling section.

In the jet-radiation composite heating section and the soaking section, in addition to the use of the radiation of a radiant tube to heat the strip steel, the combustion exhaust gas of the radiant tube is also used to heat a recycled nitrogen-hydrogen protective gas, and then the nitrogen-hydrogen protective gas is jetted onto the upper and lower surfaces of the strip steel to achieve forced convection heat exchange.

A longitudinal magnetic induction heating device is used in both the reheating section and the secondary reheating section to heat the strip steel quickly.

In the soaking section, a jet-radiation composite heating device is used to achieve rapid regulation of the soaking temperature of the strip steel when the working conditions change, such as changes in strip steel thickness specification, target temperature, unit speed, etc.

Preferably, the pure zinc hot-dip galvanizing station of the central continuous post-processing station in a pure zinc hot-dip galvanized strip steel production line is provided with a selectable mobile post-plating rapid cooling section after the air knife section and before the post-plating cooling section. After the strip steel is hot-dip galvanized in the zinc pot section and the coating weight is controlled by the air knife section device, the mobile post-plating rapid cooling section may be chosen to carry out post-plating rapid cooling. Alternatively, the mobile post-plating rapid cooling section may not be used; instead, natural cooling may be carried out before post-plating cooling, thereby enabling continuous production of the hot-dip galvanized high-strength strip steel.

For a hot-dip galvannealed strip steel production line, a selectable mobile post-plating rapid cooling section is provided in parallel with the alloying heating section after the air knife section of the central continuous post-processing station. After the strip steel is hot-dip galvanized in the zinc pot section and the coating weight is controlled by the air knife section, if a pure zinc hot-dip galvanized product is to be produced, the mobile post-plating rapid cooling section is switched online for use and the alloying heating section is switched offline; if a hot-dip galvannealed product is to be produced, the mobile post-plating rapid cooling section is switched offline, and the alloying heating section device is switched online for use.

The differences or innovation points of the production line of the present disclosure as compared with the conventional continuous heat treatment line include:

1. When direct fire heating is used according to the present disclosure, a jet direct fire preheating section is used instead of a common preheating section. The significant features of the jet direct fire preheating section over the common preheating section include:

(1) An in-furnace heat exchanger (the heat exchanger is not provided outside the furnace) is used to heat a recycled nitrogen-hydrogen protective gas, and the heated nitrogen-hydrogen protective gas is jetted at a high speed onto the upper and lower surfaces of the strip steel to achieve forced convection heat exchange, thereby preheating the strip steel fast and efficiently. Compared with the traditional preheating process, this process significantly reduces the heat loss from the furnace housing and the protective gas channel, makes more full use of the waste heat of the combustion exhaust gas, and has higher heating efficiency and a faster heating rate.

(2) In the jet direct fire jet preheating section, the combustion exhaust gas from the heating section passes through the heat exchanger chamber of the preheating section. During the passing process, the combustion exhaust gas from the heating section fully exchanges heat with the heat exchanger in the heat exchanger chamber to heat the nitrogen-hydrogen protective gas. Therefore, in the jet direct fire jet preheating section, the combustion exhaust gas from the heating section is not always in direct contact with the strip steel (when direct fire heating is used in the heating section, the jet direct fire jet preheating section is only in direct contact with the strip steel at high temperature for a short time, and the exhaust gas at this time is a reducing atmosphere or a slightly oxidizing atmosphere), thereby avoiding overoxidation of the strip steel surface.

(3) When direct fire heating is used in the heating section, the incompletely burned fuel gas in the direct fire combustion exhaust gas undergoes oxygen-enriched secondary combustion in a semi-sealed unit at the top of the jet preheating section, but the burning flame does not contact the strip steel, thereby effectively avoiding overoxidation of the strip steel surface.

(4) The strip steel is preheated to a higher temperature. When direct fire heating is used in the heating section, due to the high heat transfer efficiency of the high-temperature nitrogen-hydrogen protective gas in the jet direct fire jet preheating, the temperature of the preheated strip steel can reach at least 350° C., which is at least 100° C. higher than the strip steel temperature in the common preheating section.

(5) When direct fire heating is used in the heating section, the temperature of the direct fire combustion exhaust gas coming out of the jet radiant tube preheating section according to the present disclosure is usually much lower than 750° C. (if a sufficient number of high-speed jet preheating units are provided, it can even be 200° C. or lower, suitable for direct discharge), and there is no need to mix cold air into the direct fire combustion exhaust gas for reutilization outside the furnace, or no need for reutilization at all.

2. When direct fire heating is not used, a jet-radiation composite heating section device is used to heat the strip steel quickly. In addition to the use of the radiation of the radiant tube to heat the strip steel, the heating device also uses the combustion exhaust gas of the radiant tube to heat a recycled nitrogen-hydrogen protective gas, and then the nitrogen-hydrogen protective gas is jetted onto the upper and lower surfaces of the strip steel to achieve forced convection heat exchange. The heat exchange efficiency is high. The temperature of the exhaust gas after use can be below 250° C., suitable for direct discharge. The combustion heat is substantially all transferred to heat the strip steel.

The direct fire heating device can be used for pre-redox treatment of high-strength steel to improve the platability of the high-strength steel.

The coordinated use of the direct fire heating device or jet-radiation composite heating device and the high hydrogen rapid cooling device allows for rapid heating and rapid cooling annealing treatments of high-strength steel, thereby improving the strength of the high-strength steel.

According to the present disclosure, there is provided a secondary reheating section device. Thus, the strip steel temperature can be raised twice before the hot-dip galvanizing treatment. A third-generation high-strength steel (QP steel) product may be cooled quickly to a lower temperature, and then immediately heated quickly to a higher temperature for long-term carbon redistribution treatment. After the treatment is completed, it is quickly reheated for a second time to a temperature at which it is put into a hot-dip galvanizing zinc pot to carry out the galvanizing treatment.

The hot-dip galvannealed high-strength steel production line according to the present disclosure can produce hot-dip galvanized products with either of the following two coating types: hot-dip pure zinc coating and hot-dip alloy coating.

The beneficial effects of the present disclosure include:

1) After preheating, the temperature of the strip steel is high, and the primary thermal energy utilization rate is high.

2) When the direct fire heating technology is utilized, the strip steel has good platability.

3) With the use of a secondary reheating device, the strip steel temperature can be raised twice before the hot-dip galvanizing treatment. A third-generation high-strength steel (QP steel) product can be cooled quickly to a lower temperature, and then immediately heated quickly to a higher temperature for long-term carbon redistribution treatment. After the treatment is completed, it is quickly reheated for a second time to a temperature at which it is put into a hot-dip galvanizing zinc pot to carry out the galvanizing treatment.

4) Rapid heating and rapid cooling treatments of the strip steel can be implemented, and strip steel products with high strength grades can be produced.

5) When jet-radiation composite soaking is utilized, rapid regulation of the soaking temperature of the strip steel can be achieved when the working conditions change, such as changes in strip steel thickness specification, target temperature, unit speed, etc., which can reduce the quality loss caused by substandard strip steel temperature.

### Rapid Production Line for Hot-Dip Galvanized High-Strength Strip Steel

The present disclosure further provides a rapid production line for hot-dip galvanized high-strength strip steel which can achieve the following purposes: 1) improving preheating: a new heating technology is used to make full use of the waste heat of the combustion exhaust gas, and transfer substantially all the waste heat of the combustion exhaust gas to the strip steel, thereby improving the primary utilization rate of thermal energy, so that the combustion exhaust gas can be discharged directly after fully heating the strip steel; or to make full use of the waste heat from the radiant tube heating section and/or the radiant tube soaking section to fully preheat the strip steel, with no need to add a boiler or superheated water heating device for reutilization of the waste heat, so that the investment and footprint are reduced significantly; 2) improving soaking to enable rapid regulation of the soaking temperature of the strip steel; 3) improving ultra-high temperature heating: a transverse magnetic induction heating technology is used to further increase the heating temperature of the high-temperature strip steel quickly, implement ultra-high temperature annealing of the high-strength strip steel, and improve the energy utilization rate.

To achieve the above purposes, the technical solution according to the present disclosure is:

A rapid production line for pure zinc hot-dip galvanized high-strength strip steel, including the following stations in sequence: uncoiling—welding—inlet looper—washing—central continuous post-processing—temper rolling—outlet looper—coiling, wherein the central continuous post-processing station includes in sequence a jet-radiation composite heating section, a radiant tube heating section, a transverse magnetic induction heating section, a radiant tube soaking section, a slow cooling section, a high hydrogen cooling section, a reheating section, a uniform holding section, a secondary reheating section, a furnace nose section, a zinc pot section, an air knife section, a post-plating cooling section and a final water cooling section. In the jet-radiation composite heating section, in addition to the use of the radiation of a radiant tube to heat the strip steel, the combustion exhaust gas of the radiant tube is also used to heat a recycled nitrogen-hydrogen protective gas or an all-hydrogen gas, and then the nitrogen-hydrogen protective gas or all-hydrogen gas is jetted onto the upper and lower surfaces of the strip steel to achieve forced convection heat exchange. Longitudinal magnetic induction heating is used in both the reheating section and the secondary reheating section to heat the strip steel quickly.

Further, the rapid production line for pure zinc hot-dip galvanized high-strength strip steel according to the present disclosure includes the following stations in sequence: uncoiling—welding—inlet looper—washing—central continuous post-processing—temper rolling—outlet looper—coiling, wherein the central continuous post-processing station includes in sequence a jet radiant tube preheating section, a radiant tube heating section, a transverse magnetic induction heating section, a radiant tube soaking section, a slow cooling section, a high hydrogen cooling section, a reheating section, a uniform holding section, a secondary reheating section, a furnace nose section, a zinc pot section, an air knife section, a post-plating cooling section and a final water cooling section. In the jet radiant tube preheating section, the combustion exhaust gas from the radiant tube heating section and the radiant tube soaking section is used to heat a recycled nitrogen-hydrogen protective gas in the furnace, and then the nitrogen-hydrogen protective gas is jetted onto the upper and lower surfaces of the strip steel to realize forced convection heat exchange. A longitudinal magnetic induction heating device is used in both the reheating section and the secondary reheating section to heat the strip steel quickly.

Still further, the rapid production line for pure zinc hot-dip galvanized high-strength strip steel according to the present disclosure includes the following stations in sequence: uncoiling—welding—inlet looper—washing—central continuous post-processing—temper rolling—outlet looper—coiling, wherein the central continuous post-processing station includes in sequence a jet-radiation composite heating section, a radiant tube heating section, a transverse magnetic induction heating section, a jet-radiation composite soaking section, a slow cooling section, a high hydrogen cooling section, a reheating section, a uniform holding section, a secondary reheating section, a furnace nose section, a zinc pot section, an air knife section, a post-plating cooling section and a final water cooling section; wherein in the jet-radiation composite heating section, in addition to the use of the radiation of a radiant tube to heat the strip steel, the combustion exhaust gas of the radiant tube is also used to heat a recycled nitrogen-hydrogen protective gas or an all-hydrogen gas, and then the nitrogen-hydrogen protective gas or all-hydrogen gas is jetted onto the upper and lower surfaces of the strip steel to realize forced convection heat exchange; and a longitudinal magnetic induction heating device is used in both the reheating section and the secondary reheating section to heat the strip steel quickly.

Yet further, the rapid production line for pure zinc hot-dip galvanized high-strength strip steel according to the present disclosure includes the following stations in sequence: uncoiling—welding—inlet looper—washing—central continuous post-processing—temper rolling—outlet looper—coiling, wherein the central continuous post-processing station includes in sequence a jet radiant tube preheating section, a radiant tube heating section, a transverse magnetic induction heating section, a jet-radiation composite soaking section, a slow cooling section, a high hydrogen cooling section, a reheating section, a uniform holding section, a secondary reheating section, a furnace nose section, a zinc pot section, an air knife section, a post-plating cooling section and a final water cooling section; wherein in the jet radiant tube preheating section, the combustion exhaust gas from the radiant tube heating section and the radiant tube soaking section is used to heat a recycled nitrogen-hydrogen protective gas in the furnace, and then the nitrogen-hydrogen protective gas is jetted onto the upper and lower surfaces of the strip steel to realize forced convection heat exchange; and a longitudinal magnetic induction heating device is used in both the reheating section and the secondary reheating section to heat the strip steel quickly.

Further, an alloying heating section and an alloying soaking section are provided between the air knife section and the post-plating cooling section, so that the hot-dip galvanizing is hot-dip galvannealing.

Still further, a selectable mobile post-plating rapid cooling section is provided after the air knife section and before the post-plating cooling section.

Yet further, a selectable mobile post-plating rapid cooling section is provided after the air knife section, and the mobile post-plating rapid cooling section is provided in parallel with the alloying heating section.

Preferably, a washing station is provided before the inlet looper station.

Preferably, washing stations are provided before and after the inlet looper station.

Preferably, a central looper is provided before the temper rolling station and after the central continuous post-processing station.

Preferably, a finishing station is provided between the coiling station and the outlet looper station, and the strip steel is coiled after finishing.

Preferably, a tension levelling station is provided between the temper rolling station and the outlet looper station, and the strip steel may be subjected to tension levelling treatment before entering the outlet looper.

Preferably, a surface post-treatment station such as that for passivation or anti-fingerprint treatment is also provided between the temper rolling station and the outlet looper station, and the strip steel may be subjected to surface treatment such as passivation or anti-fingerprint treatment before entering the outlet looper.

Preferably, both a tension levelling station and a surface post-treatment station such as that for passivation or anti-fingerprint treatment are provided between the temper rolling station and the outlet looper station, and the strip steel may be subjected to tension levelling and/or surface treatment such as passivation or anti-fingerprint treatment before entering the outlet looper.

The differences or innovation points of the production line of the present disclosure as compared with the conventional continuous heat treatment line include:

1) A jet-radiation composite heating section device is used to heat the strip steel quickly according to the present disclosure. In addition to the use of the radiation of the radiant tube to heat the strip steel, the heating device also uses the combustion exhaust gas of the radiant tube to heat a recycled nitrogen-hydrogen protective gas, and then the nitrogen-hydrogen protective gas is jetted onto the upper and lower surfaces of the strip steel to achieve forced convection heat exchange. The heat exchange efficiency is high. The temperature of the exhaust gas after use can be below 250° C., suitable for direct discharge. The combustion heat is substantially all transferred to heat the strip steel.

2) When a jet radiant tube preheating section device which makes use of the combustion exhaust gas from the radiant tube heating section and/or the radiant tube soaking section is used according to the present disclosure, the waste heat from the radiant tube heating and soaking can all be utilized online, and the strip steel can be preheated to a temperature of at least 250° C.

The present disclosure enables rapid heating and rapid cooling annealing treatments of high-strength steel by using a jet radiant tube preheating device or a jet-radiation composite heating device+a transverse magnetic induction heating device in conjunction with a high hydrogen rapid cooling device, thereby improving the strength of the high-strength steel.

3) Transverse magnetic induction heating is utilized to further increase the temperature of the high-temperature strip steel quickly according to the present disclosure, thereby allowing for ultra-high temperature annealing of the high-strength steel.

4) According to the present disclosure, there is provided a secondary reheating section device. Thus, the strip steel temperature can be raised twice before the hot-dip galvanizing treatment. A third-generation high-strength steel (QP steel) product may be cooled quickly to a lower temperature, and then immediately heated quickly to a higher temperature for long-term carbon redistribution treatment. After the treatment is completed, it is quickly reheated for a second time to a temperature at which it is put into a hot-dip galvanizing zinc pot to carry out the galvanizing treatment.

5) The hot-dip galvanized high-strength steel production line of the present disclosure can produce hot-dip galvanized products with either of the following two coating types: hot-dip pure zinc coating and hot-dip alloy coating.

The beneficial effects of the present disclosure include:

1) After preheating, the temperature of the strip steel is high, and the primary thermal energy utilization rate is high.

2) Transverse magnetic induction heating is utilized to further increase the temperature of the high-temperature strip steel quickly, thereby allowing for ultra-high temperature annealing of the high-strength steel.

3) With the use of a secondary reheating device, the strip steel temperature can be raised twice before the hot-dip galvanizing treatment. A third-generation high-strength steel (QP steel) product can be cooled quickly to a lower temperature, and then immediately heated quickly to a higher temperature for long-term carbon redistribution treatment. After the treatment is completed, it is quickly reheated for a second time to a temperature at which it is put into a hot-dip galvanizing zinc pot to carry out the galvanizing treatment.

4) Rapid heating and rapid cooling treatments of the strip steel can be implemented, and strip steel products with high strength grades can be produced.

5) When jet-radiation composite soaking is utilized, rapid regulation of the soaking temperature of the strip steel can be achieved when the working conditions change, such as changes in strip steel thickness specification, target temperature, unit speed, etc., which can reduce the quality loss caused by substandard strip steel temperature.

### Rapid Production Line for Hot-Dip Galvanized Ultra-High-Strength Strip Steel

The rapid production line for hot-dip galvanized ultra-high-strength strip steel according to the present disclosure can realize ultra-high temperature annealing of the high-strength strip steel at a low cost and achieve the following purposes: 1) improving preheating: direct fire heating is used, and the waste heat of the direct fire combustion exhaust gas is fully utilized, so that the strip steel can be quickly preheated to a temperature of at least 350° C., and the direct fire combustion exhaust gas is prevented from directly contacting the strip steel in the preheating furnace for a long time, thereby avoiding formation of an excessively thick oxide layer on the surface of the strip steel; 2) improving soaking to enable rapid regulation of the soaking temperature of the strip steel; 3) improving ultra-high temperature heating: a transverse magnetic induction heating technology is used to further increase the heating temperature of the high-temperature strip steel quickly.

To achieve the above purposes, the technical solution of the present disclosure is:

A rapid production line for hot-dip galvanized ultra-high-strength strip steel, including the following stations in sequence: uncoiling—welding—inlet looper—washing—central continuous post-processing—temper rolling—outlet looper—coiling, wherein the central continuous post-processing station includes in sequence a jet direct fire preheating section, a direct fire heating section, a radiant tube heating section, a transverse magnetic induction heating section, a soaking section, a slow cooling section, a high hydrogen cooling section, a reheating section, a uniform holding section, a secondary reheating section, a furnace nose section, a zinc pot section, an air knife section, a post-plating cooling section and a final water cooling section; wherein a radiant tube soaking section or a jet-radiation composite soaking section is used for the soaking section; in the jet direct fire preheating section, the combustion exhaust gas from the direct fire heating section is used to heat a recycled nitrogen-hydrogen protective gas, and then the nitrogen-hydrogen protective gas is jetted onto the upper and lower surfaces of the strip steel to realize forced convection heat exchange; and a longitudinal magnetic induction heating device is used in both the reheating section and the secondary reheating section to heat the strip steel quickly.

Further, according to the present disclosure, there is also designed a rapid production line for hot-dip galvanized ultra-high-strength strip steel, including the following stations in sequence: uncoiling—welding—inlet looper—washing—central continuous post-processing—temper rolling-outlet looper—coiling, wherein the central continuous post-processing station includes in sequence a jet direct fire preheating section, a direct fire heating section, a radiant tube heating section, a transverse magnetic induction heating section, a soaking section, a slow cooling section, a rapid cooling section, a pickling section, a reheating section, a uniform holding section, a secondary reheating section, a furnace nose section, a zinc pot section, an air knife section, a post-plating cooling section and a final water cooling section; wherein a radiant tube soaking section or a jet-radiation composite soaking section is used for the soaking section; a mist cooling section and/or a water quenching cooling section is used for the rapid cooling section; in the jet direct fire preheating section, the combustion exhaust gas from the direct fire heating section is used to heat a recycled nitrogen-hydrogen protective gas, and then the nitrogen-hydrogen protective gas is jetted onto the upper and lower surfaces of the strip steel to realize forced convection heat exchange; and a longitudinal magnetic induction heating device is used in both the reheating section and the secondary reheating section to heat the strip steel quickly.

Further, hot-dip galvannealing is used for the hot-dip galvanizing, that is, an alloying heating section and an alloying soaking section are provided between the air knife section and the post-plating cooling section.

Preferably, an iron flash plating or nickel flash plating section is added after the pickling section, and the strip steel is flash plated before subsequent treatments. Preferably, a selectable mobile post-plating rapid cooling section device is provided after the air knife section and before the post-plating cooling section device. After the strip steel is hot-dip galvanized in the zinc pot section and the coating weight is controlled by the air knife section, the mobile post-plating rapid cooling section may be chosen to carry out post-plating rapid cooling. Alternatively, the mobile post-plating rapid cooling section may not be used; instead, natural cooling may be carried out before post-plating cooling, thereby enabling continuous production of the hot-dip galvanized strip steel.

Preferably, after the air knife section, a selectable mobile post-plating rapid cooling section is provided in parallel with the alloying heating section. After the strip steel is hot-dip galvanized in the zinc pot section and the coating weight is controlled by the air knife section device, if a pure zinc hot-dip galvanized product is to be produced, the mobile post-plating rapid cooling section is switched online for use and the alloying heating section is switched offline; if a hot-dip galvannealed product is to be produced, the mobile post-plating rapid cooling section is switched offline, and the alloying heating section device is switched online for use.

Preferably, the radiant tube soaking section is replaced with a jet-radiation composite soaking section to achieve rapid regulation of the soaking temperature of the strip steel when the working conditions change, such as changes in strip steel thickness specification, target temperature, unit speed, etc.

Preferably, washing stations are provided before and after the inlet looper station.

Preferably, a central looper station is provided before the temper rolling station.

Preferably, a finishing station is provided between the coiling station and the outlet looper station, and the strip steel is coiled after finishing.

Preferably, a tension levelling station is provided between the temper rolling station and the outlet looper station, and the strip steel may be subjected to tension levelling treatment before entering the outlet looper.

Preferably, a surface post-treatment station such as that for passivation or anti-fingerprint treatment is provided between the temper rolling station and the outlet looper station, and the strip steel may be subjected to surface treatment such as passivation or anti-fingerprint treatment before entering the outlet looper.

Preferably, both a tension levelling station and a surface post-treatment station such as that for passivation or anti-fingerprint treatment are provided between the temper rolling station and the outlet looper station, and the strip steel may be subjected to tension levelling and/or surface treatment such as passivation or anti-fingerprint treatment before entering the outlet looper.

In the rapid production line for hot-dip galvanized ultra-high-strength steel according to the present disclosure, for the rapid cooling section, a high hydrogen cooling section may be provided in parallel with a mist cooling section+a pickling section, or a high hydrogen cooling section may be provided in parallel with a water quenching cooling section+a pickling section. The strip steel may be subjected to high hydrogen cooling, or may be subjected to mist cooling or water quenching cooling.

In the production line for pure zinc hot-dip galvanized ultra-high-strength steel and hot-dip galvannealed ultra-high-strength steel, for the rapid cooling section, a mist cooling section and a water quenching cooling section are provided in series, and a pickling section is provided after the water quenching cooling section. The strip steel may be subjected to mist cooling only, or water quenching cooling only, or mist cooling followed by water quenching cooling.

In the pure zinc hot-dip ultra-high-strength steel production line or the hot-dip galvannealed ultra-high-strength steel production line, for the rapid cooling section, a high hydrogen cooling section is provided in parallel with (a mist cooling section+a water quenching cooling section+a pickling section) provided in series. The strip steel may be subjected to high hydrogen cooling, or mist cooling, or water quenching cooling, or mist cooling followed by water quenching cooling.

In the pure zinc hot-dip galvanized strip steel production line, in the pure zinc hot-dip galvanizing station of the central continuous post-processing station, a selectable mobile post-plating rapid cooling section is provided after the air knife section and before the post-plating cooling section. After the strip steel is hot-dip galvanized in the zinc pot section and the coating weight is controlled by the air knife section, the mobile post-plating rapid cooling section may be chosen to carry out post-plating rapid cooling. Alternatively, the mobile post-plating rapid cooling section may not be used; instead, natural cooling may be carried out before post-plating cooling, thereby enabling continuous production of the hot-dip galvanized high-strength strip steel.

For the hot-dip galvannealed strip steel production line, a selectable mobile post-plating rapid cooling section is provided in parallel with an alloying heating section after the air knife section device in the central continuous post-processing station. After the strip steel is hot-dip galvanized in the zinc pot section and the coating weight is controlled by the air knife section, if a pure zinc hot-dip galvanized product is to be produced, the mobile post-plating rapid cooling section is switched online for use and the alloying heating section is switched offline; if a hot-dip galvannealed product is to be produced, the mobile post-plating rapid cooling section is switched offline and the alloying heating section is switched online for use.

Preferably, a selectable washing station device is provided between the welding station and the inlet looper station, and the strip steel may be washed by passing through the washing station, or may bypass the washing station; further preferably, washing stations are provided before and after the inlet looper station.

The differences or innovation points of the present disclosure as compared with the conventional continuous heat treatment line include:

1) When direct fire heating is used, a jet direct fire preheating section is used instead of a common preheating section. The significant features of the jet direct fire preheating section over the common preheating section include:

(1) An in-furnace heat exchanger (the heat exchanger is not provided outside the furnace) is used to heat a recycled nitrogen-hydrogen protective gas, and the heated nitrogen-hydrogen protective gas is jetted at a high speed onto the upper and lower surfaces of the strip steel to achieve forced convection heat exchange, thereby preheating the strip steel fast and efficiently. Compared with the traditional preheating process, this process significantly reduces the heat loss from the furnace housing and the protective gas channel, makes more full use of the waste heat of the combustion exhaust gas, and has higher heating efficiency and a faster heating rate.

(2) In the jet direct fire preheating section, the combustion exhaust gas from the heating section passes through the heat exchanger chamber of the preheating section. During the passing process, the combustion exhaust gas from the heating section fully exchanges heat with the heat exchanger in the heat exchanger chamber to heat the nitrogen-hydrogen protective gas. Therefore, in the jet direct fire preheating section, the combustion exhaust gas from the heating section is not always in direct contact with the strip steel (when direct fire heating is used in the heating section, the jet direct fire preheating section is only in direct contact with the strip steel at high temperature for a short time, and the exhaust gas at this time is a reducing atmosphere or a slightly oxidizing atmosphere), thereby avoiding overoxidation of the strip steel surface.

(3) When direct fire heating is used in the heating section, the incompletely burned fuel gas in the direct fire combustion exhaust gas undergoes oxygen-enriched secondary combustion in a semi-sealed unit at the top of the jet preheating section, but the burning flame does not contact the strip steel, thereby effectively avoiding overoxidation of the strip steel surface.

(4) The strip steel is preheated to a higher temperature. When direct fire heating is used in the heating section, due to the high heat transfer efficiency of the high-temperature nitrogen-hydrogen protective gas in the jet direct fire preheating, the temperature of the preheated strip steel can reach at least 350° C., which is at least 100° C. higher than the strip steel temperature in the common preheating section.

(5) When direct fire heating is used in the heating section, the temperature of the direct fire combustion exhaust gas coming out of the jet direct fire preheating section according to the present disclosure is usually much lower than 750° C. (if a sufficient number of high-speed jet preheating units are provided, it can even be 200° C. or lower, suitable for direct discharge), and there is no need to mix cold air into the direct fire combustion exhaust gas for reutilization outside the furnace, or no need for reutilization at all.

2) A jet direct fire preheating device is designed according to the present disclosure.

3) The direct fire heating device can be used for pre-redox treatment of high-strength steel to improve the platability of the high-strength steel.

4) The coordinated use of the direct fire heating device or jet-radiation composite heating device+transverse magnetic induction heating and high hydrogen rapid cooling device allows for rapid heating and rapid cooling annealing treatments of high-strength steel, thereby improving the strength of the high-strength steel.

5) Transverse magnetic induction heating is utilized to further increase the temperature of the high-temperature strip steel quickly, thereby allowing for ultra-high temperature annealing of the high-strength steel.

6) According to the present disclosure, there is provided a secondary reheating section device. Thus, the strip steel temperature can be raised twice before the hot-dip galvanizing treatment. A third-generation high-strength steel (QP steel) product may be cooled quickly to a lower temperature, and then immediately heated quickly to a higher temperature for long-term carbon redistribution treatment. After the treatment is completed, it is quickly reheated for a second time to a temperature at which it is put into a hot-dip galvanizing zinc pot to carry out the galvanizing treatment.

7) The hot-dip galvanized high-strength steel production line of the present disclosure can produce hot-dip galvanized products with either of the following two coating types: hot-dip pure zinc coating and hot-dip alloy coating.

The beneficial effects of the present disclosure include:

1) Rapid heating and rapid cooling treatments of the strip steel can be implemented, and strip steel products with high strength grades can be produced.

2) Transverse magnetic induction heating is utilized to further increase the temperature of the high-temperature strip steel quickly, thereby allowing for ultra-high temperature annealing of the high-strength steel.

3) When jet-radiation composite soaking is utilized, rapid regulation of the soaking temperature of the strip steel can be achieved when the working conditions change, such as changes in strip steel thickness specification, target temperature, unit speed, etc., which can reduce the quality loss caused by substandard strip steel temperature.

4) The use of direct fire heating allows for the use of a pre-redox process, and the ultra-high-strength strip steel has good platability.

5) With the use of a secondary reheating device, the strip steel temperature can be raised twice before the hot-dip galvanizing treatment. A third-generation high-strength steel (QP steel) product can be cooled quickly to a lower temperature, and then immediately heated quickly to a higher temperature for long-term carbon redistribution treatment. After the treatment is completed, it is quickly reheated for a second time to a temperature at which it is put into a hot-dip galvanizing zinc pot to carry out the galvanizing treatment.

6) After preheating, the temperature of the strip steel is high, and the primary utilization rate of heat energy is high.

### Rapid Production Line for Continuously Annealed Strip Steel

The rapid production line for continuously annealed strip steel according to the present disclosure can achieve the following purposes: when direct fire heating is used, the waste heat of the direct fire combustion exhaust gas can be utilized fully to preheat the strip steel quickly to a temperature of at least 350° C., and the direct fire combustion exhaust gas is prevented from directly contacting the strip steel in the preheating furnace for a long time, thereby avoiding formation of an excessively thick oxide layer on the surface of the strip steel. When direct fire heating is not used, a new heating technology is used to make full use of the waste heat of the combustion exhaust gas, and the waste heat of the combustion exhaust gas is substantially all transferred to the strip steel, thereby improving the primary utilization rate of thermal energy, so that the combustion exhaust gas can be discharged directly after fully heating the strip steel, with no need to add a boiler or superheated water heating device for reutilization of the waste heat, so that the investment and footprint are reduced significantly. In addition, ultra-high-strength steel can be heated rapidly and cooled rapidly, and the heat treatment cycle period of the strip steel can be shortened. The implementation of the process technology of rapid heating, rapid cooling and rapid heat treatment enables production of various advanced high-strength steel products with higher strength grades using alloy components for lower grades, which can not only reduce the production cost of the high-strength steel, but also improve the mechanical performances and subsequent processing performances (such as welding performance and coating performance) of the various ultra-high-strength steel products, thereby significantly promoting the market competitiveness of the high-strength steel products.

To achieve the above purposes, the technical solution of the present disclosure is:

A rapid production line for annealed strip steel, including the following stations in sequence: uncoiling—welding—inlet looper—washing—central continuous post-processing—temper rolling—outlet looper—coiling; wherein the central continuous post-processing station includes in sequence a preheating section, a heating section, a soaking section, a slow cooling section, a rapid cooling section, a reheating section, an overaging section, a final gas jet cooling section, and a final water cooling section; a jet direct fire preheating device or a jet-radiation composite heating device is used for the preheating section; a direct fire heating section and/or a radiant tube heating section is used for the heating section; in the soaking section, a radiant tube soaking or a jet-radiation composite heating device is used for the soaking; and high hydrogen cooling, or mist cooling, or water quenching cooling is used for the rapid cooling section.

According to the present disclosure, there is further designed a rapid production line for annealed strip steel, including the following stations in sequence: uncoiling—welding—inlet looper—washing—central continuous post-processing—temper rolling—outlet looper—coiling; wherein the central continuous post-processing station includes in sequence a preheating section, a heating section, a radiant tube soaking section, a slow cooling section, a rapid cooling section, a reheating section, an overaging section, a final gas jet cooling section, and a final water cooling section; a jet direct fire preheating device or a jet-radiation composite heating device is used for the preheating section; a direct fire heating section and/or a radiant tube heating section is used for the heating section; for the rapid cooling section, a high hydrogen cooling section is provided in parallel with a mist cooling or water quenching cooling section, or mist cooling and a water quenching cooling are provided in parallel and a connecting channel is provided between the mist cooling and the water quenching cooling, or high hydrogen cooling is provided in parallel with mist cooling and water quenching cooling section and a connecting channel is provided between the mist cooling section and the water quenching cooling section.

Further, a selectable pickling section is provided after the final water cooling section. It may be used for pickling the strip steel when the strip steel passes through the pickling section device. If the strip steel does not need to be pickled, the strip steel can bypass the pickling section device.

Still further, a selectable flash plating section is provided after the pickling section. The pickled strip steel may enter the flash plating section to produce a flash-plated product such as a product flash-plated with nickel or zinc. When the strip steel does not need to be flash plated, the strip steel can bypass the flash plating section.

Preferably, a washing station is provided between the welding station and the inlet looper station. The strip steel may be washed by passing through the washing station device; alternatively, the strip steel may bypass the washing station. Preferably, washing stations are provided before and after the inlet looper station. In this case, the strip steel may be washed for the first time, introduced into the looper, washed for the second time, and then introduced into the central continuous post-processing station.

Preferably, a finishing station is provided before the coiling station, and the strip steel is finished before being coiled.

Preferably, an intermediate looper station is provided before the temper rolling station.

Preferably, a tension levelling station is provided between the temper rolling station and the outlet looper station.

Preferably, a surface post-treatment station such as that for passivation or anti-fingerprint treatment is provided between the temper rolling station and the outlet looper station, and the strip steel may be subjected to surface treatment such as passivation or anti-fingerprint treatment before entering the outlet looper. Alternatively, both a tension levelling station and a surface post-treatment station such as that for passivation or anti-fingerprint treatment are provided between the temper rolling station and the outlet looper station, and the strip steel may be subjected to tension levelling and/or surface treatment such as passivation or anti-fingerprint treatment before entering the outlet looper.

According to the present disclosure, the radiant tube soaking section may be changed into a jet-radiation composite heating device for soaking to achieve rapid regulation of the soaking temperature of the strip steel when the working conditions change, such as changes in strip steel thickness specification, target temperature, unit speed, etc.

The differences or innovation points of the production line of the present disclosure as compared with the conventional continuous heat treatment line include:

When direct fire heating is used, a jet direct fire preheating section is used instead of a common preheating section. The significant features of the jet direct fire preheating section over the common preheating section include:

(1) An in-furnace heat exchanger (the heat exchanger is not provided outside the furnace) is used to heat a recycled nitrogen-hydrogen protective gas, and the heated nitrogen-hydrogen protective gas is jetted at a high speed onto the upper and lower surfaces of the strip steel to achieve forced convection heat exchange, thereby preheating the strip steel fast and efficiently. Compared with the traditional preheating process, this process significantly reduces the heat loss from the furnace housing and the protective gas channel, makes more full use of the waste heat of the combustion exhaust gas, and has higher heating efficiency and a faster heating rate.

(2) In the jet direct fire preheating section, the combustion exhaust gas from the heating section passes through the heat exchanger chamber of the preheating section. During the passing process, the combustion exhaust gas from the heating section fully exchanges heat with the heat exchanger in the heat exchanger chamber to heat the nitrogen-hydrogen protective gas. Therefore, in the jet direct fire preheating section, the combustion exhaust gas from the heating section is not always in direct contact with the strip steel (when direct fire heating is used in the heating section, the jet direct fire preheating section is only in direct contact with the strip steel at high temperature for a short time, and the exhaust gas at this time is a reducing atmosphere or a slightly oxidizing atmosphere), thereby avoiding overoxidation of the strip steel surface.

(3) When direct fire heating is used in the heating section, the incompletely burned fuel gas in the direct fire combustion exhaust gas undergoes oxygen-enriched secondary combustion in a semi-sealed unit at the top of the jet preheating section, but the burning flame does not contact the strip steel, thereby effectively avoiding overoxidation of the strip steel surface.

(4) The strip steel is preheated to a higher temperature. When direct fire heating is used in the heating section, due to the high heat transfer efficiency of the high-temperature nitrogen-hydrogen protective gas in the jet direct fire preheating, the temperature of the preheated strip steel can reach at least 350° C., which is at least 100° C. higher than the strip steel temperature in the common preheating section.

(5) When direct fire heating is used in the heating section, the temperature of the direct fire combustion exhaust gas coming out of the jet direct fire preheating section according to the present disclosure is usually much lower than 750° C. (if a sufficient number of high-speed jet preheating units are provided, it can even be 200° C. or lower, suitable for direct discharge), and there is no need to mix cold air into the direct fire combustion exhaust gas for reutilization outside the furnace, or no need for reutilization at all.

When direct fire heating is not used, a jet-radiation composite heating section device is used to heat the strip steel quickly. In addition to the use of the radiation of the radiant tube to heat the strip steel, the heating device also uses the combustion exhaust gas of the radiant tube to heat a recycled nitrogen-hydrogen protective gas, and then the nitrogen-hydrogen protective gas is jetted onto the upper and lower surfaces of the strip steel to achieve forced convection heat exchange. The heat exchange efficiency is high. The temperature of the exhaust gas after use can be below 250° C., suitable for direct discharge. The combustion heat is substantially all transferred to heat the strip steel.

The coordinated use of the direct fire heating device or jet-radiation composite heating device and the high hydrogen rapid cooling device allows for rapid heating and rapid cooling annealing treatments of high-strength steel, thereby improving the strength of the high-strength steel.

The technical solution of the present disclosure enables continuous production of ultra-high-strength steel with three different surface states generated by: cold-rolling annealing, pickling and flash plating.

The beneficial effects of the present disclosure include:

1) After preheating, the temperature of the strip steel is high, and the primary thermal energy utilization rate is high.

2) Rapid heating and rapid cooling treatments of the strip steel can be implemented, and strip steel products with high strength grades can be produced.

3) When a jet-radiation composite heating device is utilized for soaking, rapid regulation of the soaking temperature of the strip steel can be achieved when the working conditions change, such as changes in strip steel thickness specification, target temperature, unit speed, etc., which can reduce the quality loss caused by substandard strip steel temperature.

4) The implementation of the process technology of rapid heating, rapid cooling and rapid heat treatment enables production of various advanced high-strength steel products with higher strength grades using alloy components for lower grades. The strength of 590 MPa-grade products can be achieved using alloy components for 450 MPa-grade products, and the performances of 980 MPa-grade products can be achieved using alloy components for 780 MPa-grade products. Not only the production cost of the high-strength steel can be reduced, but also the mechanical performances and subsequent processing performances (such as welding performance and coating performance) of the various ultra-high-strength steel products can be improved, thereby significantly promoting the market competitiveness of the high-strength steel products.

5) Rapid heating and rapid cooling treatments of ultra-high-strength steel are enabled, and the heat treatment cycle period of strip steel is shortened.

### Rapid Production Line for Continuously Annealed High-Strength Strip Steel

The present disclosure proposes a rapid production line for continuously annealed high-strength strip steel, wherein jet-radiation composite heating and transverse magnetic induction heating are used to achieve rapid heating of the strip steel, and a high hydrogen cooling section, or a mist cooling section, or a water quenching cooling section is used to achieve rapid cooling of the strip steel, thereby shortening the heat treatment cycle period of the strip steel. The implementation of this rapid heat treatment process technology enables production of various advanced high-strength steel products with higher strength grades using alloy components for lower grades, which can not only reduce the production cost of the high-strength steel, but also improve the mechanical performances and subsequent processing performances (such as welding performance and coating performance) of the various ultra-high-strength steel products. At the same time, the strip steel can be quickly heated to a temperature of at least 900° C. to achieve ultra-high temperature annealing treatment of the high-strength steel.

To achieve the above object, the technical solution of the present disclosure is:

A rapid production line for annealed high-strength strip steel, including the following stations in sequence: uncoiling—welding—inlet looper—washing—central continuous post-processing—temper rolling—outlet looper—coiling; wherein the central continuous post-processing station includes in sequence a jet-radiation composite heating section, a radiant tube heating section, a transverse magnetic induction heating section, a soaking section, a slow cooling section, a rapid cooling section, a reheating section, an overaging section, a final gas jet cooling section, and a final water cooling section; in the jet-radiation composite heating section, a radiant tube is installed inside a high-speed gas jet bellows to rapidly transfer the heat generated by the combustion gas of the radiant tube to the strip steel through both high-speed high-temperature gas jet and radiation, thereby enabling rapid heating of the strip steel; the rapid cooling section includes a high hydrogen cooling section or a mist cooling section or a water quenching cooling section; and a radiant tube heating device or a jet-radiation composite heating device is used for the soaking section.

Further, the present disclosure also provides a rapid production line for annealed high-strength strip steel, including the following stations in sequence: uncoiling—welding—inlet looper—washing—central continuous post-processing—temper rolling—outlet looper—coiling; wherein the central continuous post-processing station includes in sequence a jet-radiation composite heating section, a radiant tube heating section, a transverse magnetic induction heating section, a soaking section, a slow cooling section, a rapid cooling section, a reheating section, an overaging section, a final gas jet cooling section, and a final water cooling section; in the jet-radiation composite heating section, a radiant tube is installed inside a high-speed gas jet bellows to rapidly transfer the heat generated by the combustion gas of the radiant tube to the strip steel through both high-speed high-temperature gas jet and radiation, thereby enabling rapid heating of the strip steel; the rapid cooling section includes a high hydrogen cooling section, a mist cooling section or a water quenching cooling section, and the high hydrogen cooling section is provided in parallel with the mist cooling section, or the high hydrogen cooling section is provided in parallel with the water quenching cooling section; and a radiant tube heating device or a jet-radiation composite heating device is used for the soaking section.

In this production line, a combination of a jet-radiation composite heating device+a transverse magnetic induction heating section is utilized together with a rapid cooling means selected from a high hydrogen cooling section or a mist cooling section or a water quenching cooling section to carry out rapid heating and rapid cooling treatments, thereby enabling continuous production of the ultra-high-strength strip steel.

Further, the rapid production line for annealed high-strength strip steel according to the present disclosure includes the following stations in sequence: uncoiling—welding—inlet looper-washing—central continuous post-processing—temper rolling—outlet looper—coiling; wherein the central continuous post-processing station includes in sequence a jet-radiation composite heating section, a radiant tube heating section, a transverse magnetic induction heating section, a radiant tube soaking section, a slow cooling section, a rapid cooling section, a reheating section, an overaging section, a final gas jet cooling section, and a final water cooling section; in the jet-radiation composite heating section, a radiant tube is installed inside a high-speed gas jet bellows to rapidly transfer the heat generated by the combustion gas of the radiant tube to the strip steel through both high-speed high-temperature gas jet and radiation, thereby enabling rapid heating of the strip steel; the rapid cooling section includes a mist cooling section and a water quenching cooling section provided in parallel, and a connecting channel is provided between the mist cooling section and the water quenching cooling section, thereby forming three cooling modes in which the strip steel may be subjected to mist cooling followed by water quenching cooling, or mist cooling only, or water quenching cooling only; and a radiant tube heating device or a jet-radiation composite heating device is used for the soaking section; and the transverse magnetic induction heating section is used to further increase the temperature of the high-temperature strip steel rapidly.

Further, the rapid cooling section also includes a high-hydrogen cooling section, wherein the high-hydrogen cooling section is provided in parallel with the mist cooling section; the high-hydrogen cooling section is provided in parallel with the mist cooling section+water quenching cooling section provided in series to form a fourth cooling mode for the strip steel which may be alternatively subjected only to the high-hydrogen cooling section.

Preferably, a selectable pickling section is provided after the final water cooling section.

Preferably, a selectable flash plating section is provided after the pickling section.

Preferably, a washing station is provided between the welding station and the inlet looper station. Preferably, washing stations are provided before and after the inlet looper station.

Preferably, a finishing station is provided before the coiling station.

Preferably, an intermediate looper station is provided before the temper rolling station.

Preferably, a tension levelling station is provided between the temper rolling station and the outlet looper station.

Preferably, a surface post-treatment station such as that for passivation or anti-fingerprint treatment is provided between the temper rolling station and the outlet looper station.

Preferably, both a tension levelling station and a surface post-treatment station such as that for passivation or anti-fingerprint treatment are provided between the temper rolling station and the outlet looper station.

In this production line, a jet-radiation composite heating device, a transverse magnetic induction heating section and a rapid cooling means selected from a high hydrogen cooling section or a mist cooling section or a water quenching cooling section are utilized together to carry out rapid heating and rapid cooling treatments, thereby enabling continuous production of the ultra-high-strength strip steel.

The differences or innovation points of the production line of the present disclosure as compared with the conventional continuous heat treatment line include:

According to the present disclosure, a jet-radiation composite heating device is used to heat the strip steel quickly. In addition to the use of the radiation of a radiant tube to heat the strip steel, the heating device also uses the combustion exhaust gas of the radiant tube to heat a recycled nitrogen-hydrogen protective gas or an all-hydrogen gas (hydrogen concentration 100%), and then the nitrogen-hydrogen protective gas or all-hydrogen gas is jetted onto the upper and lower surfaces of the strip steel to achieve forced convection heat exchange. The heat exchange efficiency is high. The temperature of the exhaust gas after use can be below 250° C., suitable for direct discharge. The combustion heat is substantially all transferred to heat the strip steel.

By providing the transverse magnetic induction heating device after the radiant tube heating section, the temperature of the high-temperature strip steel can be further increased quickly, and the strip steel can be heated to at least 900° C. for annealing treatment.

The present disclosure enables rapid heating and rapid cooling annealing treatments of high-strength steel by using a jet-radiation composite heating device+a transverse magnetic induction heating device in conjunction with a high hydrogen rapid cooling device, thereby improving the strength of the high-strength steel.

The present disclosure enables continuous production of ultra-high-strength steel with three different surface states generated by: cold-rolling annealing, pickling and flash plating.

The beneficial effects of the present disclosure include:

1) The present disclosure enables rapid heating and rapid cooling treatments of strip steel, and enables production of high-strength strip steel products with high strength grades.

2) The present disclosure enables ultra-high temperature annealing at 900° C. or above.

3) When jet-radiation composite soaking is utilized according to the present disclosure, rapid regulation of the soaking temperature of the strip steel can be achieved when the working conditions change, such as changes in strip steel thickness specification, target temperature, unit speed, etc., which can reduce the quality loss caused by substandard strip steel temperature.

4) The implementation of the process technology of rapid heating, rapid cooling and rapid heat treatment enables production of various advanced high-strength steel products with higher strength grades using alloy components for lower grades. The strength of 590 MPa-grade products can be achieved using alloy components for 450 MPa-grade products, and the performances of 980 MPa-grade products can be achieved using alloy components for 780 MPa-grade products. Not only the production cost of the high-strength steel can be reduced, but also the mechanical performances and subsequent processing performances (such as welding performance and coating performance) of the various ultra-high-strength steel products can be improved, thereby significantly promoting the market competitiveness of the high-strength steel products.

5) The present disclosure enables rapid heating and rapid cooling treatments of ultra-high-strength steel, and the heat treatment cycle period of the strip steel is shortened.

### Rapid Production Line for Annealed Ultra-High-Strength Strip Steel

The rapid production line for annealed ultra-high-strength strip steel according to the present disclosure can achieve the following purposes: when direct fire heating is used, the waste heat of direct fire combustion exhaust gas is fully utilized, and the strip steel can be quickly preheated to a temperature of at least 350° C. At the same time, the direct fire combustion exhaust gas is prevented from directly contacting the strip steel in the preheating furnace for a long time, thereby avoiding formation of an excessively thick oxide layer on the surface of the strip steel; and the waste heat of the combustion exhaust gas is substantially all transferred to the strip steel, thereby improving the primary utilization rate of thermal energy, so that the combustion exhaust gas can be directly discharged after fully heating the strip steel, with no need to add a boiler or superheated water heating device for reutilization of the waste heat, so that the investment and footprint are reduced significantly. Soaking is improved to enable rapid regulation of the soaking temperature of the strip steel. Ultra-high temperature heating is improved. That is, a transverse magnetic induction heating technology is used to further increase the heating temperature of the high-temperature strip steel quickly, so as to implement ultra-high temperature annealing of the high-strength strip steel, and improve the energy utilization rate. In addition, ultra-high-strength steel can be heated rapidly and cooled rapidly, and the heat treatment cycle period of the strip steel can be shortened. The implementation of the process technology of rapid heating, rapid cooling and rapid heat treatment enables production of various advanced high-strength steel products with higher strength grades using alloy components for lower grades, which can not only reduce the production cost of the high-strength steel, but also improve the mechanical performances and subsequent processing performances (such as welding performance and coating performance) of the various ultra-high-strength steel products, thereby significantly promoting the market competitiveness of the high-strength steel products.

To achieve the above purposes, the technical solution of the present disclosure is:

A rapid production line for annealed ultra-high-strength strip steel, including the following stations in sequence: uncoiling—welding—inlet looper—washing—central continuous post-processing—temper rolling—outlet looper—coiling, wherein the central continuous post-processing station includes in sequence a jet direct fire preheating section, a direct fire heating section, a radiant tube heating section, a transverse magnetic induction heating section, a soaking section, a slow cooling section, a fast cooling section, a reheating section, an overaging section, a final gas jet cooling section and a final water cooling section; wherein a radiant tube soaking section or a jet-radiation composite soaking section is used for the soaking section; in the rapid cooling section, a high hydrogen cooling section or a mist cooling section or a water quenching cooling section is used; alternatively, a high hydrogen cooling section is provided in parallel with a mist cooling section or a water quenching cooling section; alternatively, a mist cooling section is provided in parallel with a water quenching cooling section, and a connecting channel is provided between the mist cooling section and the water quenching cooling section; alternatively, a high hydrogen cooling section, a mist cooling section, and a water quenching cooling section are provided in parallel, and a connecting channel is provided between the mist cooling section and the water quenching cooling section, wherein the high hydrogen cooling section is connected to the reheating section.

Preferably, a selectable pickling section is provided after the final water cooling section, and the strip steel may pass through the pickling section or bypass the pickling section.

Preferably, a selectable flash plating section is provided after the pickling section, and the strip steel may be flash plated with nickel or zinc after pickling; alternatively, the flash plating section may be skipped to produce a product with a pickled surface directly.

Preferably, a washing station is provided between the welding station and the inlet looper station, and preferably, washing stations are provided before and after the inlet looper station, wherein the strip steel may be washed for the first time, introduced into the looper, washed for the second time, and then introduced into the central continuous post-processing station.

Preferably, a finishing station is provided before the coiling station, and the strip steel is finished before coiling.

Preferably, an intermediate looper station is provided before the temper rolling station. After central continuous post-processing, the strip steel enters the central looper, and then enters the temper rolling station, such that the working rolls of the temper rolling machine can be replaced without reducing the speed of the central continuous post-processing.

Preferably, a tension levelling station is provided between the temper rolling station and the outlet looper station, and the strip steel may be subjected to tension levelling treatment before entering the outlet looper.

Preferably, a surface post-treatment station such as that for passivation or anti-fingerprint treatment is provided between the temper rolling station and the outlet looper station, and the strip steel may be subjected to surface treatment such as passivation or anti-fingerprint treatment before entering the outlet looper.

Preferably, a tension levelling station and a surface post-treatment station such as that for passivation or anti-fingerprint treatment are provided between the temper rolling station and the outlet looper station, and the strip steel may be subjected to tension levelling and/or surface post-treatment such as passivation or anti-fingerprint treatment before entering the outlet looper.

The differences or innovation points of the production line of the present disclosure as compared with the conventional continuous heat treatment line include:

1) When direct fire heating is used, a jet direct fire preheating section is used instead of a common preheating section. The significant features of the jet direct fire preheating section over the common preheating section include:

(1) An in-furnace heat exchanger (the heat exchanger is not provided outside the furnace) is used to heat the recycled nitrogen-hydrogen protective gas, and the heated nitrogen-hydrogen protective gas is jetted at a high speed onto the upper and lower surfaces of the strip steel to achieve forced convection heat exchange, thereby preheating the strip steel fast and efficiently. Compared with the traditional preheating process, this process significantly reduces the heat loss from the furnace housing and the protective gas channel, makes more full use of the waste heat of the combustion exhaust gas, and has higher heating efficiency and a faster heating rate.

(2) In the jet direct fire preheating section, the combustion exhaust gas from the heating section passes through the heat exchanger chamber of the preheating section. During the passing process, the combustion exhaust gas from the heating section fully exchanges heat with the heat exchanger in the heat exchanger chamber to heat the nitrogen-hydrogen protective gas. Therefore, in the jet direct fire preheating section, the combustion exhaust gas from the heating section is not always in direct contact with the strip steel (when direct fire heating is used in the heating section, the jet direct fire preheating section is only in direct contact with the strip steel at high temperature for a short time, and the exhaust gas at this time is a reducing atmosphere or a slightly oxidizing atmosphere), thereby avoiding overoxidation of the strip steel surface.

(3) When direct fire heating is used in the heating section, the incompletely burned fuel gas in the direct fire combustion exhaust gas undergoes oxygen-enriched secondary combustion in a semi-sealed unit at the top of the jet preheating section, but the burning flame does not contact the strip steel, thereby effectively avoiding overoxidation of the strip steel surface.

(4) The strip steel is preheated to a higher temperature. When direct fire heating is used in the heating section, due to the high heat transfer efficiency of the high-temperature nitrogen-hydrogen protective gas in the jet direct fire preheating, the temperature of the preheated strip steel can reach at least 350° C., which is at least 100° C. higher than the strip steel temperature in the common preheating section.

(5) When direct fire heating is used in the heating section, the temperature of the direct fire combustion exhaust gas coming out of the jet direct fire preheating section according to the present disclosure is usually much lower than 750° C. (if a sufficient number of high-speed jet preheating units are provided, it can even be 200° C. or lower, suitable for direct discharge), and there is no need to mix cold air into the direct fire combustion exhaust gas for reutilization outside the furnace, or no need for reutilization at all.

2) The coordinated use of a direct fire heating device, a transverse magnetic induction heating device and a high hydrogen rapid cooling device allows for rapid heating and rapid cooling annealing treatments of high-strength steel, thereby improving the strength of the high-strength steel.

3) Transverse magnetic induction heating is utilized to further increase the temperature of the high-temperature strip steel quickly, thereby allowing for ultra-high temperature annealing of the high-strength steel.

4) According to the present disclosure, a jet-radiation composite soaking section is used for the soaking section to achieve rapid regulation of the soaking temperature of the strip steel when the working conditions change, such as changes in strip steel thickness specification, target temperature, unit speed, etc.

5) The technical solution of the present disclosure also enables continuous production of ultra-high-strength steel with three different surface states generated by: cold-rolling annealing, pickling and flash plating.

The beneficial effects of the present disclosure include:

1) According to the present disclosure, the temperature of the strip steel is high after preheating, and the primary utilization rate of heat energy is high.

2) The present disclosure enables rapid heating and rapid cooling treatments of the strip steel, and enables production of strip steel products with high strength grades.

3) When jet-radiation composite soaking is utilized according to the present disclosure, rapid regulation of the soaking temperature of the strip steel can be achieved when the working conditions change, such as changes in strip steel thickness specification, target temperature, unit speed, etc., which can reduce the quality loss caused by substandard strip steel temperature.

4) The implementation of the process technology of rapid heating, rapid cooling and rapid heat treatment according to the present disclosure enables production of various advanced high-strength steel products with higher strength grades using alloy components for lower grades.

The strength of 590 MPa-grade products can be achieved using alloy components for 450 MPa-grade products, and the performances of 980 MPa-grade products can be achieved using alloy components for 780 MPa-grade products. Not only the production cost of the high-strength steel can be reduced, but also the mechanical performances and subsequent processing performances (such as welding performance and coating performance) of the various ultra-high-strength steel products can be improved, thereby significantly promoting the market competitiveness of the high-strength steel products.

5) The present disclosure enables rapid heating and rapid cooling treatments of ultra-high-strength steel, and the heat treatment cycle period of the strip steel is shortened.

6) The technical solution of the present disclosure enables continuous production of ultra-high-strength steel with three different surface states generated by: cold-rolling annealing, pickling and flash plating.

### Ultra-Short-Process Production Line for Dual-Purpose Strip Steel

The ultra-short-process production line for dual-purpose strip steel according to the present disclosure enables flexible selection between production of continuously annealed products and production of hot-dip galvanized products according to market demand, and allows for a smaller unit footprint, a smaller size of operating personnel, less consumption of fuel gas, and a decrease in the overall operating cost of the unit. With the use of a rapid heating technology, fine-grained austenite can be generated in the process of heating high-strength steel, thereby further improving the strength of the high-strength steel. The high-strength steel can be heated rapidly and cooled rapidly, and the heat treatment cycle period of the strip steel can be shortened. The implementation of the process technology of rapid heating, rapid cooling and rapid heat treatment enables production of various advanced high-strength steel products with higher strength grades using alloy components for lower grades, which can not only reduce the production cost of the high-strength steel, but also improve the mechanical performances and subsequent processing performances (such as welding performance and coating performance) of the various ultra-high-strength steel products, thereby significantly promoting the market competitiveness of the high-strength steel products.

To achieve the above purposes, the technical solution of the present disclosure is:

An ultra-short-process production line for dual-purpose strip steel, including the following stations in sequence: uncoiling—welding—inlet looper—central continuous post-processing—temper rolling—outlet looper—coiling; wherein the central continuous post-processing station includes in sequence a transverse magnetic induction heating section, a radiant tube soaking section, a mist cooling section and/or a water quenching cooling section, a pickling section, a reheating section, a parallel arrangement of (furnace nose section+zinc pot section+air knife section+post-plating cooling section) and (mobile channel section+overaging section+final gas jet cooling section), and a final water cooling section.

Transverse magnetic induction heating is selected for rapid heating of the strip steel, and mist cooling and/or water quenching cooling is selected for rapid cooling, thereby enabling such a rapid heat treatment process of rapid heating and rapid cooling for the strip steel.

As for the mist cooling section and/or the water quenching cooling section, the strip steel may be subjected to mist cooling, or water quenching cooling, or mist cooling followed by water quenching cooling.

The (furnace nose section+zinc pot section+air knife section+post-plating cooling section) is provided in parallel with the (mobile channel section+overaging section+final gas jet cooling section). The strip steel may go through the furnace nose section+zinc pot section+air knife section+post-plating cooling section, that is, taking a hot-dip galvanizing process path for producing a pure zinc hot-dip galvanized product; alternatively, it may go through the mobile channel section+overaging section+final gas jet cooling section, that is, taking a continuous annealing process path for producing a continuously annealed product. The mobile channel section is provided in parallel with the furnace nose section, and the mobile channel section may be movably switched to an online position, or movably switched to an offline position. The switching between the continuous annealing process path and the pure zinc hot-dip galvanizing process path is achieved by cutting the strip steel and reloading the strip steel.

An ultra-short-process production line for dual-purpose strip steel includes the following stations in sequence: uncoiling—welding—inlet looper—central continuous post-processing—temper rolling—outlet looper—coiling; wherein the central continuous post-processing station includes in sequence a transverse magnetic induction heating section, a radiant tube soaking section, a mist cooling section and/or a water quenching cooling section, a pickling section, a reheating section, a parallel arrangement of (furnace nose section+zinc pot section+air knife section+alloying heating section+alloying soaking section+post-plating cooling section) and (mobile channel section+overaging section+final gas jet cooling section), and a final water cooling section.

Transverse magnetic induction heating is selected for rapid heating of the strip steel, and mist cooling and/or water quenching cooling is selected for rapid cooling, thereby enabling such a rapid heat treatment process of rapid heating and rapid cooling for the strip steel.

As for the mist cooling section and/or the water quenching cooling section, the strip steel may be subjected to mist cooling, or water quenching cooling, or mist cooling followed by water quenching cooling.

According to the present disclosure, there is designed a parallel arrangement of (furnace nose section+zinc pot section+air knife section+alloying heating section+alloying soaking section+post-plating cooling section) and (mobile channel section+overaging section+final gas jet cooling section). The strip steel may go through the furnace nose section+zinc pot section+air knife section+alloying heating section+alloying soaking section+post-plating cooling section, that is, taking a hot-dip galvannealing process path for producing a hot-dip galvannealed product.

When the alloying heating section+alloying soaking section is not started for operation, the strip steel passes through these process sections with no action on it, and thus a pure zinc hot-dip galvanized product will be produced. The strip steel may also go through the mobile channel section+overaging section+final gas jet cooling section, that is, taking a continuous annealing process path for producing a continuously annealed product.

The mobile channel section is designed in parallel with the furnace nose section. The mobile channel section may be movably switched to an online position, or movably switched to an offline position. The continuous annealing process path and the hot-dip galvanizing process path can be switched by cutting the strip steel and reloading the strip steel.

An ultra-short-process production line for dual-purpose strip steel includes the following stations in sequence: uncoiling—welding—inlet looper—central continuous post-processing—temper rolling—outlet looper—coiling; wherein the central continuous post-processing station includes in sequence a transverse magnetic induction heating section, a radiant tube soaking section, a mist cooling section and/or a water quenching cooling section, a pickling section, a reheating section, a uniform holding section, a secondary reheating section, a parallel arrangement of (furnace nose section+zinc pot section+air knife section+post-plating cooling section) and (mobile channel section+overaging section+final gas jet cooling section), and a final water cooling section.

Transverse magnetic induction heating is selected for rapid heating of the strip steel, and mist cooling and/or water quenching cooling is selected for rapid cooling, thereby enabling such a rapid heat treatment process of rapid heating and rapid cooling for the strip steel.

According to the design of the present disclosure, a uniform holding section+a secondary reheating section is utilized, which can realize a secondary reheating process for high-strength steel such as QP steel.

As for the mist cooling section and/or the water quenching cooling section, the strip steel may be subjected to mist cooling, or water quenching cooling, or mist cooling followed by water quenching cooling.

According to the present disclosure, there is designed a parallel arrangement of (furnace nose section+zinc pot section+air knife section+post-plating cooling section) and (mobile channel section+overaging section+final gas jet cooling section). The strip steel may go through the furnace nose section+zinc pot section+air knife section+post-plating cooling section, that is, taking a hot-dip galvanizing process path for producing a pure zinc hot-dip galvanized product; alternatively, it may go through the mobile channel section+overaging section+final gas jet cooling section, that is, taking a continuous annealing process path for producing a continuously annealed product.

The mobile channel section is designed in parallel with the furnace nose section, and the mobile channel section may be movably switched to an online position, or movably switched to an offline position. The switching between the continuous annealing process path and the pure zinc hot-dip galvanizing process path is achieved by cutting the strip steel and reloading the strip steel.

An ultra-short-process production line for dual-purpose strip steel includes the following stations in sequence: uncoiling—welding—inlet looper—central continuous post-processing—temper rolling—outlet looper—coiling; wherein the central continuous post-processing station includes in sequence a transverse magnetic induction heating section, a radiant tube soaking section, a mist cooling section and/or a water quenching cooling section, a pickling section, a reheating section, a uniform holding section, a secondary reheating section, a parallel arrangement of (furnace nose section+zinc pot section+air knife section+alloying heating section+alloying soaking section+post-plating cooling section) and (mobile channel section+overaging section+final gas jet cooling section), and a final water cooling section.

Transverse magnetic induction heating is selected for rapid heating of the strip steel, and mist cooling and/or water quenching cooling is selected for rapid cooling, thereby enabling such a rapid heat treatment process of rapid heating and rapid cooling for the strip steel.

According to the design of the present disclosure, a uniform holding section+a secondary reheating section is utilized, which can realize a secondary reheating process for high-strength steel such as QP steel. The design is also characterized by the mist cooling section and/or water quenching cooling section, wherein the strip steel may be subjected to mist cooling, or water quenching cooling, or mist cooling followed by water quenching cooling.

According to the present disclosure, there is designed a parallel arrangement of (furnace nose section+zinc pot section+air knife section+alloying heating section+alloying soaking section+post-plating cooling section) and (mobile channel section+overaging section+final gas jet cooling section). The strip steel may go through the furnace nose section+zinc pot section+air knife section+alloying heating section+alloying soaking section+post-plating cooling section, that is, taking a hot-dip galvannealing process path for producing a hot-dip galvannealed product. When the alloying heating section+alloying soaking section is not started for operation, the strip steel passes through these process sections with no action on it, and thus a pure zinc hot-dip galvanized product will be produced. The strip steel may also go through the mobile channel section+overaging section+final gas jet cooling section, that is, taking a continuous annealing process path for producing a continuously annealed product.

The mobile channel section is designed in parallel with the furnace nose section. The mobile channel section may be movably switched to an online position, or movably switched to an offline position. The continuous annealing process path and the hot-dip galvanizing process path can be switched by cutting the strip steel and reloading the strip steel.

Preferably, a mobile post-plating rapid cooling section is provided after the air knife section. The mobile post-plating rapid cooling section is set to be switchable between online and offline, and is provided in parallel with the alloying heating section (designed to be mobile). When producing a pure zinc hot-dip galvanized product, the mobile post-plating rapid cooling section is online to quickly cool the galvanized strip steel, and the alloying heating section is offline at this time; when producing a hot-dip galvannealed product, the mobile post-plating rapid cooling section is offline, and the alloying heating section is online to implement alloying heating of the strip steel.

Preferably, a selectable washing station is provided between the welding station and the inlet looper station, and the strip steel may be washed by passing through the washing station, or may bypass the washing station.

Preferably, the washing station is provided after the inlet looper station, and the strip steel may be washed by passing through the washing station, or may bypass the washing station.

Preferably, washing stations are provided before and after the inlet looper station to perform secondary washing on the strip steel to further improve the surface quality of the strip steel.

Preferably, a longitudinal magnetic induction heating section is further provided before the transverse magnetic induction heating section. The strip steel may be subjected to longitudinal magnetic induction heating by passing through the longitudinal magnetic induction heating section; alternatively, it may pass through the longitudinal magnetic induction heating section without being heated and directly enter the transverse magnetic induction heating section to be heated.

Preferably, an iron or nickel flash plating station is provided after the pickling section, and the pickled strip steel may be flash plated with iron or nickel to improve the platability of the strip steel.

Preferably, a finishing station is provided before the coiling station, and the strip steel is finished before coiling.

Preferably, an intermediate looper station is further provided before the temper rolling station to ensure that the quality of the strip steel is not lost when the working rolls of the temper rolling machine are replaced online.

Preferably, a tension levelling station is provided between the temper rolling station and the outlet looper station, and the strip steel may enter the outlet looper after tension levelling.

Preferably, a surface post-treatment station such as that for passivation or anti-fingerprint treatment is provided between the temper rolling station and the outlet looper station, and the strip steel may be subjected to surface post-treatment such as passivation or anti-fingerprint treatment before entering the outlet looper.

Preferably, both a tension levelling station and a corresponding surface post-treatment station such as that for passivation or anti-fingerprint treatment are provided between the temper rolling station and the outlet looper station. The strip steel may be subjected to surface post-treatment such as passivation or anti-fingerprint treatment before entering the outlet looper.

The differences or innovation points of the production line of the present disclosure as compared with the conventional continuous heat treatment line include:

1) Production of continuously annealed products or hot-dip galvanized products can be chosen flexibly.

2) The equipment is configured to be relatively simple, and has a small footprint.

3) Fewer people are needed on the production line.

4) The production line consumes less fuel gas.

5) The overall operating cost of the production line is low.

6) The production line generates less CO2 and NOx emissions, suitable for urban steel mills.

7) The coordinated use of a transverse magnetic induction heating device and a plurality of rapid cooling devices allows for rapid heating and rapid cooling annealing treatments, thereby enabling continuous production of rapidly heat-treated high-strength strip steel.

8) It's possible for continuous production of strip steel products with three different surface states generated by: cold rolling, pure zinc hot-dip galvanizing and hot-dip galvannealing.

The beneficial effects of the present disclosure include:

1) Production of continuously annealed products or hot-dip galvanized products can be chosen flexibly.

2) The equipment is configured to be relatively simple, and has a small footprint.

3) Fewer people are needed on the production line.

4) The production line consumes less fuel gas.

5) The overall operating cost of the production line is low.

6) The production line generates less CO2 and NOx emissions, suitable for urban steel mills.

7) The implementation of the process technology of rapid heating, rapid cooling and rapid heat treatment enables production of various advanced high-strength steel products with higher strength grades using alloy components for lower grades. The strength of 590 MPa-grade products can be achieved using alloy components for 450 MPa-grade products, and the performances of 980 MPa-grade products can be achieved using alloy components for 780 MPa-grade products. Not only the production cost of the high-strength steel can be reduced, but also the mechanical performances and subsequent processing performances (such as welding performance and coating performance) of the various ultra-high-strength steel products can be improved.

8) Rapid heating and rapid cooling treatments of ultra-high-strength steel are enabled, and the heat treatment cycle period of strip steel is shortened.

### Ultra-Short-Process Production Line for Pure Zinc Hot-Dip Galvanized High-Strength Strip Steel

The ultra-short-process production line for pure zinc hot-dip galvanized high-strength strip steel according to the present disclosure can achieve the following purposes: 1) reducing the unit footprint; 2) reducing the size of the operating personnel; 3) reducing the overall operating cost of the unit; 4) generating fine-grained austenite in the process of heating the high-strength steel with the use of a rapid heating technology, thereby further improving the strength of the high-strength steel; 5) subjecting the high-strength steel to rapid heating and ultra-rapid cooling to shorten the heat treatment cycle period of the strip steel, thereby enabling production of ultra-high-strength steel products with a high martensite content; 6) implementing the process technology of rapid heating, rapid cooling and rapid heat treatment to enable production of various advanced high-strength steel products with higher strength grades using alloy components for lower grades, which can not only reduce the production cost of the high-strength steel, but also improve the mechanical performances and subsequent processing performances (such as welding performance and coating performance) of the various ultra-high-strength steel products, thereby significantly promoting the market competitiveness of the high-strength steel products; 7) subjecting the high-strength steel to ultra-high temperature heating, wherein the strip steel can be heated to a temperature of 900° C. or even higher, thereby realizing ultra-high temperature heating annealing treatment of the hot-dip galvanized high-strength steel.

To achieve the above purposes, the technical solution according to the present disclosure is:

An ultra-short-process production line for pure zinc hot-dip galvanized high-strength strip steel, including the following stations in sequence: uncoiling—welding—inlet looper—central continuous post-processing—outlet looper—temper rolling—coiling; wherein the central continuous post-processing station includes in sequence a rapid heating station, a soaking station, a rapid cooling station, a surface modification station and a pure zinc hot-dip galvanizing station; a direct fire heating device is used for the rapid heating station; a radiant tube soaking device or a jet-radiation composite soaking device is used for the soaking station; a mist cooling device or a water quenching cooling device is used for the rapid cooling station; a pickling device is used for the surface modification station; the pure zinc hot-dip galvanizing station is provided with a reheating section, a furnace nose section, a zinc pot section, an air knife section, a post-plating cooling section and a final water cooling section in sequence. Thus, both a direct fire heating device and a mist cooling device are used on the same production line for rapid heating and rapid cooling treatments, and a pickling device is used for surface modification, so as to improve the platability of the ultra-high-strength steel and enable continuous production of the hot-dip galvanized ultra-high-strength strip steel.

Preferably, the rapid heating station is provided with a direct fire heating device and a transverse magnetic induction heating device in sequence.

Preferably, in the surface modification station, a selectable iron or nickel flash plating device is provided after the pickling section, followed by the subsequent pure zinc hot-dip galvanizing station.

Preferably, in the pure zinc hot-dip galvanizing station, a selectable mobile post-plating rapid cooling device may be provided between the air knife section and the post-plating cooling section.

Preferably, the pure zinc hot-dip galvanizing station is replaced with a hot-dip galvannealing station, that is, an alloying heating section and an alloying soaking section are provided between the air knife section and the post-plating cooling section, so that both pure zinc hot-dip galvanized products and hot-dip galvannealed products can be produced.

Preferably, the hot-dip galvanizing station is provided with a selectable mobile post-plating rapid cooling section device in parallel with the alloying heating section after the air knife section.

Preferably, a washing station is provided between the welding station and the inlet looper station.

Preferably, a washing station is provided after the inlet looper station.

Preferably, a central looper device is provided before the temper rolling station.

Preferably, a finishing station device is provided between the coiling station and the outlet looper station, and the strip steel is coiled after finishing.

Preferably, a tension levelling station is provided between the temper rolling station and the outlet looper station.

Preferably, a surface post-processing station device such as that for passivation or anti-fingerprint treatment is provided between the temper rolling station and the outlet looper station.

Preferably, both a tension levelling station and a surface post-treatment station such as that for passivation or anti-fingerprint treatment are provided between the temper rolling station and the outlet looper station.

Preferably, in the soaking station, an electric radiant tube soaking device, a resistance wire soaking device or a resistance belt soaking device is used instead of the radiant tube soaking device or the jet-radiation composite soaking device.

The differences or innovation points of the present disclosure as compared with the conventional continuous heat treatment line include:

1) According to the technical solution of the present disclosure, the equipment is configured to be simple, and has a small footprint.

2) Fewer people are needed on the pure zinc hot-dip galvanized and hot-dip galvannealed ultra-high-strength steel production line according to the technical solution of the present disclosure.

3) The overall operating cost of the ultra-high-strength steel production line according to the technical solution of the present disclosure is low.

4) The use of the direct fire heating device enables pre-redox treatment of the ultra-high-strength steel to improve the platability of the high strength steel.

5) The coordinated use of the direct fire heating device+the transverse magnetic induction heating device and the mist cooling or water quenching cooling or mist+water quenching cooling device allows for rapid heating and ultra-rapid cooling annealing treatments of the high-strength steel, thereby reducing the enrichment of strengthening elements such as Si and Mn in the surface of the substrate from the substrate during the annealing process, which further improves the platability of the high-strength steel, and enables production of the ultra-high-strength steel with a high martensite content.

6) The technical solution of the present disclosure can quickly heat the strip steel to 900° C. or even higher by using a transverse magnetic induction heating device and a direct fire heating device in series.

7) The hot-dip galvannealed high-strength steel production line according to the technical solution of the present disclosure can produce hot-dip galvanized products with two types of coatings: hot-dip pure zinc coating and hot-dip alloy coating.

The beneficial effects of the present disclosure include:

1) The unit has a short length and a small footprint.

2) The size of the operating personnel is small, and only 4 people are needed to operate a unit.

3) The overall operating cost of the unit is low.

4) The implementation of the process technology of rapid heating, ultra-rapid cooling and rapid heat treatment enables production of various advanced high-strength steel products with higher strength grades using alloy components for lower grades. The strength of 590 MPa-grade products can be achieved using alloy components for 450 MPa-grade products, and the performances of 980 MPa-grade products can be achieved using alloy components for 780 MPa-grade products. Not only the production cost of the high-strength steel can be reduced, but also the mechanical performances and subsequent processing performances (such as welding performance and coating performance) of the various ultra-high-strength steel products can be improved, thereby significantly promoting the market competitiveness of the high-strength steel products.

5) The production of hot-dip galvanized and hot-dip galvannealed martensitic steel products is realized.

6) Rapid heating and rapid cooling treatments of high-strength steel are enabled, and the heat treatment cycle period of the strip steel is shortened.

7) Ultra-high temperature heating of high-strength steel is enabled, wherein the strip steel can be heated to a temperature of 900° C. or even higher, thereby realizing ultra-high temperature heating annealing treatment of the high-strength steel.

### Ultra-Short-Process Production Line for Ultra-High-Strength Strip Steel

The ultra-short-process production line for ultra-high-strength strip steel according to the present disclosure can achieve the following purposes: 1) reducing the unit footprint; 2) reducing the size of operating personnel; 3) reducing the overall operating cost of the unit; 4) generating fine-grained austenite in the process of heating ultra-high-strength steel with the use of a rapid heating technology, thereby further improving the strength of the ultra-high-strength steel; 5) subjecting the ultra-high-strength steel to rapid heating and rapid cooling to shorten the heat treatment cycle period of the strip steel; 6) implementing the process technology of rapid heating, rapid cooling and rapid heat treatment to enable production of various advanced high-strength steel products with higher strength grades using alloy components for lower grades, which can not only reduce the production cost of the high-strength steel, but also improve the mechanical performances and subsequent processing performances (such as welding performance and coating performance) of the various ultra-high-strength steel 1 products; 7) subjecting the ultra-high-strength steel to ultra-high temperature heating, wherein the strip steel can be heated to a temperature of 900° C. or even higher, thereby realizing ultra-high temperature heating annealing treatment of the ultra-high-strength steel.

To achieve the above purposes, the technical solution according to the present disclosure is:

An ultra-short-process production line for ultra-high-strength strip steel, including the following stations in sequence: uncoiling—welding—inlet looper—central continuous post-processing—outlet looper—coiling; wherein the central continuous post-processing station includes in sequence a rapid heating station, a soaking station and a rapid cooling station; a jet-radiation composite heating device is used for the rapid heating station; a radiant tube soaking device, a jet-radiation composite soaking device, an electric radiant tube soaking device, a resistance wire soaking device or a resistance belt soaking device is used for the soaking station; and a high hydrogen cooling device, a mist cooling device or a water quenching cooling device is used for the rapid cooling station.

Further, in the rapid heating station, a jet-radiation composite heating device and a transverse magnetic induction heating device are provided in series, and in the rapid cooling station, a mist cooling device and a water quenching cooling device are provided in series or in parallel, or a high-hydrogen cooling device and a water quenching cooling device are provided in parallel, or a high-hydrogen cooling device and a mist cooling device are provided in parallel, or a high-hydrogen cooling device, a mist cooling device and a water quenching cooling device are provided in parallel.

Preferably, a selectable washing station is provided between the welding station and the inlet looper station.

Further, in the rapid heating station, a selectable direct fire heating device is provided in parallel with a jet-radiation composite heating device+a transverse magnetic induction heating device provided in series. The strip steel may be heated by the direct fire heating device first and then by the jet-radiation composite heating device+the transverse magnetic induction heating device provided in series, or it may bypass the direct fire heating device and directly enter the jet-radiation composite heating device+the transverse magnetic induction heating device provided in series for heating.

Still further, in the rapid heating station, a selectable longitudinal magnetic induction heating device is provided in parallel or in series with a jet-radiation composite heating device+a transverse magnetic induction heating device provided in series. The strip steel may be heated by the longitudinal magnetic induction heating device first, or it may bypass the longitudinal magnetic induction heating device and directly enter the jet-radiation composite heating device+the transverse magnetic induction heating provided in series for heating.

Preferably, a selectable pickling section device is provided before the coiling station and after the central continuous post-processing station. It may be used for pickling the strip steel when the strip steel passes through the pickling section, and when the strip steel does not need to be pickled, the strip steel may bypass the pickling section.

Preferably, a selectable flash plating section is provided after the pickling section and before the coiling station. The pickled strip steel may enter the flash plating section for producing flash plated products such as those flash plated with nickel or zinc. When the strip steel does not need to be flash plated, the strip steel may bypass the flash plating section.

Preferably, a temper rolling station is provided before the coiling station, and the strip steel is temper rolled before coiling.

Preferably, a finishing station is provided between the coiling station and the temper rolling station, and the temper-rolled strip steel is finished before coiling.

Preferably, an electric radiant tube soaking device, or a resistance wire soaking device, or a resistance belt soaking device is used instead of a radiant tube soaking device or a jet-radiation composite soaking device to construct the production line of the present disclosure for producing ultra-high-strength strip steel in places where there is no gas supply.

Preferably, a selectable washing station is provided between the welding station and the inlet looper station, and the strip steel may be washed by passing through the washing station, or may bypass the washing station. Further preferably, the selectable washing station is provided immediately after the inlet looper station, so that when the strip steel enters the washing station device for washing, constant speed washing can be achieved to maintain a stable washing quality of the strip steel surface.

The differences or innovation points of the production line of the present disclosure as compared with the conventional continuous heat treatment line include:

1) The equipment of the present disclosure is configured to be simple, and has a small footprint.

2) Fewer people are needed on the ultra-high-strength steel production line of the present disclosure.

3) The overall operating cost of the ultra-high-strength steel production line of the present disclosure is low.

4) The ultra-high-strength steel production line of the present disclosure achieves low or even zero emission of CO2 and NOx, and is very suitable for construction in urban steel plants.

5) The coordinated use of a jet-radiation composite heating device and a variety of rapid cooling devices allows for rapid heating and rapid cooling annealing treatments of ultra-high-strength steel, thereby enabling continuous production of rapidly heat-treated ultra-high-strength strip steel.

6) Through the use of a direct fire heating device and a jet-radiation composite heating device in series, the present disclosure enables rapidly heating the strip steel to a temperature of 900° C. or even higher in an economical way.

7) According to the present disclosure, there are four process paths available in the rapid cooling station, and thus the production process is flexible and diverse.

8) The present disclosure enables continuous production of ultra-high-strength steel with three different surface states generated by: cold rolling, pickling and flash plating.

The beneficial effects of the present disclosure include:

1) The length of the unit can be shortened by about ⅓ compared with the existing production line.

2) The size of the operating personnel can be reduced, and one unit can be operated by only three or even two people.

3) The overall operating cost of the unit is low.

4) The implementation of the process technology of rapid heating, rapid cooling and rapid heat treatment enables production of various advanced high-strength steel products with higher strength grades using alloy components for lower grades. The strength of 590 MPa-grade products can be achieved using alloy components for 450 MPa-grade products, and the performances of 980 MPa-grade products can be achieved using alloy components for 780 MPa-grade products. Not only the production cost of the high-strength steel can be reduced, but also the mechanical performances and subsequent processing performances (such as welding performance and coating performance) of the various ultra-high-strength steel products can be improved, thereby significantly promoting the market competitiveness of the high-strength steel products.

5) Rapid heating and rapid cooling treatments of ultra-high-strength steel are enabled, and the heat treatment cycle period of strip steel is shortened.

6) Ultra-high temperature heating of ultra-high-strength steel is enabled, wherein the strip steel can be heated to a temperature of 900° C. or even higher, thereby realizing ultra-high temperature heating annealing treatment of the ultra-high-strength steel.

### Ultra-Short-Process Production Line for Hot-Dip Galvanized High-Strength Strip Steel

The ultra-short-process production line for hot-dip galvanized high-strength strip steel according to the present disclosure can achieve the following purposes: 1) reducing the unit footprint; 2) reducing the size of operating personnel; 3) reducing the overall operating cost of the unit; 4) generating fine-grained austenite in the process of heating high-strength steel with the use of a rapid heating technology, thereby further improving the strength of the high-strength steel; 5) subjecting the high-strength steel to rapid heating and rapid cooling to shorten the heat treatment cycle period of the strip steel; 6) implementing the process technology of rapid heating, rapid cooling and rapid heat treatment to enable production of various advanced high-strength steel products with higher strength grades using alloy components for lower grades, which can not only reduce the production cost of the high-strength steel, but also improve the mechanical performances and subsequent processing performances (such as welding performance and coating performance) of the various high-strength steel products, thereby significantly promoting the market competitiveness of the high-strength steel products; 7) subjecting the high-strength steel to ultra-high temperature heating, wherein the strip steel can be heated to a temperature of 900° C. or even higher, thereby realizing ultra-high temperature heating annealing treatment of the hot-dip galvanized high-strength steel.

To achieve the above purposes, the technical solution of the present disclosure is:

An ultra-short-process production line for pure zinc hot-dip galvanized high-strength strip steel, including the following stations in sequence: uncoiling—welding—inlet looper—central continuous post-processing—outlet looper—temper rolling—coiling; wherein the central continuous post-processing station includes in sequence a rapid heating section, a soaking section, a rapid cooling section, and a hot-dip galvanizing section; direct fire heating is used for the rapid heating section; alternatively, direct fire heating and transverse magnetic induction heating are provided in series; alternatively, direct fire heating, jet-radiation composite heating and transverse magnetic induction heating are provided in series; jet-radiation composite soaking, electric radiant tube soaking, resistance wire soaking or resistance belt soaking is used for the soaking section; high hydrogen cooling is used for the rapid cooling section; the hot-dip galvanizing section is provided with a furnace nose, a zinc pot, an air knife, a post-plating cooling device and a final water cooling device in sequence.

Further, in the hot-dip galvanizing section, an alloying heating device and an alloying soaking device are provided between the air knife and the post-plating cooling device to enable production of hot-dip galvannealed products.

Still further, in the hot-dip galvanizing section, a selectable mobile post-plating rapid cooling device is provided after the air knife and before the post-plating cooling device.

Preferably, a selectable washing station is provided between the welding station and the inlet looper station, and the strip steel may be washed by passing through the washing station, or may bypass the washing station. Alternatively, a selectable washing station is provided after the inlet looper station, so that when the strip steel enters the washing station for washing, constant speed washing can be achieved to maintain a stable washing quality of the strip steel surface.

Preferably, a central looper station is provided before the temper rolling station and after the central continuous post-processing station.

Preferably, a finishing station is provided between the coiling station and the outlet looper station, and the strip steel is finished before coiling.

Preferably, a tension levelling station is provided between the temper rolling station and the outlet looper station, and the strip steel may be subjected to tension levelling treatment before entering the outlet looper station.

Preferably, a surface post-treatment station such as that for passivation or anti-fingerprint treatment is provided between the temper rolling station and the outlet looper station, and the strip steel may be subjected to surface treatments such as passivation or anti-fingerprint treatment before entering the outlet looper; alternatively, both a tension levelling station and a surface post-treatment station such as that for passivation or anti-fingerprint treatment are provided between the temper rolling station and the outlet looper station, and the strip steel may be subjected to tension levelling and/or surface treatments such as passivation or anti-fingerprint treatment before entering the outlet looper station.

Preferably, an electric radiant tube soaking section, or a resistance wire soaking section or a resistance belt soaking section is used instead of the jet-radiation composite soaking section to construct the production line of the present disclosure for producing hot-dip galvanized high-strength strip steel in places where gas supply is tight.

The differences or innovation points of the production line of the present disclosure as compared with the conventional continuous heat treatment line include:

1) The equipment of the present disclosure is configured to be simple, and has a small footprint.

2) Fewer people are needed on the pure zinc hot-dip galvanized and hot-dip galvannealed ultra-high-strength steel production line according to the present disclosure.

3) The overall operating cost of the ultra-high-strength steel production line of the present disclosure is low.

4) The use of the direct fire heating device according to the present disclosure enables pre-redox treatment of the ultra-high-strength steel to improve the platability of the high strength steel.

5) The coordinated use of the direct fire heating device, the transverse magnetic induction heating device, the jet-radiation composite heating/soaking device and the high hydrogen rapid cooling device allows for rapid heating and rapid cooling annealing treatments of the high-strength steel, thereby reducing the enrichment of strengthening elements such as Si and Mn in the surface of the substrate from the substrate during the annealing process, which further improves the platability of the high-strength steel.

6) Through the use of the transverse magnetic induction heating device with the direct fire heating device and the jet-radiation composite heating/soaking device in series, the present disclosure enables rapidly heating the strip steel to a temperature of 900° C. or even higher.

7) The hot-dip galvannealed high-strength steel production line of the present disclosure enables production of hot-dip galvanized products with either of the following two coating types: hot-dip pure zinc coating and hot-dip alloy coating.

The beneficial effects of the present disclosure include:

1) The unit has a short length and a small footprint.

2) The size of the operating personnel is small, and only 4 people are needed to operate a unit.

3) The overall operating cost of the unit is low.

4) The implementation of the process technology of rapid heating, rapid cooling and rapid heat treatment enables production of various advanced high-strength steel products with higher strength grades using alloy components for lower grades. The strength of 590 MPa-grade products can be achieved using alloy components for 450 MPa-grade products, and the performances of 980 MPa-grade products can be achieved using alloy components for 780 MPa-grade products. Not only the production cost of the high-strength steel can be reduced, but also the mechanical performances and subsequent processing performances (such as welding performance and coating performance) of the various ultra-high-strength steel products can be improved, thereby significantly promoting the market competitiveness of the high-strength steel products.

5) Rapid heating and rapid cooling treatments of high-strength steel are enabled, and the heat treatment cycle period of the strip steel is shortened.

6) Ultra-high temperature heating of high-strength steel is enabled, wherein the strip steel can be heated to a temperature of 900° C. or even higher, thereby realizing ultra-high temperature heating annealing treatment of the high-strength steel.

### Flexible Cold-Rolled Strip Steel Post-Processing Production Line Suitable for Producing a Variety of High-Strength Steels

The flexible cold-rolled strip steel post-processing production line suitable for producing a variety of high-strength steels according to the present disclosure can achieve the following purposes: 1) making full use of the waste heat of the combustion exhaust gas from a radiant tube to quickly preheat the strip steel to a temperature of at least 250° C.; 2) significantly reducing the temperature of the combustion exhaust gas from the radiant tube after fully preheating the strip steel, so that it can be discharged directly, with no need to add a boiler or superheated water heating device to reutilize the waste heat from the combustion exhaust gas, thereby significantly reducing investment and footprint; 3) transferring substantially all of the waste heat of the combustion exhaust gas from the radiant tube to the strip steel, so that the primary utilization rate of thermal energy is high; 4) enabling rapid heating by transverse magnetic induction during the ultra-high temperature period to improve the utilization rate of thermal energy; 5) enabling rapid regulation of the annealing heating temperature and the soaking temperature of the strip steel; 6) enabling flexible production of various new products using the special flexible production line for high-strength steel, such as cold-rolled steel, pure zinc hot-dip galvanized (GI) steel, hot-dip galvannealed (GA) steel, cold-rolled steel whose surface is flash plated with nickel or zinc, so that the production line can better meet the market needs; 7) effectively controlling diffusion and enrichment of alloying elements in the surface of high-strength steel due to the independent control of the atmosphere in the muffle furnace, so that the platability of ultra-high-strength steel products can be improved greatly, and thus the surface quality of the hot-dip ultra-high-strength products can also be improved significantly; 8) enabling production of various advanced high-strength steel products with higher strength grades using alloy components for lower grades by implementing the rapid heating technology in conjunction with the rapid cooling technology according to the present disclosure, which can not only reduce the production cost, but also improve the mechanical performances of the various ultra-high-strength steel products.

To achieve the above purposes, the technical solution of the present disclosure is:

A flexible cold-rolled strip steel post-processing production line suitable for producing a variety of high-strength steels, including the following stations in sequence: uncoiling—welding—inlet looper—washing—central continuous post-processing-intermediate looper—temper rolling—outlet looper-finishing-coiling; wherein the central continuous post-processing station includes in sequence a jet radiant tube preheating section, a radiant tube heating section, a selectable transverse magnetic induction heating section or muffle furnace section provided in parallel, a jet-radiation composite soaking section, a slow cooling section, a rapid cooling section, and a reheating section; the rapid cooling section includes a high hydrogen cooling and/or mist cooling and/or water quenching cooling section; the reheating section is followed by a furnace nose section, a zinc pot section, an air knife section, an alloying heating section, an alloying soaking section, a post-plating cooling section, and a final water cooling section; or connected to the final water cooling section through a mobile channel, an overaging section, and a final gas jet cooling section; the final water cooling section may be followed by a pickling section or a pickling section+a flash plating section in sequence; the strip steel may pass through the pickling section for producing a cold-rolled pickled product, or it may bypass the pickling section to produce a cold-rolled annealed product; the pickled strip steel may further enter the flash plating section for producing a flash-plated product which is flash plated with nickel or zinc; a gas fuel such as natural gas or liquefied petroleum gas or coal gas is combusted in the radiant tube heating section, and high-temperature exhaust gas is generated during the combustion process; the jet radiant tube preheating section uses the combustion exhaust gas from the heating section and/or the soaking section to heat a recycled nitrogen-hydrogen protective gas by heat exchange in the furnace, and then the nitrogen-hydrogen protective gas is jetted onto the upper and lower surfaces of the strip steel to realize forced convection heat exchange; the radiant tube heating section is provided in series with (a selectable transverse magnetic induction heating section or muffle furnace section provided in parallel); the jet-radiation composite soaking section utilizes forced convection and radiation in combination to quickly soak the strip steel, so as to improve the uniformity of the strip steel temperature and realize rapid regulation of the soaking temperature of the strip steel; in addition to the use of the jet radiant tube preheating section, the cold-rolled strip steel post-processing production line further utilizes a rapid cooling treatment, then reheating, and then a galvanizing or overaging treatment; the furnace nose section is provided in parallel with the mobile channel; the strip steel passes through the furnace nose section to produce a pure zinc hot-dip galvanized product or a hot-dip galvannealed product, or the strip steel passes through the mobile channel to produce a cold-rolled annealed product, or a pickled product or a flash-plated product. Thus, the processing line has at least three or more process paths for selection, and enables production of five types of high-strength steel: cold-rolled annealed steel, pickled steel, flash plated steel, pure zinc hot-dip galvanized steel, and hot-dip galvannealed steel.

Further, a selectable tension levelling station and/or a selectable surface post-treatment station such as that for passivation or anti-fingerprint treatment is provided between the temper rolling station and the outlet looper station, and the strip steel may be subjected to tension leveling and/or surface post-treatment.

Preferably, the muffle furnace section device includes built-in sealing devices at the front and rear, and the muffle furnace section device is also equipped with an atmosphere regulating device, so that the hydrogen content, oxygen content and dew point therein can be regulated and controlled separately.

Preferably, a uniform holding section device is provided between the reheating section and the furnace nose section to hold the temperature of the strip steel before hot-dip galvanizing.

Preferably, a mobile post-plating rapid cooling section device is further provided between the air knife section and the post-plating cooling section. The mobile post-plating rapid cooling section is provided in parallel with the alloying heating device to achieve rapid cooling of the strip steel after galvanizing for producing a pure zinc hot-dip galvanized high-strength steel product. Preferably, the mobile post-plating rapid cooling section device is disposed within 10 meters above the air knife section.

Preferably, a secondary reheating section device is provided after the uniform holding section to perform secondary reheating on the uniformly held strip steel, and then perform hot-dip galvanizing or overaging treatment.

Preferably, a pickling section device is provided between the rapid cooling section and the reheating section. The pickling section device includes a pickling unit, a hot water brushing unit, a hot water rinsing unit, and a hot air drying unit to implement pickling of the strip steel surface. It may be used to remove the oxide layer on the strip steel surface after mist cooling and/or water quenching cooling. For pure zinc hot-dip galvanized products or hot-dip galvannealed products, it may also be used to improve the platability of high-strength strip steel, especially ultra-high-strength strip steel.

Preferably, an iron flash plating or nickel flash plating section is provided after the pickling section, and then reheating treatment is performed to further improve the platability of the ultra-high-strength strip steel.

Preferably, a mobile gas jet rapid cooling device or a mobile mist cooling device is used for the mobile post-plating rapid cooling section.

### Flexible Post-Cold-Rolling Processing Production Line Suitable for Producing a Variety of Ultra-High-Strength Strip Steels

The flexible post-cold-rolling processing production line suitable for producing a variety of ultra-high-strength strip steels according to the present disclosure can achieve the following purposes: 1) making full use of the waste heat of the combustion exhaust gas from a radiant tube to quickly preheat the strip steel to a temperature of at least 250° C.; 2) significantly reducing the temperature of the combustion exhaust gas from the radiant tube after fully preheating the strip steel, so that it can be discharged directly, with no need to add a boiler or superheated water heating device for reutilization, thereby significantly reducing investment and footprint; 3) transferring substantially all of the waste heat of the combustion exhaust gas from the radiant tube to the strip steel, so that the primary utilization rate of thermal energy is high; 4) enabling rapid heating during the ultra-high temperature period to improve the utilization rate of thermal energy; 5) enabling rapid regulation of the annealing heating temperature of the strip steel; 6) enabling flexible production of various new products using the special flexible production line for high-strength steel, such as cold-rolled annealed steel, pure zinc hot-dip galvanized (GI) steel, hot-dip galvannealed (GA) steel, pickled steel, cold-rolled steel whose surface is flash plated with nickel or zinc, so that the production line can better meet the market needs; 7) greatly improving the platability of ultra-high-strength steel products, and thus significantly improving the surface quality of the hot-dip ultra-high-strength products; 8) enabling production of various advanced high-strength steel products with higher strength grades using alloy components for lower grades by implementing the rapid cooling technology according to the present disclosure, which can not only reduce the production cost, but also improve the mechanical performances of the various ultra-high-strength steel products.

To achieve the above purposes, the technical solution of the present disclosure is:

A flexible post-cold-rolling processing production line suitable for producing a variety of ultra-high-strength strip steels, including the following stations in sequence: uncoiling—welding-inlet looper—washing—central continuous post-processing-intermediate looper—temper rolling-outlet looper-finishing-coiling; wherein the central continuous post-processing station includes in sequence a jet radiant tube preheating section, a radiant tube heating section, a selectable transverse magnetic induction heating section or muffle furnace section provided in parallel, a radiant tube soaking section, a slow cooling section, a rapid cooling section, a reheating section; starting from the reheating section, two parallel routes are provided, one of which includes a furnace nose section, a zinc pot section, an air knife section, an alloying heating section, an alloying soaking section, and a post-plating cooling section, and is connected to a final water cooling section, and the other of which includes a mobile channel section, an overaging section, a final gas jet cooling section, and is connected to the final water cooling section; the final water cooling section may be followed by a selectable pickling section and a selectable flash plating section in sequence; a gas fuel such as natural gas or liquefied petroleum gas or coal gas is used in the heating section; the jet radiant tube preheating section uses the combustion exhaust gas from the radiant tube heating section and/or the radiant tube soaking section to heat a recycled nitrogen-hydrogen protective gas by heat exchange in the furnace, and then the nitrogen-hydrogen protective gas is jetted onto the upper and lower surfaces of the strip steel to realize forced convection heat exchange; the rapid cooling section includes a high hydrogen cooling section and/or a mist cooling section and/or a water quenching cooling section.

In addition to the jet radiant tube preheating section, the production line uses high hydrogen cooling or mist cooling and/or water quenching cooling to perform rapid cooling treatment on the strip steel, followed by reheating, galvanizing or overaging in sequence.

The furnace nose section is provided in parallel with the mobile channel section. The strip steel passes through the furnace nose section to produce a pure zinc hot-dip galvanized product or a hot-dip galvannealed product, or the strip steel passes through the mobile channel section to produce a cold-rolled annealed, pickled or flash-plated product.

A pickling section and a flash plating section are provided after the final water cooling section. The strip steel may pass through the pickling section for producing a cold-rolled pickled product, or may bypass the pickling section to produce a cold-rolled annealed product. The pickled strip steel may further enter the flash plating section for producing a product which is flash plated with nickel or zinc.

Thus, the production line has at least three process paths for selection, and enables production of five types of high-strength steel: cold-rolled annealed steel, pickled steel, flash plated steel, pure zinc hot-dip galvanized steel, and hot-dip galvannealed steel.

Preferably, a selectable tension levelling station and/or a selectable surface post-treatment station such as that for passivation or anti-fingerprint treatment is provided between the temper rolling station and the outlet looper station, and the strip steel may be subjected to tension leveling and/or surface post-treatment.

Preferably, the muffle furnace section device includes built-in sealing devices at the front and rear, and the muffle furnace section device is also equipped with an atmosphere regulating device, so that the hydrogen content, oxygen content and dew point therein can be regulated and controlled separately.

Preferably, a uniform holding section is further provided between the reheating section and the furnace nose section to hold the temperature of the strip steel before hot-dip galvanizing.

Preferably, a mobile post-plating rapid cooling section is further provided between the air knife section and the post-plating cooling section. The mobile post-plating rapid cooling section is provided in parallel with the alloying heating section to achieve rapid cooling of the strip steel after galvanizing for producing the pure zinc hot-dip galvanized high-strength steel product. Preferably, the mobile post-plating rapid cooling section device is disposed within 10 meters above the air knife section.

Preferably, a secondary reheating section device is provided after the uniform holding section to perform secondary reheating on the uniformly held strip steel, followed by hot-dip galvanizing or overaging treatment.

Preferably, a pickling section is provided between the high hydrogen cooling or mist cooling and/or water quenching cooling section and the reheating section. The pickling section includes a pickling unit, a hot water brushing unit, a hot water rinsing unit, and a hot air drying unit to implement pickling of the strip steel surface. It may be used to remove the oxide layer on the strip steel surface after mist cooling and/or water quenching cooling. For pure zinc hot-dip galvanized products or hot-dip galvannealed products, it may also be used to improve the platability of high-strength strip steel, especially ultra-high-strength strip steel.

Preferably, an iron flash plating or nickel flash plating section is provided after the pickling section and before the reheating section, and then reheating treatment is performed to further improve the platability of the ultra-high-strength strip steel.

Preferably, a mobile gas jet rapid cooling device or a mobile mist cooling device is used for the mobile post-plating rapid cooling section.

### Flexible Cold-Rolled Strip Steel Post-Processing Line Suitable for Producing a Variety of High-Strength Steels

The flexible cold-rolled strip steel post-processing line suitable for producing a variety of high-strength steels according to the present disclosure enables production of cold-rolled continuously annealed, pickled, flash plated, pure zinc hot-dip galvanized (GI) and hot-dip galvannealed (GA) ultra-high-strength strip steels. The production line can achieve the following purposes: 1) making full use of the waste heat of direct fire furnace exhaust gas to quickly preheat the strip steel to a temperature of at least 350° C.; 2) preventing the direct fire combustion exhaust gas from directly contacting the strip steel for a long time in the preheating furnace, thereby avoiding formation of an excessively thick oxide layer on the surface of the strip steel; 3) using fast and efficient preheating and direct fire heating to quickly heat the strip steel to a temperature of at least 750° C., and subsequently using transverse magnetic induction heating and jet-radiation composite heating to quickly heat the strip steel evenly to a temperature of at least 850° C., thus completing fast, efficient and uniform heating; 4) enabling quick regulation of the annealing temperature of the strip steel due to the significantly reduced size of the heating furnace, the reduced thermal inertia of the furnace and the fast response speed of the transverse magnetic induction heating; 5) making the entire rapid heat treatment furnace significantly simpler, smaller and more efficient, thus saving energy, reducing emissions and reducing the footprint; 6) enabling flexible production of various cold-rolled annealed, pickled, flash plated, pure zinc hot-dip galvanized (GI) and hot-dip galvanizing (GA) products using the special flexible high-strength steel production line, so that the flexible production line can better meet the market needs; 7) greatly improving the platability of the ultra-high-strength steel products, and thus improving the surface quality of the ultra-high-strength hot-dip products significantly; 8) enabling production of various advanced high-strength steel products with higher strength grades using alloy components for lower grades by implementing the process technology of rapid heating, rapid cooling and rapid heat treatment, which can not only reduce the production cost of the high-strength steel, but also improve the mechanical performances and subsequent processing performances (such as welding performance) of the various ultra-high-strength steel products.

To achieve the above purposes, the technical solution of the present disclosure is:

A flexible cold-rolled strip steel post-processing line suitable for producing a variety of high-strength steels, including the following stations in sequence: uncoiling—welding—inlet looper—washing—central continuous post-processing-intermediate looper—temper rolling-outlet looper-finishing-coiling; wherein the central continuous post-processing station includes in sequence a jet direct fire preheating section, a direct fire heating section, a transverse magnetic induction heating section or a jet-radiation composite heating section, a jet-radiation composite soaking section, a slow cooling section, a rapid cooling section, and a reheating section; starting from the reheating section, two parallel routes are provided, one of which includes a furnace nose section, a zinc pot section, an air knife section, an alloying heating section, an alloying soaking section, and a post-plating cooling section, and is further connected to a final water cooling section, and the other of which includes a mobile channel section, an overaging section, a final gas jet cooling section, and is further connected to the final water cooling section; the final water cooling section may be optionally followed by a pickling section and a flash plating section; the rapid cooling section includes a high hydrogen cooling section or a mist cooling section and/or a water quenching cooling section; a gas fuel such as natural gas or liquefied petroleum gas is combusted in the direct fire heating section; the jet direct fire preheating section uses the combustion exhaust gas from the direct fire heating section to heat a recycled nitrogen-hydrogen protective gas by heat exchange in the furnace, and then the nitrogen-hydrogen protective gas is jetted onto the upper and lower surfaces of the strip steel to realize forced convection heat exchange; the transverse magnetic induction heating section or the jet-radiation composite heating section is provided in parallel or in series; a selectable tension levelling station and/or a selectable surface post-treatment station such as that for passivation or anti-fingerprint treatment is provided between the temper rolling station and the outlet looper station; the jet-radiation composite soaking section utilizes a rapid soaking mode combining forced convection and radiation. Thus, the processing line has at least three process paths for selection, and enables production of five types of high-strength steel: cold-rolled annealed steel, pickled steel, flash plated steel, pure zinc hot-dip galvanized steel, and hot-dip galvannealed steel.

Further, a radiant tube heating section is provided between the jet-radiation composite heating section and the jet-radiation composite soaking section.

Still further, a uniform holding section is provided between the reheating section and the furnace nose section.

Yet further, a secondary reheating section is provided after the uniform holding section, and the secondary reheating section is connected to the mobile channel section and the furnace nose section.

Yet further, a mobile post-plating rapid cooling section is provided between the air knife section and the post-plating cooling section. The mobile post-plating rapid cooling section is provided in parallel with the alloying heating section. Preferably, the mobile post-plating rapid cooling section is disposed within 10 meters above the air knife section.

Preferably, a pickling section is provided between the rapid cooling section and the reheating section, and the pickling section includes a pickling unit, a hot water brushing unit, a hot water rinsing unit, and a hot air drying unit.

Preferably, an iron flash plating or nickel flash plating section is provided after the pickling section and before the reheating section, and then connected to the reheating section.

### Flexible Production Line for Various High-Strength/Ultra-High-Strength Steels

The flexible production line for producing a variety of high-strength/ultra-high-strength steels according to the present disclosure can achieve the following purposes: 1) making full use of the waste heat of direct fire combustion exhaust gas to quickly preheat the strip steel to a temperature of at least 350° C.; 2) preventing the direct fire combustion exhaust gas from directly contacting the strip steel for a long time in the preheating furnace, thereby avoiding formation of an excessively thick oxide layer on the surface of the strip steel; 3) using fast and efficient preheating and direct fire heating to quickly heat the strip steel to a temperature of at least 750° C., and subsequently using transverse magnetic induction heating and jet-radiation composite heating to quickly heat the strip steel evenly to a temperature of at least 850° C., thus completing fast, efficient and uniform heating; 4) enabling quick regulation of the annealing temperature of the strip steel due to the significantly reduced size of the heating furnace, the reduced thermal inertia of the furnace and the fast response speed of the transverse magnetic induction heating; 5) making the entire rapid heat treatment furnace significantly simpler, smaller and more efficient, thus saving energy, reducing emissions and reducing the footprint; 6) enabling flexible production of various flash plated products using the flexible high-strength steel production line, such as cold-rolled annealed steel, pure zinc hot-dip galvanized (GI) steel, hot-dip galvannealed (GA) steel, cold-rolled steel whose surface is flash plated with nickel or zinc, so that the flexible production line can better meet the market needs; 7) greatly improving the platability of the ultra-high-strength steel products, and thus improving the surface quality of the ultra-high-strength hot-dip products significantly; 8) enabling production of various advanced high-strength steel products with higher strength grades using alloy components for lower grades by implementing the process technology of rapid heating, rapid cooling and rapid heat treatment, which can not only reduce the production cost of the high-strength steel, but also improve the mechanical performances and subsequent processing performances (such as welding performance and coating performance) of the various ultra-high-strength steel products.

To achieve the above purposes, the technical solution of the present disclosure is:

A flexible production line for producing a variety of high-strength/ultra-high-strength steels, including the following stations in sequence: uncoiling—welding—inlet looper—washing—central continuous post-processing-intermediate looper—temper rolling—outlet looper-finishing-coiling; wherein:
the central continuous post-processing station includes in sequence a jet direct fire preheating section, a heating section, a radiant tube soaking section, a slow cooling section, a rapid cooling section, a reheating section and two parallel processing lines, a final water cooling section and a selectable pickling section and a selectable flash plating section;
one of the processing lines includes a furnace nose section, a zinc pot section, an air knife section, an alloying heating section, an alloying soaking section, and a post-plating cooling section; and the other processing line includes a mobile channel section, an overaging section, and a final gas jet cooling section;
a direct fire heating section and a transverse magnetic induction heating section and/or a jet-radiation composite heating section are used for the heating section;
the transverse magnetic induction heating section and the jet-radiation composite heating section are provided in parallel or in series;
the rapid cooling section includes high hydrogen cooling or mist cooling and/or water quenching cooling;
a selectable tension levelling station and/or a selectable surface post-treatment station such as that for passivation or anti-fingerprint treatment is further provided between the temper rolling station and the outlet looper station.

Preferably, the selectable pickling section includes a pickling unit, a hot water brushing unit, a hot water rinsing unit, and a hot air drying unit to implement pickling of the strip steel surface. It may be used to remove the oxide layer on the strip steel surface after mist cooling and/or water quenching cooling, and may also be used to improve the bonding strength of the coating obtained by subsequent flash plating.

Further, a radiant tube heating device is provided between the jet-radiation composite heating section and the radiant tube soaking section. After the strip steel is heated by transverse magnetic induction heating or jet-radiation composite heating, it may further be subjected to radiant tube heating and then radiant tube soaking. Of course, the strip steel may also be directly subjected to radiant tube soaking after the jet-radiation composite heating.

Further, a uniform holding section is provided between the reheating section and the furnace nose section to hold the temperature of the strip steel before hot-dip galvanizing.

Further, a mobile post-plating rapid cooling section device is provided between the air knife section and the post-plating cooling section. The mobile post-plating rapid cooling section is provided in parallel with the alloying heating device to achieve rapid cooling of the strip steel after galvanizing for producing a pure zinc hot-dip galvanized high-strength steel product. Preferably, the mobile post-plating rapid cooling section device is disposed within 10 meters above the air knife section.

Preferably, a mobile jet rapid cooling section and/or a mobile mist rapid cooling section is used for the mobile post-plating rapid cooling section. When both the mobile jet rapid cooling section and the mobile mist rapid cooling section are provided, the two process sections are provided in parallel, and one of them is selected during production to achieve post-plating rapid cooling of the strip steel.

Further, a secondary reheating section is provided after the uniform holding section to perform secondary reheating on the uniformly held strip steel, followed by hot-dip galvanizing or overaging treatment.

Preferably, a pickling section is provided between the rapid cooling section and the reheating section, and the pickling section includes a pickling unit, a hot water brushing unit, a hot water rinsing unit, and a hot air drying unit to implement pickling of the strip steel surface. It may be used to remove the oxide layer on the strip steel surface after mist cooling and/or water quenching cooling. For pure zinc hot-dip galvanized products or hot-dip galvannealed products, it may also be used to improve the platability of high-strength strip steel, especially ultra-high-strength strip steel.

Preferably, in the heating section, a direct fire heating section, a radiant tube heating section, a transverse magnetic induction heating section or a jet-radiation composite heating section are provided in sequence.

A selectable tension levelling station and/or a selectable surface post-treatment station such as that for passivation or anti-fingerprint treatment is provided between the temper rolling station and the outlet looper station, and the strip steel may be subjected to tension levelling and/or surface post-treatment.

In the design of the flexible production line for producing various high-strength/ultra-high-strength steels according to the present disclosure:

A gas fuel, such as natural gas, liquefied petroleum gas or coal gas, is combusted in the heating section, and high-temperature exhaust gas is generated during the combustion process. The jet direct fire preheating section uses the combustion exhaust gas from the heating section to heat a recycled nitrogen-hydrogen protective gas by heat exchange in the furnace, and then the nitrogen-hydrogen protective gas is jetted onto the upper and lower surfaces of the strip steel to realize forced convection heat exchange.

The transverse magnetic induction heating section or the jet-radiation composite heating section is used for rapid heating of the strip steel. They may be provided in parallel or in series. The transverse magnetic induction heating may be selected for use in light of the peak and valley electricity prices to reduce production cost.

The furnace nose section is provided in parallel with the mobile channel section. The strip steel passes through the furnace nose section to produce a pure zinc hot-dip galvanized product or a hot-dip galvannealed product, or the strip steel passes through the mobile channel section to produce a cold-rolled or flash-plated product.

In addition to the jet direct fire preheating section, the production line uses high hydrogen cooling or mist cooling and/or water quenching cooling to implement rapid cooling treatment, followed by reheating, and then followed by galvanizing or overaging treatment.

The production line has at least three process paths for selection, and enables production of five types of high-strength steel: cold-rolled annealed steel, pickled steel, flash plated steel, pure zinc hot-dip galvanized steel, and hot-dip galvannealed steel.

The differences or innovation points of the above flexible production line according to the present disclosure as compared with the conventional continuous heat treatment line include:

1. The present disclosure creatively utilizes a jet direct fire preheating section to preheat the strip steel, more precisely a high-temperature nitrogen-hydrogen protective gas jet direct fire preheating section. This is the concentrated embodiment of the novelty, inventiveness and practical applicability of the present disclosure. Its significant features that distinguish it from the common preheating section include: (1) an in-furnace heat exchanger (the heat exchanger is not provided outside the furnace) is used to heat a recycled nitrogen-hydrogen protective gas, and the heated nitrogen-hydrogen protective gas is jetted at a high speed onto the upper and lower surfaces of the strip steel to achieve forced convection heat exchange, thereby preheating the strip steel fast and efficiently. Compared with the traditional preheating process, this process significantly reduces the heat loss from the furnace housing and the protective gas channel, makes more full use of the waste heat of the combustion exhaust gas, and has higher heating efficiency and a faster heating rate; (2) in the jet direct fire preheating section, the combustion exhaust gas from the heating section passes through the heat exchanger chamber of the preheating section. During the passing process, the combustion exhaust gas from the heating section fully exchanges heat with the heat exchanger in the heat exchanger chamber to heat the nitrogen-hydrogen protective gas. Therefore, in the jet direct fire preheating section, the combustion exhaust gas from the heating section is not always in direct contact with the strip steel (when direct fire heating is used in the heating section, the jet direct fire preheating section is only in direct contact with the strip steel at high temperature for a short time, and the exhaust gas at this time is a reducing atmosphere or a slightly oxidizing atmosphere), thereby avoiding overoxidation of the strip steel surface; (3) when direct fire heating is used in the heating section, the incompletely burned fuel gas in the direct fire combustion exhaust gas undergoes oxygen-enriched secondary combustion in a semi-sealed unit at the top of the jet preheating section, but the burning flame does not contact the strip steel, thereby effectively avoiding overoxidation of the strip steel surface; (4) the strip steel is preheated to a higher temperature. When direct fire heating is used in the heating section, due to the high heat transfer efficiency of the high-temperature nitrogen-hydrogen protective gas in the jet direct fire preheating, the temperature of the preheated strip steel can reach at least 350° C., which is at least 100° C. higher than the strip steel temperature in the common preheating section; (5) when direct fire heating is used in the heating section, the temperature of the direct fire combustion exhaust gas coming out of the jet direct fire preheating section according to the present disclosure is usually much lower than 750° C. (if a sufficient number of high-speed jet preheating units are provided, it can even be 200° C. or lower, suitable for direct discharge), and there is no need to mix cold air into the direct fire combustion exhaust gas for reutilization outside the furnace, or no need for reutilization at all.

2. The present disclosure provides at least three process paths for selection.

3. The present disclosure enables production of five types of high-strength steel, especially ultra-high-strength steel, including cold-rolled annealed steel, pickled steel, flash plated steel, pure zinc hot-dip galvanized steel and hot-dip galvannealed steel.

4. All of the five types of ultra-high-strength steel can be subjected to tension levelling and/or surface post-treatment such as passivation or anti-fingerprint treatment according to the present disclosure.

5. According to the present disclosure, there is provided a secondary reheating section device. Thus, the strip steel temperature can be raised twice before the hot-dip galvanizing or overaging treatment. A third-generation high-strength steel (QP steel) product may be cooled quickly to a lower temperature, and then immediately heated quickly to a higher temperature for long-term carbon redistribution treatment. After the treatment is completed, it is quickly reheated for a second time to a temperature at which it is put into a hot-dip galvanizing zinc pot to carry out the galvanizing treatment.

6. A direct fire heating section is preferably used for the heating section according to the present disclosure, and a rapid heating device is provided after the direct fire heating section. The rapid heating device may be a transverse magnetic induction heating section device or a jet-radiation composite heating device. Of course, a transverse magnetic induction heating section device and a jet-radiation composite heating device may also be used at the same time. However, when a transverse magnetic induction heating section device and a jet-radiation composite heating device are used at the same time, the jet-radiation composite heating device should be provided after the transverse magnetic induction heating section device. The simultaneous use of a jet direct fire preheating section and a subsequent rapid heating device is another embodiment of the novelty, inventiveness and practical applicability of the present disclosure. When only a transverse magnetic induction heating section device is selected, it is recommended to select a radiation heating device for the subsequent section first, and then select a soaking section device. However, when a jet-radiation composite heating section device is selected, it is recommended not to further select a radiation heating section device. The beneficial effects of using a rapid heating device according to the present disclosure mainly lie in the following aspects: (1) rapid regulation of the soaking temperature of strip steel can be achieved, which is very critical for production of high-strength steel, especially ultra-high-strength steel, and can reduce substandard performances and quality loss of the strip steel caused by an over-standard soaking temperature; (2) transverse magnetic induction heating can heat strip steel to a higher temperature economically and conveniently. Transverse magnetic induction heating has achieved rapid heating of strip steel to 930° C., realizing ultra-high temperature annealing that cannot be achieved by conventional radiant tube heating; (3) the temperature of the heated strip steel is uniform, and the temperature variation along the width direction of the strip steel can be controlled within +5° C.; (4) due to the significant increase in the heating rate, the grain structure can be refined, and the strength and plasticity of the material can be improved, which is particularly beneficial to the performance improvement and cost reduction of high-strength steel and ultra-high-strength steel products.

7. According to the present disclosure, a flash plating section device is provided after the final water cooling section and before the temper rolling station. The strip steel may pass through the flash plating section or bypass the flash plating section, thereby enabling surface modification of cold-rolled high-strength steel, especially cold-rolled ultra-high-strength steel.

8. According to the present disclosure, a selectable pickling section device is further provided after the final water cooling section and before the flash plating section. It may be used to remove the oxide layer on the surface of the strip steel after mist cooling and/or water quenching cooling, and it may also be used to improve the bonding strength of the coating obtained by subsequent flash plating.

9. According to the present disclosure, a pickling section and/or an iron flash plating or nickel flash plating section device is provided after the strip steel is quickly cooled, so as to implement pickling of the strip steel surface. It may be used to remove the oxide layer on the surface of the strip steel after mist cooling and/or water quenching cooling. For pure zinc hot-dip galvanized or hot-dip galvannealed products, the platability of high-strength strip steel, especially ultra-high-strength strip steel, can also be improved.

The beneficial effects of the above flexible production line according to the present disclosure include:

1) The waste heat of the combustion exhaust gas of direct fire heating has a high primary utilization rate, and it can preheat the strip steel to a temperature of at least 350° C.

2) The direct fire combustion exhaust gas is prevented from directly contacting the strip steel for a long time in the preheating furnace, thereby avoiding formation of an excessively thick oxide layer on the strip steel surface.

3) The flame of the reignited excess fuel gas in the direct fire combustion exhaust gas will not contact the strip steel, and formation of an excessively thick oxide layer on the strip steel surface can also be avoided.

4) When transverse magnetic induction heating is used, the strip steel can be quickly heated to at least 850° C. or even at least 900° C. in a relatively economical manner, and ultra-high temperature annealing can be achieved, thereby producing various new ultra-high-strength steel products.

5) The temperature of the rapidly heated strip steel is uniform, and the variation of the temperature along the width direction of the strip steel can be controlled within +5° C.

6) Rapid regulation of the heating temperature and soaking temperature of various high-strength strip steels can be achieved.

7) The same production line can produce ultra-high-strength steel products such as continuously annealed cold-rolled DP steel, MS steel, TRIP steel, QP steel and hot-dip galvanized DP steel, MS steel, TRIP steel, QP steel, etc., and the various high-strength steel products produced by the rapid heat treatment process have better performances and lower cost.

8) The use of water mist cooling+pickling or +pickling, nickel flash plating enables production of martensitic ultra-high-strength steel with a strength of up to 1500 MPa, and the surface quality and shape quality are high. The strip steel has good platability during hot-dip galvanizing, and the coating quality is excellent. In addition, new products of hot-dip galvanized tempered martensitic steel can be produced with excellent overall performances.

9) The present disclosure enables the pre-redox process by adjusting the air-fuel ratio in the direct fire burners in the direct fire section, and the platability of the ultra-high-strength steel is better.

### Dual-Purpose Ultra-High-Strength Strip Steel Production Line for Continuous Annealing or Hot-Dip Galvanizing

The dual-purpose ultra-high-strength strip steel production line for continuous annealing or hot-dip galvanizing according to the present disclosure can achieve the following purposes: 1) enabling flexible selection between production of continuously annealed products and production of hot-dip galvanized products according to market demand; 2) increasing the preheating temperature of strip steel to about 350° C., and maximizing transfer of combustion heat to the strip steel; 3) reducing the temperature of exhaust gas after preheating, so that it can be reutilized outside the furnace without adding cold air; 4) avoiding long-term contact of the direct fire combustion exhaust gas with the strip steel; 5) enabling ultra-high-temperature annealing at 900° C. or higher; 6) enabling generation of fine-grained austenite in the process of heating high-strength steel by implementing the rapid heating technology, thereby further improving the strength of the high-strength steel; 7) enabling rapid heating and rapid cooling treatments of the high-strength steel, thereby shortening the heat treatment cycle period of the strip steel; 8) enabling production of various advanced high-strength steel products with higher strength grades using alloy components for lower grades by implementing the process technology of rapid heating, rapid cooling and rapid heat treatment, which can not only reduce the production cost of the high-strength steel, but also improve the mechanical performances and subsequent processing performances (such as welding performance and coating performance) of the various high-strength steel products; 9) improving soaking, and enabling rapid regulation of the soaking temperature of the strip steel.

To achieve the above purposes, the technical solution of the present disclosure is:

A dual-purpose ultra-high-strength strip steel production line for continuous annealing or hot-dip galvanizing, including the following stations in sequence: uncoiling—welding—inlet looper—washing—central continuous post-processing—temper rolling—outlet looper—coiling; wherein the central continuous post-processing station includes in sequence a jet direct fire preheating section, a direct fire heating section, a transverse magnetic induction heating section, a radiant tube soaking section or a jet-radiation composite soaking section, a slow cooling section, a rapid cooling section, and a reheating section; starting from the reheating section, two parallel processing lines are provided, one of which is provided with a furnace nose section, a zinc pot section, an air knife section, and a post-plating cooling section, and is connected to a final water cooling section, and the other of which is provided with a mobile channel section, an overaging section, a final gas jet cooling section, and is connected to the final water cooling section; the production line uses jet direct fire preheating to preheat the strip steel, and a transverse magnetic induction heating device is provided after the direct fire heating section to quickly increase the heating temperature, while high hydrogen cooling is selected for rapid cooling; in the jet direct fire preheating section, the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to realize forced convection heat exchange; a high hydrogen cooling section or a mist cooling section or a water quenching cooling section is used for the rapid cooling section.

Further, a uniform holding section and a secondary reheating section are provided in sequence after the reheating section, and then connected to the two parallel processing lines.

Still further, the hot-dip galvanizing is hot-dip galvannealing, and an alloying heating section and an alloying soaking section are provided between the air knife section and the post-plating cooling section.

Yet further, the dual-purpose ultra-high-strength strip steel production line for continuous annealing or hot-dip galvanizing according to the present disclosure includes the following stations in sequence: uncoiling—welding—inlet looper—washing—central continuous post-processing—temper rolling—outlet looper—coiling; wherein the central continuous post-processing station includes in sequence a jet direct fire preheating section, a direct fire heating section, a transverse magnetic induction heating section, a radiant tube soaking section or a jet-radiation composite soaking section, a slow cooling section, a rapid cooling section, a pickling section and a reheating section; starting from the reheating section, two parallel processing lines are provided, one of which is provided with a furnace nose section, a zinc pot section, an air knife section, and a post-plating cooling section, and is connected to a final water cooling section, and the other of which is provided with a mobile channel section, an overaging section, a final gas jet cooling section, and is connected to the final water cooling section; a mist cooling section and/or a water quenching cooling section is used for the rapid cooling section.

In this production line, the strip steel is preheated in the jet direct fire preheating section; a transverse magnetic induction heating section is provided after the direct fire heating section to quickly increase the heating temperature; and mist cooling and/or water quenching cooling is provided for rapid cooling.

In the jet direct fire preheating section, the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to achieve forced convection heat exchange.

Further, a uniform holding section and a secondary reheating section are provided in sequence after the reheating section, and the secondary reheating section is connected to the two parallel processing lines.

Still further, the hot-dip galvanizing is hot-dip galvannealing, and an alloying heating section and an alloying soaking section are provided between the air knife section and the post-plating cooling section.

Yet further, the dual-purpose ultra-high-strength strip steel production line for continuous annealing or hot-dip galvanizing according to the present disclosure includes the following stations in sequence: uncoiling—welding—inlet looper—washing—central continuous post-processing—temper rolling—outlet looper—coiling; wherein the central continuous post-processing station includes in sequence a jet direct fire preheating section, a direct fire heating section, a transverse magnetic induction heating section, a radiant tube soaking section or a jet-radiation composite soaking section, a slow cooling section, a rapid cooling section, a pickling section and a reheating section; starting from the reheating section, two parallel processing lines are provided, one of which is provided with a furnace nose section, a zinc pot section, an air knife section, and a post-plating cooling section, and is connected to a final water cooling section, and the other of which is provided with a mobile channel section, an overaging section, a final gas jet cooling section, and is connected to the final water cooling section; a high hydrogen cooling section, a mist cooling section and/or a water quenching cooling section is used for the rapid cooling section; in addition, the high hydrogen cooling section is provided in parallel with the mist cooling section and/or the water quenching cooling section, and the high hydrogen cooling section is connected to the reheating section; in this production line, the strip steel is preheated in the jet direct fire preheating section; a transverse magnetic induction heating section is provided after the direct fire heating section to quickly increase the heating temperature; and mist cooling and/or water quenching cooling is provided for rapid cooling; in the jet direct fire preheating section, the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to achieve forced convection heat exchange.

Further, a uniform holding section and a secondary reheating section are provided in sequence after the reheating section, and the secondary reheating section is connected to the two parallel-provided processing lines.

Still further, the hot-dip galvanizing is hot-dip galvannealing, and an alloying heating section and an alloying soaking section are provided between the air knife section and the post-plating cooling section.

Preferably, a mobile post-plating rapid cooling section is provided after the air knife section. The mobile post-plating rapid cooling section can be moved online or offline and is provided in parallel with the alloying heating section.

Preferably, a radiant tube heating section is further provided between the direct fire heating section and the transverse magnetic induction heating section.

Preferably, washing stations are provided before and after the inlet looper station.

Preferably, a finishing station is provided before the coiling station.

Preferably, an intermediate looper station is provided before the temper rolling station.

Preferably, a selectable tension levelling station is provided between the temper rolling station and the outlet looper station, and the strip steel may be tension levelled before entering the outlet looper.

Preferably, a selectable surface post-treatment station such as that for passivation or anti-fingerprint treatment is provided between the temper rolling station and the outlet looper station.

Preferably, a selectable tension levelling station and a selectable surface post-treatment station such as that for passivation or anti-fingerprint treatment are provided between the temper rolling station and the outlet looper station.

The differences or innovation points of the production line of the present disclosure as compared with the conventional continuous heat treatment line include:

1. According to the present disclosure, the strip steel is preheated using a jet direct fire preheating section device. The jet direct fire preheating section device uses the combustion exhaust gas from the direct fire heating section to heat a recycled nitrogen-hydrogen protective gas in the furnace, and then jets the nitrogen-hydrogen protective gas onto the upper and lower surfaces of the strip steel to realize forced convection heat exchange, so that all the waste heat from the combustion in the radiant tube can be fully utilized online, and the strip steel can be preheated to a temperature of at least 350° C.

A heat exchange and jet bellows unit is added in the preheating furnace of the preheating device. The heated nitrogen-hydrogen protective gas is jetted at a high speed onto the upper and lower surfaces of the strip steel to achieve forced convection heat exchange, thereby preheating of the strip steel rapidly and efficiently. Compared with conventional preheating process, this process significantly reduces the heat loss from the furnace housing and the protective gas channel, makes more full use of the waste heat of the direct fire combustion exhaust gas, and has higher heating efficiency and a faster heating rate. The direct fire exhaust gas is used to heat the gas in the jet bellows and preheat the strip steel through the nozzles. Compared with the existing technology, the preheating efficiency is further improved, and the heat of the direct fire exhaust gas is more fully utilized.

The preheating device is designed to allow heat exchange to occur in a preheating furnace. The direct fire combustion exhaust gas mainly passes through the heat exchange and jet bellows unit in the preheating furnace. During the passing process, the direct fire combustion exhaust gas fully exchanges heat with the heat exchange pipe in the bellows to heat the nitrogen-hydrogen protective gas in the bellows. Therefore, the direct fire combustion exhaust gas in the preheating furnace is not always in direct contact with the strip steel (direct contact only occurs at the high temperature section for a short time, and the exhaust gas at this time is a reducing atmosphere or a slightly oxidizing atmosphere), thereby avoiding overoxidation of the strip steel surface.

In the preheating device, a direct fire combustion exhaust gas secondary combustion chamber and an open flame burner are designed in the preheating furnace. The incompletely burned fuel gas in the direct fire combustion exhaust gas is subjected to oxygen-enriched secondary combustion in the semi-sealed direct fire combustion exhaust gas secondary combustion chamber on the top of the preheating furnace, but the burning flame does not contact the strip steel, thereby effectively avoiding overoxidation of the strip steel surface.

With the use of this preheating device for preheating, the preheating temperature of the strip steel is higher. Due to the high heat transfer efficiency of the high-temperature nitrogen-hydrogen protective gas in the jet direct fire jet preheating, the temperature of the preheated strip steel can reach at least 350° C., which is at least 100° C. higher than the strip steel temperature using a common preheating furnace.

The temperature of the direct fire combustion exhaust gas coming out of the preheating furnace is usually much lower than 750° C. (if a sufficient number of high-speed jet preheating units are provided, it can even be 200° C. or lower, suitable for direct discharge), and there is no need to mix cold air into the direct fire combustion exhaust gas for reutilization outside the furnace, or no need for reutilization at all. As it can be seen, the preheating device not only makes full use of the waste heat of the direct fire furnace exhaust gas, but also avoids excessive oxidation of the strip steel surface caused by long-term contact between the direct fire furnace exhaust gas and the strip steel.

A transverse magnetic induction heating section is provided after the direct fire heating section. The transverse magnetic induction heating is used to further raise the temperature of the high-temperature strip steel quickly, thereby allowing for ultra-high temperature annealing of the high-strength steel.

2. According to the present disclosure, there is provided a secondary reheating section. Thus, the strip steel temperature can be raised twice before the hot-dip galvanizing treatment. A third-generation high-strength steel (QP steel) product may be cooled quickly to a lower temperature, and then immediately heated quickly to a higher temperature for long-term carbon redistribution treatment. After the treatment is completed, it is quickly reheated for a second time to a temperature at which it is put into a hot-dip galvanizing zinc pot to carry out the galvanizing treatment.

3. The present disclosure enables flexible selection from four cooling paths to produce continuously annealed products or hot-dip galvanized products.

4. The coordinated use of a transverse magnetic induction heating device and a variety of rapid cooling devices allows for rapid heating and rapid cooling annealing treatments, thereby enabling continuous production of rapidly heat-treated high-strength strip steel.

5. According to the present disclosure, jet-radiation composite soaking is used instead of radiant tube soaking to achieve rapid regulation of the soaking temperature of the strip steel when the working conditions change, such as changes in strip steel thickness specification, target temperature, unit speed, etc.

6. The present disclosure enables continuous production of strip steel products with three different surface states generated by: cold-rolling annealing, pure zinc hot-dip galvanizing and hot-dip galvannealing.

The beneficial effects of the present disclosure include:

1) The present disclosure enables flexible selection between production of continuously annealed products and production of hot-dip galvanized products.

2) The present disclosure avoids contact between the direct fire combustion exhaust gas and the strip steel for too long, and the surface quality and platability of the strip steel are good.

3) According to the present disclosure, the temperature of the strip steel is high after preheating, and the primary utilization rate of heat energy is high.

4) According to the present disclosure, transverse magnetic induction heating is used to further raise the temperature of the high-temperature strip steel quickly, thereby allowing for ultra-high temperature annealing of the high-strength steel.

5) With the use of a secondary reheating device according to the present disclosure, the strip steel temperature can be raised twice before the hot-dip galvanizing treatment. A third-generation high-strength steel (QP steel) product can be cooled quickly to a lower temperature, and then immediately heated quickly to a higher temperature for long-term carbon redistribution treatment. After the treatment is completed, it is quickly reheated for a second time to a temperature at which it is put into a hot-dip galvanizing zinc pot to carry out the galvanizing treatment.

6) The implementation of the process technology of rapid heating, rapid cooling and rapid heat treatment enables production of various advanced high-strength steel products with higher strength grades using alloy components for lower grades. The strength of 590 MPa-grade products can be achieved using alloy components for 450 MPa-grade products, and the performances of 980 MPa-grade products can be achieved using alloy components for 780 MPa-grade products. Not only the production cost of the high-strength steel can be reduced, but also the mechanical performances and subsequent processing performances (such as welding performance and coating performance) of the various ultra-high-strength steel products can be improved, thereby significantly promoting the market competitiveness of the high-strength steel products.

7) The present disclosure enables rapid heating and rapid cooling treatments of ultra-high-strength steel, and the heat treatment cycle period of the strip steel is shortened.

8) According to the present disclosure, jet-radiation composite soaking is used instead of radiant tube soaking to achieve rapid regulation of the soaking temperature of the strip steel when the working conditions change, such as changes in strip steel thickness specification, target temperature, unit speed, etc.

### Dual-Purpose High-Strength Strip Steel Production Line for Continuous Annealing or Hot-Dip Galvanizing

The dual-purpose high-strength strip steel production line for continuous annealing or hot-dip galvanizing according to the present disclosure can achieve the following purposes: 1) enabling flexible selection between production of continuously annealed products and production of hot-dip galvanized products according to market demand; 2) increasing the preheating temperature of strip steel to about 250° C., and maximizing transfer of combustion heat to the strip steel; 3) reducing the low temperature of the preheated exhaust gas further to 200° C. or lower, so that the exhaust gas can be discharged directly without reutilization outside the furnace, while of course, it may be used to heat water so as to further utilize the waste heat; 4) enabling ultra-high-temperature annealing at 900° C. or higher; 5) enabling generation of fine-grained austenite in the process of heating high-strength steel by implementing the rapid heating technology, thereby further improving the strength of the high-strength steel; 6) enabling rapid heating and rapid cooling treatments of the high-strength steel, thereby shortening the heat treatment cycle period of the strip steel; 7) enabling production of various advanced high-strength steel products with higher strength grades using alloy components for lower grades by implementing the process technology of rapid heating, rapid cooling and rapid heat treatment, which can not only reduce the production cost of the high-strength steel, but also improve the mechanical performances and subsequent processing performances (such as welding performance and coating performance) of the various high-strength steel products, thereby significantly promoting the market competitiveness of the high-strength steel products; 8) improving soaking, and enabling rapid regulation of the soaking temperature of the strip steel.

To achieve the above purposes, the technical solution of the present disclosure is:

A dual-purpose high-strength strip steel production line for continuous annealing or hot-dip galvanizing, including the following stations in sequence: uncoiling—welding—inlet looper-washing—central continuous post-processing—temper rolling—outlet looper—coiling; wherein the central continuous post-processing station includes in sequence a jet radiant tube preheating section, a radiant tube heating section, a transverse magnetic induction heating section, a soaking section, a slow cooling section, a rapid cooling section, a reheating section, a parallel arrangement of (furnace nose section+zinc pot section+air knife section+post-plating cooling section) and (mobile channel section+overaging section+final gas jet cooling section), and a final water cooling section; a radiant tube soaking section or a jet-radiation composite soaking section is used for the soaking section; the rapid cooling section includes a high hydrogen cooling section or/a mist cooling section or/a water quenching cooling section.

Further, a uniform holding section and a secondary reheating section are provided after the reheating section, and the secondary reheating section is further connected to the parallel arrangement of (furnace nose section+zinc pot section+air knife section+post-plating cooling section) and (mobile channel section+overaging section+final gas jet cooling section).

Still further, the hot-dip galvanizing is hot-dip galvannealing, and an alloying heating section and an alloying soaking section are provided between the air knife section and the post-plating cooling section.

Still further, the dual-purpose high-strength strip steel production line for continuous annealing or hot-dip galvanizing according to the present disclosure includes the following stations in sequence: uncoiling—welding—inlet looper—washing—central continuous post-processing—temper rolling—outlet looper—coiling; wherein the central continuous post-processing station includes in sequence a jet radiant tube preheating section, a radiant tube heating section, a transverse magnetic induction heating section, a soaking section, a slow cooling section, a rapid cooling section, a pickling section, a reheating section, a parallel arrangement of (furnace nose section+zinc pot section+air knife section+post-plating cooling section) and (mobile channel section+overaging section+final gas jet cooling section), and a final water cooling section; a radiant tube soaking section or a jet-radiation composite soaking section is used for the soaking section; the rapid cooling section includes a mist cooling section and a water quenching cooling section; the strip steel may be subjected to mist cooling, or water quenching cooling, or mist cooling followed by water quenching cooling.

Further, a uniform holding section and a secondary reheating section are provided after the reheating section, and the secondary reheating section is further connected to the parallel arrangement of (furnace nose section+zinc pot section+air knife section+post-plating cooling section) and (mobile channel section+overaging section+final gas jet cooling section).

Still further, the hot-dip galvanizing is hot-dip galvannealing, and an alloying heating section and an alloying soaking section are provided between the air knife section and the post-plating cooling section.

Yet further, the dual-purpose high-strength strip steel production line for continuous annealing or hot-dip galvanizing according to the present disclosure includes the following stations in sequence: uncoiling—welding—inlet looper—washing—central continuous post-processing—temper rolling—outlet looper—coiling; wherein the central continuous post-processing station includes in sequence a jet radiant tube preheating section, a radiant tube heating section, a transverse magnetic induction heating section, a soaking section, a slow cooling section, a rapid cooling section, a pickling section, a reheating section, a parallel arrangement of (furnace nose section+zinc pot section+air knife section+alloying heating section+alloying soaking section+post-plating cooling section) and (mobile channel section+overaging section+final gas jet cooling section), and a final water cooling section; a radiant tube soaking section or a jet-radiation composite soaking section is used for the soaking section; a high hydrogen cooling section, a mist cooling section and/or a water quenching cooling section is used for the rapid cooling section; the high hydrogen cooling section is provided in parallel with the mist cooling section and/or the water quenching cooling section, and the high hydrogen cooling section is connected to the reheating section.

Further, a uniform holding section and a secondary reheating section are provided after the reheating section, and the secondary reheating section is further connected to the parallel arrangement of (furnace nose section+zinc pot section+air knife section+post-plating cooling section) and (mobile channel section+overaging section+final gas jet cooling section).

Still further, the hot-dip galvanizing is hot-dip galvannealing, and an alloying heating section and an alloying soaking section are provided between the air knife section and the post-plating cooling section.

Preferably, a mobile post-plating rapid cooling section is provided after the air knife section, and is provided in parallel with the alloying heating section, so that such a design is formed that the post-plating rapid cooling section can be switched between online and offline. When producing a pure zinc hot-dip galvanized product, the mobile post-plating rapid cooling section is online to quickly cool the plated strip steel, and the alloying heating section is offline at this time; when producing a hot-dip galvannealed product, the mobile post-plating rapid cooling section is offline, and the alloying heating section is online to perform alloying heating on the strip steel.

Preferably, the radiant tube soaking section is replaced with a jet-radiation composite soaking section to achieve rapid regulation of the soaking temperature of the strip steel when the working conditions change, such as changes in strip steel thickness specification, target temperature, unit speed, etc.

Preferably, a nickel flash plating or iron flash plating section is provided before the reheating section to improve the corrosion resistance or platability of the strip steel.

Preferably, washing stations are provided before and after the inlet looper station to perform secondary washing on the strip steel, so as to further improve the surface quality of the strip steel.

Preferably, a finishing station is provided before the coiling station, and the strip steel is finished before coiling.

Preferably, an intermediate looper station is provided before the temper rolling station to ensure that the quality of the strip steel is not lost when the working rolls of the temper rolling machine are replaced online.

Preferably, a selectable tension levelling station is provided between the temper rolling station and the outlet looper station, and the strip steel may be tension levelled before entering the outlet looper.

Preferably, a selectable surface post-treatment station such as that for passivation or anti-fingerprint treatment is provided between the temper rolling station and the outlet looper station, and the strip steel may be subjected to surface post-treatment such as passivation or anti-fingerprint treatment before entering the outlet looper.

Preferably, a selectable tension levelling station device and a selectable surface post-treatment station such as that for passivation or anti-fingerprint treatment are provided between the temper rolling station and the outlet looper station. The strip steel may be subjected to surface post-treatment such as passivation or anti-fingerprint treatment before entering the outlet looper.

The differences or innovation points of the production line of the present disclosure as compared with the conventional continuous heat treatment line include:

1) According to the present disclosure, a jet radiant tube preheating section device is used to preheat the strip steel. In the jet radiant tube preheating section device, the combustion exhaust gas from the radiant tube heating section is used to heat a recycled nitrogen-hydrogen protective gas in the furnace, and then the nitrogen-hydrogen protective gas is jetted onto the upper and lower surfaces of the strip steel to realize forced convection heat exchange, so that all the waste heat from the combustion in the radiant tube can be fully utilized online, and the strip steel can be preheated to a temperature of at least 250° C. The jet radiant tube jet preheating section is one of the core technologies of the present disclosure.

2) According to the present disclosure, a transverse magnetic induction heating section device is provided after the radiant tube heating section. The transverse magnetic induction heating is used to further raise the temperature of the high-temperature strip steel quickly, thereby allowing for ultra-high temperature annealing of the high-strength steel.

3) The present disclosure enables flexible selection from four cooling paths to produce continuously annealed products or hot-dip galvanized products.

4) According to the present disclosure, the coordinated use of a transverse magnetic induction heating device and a variety of rapid cooling devices allows for rapid heating and rapid cooling annealing treatments, thereby enabling continuous production of rapidly heat-treated high-strength strip steel.

5) According to the present disclosure, jet-radiation composite soaking is used instead of radiant tube soaking to achieve rapid regulation of the soaking temperature of the strip steel when the working conditions change, such as changes in strip steel thickness specification, target temperature, unit speed, etc.

6) The present disclosure enables continuous production of strip steel products with three different surface states generated by: cold-rolling annealing, pure zinc hot-dip galvanizing and hot-dip galvannealing.

7) The technical solution of the present disclosure in which a secondary reheating section device is provided enables the strip steel temperature to be raised twice before the hot-dip galvanizing treatment. A third-generation high-strength steel (QP steel) product may be cooled quickly to a lower temperature, and then immediately heated quickly to a higher temperature for long-term carbon redistribution treatment. After the treatment is completed, it is quickly reheated for a second time to a temperature at which it is put into a hot-dip galvanizing zinc pot to carry out the galvanizing treatment.

The beneficial effects of the present disclosure include:

1) The present disclosure enables flexible selection between production of continuously annealed products and production of hot-dip galvanized products.

2) According to the present disclosure, the temperature of the strip steel is high after preheating, and the primary utilization rate of heat energy is high.

3) According to the present disclosure, transverse magnetic induction heating is used to further raise the temperature of the high-temperature strip steel quickly, thereby allowing for ultra-high temperature annealing of the high-strength steel.

4) With the use of a secondary reheating device according to the present disclosure, the strip steel temperature can be raised twice before the hot-dip galvanizing treatment. A third-generation high-strength steel (QP steel) product can be cooled quickly to a lower temperature, and then immediately heated quickly to a higher temperature for long-term carbon redistribution treatment. After the treatment is completed, it is quickly reheated for a second time to a temperature at which it is put into a hot-dip galvanizing zinc pot to carry out the galvanizing treatment.

5) The implementation of the process technology of rapid heating, rapid cooling and rapid heat treatment enables production of various advanced high-strength steel products with higher strength grades using alloy components for lower grades. The strength of 590 MPa-grade products can be achieved using alloy components for 450 MPa-grade products, and the performances of 980 MPa-grade products can be achieved using alloy components for 780 MPa-grade products. Not only the production cost of the high-strength steel can be reduced, but also the mechanical performances and subsequent processing performances (such as welding performance and coating performance) of the various ultra-high-strength steel products can be improved, thereby significantly promoting the market competitiveness of the high-strength steel products.

6) The present disclosure enables rapid heating and rapid cooling treatments of ultra-high-strength steel, and the heat treatment cycle period of the strip steel is shortened.

7) According to the present disclosure, jet-radiation composite soaking is used instead of radiant tube soaking to achieve rapid regulation of the soaking temperature of the strip steel when the working conditions change, such as changes in strip steel thickness specification, target temperature, unit speed, etc.

### Jet Direct Fire Preheating Device

The jet direct fire preheating device used in each production line of the present disclosure comprises: a direct fire furnace and a preheating furnace; wherein
the direct fire furnace comprises:
a furnace housing, wherein a furnace top roller chamber and a furnace bottom roller chamber are provided at upper and lower ends thereof respectively; turning rollers are provided in the furnace top roller chamber and the furnace bottom roller chamber respectively; a plurality of direct fire heating zones are provided along a height direction in the furnace housing, and a plurality of direct fire burners are provided in the direct fire heating zone; at least two through holes are provided in an upper side wall of the furnace housing symmetrically on left and right;
the preheating furnace comprises:
a furnace body, wherein at least two connecting holes are provided in its upper side wall symmetrically on left and right, and are respectively connected to the through holes on the upper part of the furnace housing of the direct fire furnace through connecting pipes; a furnace throat corresponding to the top roller chamber of the direct fire furnace is provided at the top of the furnace body for strip steel to pass through; a strip steel inlet, and correspondingly a sealing device and a turning roller are provided at the bottom of the furnace body; an upper baffle with a strip passing hole is provided in the upper part of the furnace body to form an upper collecting chamber for direct fire exhaust gas; a secondary combustion chamber for direct fire combustion exhaust gas is provided below the upper collecting chamber for direct fire combustion exhaust gas, and at least one open flame burner is provided in the secondary combustion chamber for direct fire combustion exhaust gas; preferably, a combustion exhaust gas thermometer is further provided in the secondary combustion chamber for direct fire combustion exhaust gas; a lower baffle with a strip passing hole is provided in the lower part of the furnace body to form a lower collecting chamber for direct fire exhaust gas, and is connected to an exhaust gas fan through an exhaust pipe; a control valve is provided on the exhaust pipe;
a plurality of heat exchange and jet bellows units provided on both sides below the secondary combustion chamber for direct fire combustion exhaust gas in the furnace body along a height direction of the furnace body, with a strip passing channel for the strip steel to pass through being formed in the middle; wherein each heat exchange and jet bellows unit comprises:
a bellows body, wherein a plurality of heat exchange tubes are provided vertically therein; a plurality of nozzles are provided on a side of the bellows body facing the strip passing channel; a secondary exhaust gas mixing chamber in communication with the heat exchange tube is provided between an upper bellows body and a lower bellows body; a nitrogen-hydrogen protective gas is introduced into the bellows body;
a circulating fan, wherein a port of its inlet pipe is provided in the strip passing channel, and a port of its outlet pipe is located in the bellows body;
a plurality of sealing devices through which the strip steel can pass, wherein they are respectively provided at upper and lower ports of the strip passing channel and the strip passing holes of the upper and lower baffles; preferably, the sealing device is a nitrogen sealing structure, wherein a nitrogen sealing chamber provided with a nitrogen injection pipe is used.

During the production process, the high-temperature combustion exhaust gas generated by direct fire combustion in the direct fire furnace enters the preheating furnace through the connecting pipe. In the preheating furnace, a plurality of heat exchange and jet bellows units are provided up and down in sequence. The heat exchange tubes of the heat exchange and jet bellows units (high-temperature combustion exhaust gas takes the tube-side path, and the protective gas takes the shell-side path) heat the nitrogen-hydrogen mixed gas in the bellows body, and jet the high-temperature nitrogen-hydrogen mixed gas onto both sides of the strip steel through the high-speed nozzles facing both sides of the strip steel to quickly heat the strip steel. The jetted high-temperature nitrogen-hydrogen mixed gas exchanges heat with the low-temperature strip steel. After the temperature of the mixed gas is reduced, it is drawn back to the heat exchanger in the furnace by the circulating fans disposed close to both sides of the strip steel and exchanges heat again with the combustion exhaust gas taking the tube-side path in the heat exchanger, thereby raising the temperature of the nitrogen-hydrogen mixed gas again. Then, the nitrogen-hydrogen mixed gas is jetted onto both sides of the strip steel again from inside the jet bellows unit. The cycle is thus repeated over and over.

### In the Preheating Device:

The heat exchange and jet bellows unit and the secondary combustion chamber for direct fire combustion exhaust gas are provided for the preheating. The heat exchange and jet bellows unit uses a heat exchange tube (the heat exchanger is not provided outside the furnace), and the combustion exhaust gas burned again in the secondary combustion chamber for direct fire combustion exhaust gas is used to heat the recycled nitrogen-hydrogen protective gas in the bellows body. Under the action of the circulating fan, the heated nitrogen-hydrogen protective gas is jetted at a high speed onto the upper and lower surfaces of the strip steel for forced convection heat exchange, thereby realizing fast and efficient preheating of the strip steel.

An open flame burner is further provided in the secondary combustion chamber for direct fire combustion exhaust gas to carry out, in the secondary combustion chamber for direct fire combustion exhaust gas, oxygen-enriched secondary combustion of the incompletely burned fuel gas in the direct fire combustion exhaust gas, and the burning flame will not contact the strip steel.

A secondary exhaust gas mixing chamber in communication with the heat exchange tube is provided between the upper and lower bellows bodies. The temperature of the exhaust gas is homogenized in the secondary exhaust gas mixing chamber before the exhaust gas enters the downstream bellows body.

The sealing device is a nitrogen sealing structure, and a nitrogen sealing chamber is provided. The nitrogen sealing chamber is provided with a nitrogen injection pipe port. By introducing sealing nitrogen into the nitrogen sealing chamber, a relatively high pressure is maintained to prevent a large amount of direct fire combustion exhaust gas from entering the strip passing channel inside the heat exchange and jet bellows unit in the furnace, thereby avoiding excessive oxidation of the strip steel surface by the direct fire combustion exhaust gas.

A sealing device is provided at the strip steel inlet of the preheating furnace. A gas injection port is also provided inside the sealing device to blow a small amount of sealing nitrogen or air, which is used to prevent direct fire combustion exhaust gas from overflowing outside the furnace.

### Jet Radiant Tube Preheating Device

The jet radiant tube preheating device used in each production line of the present disclosure comprises:
a radiant tube heating furnace, wherein a furnace top roller chamber is provided above the furnace body, and a turning roller is provided in the furnace top roller chamber;
a radiant tube exhaust gas collecting chamber connected to the furnace body of the radiant tube heating furnace via a connecting pipe;
a preheating furnace, comprising:
a preheating furnace body, wherein a connecting hole is provided through its upper side wall, and is communicated with the radiant tube exhaust gas collecting chamber through a connecting pipe; a furnace throat corresponding to the furnace top roller chamber of the radiant tube heating furnace is provided at the top of the preheating furnace body for strip steel to pass through; a strip steel inlet, an inlet sealing device and an inlet turning roller are provided at the bottom of the preheating furnace body; a preheating furnace gas collecting chamber is provided in an upper part of the preheating furnace body; a lower baffle with a strip passing hole is provided at a lower part of the furnace body to form an exhaust gas collecting chamber which is connected to an exhaust gas fan through an exhaust pipe; preferably, a control valve is provided on the exhaust pipe;
a plurality of heat exchange and jet bellows units provided on both sides below the preheating furnace gas collecting chamber in the preheating furnace body along a height direction of the furnace body, with a strip passing channel being formed in the middle for the strip steel to pass through, wherein each heat exchange and jet bellows unit comprises:
a bellows body, wherein a plurality of heat exchange tubes are vertically provided therein; a plurality of nozzles are provided on a side of the bellows body facing the strip passing channel; a secondary exhaust gas mixing chamber in communication with the heat exchange tube is provided between an upper bellows body and a lower bellows body; a protective gas is introduced into the bellows body; preferably, a nitrogen-hydrogen protective gas is introduced into the bellows body;
a circulating fan, wherein a port of its inlet pipe is provided in the strip passing channel, and a port of its outlet pipe is located in the bellows body;
sealing devices through which the strip steel can pass, wherein they are respectively provided at a lower port of the strip passing channel and the strip passing holes of the upper and lower baffles;
preferably, the inlet sealing device and the sealing devices through which the strip steel can pass have a nitrogen sealing structure, wherein a nitrogen sealing chamber provided with a nitrogen injection pipe is used.

The jet radiant tube preheating device of the present disclosure heats the recycled nitrogen-hydrogen protective gas directly by heat exchange in the furnace (the heat exchange is not provided outside the furnace). The heated nitrogen-hydrogen protective gas is jetted at a high speed onto the upper and lower surfaces of the strip steel to achieve forced convection heat exchange, thereby preheating of the strip steel fast and efficiently. Compared with the conventional heat exchange outside the furnace, this method leads to less heat loss from the furnace body, fuller use of the waste heat of the combustion exhaust gas, higher heating efficiency, and faster heating rate. Moreover, the combustion exhaust gas in the radiant tube enters the preheating furnace gas collecting chamber from the radiant tube exhaust gas collecting chamber through the connecting pipe, and then passes through the heat exchanger chamber in the preheating furnace (the heat exchanger is not provided outside the furnace) from top to bottom. During the passing process, the combustion exhaust gas taking the tube-side path and the nitrogen-hydrogen protective gas taking the shell-side path exchange heat fully in the heat exchanger, so that the nitrogen-hydrogen protective gas is heated. Therefore, the radiant tube combustion exhaust gas is never in direct contact with the strip steel in the preheating furnace, thereby avoiding oxidation of the strip steel surface. In addition, with the use of this preheating device, the strip steel is preheated to a high temperature which can reach at least 250° C., at least 50° C. higher than the temperature of the strip steel preheated in a conventional way. If an enough number of jet preheating units are provided, the radiant tube combustion exhaust gas coming out of multiple stages of preheating furnaces can have a temperature that is usually lower than 200° C., and can be discharged directly, with no need for additional investment for reutilization of the waste heat of the combustion exhaust gas outside the furnace.

### Jet-Radiation Composite Heating Device

The jet-radiation composite heating device used in each production line of the present disclosure comprises:
a furnace body provided therein with a composite heating body in a height direction; wherein the composite heating body comprises:
a heat insulated box having an insulating material provided on an inner wall of its housing body, wherein a mounting hole is provided at the center of a side face of the heat insulated box;
a circulating fan provided at the mounting hole of the heat insulated box, wherein a suction opening of the circulating fan aligns with an axis of the mounting hole, and a discharge opening is provided at a side face of a housing of the circulating fan;
a buffer cavity provided in the heat insulated box in alignment with the suction opening of the circulating fan, wherein a hot gas outlet is provided at a back side of the buffer cavity in alignment with the suction opening of the circulating fan, and a hot gas inlet is provided at a front side of the buffer cavity; preferably, the buffer cavity and the jet bellows form an integrated structure;
a pair of jet bellows provided vertically and symmetrically at opposite sides in front of the hot gas inlet at the front side of the buffer cavity in the heat insulated box, thereby forming therebetween a strip passing channel for strip steel to pass through; wherein a plurality of rows of jet nozzles are provided at intervals at a side face of the pair of jet bellows located at both sides of the strip passing channel in a height direction, and a gap is provided between n rows of jet nozzles, wherein n≥1; preferably, the jet nozzle has diameter that is 1/10 to ⅕ of a distance from the jet nozzle to the strip steel; more preferably, the jet nozzle has a circular hole structure;
a plurality of radiant tubes symmetrically provided in the pair of jet bellows, wherein the radiant tube includes a connecting tube section connected to the nozzle, a radiation tube section extending sinuously from an end of the connecting tube section, and a heat exchange tube section extending sinuously from an end of the radiation tube section; the radiation tube section aligns with the gap provided between the n rows of jet nozzles in the jet bellows, thereby forming a structure with alternating jetting and radiation; preferably, the radiation tube section, the connecting tube section, and the heat exchange tube section of the radiant tube are provided in parallel.

Preferably, the jet bellows is a high-temperature jet bellows. Preferably, high-temperature gas in the high-temperature jet bellows has a temperature of at least 750° C., for example, 750-880° C. Preferably, the nozzle is a high-speed jet nozzle. Preferably, jet gas has a velocity of not less than 50 m/s at an outlet of the nozzle.

The jet-radiation composite heating device of the present disclosure utilizes a composite heating technology. It can combine the high-speed high-temperature jet heating technology with the radiant tube heating technology organically, and gives full play to the technical advantages of the high-speed high-temperature jet heating technology and the radiant tube heating technology. By optimizing the design of the structure of the radiant tube, the radiant tube is installed inside a high-speed jet bellows, so that the heat generated by burning gas in the radiant tube is quickly transferred to the strip steel by way of both high-speed high-temperature jet and radiation, thereby heating the strip steel rapidly. For 1 mm strip steel, the average heating speed is not less than 40° C./s at most, which can greatly reduce the length of the heating furnace. For a unit with an annual output of 300,000 tons, the heating section is about 2 passes, which reduces the thermal inertia of the furnace body.

In addition, since the heat generated by the fuel gas is taken away by the circulating gas (N₂+H₂) in the bellows, the exhaust temperature of the radiant tube can be reduced. The exhaust temperature of the radiant tube can be reduced by about 100° C. under the same conditions, thereby improving the thermal efficiency of the radiant tube by about 5%. Besides, the average working temperature of the radiant tube can also be reduced, thus extending the service life of the radiant tube.

Furthermore, the temperature of the heated circulating gas is relatively uniform, so the temperature distribution in the width direction of the strip steel is relatively uniform during the heating process. According to the practical operation, the variation in the width direction of the strip steel during the heating process is controlled at ±5° C., thereby achieving stable operation of the unit. The composite heating technology of high-speed jet and radiation will significantly increase the production capacity of the existing units, and solve the problem that the heating ability of the production line is insufficient.

The radiant tube in the jet-radiation composite soaking device according to the present disclosure has the combustion radiation function (referring to the high temperature section of the radiant tube between the two rows of nozzles) and the heat exchanger function for heating the circulating gas at the same time, so that the heat generated by burning gas in the radiant tube can be quickly transferred to the strip steel through forced heat exchange, thereby heating the strip steel rapidly. The length of the heating furnace can be shortened greatly, and the thermal inertia of a large vertical continuous annealing furnace body can be reduced.

### BRIEF DESCRIPTION OF THE DRAWINGS

FIG. 1 is a view showing the station layout of a conventional hot-dip galvanizing (GI) production line;

FIG. 2 is a view showing the station layout of a conventional hot-dip galvannealing (GA) production line;

FIGS. 3 to 10 are views showing the station layouts of the production lines in Examples 1 to 8 according to the rapid production line for hot-dip galvanized strip steel in the present disclosure;

FIG. 11 is a schematic structural view of an embodiment of a jet direct fire preheating device according to the present disclosure;

FIG. 12 is a schematic structural view of a preheating furnace in an embodiment of the jet direct fire preheating device according to the present disclosure;

FIG. 13 is a schematic structural view 1 of an embodiment of the jet-radiation composite heating/soaking device according to the present disclosure;

FIG. 14 is a schematic structural view 2 of an embodiment of the jet-radiation composite heating/soaking device according to the present disclosure;

FIG. 15 is a schematic structural view of the composite heating body in an embodiment of the jet-radiation composite heating/soaking device according to the present disclosure;

FIG. 16 is a partial stereoscopic view of the jet bellows in an embodiment of the jet-radiation composite heating/soaking device according to the present disclosure;

FIG. 17 is a stereoscopic view of the radiant tube in an embodiment of the jet-radiation composite heating/soaking device according to the present disclosure;

FIGS. 18 to 25 are views showing the station layouts of the production lines in Examples 1 to 8 according to the rapid production line for hot-dip galvanized high-strength strip steel in the present disclosure;

FIG. 26 is a schematic structural view of an embodiment of a jet radiant tube preheating device according to the present disclosure;

FIG. 27 is a schematic structural view of the preheating furnace in an embodiment of the jet radiant tube preheating device according to the present disclosure;

FIGS. 28 to 41 are views showing the station layouts of the production lines in Examples 1 to 14 according to the rapid hot-dip galvanized ultra-high-strength strip steel in the present disclosure;

FIG. 42 is a schematic view showing the station layout of a conventional continuously annealing production line;

FIGS. 43 to 71 are schematic views showing the station layouts of the production lines in Examples 1 to 29 according to the rapid production line for continuously annealed strip steel in the present disclosure;

FIGS. 72 to 78 are schematic views showing the station layouts of the production lines in Examples 1 to 7 according to the rapid production line for continuously annealed high-strength strip steel in the present disclosure;

FIGS. 79 to 85 are views showing the station layouts of the production lines in Examples 1 to 7 according to the rapid production line for continuously annealed ultra-high-strength strip steel in the present disclosure;

FIGS. 86 to 93 are schematic views showing the station layouts of the production lines in Examples 1 to 8 according to the rapid production line for continuously annealed ultra-high-strength strip steel in the present disclosure;

FIGS. 94 to 111 are views showing the station layouts of the production lines in Examples 1 to 18 according to the ultra-short-process production line for dual-purpose strip steel in the present disclosure;

FIGS. 112 to 129 are views showing the station layouts of the production lines in Examples 1 to 28 according to the ultra-short-process production line for ultra-high-strength strip steel in the present disclosure;

FIGS. 140 to 147 are views showing the station layouts of the production lines in Examples 1 to 8 according to the ultra-short-process production line for hot-dip galvanized high-strength strip steel in the present disclosure;

FIGS. 148 to 153 are views showing the station layouts of the production lines in Examples 1 to 6 according to the flexible cold-rolled strip steel post-processing production line suitable for producing a variety of high-strength steels in the present disclosure;

FIGS. 154 to 159 are views showing the station layouts of the production lines in Examples 1 to 6 according to the flexible post-cold-rolling processing production line suitable for producing a variety of ultra-high-strength steels in the present disclosure;

FIGS. 160 to 166 are views showing the station layouts of the production lines in Examples 1 to 7 according to the flexible cold-rolled strip steel post-processing production line suitable for producing a variety of high-strength steels in the present disclosure;

FIGS. 167 to 174 are views showing the station layouts of the production lines in Examples 1 to 8 according to the flexible production line suitable for a variety of ultra-high-strength steels in the present disclosure;

FIGS. 175 to 186 are views showing the station layouts of the production lines in Examples 1 to 12 according to the dual-purpose ultra-high-strength strip steel production line for continuous annealing or hot-dip galvanizing in the present disclosure;

FIGS. 187 to 198 are views showing the station layouts of the production lines in Examples 1 to 12 according to the dual-purpose high-strength strip steel production line for continuous annealing or hot-dip galvanizing in the present disclosure.

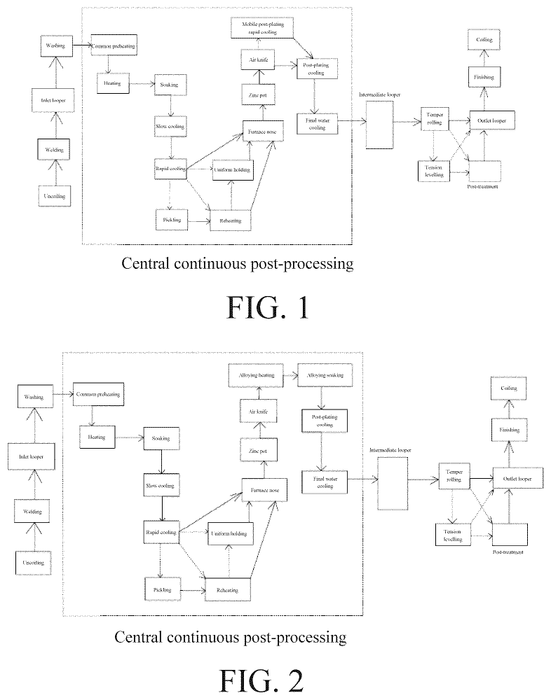

### DETAILED DESCRIPTION

The present disclosure will be further illustrated below with reference to the Examples and drawings. It should be noted that a variety of production lines can be derived and developed based on the concept of the present disclosure. The Examples only set forth some embodiments, and the family patents of the present disclosure will also provide other embodiments. Even with the whole family of patents taken into account, the Examples still provide only a portion of possible embodiments. Various combinations resulting from selection or omission of the stations or sections described in the present disclosure all fall within the protection scope of the present disclosure. Various production lines derived based on the concept of the present disclosure also fall within the protection scope of the present disclosure. In addition, for production lines including conventional stations, such as a washing station including an alkaline solution spraying section, an alkaline solution brushing section, an electrolytic washing section, a hot water brushing or cold water abrasive roller brushing section and hot water rinsing section, or omitting some of them for simplification, or even in combination with a high-pressure water jet brushing section, an ultrasonic washing section, a high-pressure washing section and other devices based on new washing technologies, they are all considered to be production lines derived from the present disclosure, and also fall within the protection scope of the present disclosure. For another example, a finishing station including an edge trimming device, an oiling device and other devices also falls within the protection scope of the present disclosure.

### Rapid Production Line for Hot-Dip Galvanized Strip Steel

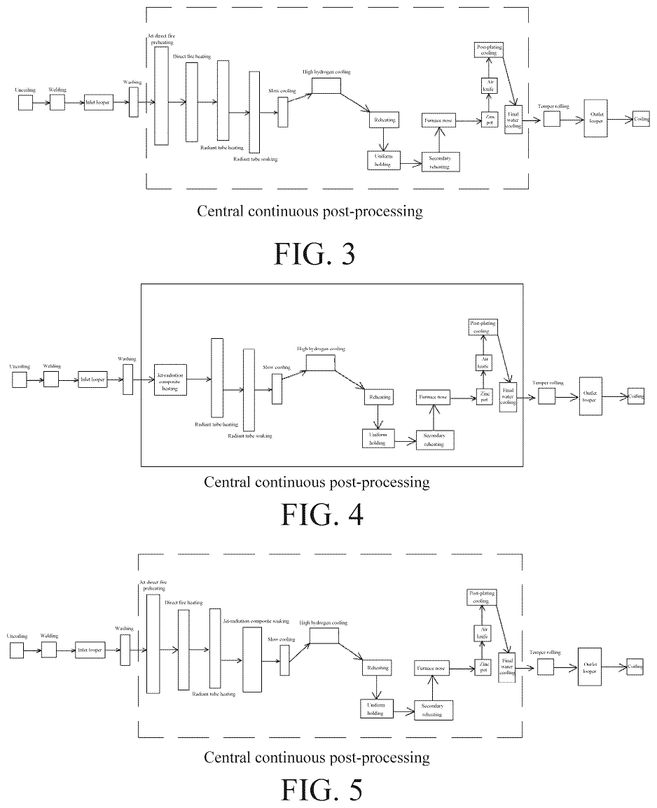

Referring to FIG. 3, the rapid production line for hot-dip galvanized strip steel according to the present disclosure includes the following stations in sequence: uncoiling—welding—inlet looper—washing—central continuous post-processing—outlet looper—temper rolling—coiling; wherein
the central continuous post-processing station includes in sequence a jet direct fire preheating section, a direct fire heating section, a radiant tube heating section, a radiant tube soaking section, a slow cooling section, a high hydrogen cooling section, a reheating section, a uniform holding section, a secondary reheating section, a furnace nose section, a zinc pot section, an air knife section, a post-plating cooling section and a final water cooling section.

The jet direct fire preheating section uses the combustion exhaust gas from the direct fire heating section to heat the recycled nitrogen-hydrogen protective gas, and then the nitrogen-hydrogen protective gas is jetted onto the upper and lower surfaces of the strip steel to achieve forced convection heat exchange.

A longitudinal magnetic induction heating device is used in both the reheating section and the secondary reheating section to heat the strip steel quickly.

Referring to FIG. 4 which shows Example 2 of the present disclosure, in Example 2, the rapid production line for hot-dip galvanized strip steel includes the following stations in sequence: uncoiling—welding—inlet looper—washing—central continuous post-processing—outlet looper-temper rolling—coiling; wherein
the central continuous post-processing station includes in sequence a jet-radiation composite heating section, a radiant tube heating section, a radiant tube soaking section, a slow cooling section, a high hydrogen cooling section, a reheating section, a uniform holding section, a secondary reheating section, a furnace nose section, a zinc pot section, an air knife section, a post-plating cooling section and a final water cooling section.

In the jet-radiation composite heating section, in addition to the use of the radiant tube to heat the strip steel by radiation, the combustion exhaust gas from the radiant tube is also used to heat the recycled nitrogen-hydrogen protective gas, and then the nitrogen-hydrogen protective gas is jetted onto the upper and lower surfaces of the strip steel to realize forced convection heat exchange.

A longitudinal magnetic induction heating device is used in both the reheating section and the secondary reheating section to heat the strip steel quickly.

Referring to FIG. 5 which shows Example 3 of the present disclosure, in Example 3, the rapid production line for hot-dip galvanized strip steel includes the following stations in sequence: uncoiling—welding—inlet looper—washing—central continuous post-processing—outlet looper-temper rolling—coiling; wherein
the central continuous post-processing station includes in sequence a jet direct fire preheating section, a direct fire heating section, a radiant tube heating section, a jet-radiation composite soaking section, a slow cooling section, a high hydrogen cooling section, a reheating section, a uniform holding section, a secondary reheating section, a furnace nose section, a zinc pot section, an air knife section, a post-plating cooling section and a final water cooling section.

The jet direct fire jet preheating section is characterized in that the combustion exhaust gas from the direct fire heating section is used to heat the recycled nitrogen-hydrogen protective gas, and then the nitrogen-hydrogen protective gas is jetted onto the upper and lower surfaces of the strip steel to realize forced convection heat exchange.

A longitudinal magnetic induction heating device is used in both the reheating section and the secondary reheating section to heat the strip steel quickly.

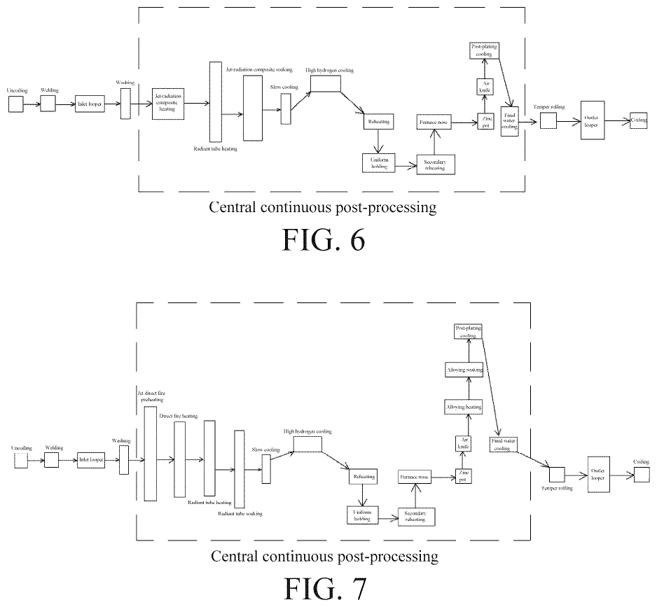

Referring to FIG. 6 which shows Example 4 of the present disclosure, in Example 4, the rapid production line for hot-dip galvanized strip steel includes the following stations in sequence: uncoiling—welding—inlet looper—washing—central continuous post-processing—outlet looper-temper rolling—coiling; wherein
the central continuous post-processing station includes in sequence a jet-radiation composite heating section, a radiant tube heating section, a jet-radiation composite soaking section, a slow cooling section, a high hydrogen cooling section, a reheating section, a uniform holding section, a secondary reheating section, a furnace nose section, a zinc pot section, an air knife section, a post-plating cooling section and a final water cooling section.

In the jet-radiation composite heating and soaking sections, in addition to the use of the radiant tube to heat the strip steel by radiation, the combustion exhaust gas from the radiant tube is also used to heat the recycled nitrogen-hydrogen protective gas, and then the nitrogen-hydrogen protective gas is jetted onto the upper and lower surfaces of the strip steel to realize forced convection heat exchange.

A longitudinal magnetic induction heating device is used in both the reheating section and the secondary reheating section to heat the strip steel quickly.

Referring to FIG. 7 which shows Example 5 of the present disclosure, in Example 5, the production line includes the following stations in sequence: uncoiling—welding—inlet looper-washing—central continuous post-processing—outlet looper—temper rolling—coiling; wherein
the central continuous post-processing station includes in sequence a jet direct fire preheating section, a direct fire heating section, a radiant tube heating section, a radiant tube soaking section, a slow cooling section, a high hydrogen cooling section, a reheating section, a uniform holding section, a secondary reheating section, a furnace nose section, a zinc pot section, an air knife section, an alloying heating section, an alloying soaking section, a post-plating cooling section and a final water cooling section.

The jet direct fire jet preheating section is characterized in that the combustion exhaust gas from the direct fire heating section is used to heat the recycled nitrogen-hydrogen protective gas, and then the nitrogen-hydrogen protective gas is jetted onto the upper and lower surfaces of the strip steel to realize forced convection heat exchange.

A longitudinal magnetic induction heating device is used in both the reheating section and the secondary reheating section to heat the strip steel quickly.

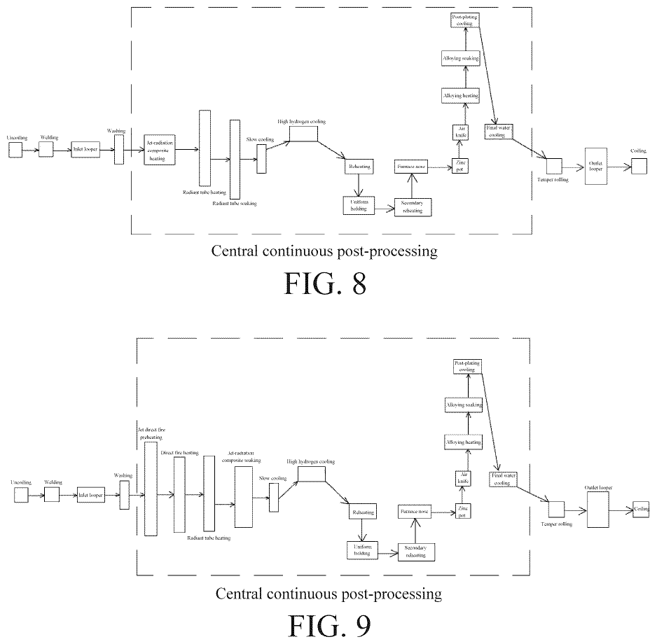

Referring to FIG. 8, the rapid hot-dip galvannealed strip steel production line of the present disclosure includes the following stations in sequence: uncoiling—welding—inlet looper—washing
central continuous post-processing—outlet looper—temper rolling—coiling; wherein the central continuous post-processing station includes in sequence a jet-radiation composite heating section, a radiant tube heating section, a radiant tube soaking section, a slow cooling section, a high hydrogen cooling section, a reheating section, a uniform holding section, a secondary reheating section, a furnace nose section, a zinc pot section, an air knife section, an alloying heating section, an alloying soaking section, a post-plating cooling section and a final water cooling section.

In the jet-radiation composite heating section, in addition to the use of the radiant tube to heat the strip steel by radiation, the combustion exhaust gas from the radiant tube is also used to heat the recycled nitrogen-hydrogen protective gas, and then the nitrogen-hydrogen protective gas is jetted onto the upper and lower surfaces of the strip steel to realize forced convection heat exchange.

A longitudinal magnetic induction heating device is used in both the reheating section and the secondary reheating section to heat the strip steel quickly.

Referring to FIG. 9, the rapid hot-dip galvannealed strip steel production line of the present disclosure includes the following stations in sequence: uncoiling—welding—inlet looper—washing
central continuous post-processing—outlet looper—temper rolling—coiling; wherein the central continuous post-processing station includes in sequence a jet direct fire preheating section, a direct fire heating section, a radiant tube heating section, a jet-radiation composite soaking section, a slow cooling section, a high hydrogen cooling section, a reheating section, a uniform holding section, a secondary reheating section, a furnace nose section, a zinc pot section, an air knife section, an alloying heating section, an alloying soaking section, a post-plating cooling section and a final water cooling section.

In the jet direct fire preheating section, the combustion exhaust gas from the direct fire heating section is used to heat the recycled nitrogen-hydrogen protective gas, and then the nitrogen-hydrogen protective gas is jetted onto the upper and lower surfaces of the strip steel to realize forced convection heat exchange.

A longitudinal magnetic induction heating device is used in both the reheating section and the secondary reheating section to heat the strip steel quickly.

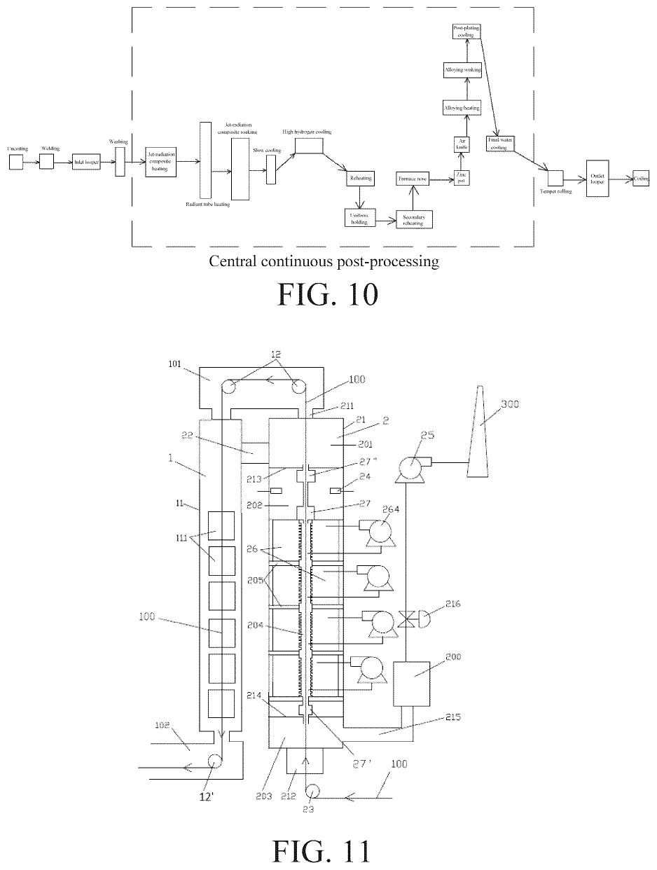

Referring to FIG. 10 which shows Example 6 of the present disclosure, in Example 6, the rapid hot-dip galvannealed strip steel production line includes the following stations in sequence: uncoiling—welding—inlet looper—washing—central continuous post-processing—outlet looper-temper rolling—coiling; wherein
the central continuous post-processing station includes in sequence a jet-radiation composite heating section, a radiant tube heating section, a jet-radiation composite soaking section, a slow cooling section, a high hydrogen cooling section, a reheating section, a uniform holding section, a secondary reheating section, a furnace nose section, a zinc pot section, an air knife section, an alloying heating section, an alloying soaking section, a post-plating cooling section and a final water cooling section.

In the jet-radiation composite heating and soaking sections, in addition to the use of the radiant tube to heat the strip steel by radiation, the combustion exhaust gas from the radiant tube is also used to heat the recycled nitrogen-hydrogen protective gas, and then the nitrogen-hydrogen protective gas is jetted onto the upper and lower surfaces of the strip steel to realize forced convection heat exchange.

A longitudinal magnetic induction heating device is used in both the reheating section and the secondary reheating section to heat the strip steel quickly.

Preferably, a selectable mobile post-plating rapid cooling section is provided after the air knife section and before the post-plating cooling section in the central continuous post-processing station. After the strip steel is hot-dip galvanized in the zinc pot section and the coating weight is controlled by the air knife section, the mobile post-plating rapid cooling section may be chosen to carry out post-plating rapid cooling. Alternatively, the mobile post-plating rapid cooling section may not be used; instead, natural cooling may be carried out before post-plating cooling, thereby enabling continuous production of the hot-dip galvanized high-strength strip steel.

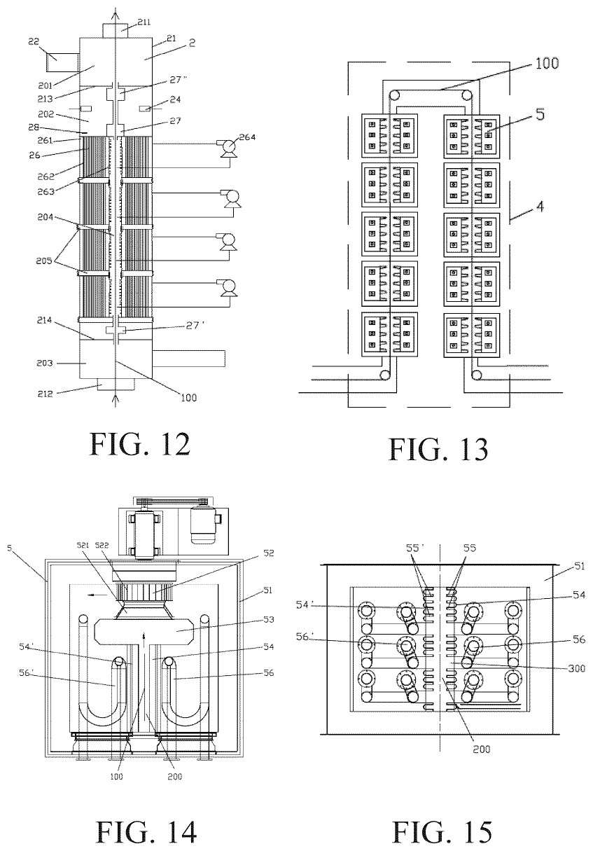

Referring to FIG. 11 and FIG. 12, the jet direct fire preheating device of the present disclosure comprises: a direct fire furnace 1 and a preheating furnace 2; wherein:
the direct fire furnace 1 comprises:
a furnace housing 11, wherein a furnace top roller chamber 101 and a furnace bottom roller chamber 102 are provided at upper and lower ends thereof respectively; turning rollers 12, 12′ are provided in the furnace top roller chamber 101 and the furnace bottom roller chamber 102 respectively; a plurality of direct fire heating zones 111 are provided along a height direction in the furnace housing 11, and a plurality of direct fire burners are provided in the direct fire heating zone 111; two through holes are provided in an upper side wall of the furnace housing 11 symmetrically on left and right;
the preheating furnace 2 comprises:
a furnace body 21, wherein two connecting holes are provided in its upper side wall symmetrically on left and right, and are respectively connected to the through holes on the upper part of the furnace housing 11 of the direct fire furnace 1 through connecting pipes 22; a furnace throat 211 corresponding to the furnace top roller chamber 101 of the direct fire furnace 1 is provided at the top of the furnace body 21 for strip steel to pass through; a strip steel inlet, and correspondingly a sealing device 212 and a turning roller 23 are provided at the bottom of the furnace body 21; an upper baffle 213 with a strip passing hole is provided in the upper part of the furnace body 21 to form an upper collecting chamber 201 for direct fire exhaust gas; a secondary combustion chamber 202 for direct fire combustion exhaust gas is provided below the upper collecting chamber 201 for direct fire combustion exhaust gas, and at least one open flame burner 24 is provided in the secondary combustion chamber 202 for direct fire combustion exhaust gas; a lower baffle 214 with a strip passing hole is provided in the lower part of the furnace body 21 to form a lower collecting chamber 203 for direct fire exhaust gas, and is connected to an exhaust gas fan 25 through an exhaust pipe 215;
a plurality of heat exchange and jet bellows units 26 provided on both sides below the secondary combustion chamber 202 for direct fire combustion exhaust gas in the furnace body 21 along a height direction of the furnace body 21, with a strip passing channel 204 for the strip steel to pass through being formed in the middle; wherein each heat exchange and jet bellows unit 26 comprises:
a bellows body 261, wherein a plurality of heat exchange tubes 262 are provided vertically therein; a plurality of nozzles 263 are provided on a side of the bellows body 261 facing the strip passing channel 204; a secondary exhaust gas mixing chamber 205 in communication with the heat exchange tube 262 is provided between an upper bellows body 261 and a lower bellows body 261; a nitrogen-hydrogen protective gas is introduced into the bellows body 261;
a circulating fan 264, wherein a port of its inlet pipe is provided in the strip passing channel 204, and a port of its outlet pipe is located in the bellows body 261;
a plurality of sealing devices 27, 27′, 27″ through which the strip steel can pass, wherein they are respectively provided at upper and lower ports of the strip passing channel 204 and the strip passing holes of the upper and lower baffles 213, 214.

Preferably, a combustion exhaust gas thermometer 28 is further provided in the secondary combustion chamber 202 for direct fire combustion exhaust gas.

Preferably, the sealing devices 27, 27′, 27″ have a nitrogen sealing structure, wherein a nitrogen sealing chamber provided with a nitrogen injection pipe is used.

Preferably, a control valve 216 is provided on the exhaust pipe 215.

The strip steel 100 is turned by the turning roller in front of the direct fire furnace to move upward. It is first sealed by the sealing device at the entrance of the preheating furnace, and then enters the preheating furnace 2 for preheating. Then, it enters the furnace top roller chamber of the direct fire furnace 1, in which it is turned by the turning roller, and then it enters the direct fire furnace 1 for direct fire heating. Then, it enters the bottom roller chamber of the direct fire furnace 1, in which it is turned by the turning roller, and then it continues to move forward.

After the direct fire combustion exhaust gas passes through the heat exchange tube and heats the nitrogen-hydrogen protective gas, the temperature of the exhaust gas drops (the nitrogen-hydrogen protective gas is jetted onto the upper and lower surfaces of the strip steel to preheat the strip steel under the action of the circulating fan), and the cooled nitrogen-hydrogen protective gas is sucked into the bellows by the circulating fan 264 at both the working side (WS side) and the driving side (DS side) of the preheating furnace for heat exchange with the heat exchange tube. The direct fire combustion exhaust gas passes through the heat exchange and jet bellows units from top to bottom in turn. Under the suction of the variable frequency exhaust gas fan 25, it passes through the exhaust pipeline 215. Then, it first passes through the waste heat boiler 400 for reutilization of the waste heat of the combustion exhaust gas outside the furnace, and then enters the chimney 500 for final discharge.

Referring to FIG. 13 to FIG. 17, the jet-radiation composite heating/soaking device of the present disclosure comprises:
a furnace body 4 provided therein with a composite heating body 5 in a height direction; wherein the composite heating body 5 comprises:
a heat insulated box 51 having an insulating material provided on an inner wall of its housing body, wherein a mounting hole is provided at the center of a side face of the heat insulated box 51;
a circulating fan 52 provided at the mounting hole of the heat insulated box 51, wherein a suction opening 521 of the circulating fan 52 aligns with an axis of the mounting hole, and a discharge opening 522 is provided at a side face of a housing of the circulating fan;
a buffer cavity 53 provided in the heat insulated box 51 in alignment with the suction opening of the circulating fan 52, wherein a hot gas outlet 531 is provided at a back side of the buffer cavity 53 in alignment with the suction opening of the circulating fan 52, and a hot gas inlet 532 is provided at a front side of the buffer cavity;
a pair of jet bellows 54, 54′ provided vertically and symmetrically at opposite sides in front of the hot gas inlet at the front side of the buffer cavity 53 in the heat insulated box 51, thereby forming therebetween a strip passing channel 200 for strip steel 100 to pass through; wherein a plurality of rows of jet nozzles 55, 55′ are provided at intervals at a side face of the pair of jet bellows 54, 54′ located at both sides of the strip passing channel 100 in a height direction, and a gap 300 is provided between n rows of jet nozzles, wherein n≥1;
a plurality of radiant tubes 56, 56′ symmetrically provided in the pair of jet bellows 54, 54′, wherein the radiant tube 56 (the radiant tube 56 is an example; similarly hereinafter) includes a connecting tube section 561 connected to the nozzle, a radiation tube section 562 extending sinuously from an end of the connecting tube section 561, and a heat exchange tube section 563 extending sinuously from an end of the radiation tube section 562; the radiation tube section 562 aligns with a gap 300 provided between the n rows of jet nozzles in the jet bellows 54, thereby forming a structure with alternating jetting and radiation.

Preferably, the buffer cavity and the jet bellows form an integrated structure.

Preferably, the jet nozzle has a diameter that is 1/10 to ⅕ of a distance from the jet nozzle to the strip steel.

Preferably, the jet nozzle has a circular hole structure.

Preferably, the radiant tube adopts a spatial four-passage structure to form four tube sections provided in parallel, wherein one tube section is a radiation tube section, and the others are connecting tube sections and heat exchange tube sections.

### Example 1

The layout of a production line for preparing a hot-dip galvanized strip steel is shown in FIG. 3. A strip steel with the main chemical composition (mass %) of the substrate being 0.1% C-0.50% Si-1.95% Mn was uncoiled, welded, passed through an inlet looper, and washed. The strip steel was then preheated to 360° C. by jet direct fire, then heated to 680° C. by direct fire, then heated to 800° C. by radiant tube heating, then soaked at 800° C. by radiant tube soaking for 50 seconds, then slowly cooled to 670° C., and then cooled to 470° C. by high hydrogen cooling. Then, the strip steel passed through a reheating section (the reheating function didn't need to be activated), a uniform holding section, and a secondary reheating section (the secondary reheating function didn't need to be activated). After passing through a furnace nose, it was immersed in a zinc pot for hot-dip galvanizing. After the coating weight was controlled by an air knife, the strip steel was subjected to post-plating cooling. Then, the strip steel was cooled to room temperature by final water cooling. After being temper rolled, it entered an outlet looper, and then it was coiled to complete the production. The final strip steel product had a yield strength of 365 MPa, a tensile strength of 685 MPa, and an elongation at break of 26%.

### Example 2

The layout of a production line for preparing a hot-dip galvanized strip steel is shown in FIG. 4. A strip steel with the main chemical composition (mass %) of the substrate being 0.18% C-1.7% Si-2.3% Mn was uncoiled, welded, passed through an inlet looper, and washed. The strip steel was then heated to 670° C. by jet-radiation composite heating, then heated to 850° C. by radiant tube heating, then soaked at 850° C. by radiant tube soaking for 80 seconds, then slowly cooled to 675° C., and then cooled to 230° C. by high hydrogen cooling. Then, it was reheated again to 400° C., uniformly held at 400° C., and then heated to 455° C. by secondary reheating. Then, it was immersed in a zinc pot for hot-dip galvanizing. After the coating weight was controlled by an air knife, the strip steel was subjected to post-plating cooling. Then, the strip steel was cooled to room temperature by final water cooling. After being temper rolled, it entered an outlet looper, and then it was coiled to complete the production. The final strip steel product had a yield strength of 726 MPa, a tensile strength of 1058 MPa, and an elongation at break of 19%.

### Example 3

The layout of a production line for preparing a hot-dip galvanized strip steel is shown in FIG. 5. A strip steel with the main chemical composition (mass %) of the substrate being 0.11% C-0.46% Si-2.0% Mn was uncoiled, welded, passed through an inlet looper, and washed. The strip steel was then preheated to 355° C. by jet direct fire, then heated to 675° C. by direct fire, then heated to 795° C. by radiant tube heating, then soaked at 795° C. by jet-radiation composite soaking for 60 seconds, then slowly cooled to 675° C., and then cooled to 475° C. by high hydrogen cooling. Then, the strip steel passed through a reheating section (the reheating function didn't need to be activated), a uniform holding section and a secondary reheating section (the secondary reheating function didn't need to be activated). After passing through a furnace nose, it was immersed in a zinc pot for hot-dip galvanizing. After the coating weight was controlled by an air knife, the strip steel was subjected to post-plating cooling. Then, the strip steel was cooled to room temperature by final water cooling. After being temper rolled, it entered an outlet looper, and then it was coiled to complete the production. The final strip steel product had a yield strength of 398 MPa, a tensile strength of 696 MPa, and an elongation at break of 28%.

### Example 4

The layout of a production line for preparing a hot-dip galvanized strip steel is shown in FIG. 6. A strip steel with the main chemical composition (mass %) of the substrate being 0.17% C-1.75% Si-2.2% Mn was uncoiled, welded, passed through an inlet looper, and washed. The strip steel was then heated to 705° C. by jet-radiation composite heating, then heated to 855° C. by radiant tube heating, then soaked at 855° C. by jet-radiation composite soaking for 80 seconds, then slowly cooled to 670° C., and then cooled to 230° C. by high hydrogen cooling. Then, it was reheated again to 395° C., uniformly held at 395° C., and then heated to 457° C. by secondary reheating. Then, it was immersed in a zinc pot for hot-dip galvanizing. After the coating weight was controlled by an air knife, the strip steel was subjected to post-plating cooling. Then, the strip steel was cooled to room temperature by final water cooling. After being temper rolled, it entered an outlet looper, and then it was coiled to complete the production. The final strip steel product had a yield strength of 715 MPa, a tensile strength of 1036 MPa, and an elongation at break of 21%.

### Example 5

The layout of a production line for preparing a hot-dip galvanized strip steel is shown in FIG. 7. A strip steel with the main chemical composition (mass %) of the substrate being 0.08% C-0.18% Si-1.96% Mn was uncoiled, welded, passed through an inlet looper, and washed. The strip steel was then preheated to 350° C. by jet direct fire, then heated to 670° C. by direct fire, then heated to 810° C. by radiant tube heating, then soaked at 810° C. by radiant tube soaking for 60 seconds, then slowly cooled to 670° C., and then cooled to 465° C. by high hydrogen cooling. Then, the strip steel passed through a reheating section (the reheating function didn't need to be activated), a uniform holding section and a secondary reheating section (the secondary reheating function didn't need to be activated). After passing through a furnace nose, it was immersed in a zinc pot for hot-dip galvanizing. After the coating weight was controlled by an air knife, the strip steel was heated to 500° C. by alloying heating, and soaked at 500° C. by alloying soaking for 18 seconds. Then, the strip steel was subjected to post-plating cooling, and then cooled to room temperature by final water cooling. After being temper rolled, it entered an outlet looper, and then it was coiled to complete the production. The final strip steel product had a yield strength of 550 MPa, a tensile strength of 837 MPa, and an elongation at break of 19%.

### Example 6

The layout of a production line for preparing a hot-dip galvanized strip steel is shown in FIG. 10. A strip steel with the main chemical composition (mass %) of the substrate being 0.165% C-1.8% Si-2.25% Mn was uncoiled, welded, passed through an inlet looper, and washed. The strip steel was then heated to 670° C. by jet-radiation composite heating, then heated to 855° C. by radiant tube heating, then soaked at 855° C. by jet-radiation composite soaking for 90 seconds, then slowly cooled to 670° C., and then cooled to 220° C. by high hydrogen cooling. Then, it was reheated again to 410° C., uniformly held at 410° C., and then heated to 460° C. by secondary reheating. Then, it was immersed in a zinc pot for hot-dip galvanizing. After the coating weight was controlled by an air knife, the strip steel was heated to 515° C. by alloying heating, and soaked at 510° C. by alloying soaking for 22 seconds. Then, the strip steel was subjected to post-plating cooling, and then cooled to room temperature by final water cooling. After being temper rolled, it entered an outlet looper, and then it was coiled to complete the production. The final strip steel product had a yield strength of 732 MPa, a tensile strength of 1028 MPa, and an elongation at break of 18%.

### Rapid Production Line for Hot-Dip Galvanized High-Strength Strip Steel

Referring to FIG. 18 which shows Example 1 in the present disclosure, in Example 1, the rapid pure zinc hot-dip galvanized high-strength strip steel production line according to the present disclosure includes the following stations in sequence: uncoiling—welding—inlet looper-central continuous post-processing—temper rolling—outlet looper—coiling, wherein the central continuous post-processing station includes in sequence a jet-radiation composite heating section, a radiant tube heating section, a transverse magnetic induction heating section, a radiant tube soaking section, a slow cooling section, a high hydrogen cooling section, a reheating section, a uniform holding section, a secondary reheating section, a furnace nose section, a zinc pot section, an air knife section, a post-plating cooling section and a final water cooling section.

In the jet-radiation composite heating section, in addition to the use of the radiation of a radiant tube to heat the strip steel, the combustion exhaust gas of the radiant tube is also used to heat a recycled nitrogen-hydrogen protective gas or an all-hydrogen gas, and then the nitrogen-hydrogen protective gas or all-hydrogen gas is jetted onto the upper and lower surfaces of the strip steel to achieve forced convection heat exchange. The transverse magnetic induction heating section is used to further increase the temperature of the high-temperature strip steel quickly. A longitudinal magnetic induction heating device is used in both the reheating section and the secondary reheating section to heat the strip steel quickly.

Referring to FIG. 19 which shows Example 2 in the present disclosure, in Example 2, the rapid production line for pure zinc hot-dip galvanized high-strength strip steel includes the following stations in sequence: uncoiling—welding—inlet looper—central continuous post-processing—temper rolling—outlet looper—coiling, wherein the central continuous post-processing station includes in sequence a jet radiant tube preheating section, a radiant tube heating section, a transverse magnetic induction heating section, a radiant tube soaking section, a slow cooling section, a high hydrogen cooling section, a reheating section, a uniform holding section, a secondary reheating section, a furnace nose section, a zinc pot section, an air knife section, a post-plating cooling section and a final water cooling section.

In the jet radiant tube preheating section, the combustion exhaust gas from the radiant tube heating section and the radiant tube soaking section is used to heat a recycled nitrogen-hydrogen protective gas in the furnace, and then the nitrogen-hydrogen protective gas is jetted onto the upper and lower surfaces of the strip steel to realize forced convection heat exchange.

The transverse magnetic induction heating section is used to further increase the temperature of the high-temperature strip steel quickly.

A longitudinal magnetic induction heating device is used in both the reheating section and the secondary reheating section to heat the strip steel quickly.

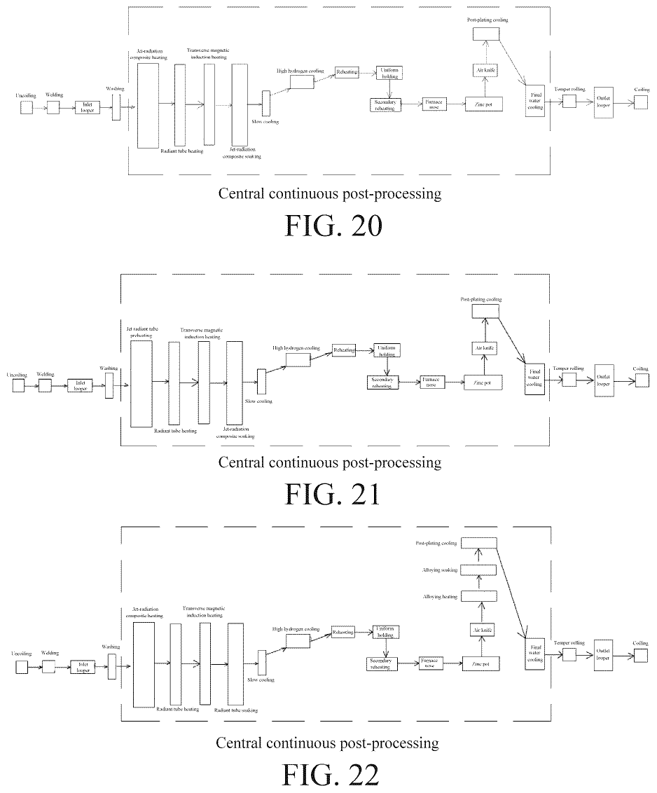

Referring to FIG. 20 which shows Example 3 in the present disclosure, the rapid production line for pure zinc hot-dip galvanized strip steel includes the following stations in sequence: uncoiling—welding—inlet looper—central continuous post-processing—temper rolling—outlet looper—coiling, wherein the central continuous post-processing station includes in sequence a jet-radiation composite heating section, a radiant tube heating section, a transverse magnetic induction heating section, a jet-radiation composite soaking section, a slow cooling section, a high hydrogen cooling section, a reheating section, a uniform holding section, a secondary reheating section, a furnace nose section, a zinc pot section, an air knife section, a post-plating cooling section and a final water cooling section.

For the jet-radiation composite heating device, in addition to the use of the radiation of a radiant tube to heat the strip steel, the combustion exhaust gas of the radiant tube is also used to heat a recycled nitrogen-hydrogen protective gas or an all-hydrogen gas, and then the nitrogen-hydrogen protective gas or all-hydrogen gas is jetted onto the upper and lower surfaces of the strip steel to realize forced convection heat exchange. The transverse magnetic induction heating section is used to further increase the temperature of the high-temperature strip steel quickly. A longitudinal magnetic induction heating device is used in both the reheating section and the secondary reheating section to heat the strip steel quickly.

Referring to FIG. 21 which shows Example 4 in the present disclosure, the rapid production line for pure zinc hot-dip galvanized high-strength strip steel includes the following stations in sequence: uncoiling—welding—inlet looper—central continuous post-processing—temper rolling-outlet looper—coiling, wherein the central continuous post-processing station includes in sequence a jet radiant tube preheating section, a radiant tube heating section, a transverse magnetic induction heating section, a jet-radiation composite soaking section, a slow cooling section, a high hydrogen cooling section, a reheating section, a uniform holding section, a secondary reheating section, a furnace nose section, a zinc pot section, an air knife section, a post-plating cooling section and a final water cooling section.

For the jet radiant tube preheating device, the combustion exhaust gas from the radiant tube heating section and the radiant tube soaking section is used to heat a recycled nitrogen-hydrogen protective gas in the furnace, and then the nitrogen-hydrogen protective gas is jetted onto the upper and lower surfaces of the strip steel to realize forced convection heat exchange.

The transverse magnetic induction heating section is used to further increase the temperature of the high-temperature strip steel quickly. A longitudinal magnetic induction heating device is used in both the reheating section and the secondary reheating section to heat the strip steel quickly.

Referring to FIG. 22 which shows Example 5 in the present disclosure, in Example 5, the hot-dip galvanizing is hot-dip galvannealing. The rapid production line for hot-dip galvannealed strip steel includes the following stations in sequence: uncoiling—welding—inlet looper—central continuous post-processing—temper rolling—outlet looper—coiling, wherein the central continuous post-processing station includes in sequence a jet-radiation composite heating section, a radiant tube heating section, a transverse magnetic induction heating section, a radiant tube soaking section, a slow cooling section, a high hydrogen cooling section, a reheating section, a uniform holding section, a secondary reheating section, a furnace nose section, a zinc pot section, an air knife section, an alloying heating section, an alloying soaking section, a post-plating cooling section and a final water cooling section.

For the jet-radiation composite heating device, in addition to the use of the radiation of a radiant tube to heat the strip steel, the combustion exhaust gas of the radiant tube is also used to heat a recycled nitrogen-hydrogen protective gas or an all-hydrogen gas, and then the nitrogen-hydrogen protective gas or all-hydrogen gas is jetted onto the upper and lower surfaces of the strip steel to realize forced convection heat exchange. The transverse magnetic induction heating section is used to further increase the temperature of the high-temperature strip steel quickly. A longitudinal magnetic induction heating device is used in both the reheating section and the secondary reheating section to heat the strip steel quickly.

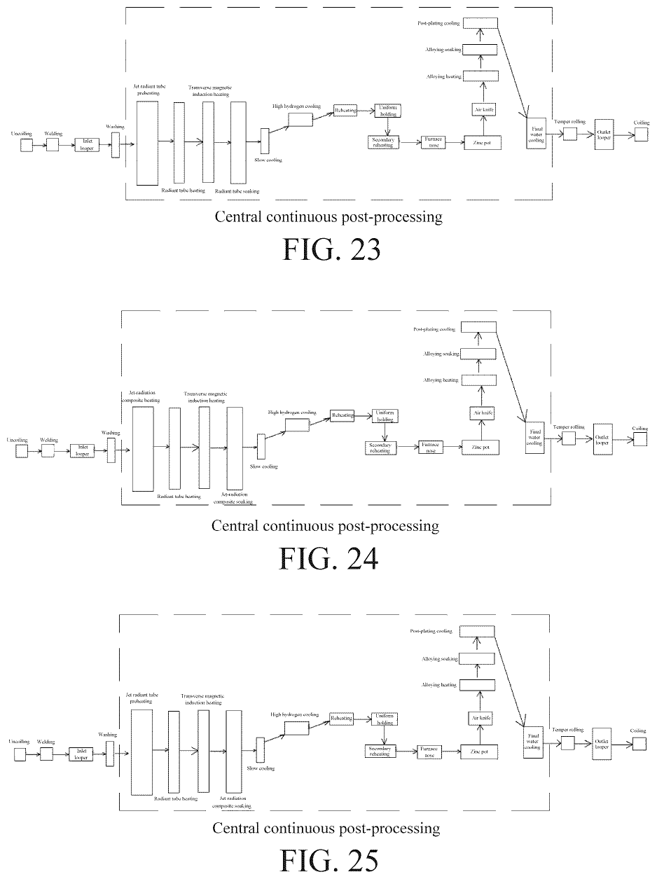

Referring to FIG. 23 which shows Example 6 in the present disclosure, in Example 6, the hot-dip galvanizing is hot-dip galvannealing. The rapid production line for hot-dip galvannealed strip steel includes the following stations in sequence: uncoiling—welding—inlet looper—central continuous post-processing—temper rolling—outlet looper—coiling, wherein the central continuous post-processing station includes in sequence a jet radiant tube preheating section, a radiant tube heating section, a transverse magnetic induction heating section, a radiant tube soaking section, a slow cooling section, a high hydrogen cooling section, a reheating section, a uniform holding section, a secondary reheating section, a furnace nose section, a zinc pot section, an air knife section, an alloying heating section, an alloying soaking section, a post-plating cooling section and a final water cooling section.

In the jet radiant tube preheating section, the combustion exhaust gas from the radiant tube heating section and the radiant tube soaking section is used to heat a recycled nitrogen-hydrogen protective gas in the furnace, and then the nitrogen-hydrogen protective gas is jetted onto the upper and lower surfaces of the strip steel to realize forced convection heat exchange. The transverse magnetic induction heating section is used to further increase the temperature of the high-temperature strip steel quickly. A longitudinal magnetic induction heating device is used in both the reheating section and the secondary reheating section to heat the strip steel quickly.

Referring to FIG. 24 which shows Example 7 in the present disclosure, the hot-dip galvanizing is hot-dip galvannealing. The rapid production line for hot-dip galvannealed strip steel includes the following stations in sequence: uncoiling—welding—inlet looper—central continuous post-processing—temper rolling—outlet looper—coiling, wherein the central continuous post-processing station includes in sequence a jet-radiation composite heating section, a radiant tube heating section, a transverse magnetic induction heating section, a jet-radiation composite soaking section, a slow cooling section, a high hydrogen cooling section, a reheating section, a uniform holding section, a secondary reheating section, a furnace nose section, a zinc pot section, an air knife section, an alloying heating section, an alloying soaking section, a post-plating cooling section and a final water cooling section.

In the jet-radiation composite heating section, in addition to the use of the radiation of a radiant tube to heat the strip steel, the combustion exhaust gas of the radiant tube is also used to heat a recycled nitrogen-hydrogen protective gas or an all-hydrogen gas, and then the nitrogen-hydrogen protective gas or all-hydrogen gas is jetted onto the upper and lower surfaces of the strip steel to achieve forced convection heat exchange.

The transverse magnetic induction heating section is used to further increase the temperature of the high-temperature strip steel quickly. A longitudinal magnetic induction heating device is used in both the reheating section and the secondary reheating section to heat the strip steel quickly.

Referring to FIG. 25 which shows Example 8 in the present disclosure, the hot-dip galvanizing is hot-dip galvannealing. The rapid production line for hot-dip galvannealed strip steel includes the following stations in sequence: uncoiling—welding—inlet looper—central continuous post-processing—temper rolling—outlet looper—coiling, wherein the central continuous post-processing station includes in sequence a jet radiant tube preheating section, a radiant tube heating section, a transverse magnetic induction heating section, a jet-radiation composite soaking section, a slow cooling section, a high hydrogen cooling section, a reheating section, a uniform holding section, a secondary reheating section, a furnace nose section, a zinc pot section, an air knife section, an alloying heating section, an alloying soaking section, a post-plating cooling section and a final water cooling section.

In the jet radiant tube preheating section, the combustion exhaust gas from the radiant tube heating section and the radiant tube soaking section is used to heat a recycled nitrogen-hydrogen protective gas in the furnace, and then the nitrogen-hydrogen protective gas is jetted onto the upper and lower surfaces of the strip steel to realize forced convection heat exchange.

The transverse magnetic induction heating section is used to further increase the temperature of the high-temperature strip steel quickly. A longitudinal magnetic induction heating device is used in both the reheating section and the secondary reheating section to heat the strip steel quickly.

Preferably, a selectable mobile post-plating rapid cooling section device is provided after the air knife section and before the post-plating cooling section. After the strip steel is hot-dip galvanized in the zinc pot section and the coating weight is controlled by the air knife section, the mobile post-plating rapid cooling section may be chosen to carry out post-plating rapid cooling.

Alternatively, the mobile post-plating rapid cooling section may not be used; instead, natural cooling may be carried out before post-plating cooling, thereby enabling continuous production of the hot-dip galvanized strip steel.

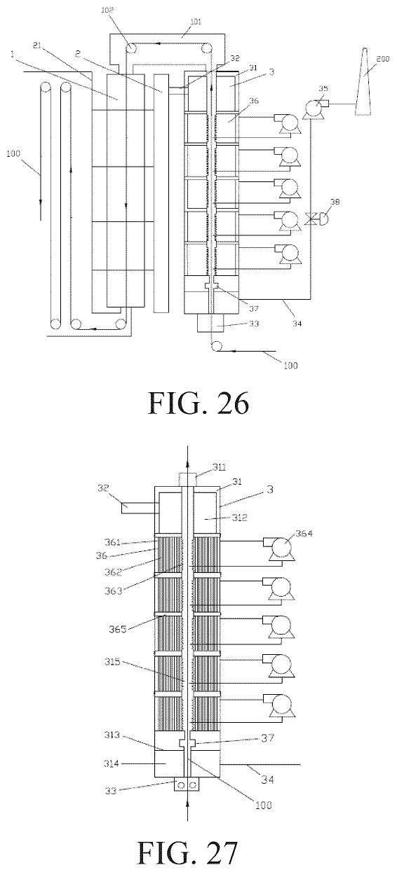

Referring to FIG. 26 and FIG. 27, the jet radiant tube preheating device of the present disclosure comprises:
a radiant tube heating furnace 1, wherein a furnace top roller chamber 101 is provided above the furnace body, and a turning roller 102 is provided in the furnace top roller chamber 101;
a radiant tube exhaust gas collecting chamber 2 connected to the furnace body of the radiant tube heating furnace 1 via a connecting pipe 21;
a preheating furnace 3, comprising:
a preheating furnace body 31, wherein a connecting hole is provided through its upper side wall, and is communicated with the radiant tube exhaust gas collecting chamber 2 through a connecting pipe 32; a furnace throat 311 corresponding to the furnace top roller chamber 101 of the radiant tube heating furnace 1 is provided at the top of the preheating furnace body 31 for strip steel to pass through; a strip steel inlet, an inlet sealing device 33 and an inlet turning roller are provided at the bottom of the preheating furnace body 31; a preheating furnace gas collecting chamber 312 is provided in an upper part of the preheating furnace body 31; a lower baffle 313 with a strip passing hole is provided at a lower part of the furnace body 31 to form a lower exhaust gas collecting chamber 314 which is connected to an exhaust gas fan 35 through an exhaust pipe 34, wherein the exhaust gas is discharged from chimney 500;
a plurality of heat exchange and jet bellows units 36 provided on both sides below the preheating furnace gas collecting chamber 312 in the preheating furnace body 31 along a height direction of the preheating furnace body 31, with a strip passing channel 315 being formed in the middle for the strip steel to pass through, wherein each heat exchange and jet bellows unit 36 comprises:
a bellows body 361, wherein a plurality of heat exchange tubes 362 are provided vertically therein; a plurality of nozzles 363 are provided on a side of the bellows body 362 facing the strip passing channel 315; a secondary exhaust gas mixing chamber 365 in communication with the heat exchange tube 362 is provided between an upper bellows body 361 and a lower bellows body 361; a nitrogen-hydrogen protective gas is introduced into the bellows body 361;
a circulating fan 364, wherein a port of its inlet pipe is provided in the strip passing channel 315, and a port of its outlet pipe is located in the bellows body 361;
sealing devices 37 through which the strip steel can pass, wherein they are respectively provided at a lower port of the strip passing channel 315 and the strip passing holes of the upper and lower baffles 313.

Preferably, the inlet sealing device 33 and the sealing devices 37 have a nitrogen sealing structure, wherein a nitrogen sealing chamber provided with a nitrogen injection pipe is used.

Preferably, a control valve 38 is provided on the exhaust pipe 34.

The strip steel 100 is turned by the inlet turning roller to move upward. After being sealed by the inlet sealing device, it enters the preheating furnace 3 for preheating treatment. Then, it enters the furnace top roller chamber in which it is turned by the turning roller, and then it enters the radiant tube heating furnace 1. The heated combustion exhaust gas in the radiant tube enters the radiant tube exhaust gas collecting chamber 2 which is connected with the preheating furnace gas collecting chamber 312 of the preheating furnace 1 through the connecting pipe 32. The preheating furnace gas collecting chamber 312 is a closed gas collecting chamber, so as to ensure that the exhaust gas therein does not contact the strip steel 100. The radiant tube combustion exhaust gas accumulates in the preheating furnace gas collecting chamber. The radiant tube combustion exhaust gas is first used to preheat the combustion-supporting air required for its own combustion.

Under the suction of the exhaust gas fan, the high-temperature radiant tube combustion exhaust gas in the preheating furnace gas collecting chamber 312 passes uninterruptedly through the jet bellows units connected in series one after another. A heat exchange tube is provided in the jet bellows unit as a heat exchanger (the tube side is the high-temperature combustion exhaust gas, and the shell side is the nitrogen-hydrogen mixed gas). The radiant tube combustion exhaust gas heats the nitrogen-hydrogen protective gas through the heat exchanger, and the heated nitrogen-hydrogen protective gas is jetted onto the upper and lower surfaces of the strip steel under the action of the circulating fan to preheat the strip steel.

The radiant tube combustion exhaust gas flows through the inner space of the heat exchange tube from top to bottom, and heats the cyclically jetted nitrogen-hydrogen protective gas by heat exchange during the flow. Then, the exhaust gas enters the secondary exhaust gas mixing chamber 365 between the jet bellows units for secondary mixing to homogenize the temperature of the exhaust gas, and then enters the downstream furnace heat exchange and jet bellows unit until it reaches the bottom nitrogen sealing device, and finally enters the exhaust gas collecting chamber 314.

The nitrogen-hydrogen protective gas passes between the heat exchange tube bundles. After being heated, it is continuously jetted from the nozzles onto the upper and lower surfaces of the strip steel under the action of the circulating fan to preheat the strip steel. The suction opening of the circulating fan is connected to the DS side and WS side of the jet bellows unit by a pipe in furnace. Under the action of the circulating fan, the nitrogen-hydrogen mixed gas is jetted onto the surface of the strip steel, then extracted from both sides, and then jetted onto the upper and lower surfaces of the strip steel by the circulating fan after passing through the heat exchanger, thereby realizing heating of the strip steel by cyclic jetting of the nitrogen-hydrogen mixed gas.

### Example 1

The layout of a production line for preparing a hot-dip galvanized high-strength strip steel is shown in FIG. 3. A strip steel with the main chemical composition (mass %) of the substrate being 0.12% C-0.41% Si-1.90% Mn was uncoiled, welded, passed through an inlet looper, and washed. The strip steel was then heated to 500° C. by jet-radiation composite heating, then heated to 700° C. by radiant tube heating, then heated to 810° C. by transverse magnetic induction heating, then soaked at 810° C. by radiant tube soaking for 40 seconds, then slowly cooled to 670° C., and then cooled to 460° C. by high hydrogen cooling. Then, the strip steel passed through a reheating section (the reheating function may be deactivated), a uniform holding section, and a secondary reheating section (the secondary reheating function may be deactivated). After passing through a furnace nose, it was immersed in a zinc pot for hot-dip galvanizing. After the coating weight was controlled by an air knife, the strip steel was subjected to post-plating cooling. Then, the strip steel was cooled to room temperature by final water cooling. After being temper rolled, it entered an outlet looper, and then it was coiled to complete the production. The final strip steel product had a yield strength of 355 MPa, a tensile strength of 665 MPa, and an elongation at break of 25%.

### Example 2

The layout of a production line for preparing a hot-dip galvanized high-strength strip steel is shown in FIG. 4. A strip steel with the main chemical composition (mass %) of the substrate being 0.18% C-1.80% Si-2.2% Mn was uncoiled, welded, passed through an inlet looper, and washed. The strip steel was then preheated to 350° C. by jet radiant tube preheating, then heated to 810° C. by radiant tube heating, then heated to 910° C. by transverse magnetic induction heating, then soaked at 910° C. by radiant tube soaking for 60 seconds, then slowly cooled to 670° C., and then cooled to 230° C. by high hydrogen cooling. Then, it was reheated to 400° C., uniformly held at 400° C., and then heated to 458° C. by secondary reheating. After passing through a furnace nose, it was immersed in a zinc pot for hot-dip galvanizing. After the coating weight was controlled by an air knife, the strip steel was subjected to post-plating cooling. Then, the strip steel was cooled to room temperature by final water cooling. After being temper rolled, it entered an outlet looper, and then it was coiled to complete the production. The final strip steel product had a yield strength of 705 MPa, a tensile strength of 1019 MPa, and an elongation at break of 22%.

### Example 3

The layout of a production line for preparing a hot-dip galvanized high-strength strip steel is shown in FIG. 7. A strip steel with the main chemical composition (mass %) of the substrate being 0.085% C-0.16% Si-1.90% Mn was uncoiled, welded, passed through an inlet looper, and washed. The strip steel was then heated to 550° C. by jet-radiation composite heating, then heated to 750° C. by radiant tube heating, then heated to 820° C. by transverse magnetic induction heating, then soaked at 820° C. by radiant tube soaking for 60 seconds, then slowly cooled to 670° C., and then cooled to 465° C. by high hydrogen cooling. Then, the strip steel passed through a reheating section (the reheating function may be deactivated), a uniform holding section and a secondary reheating section (the secondary reheating function may be deactivated). After passing through a furnace nose, it was immersed in a zinc pot for hot-dip galvanizing. After the coating weight was controlled by an air knife, the strip steel was heated to 500° C. by alloying heating, and soaked at 500° C. by alloying soaking for 18 seconds. Then, the strip steel was subjected to post-plating cooling. Then, the strip steel was cooled to room temperature by final water cooling. After being temper rolled, it entered an outlet looper, and then it was coiled to complete the production. The final strip steel product had a yield strength of 565 MPa, a tensile strength of 826 MPa, and an elongation at break of 18%.

### Example 4

The layout of a production line for preparing a hot-dip galvanized high-strength strip steel is shown in FIG. 8. A strip steel with the main chemical composition (mass %) of the substrate being 0.18% C-1.75% Si-2.65% Mn was uncoiled, welded, passed through an inlet looper, and washed. The strip steel was then preheated to 275° C. by jet radiant tube preheating, then heated to 750° C. by radiant tube heating, then heated to 850° C. by transverse magnetic induction heating, then soaked at 850° C. by radiant tube soaking for 60 seconds, then slowly cooled to 670° C., and then cooled to 260° C. by high hydrogen cooling. Then, after being reheated to 420° C., the strip steel was uniformly held at 420° C. to achieve redistribution of carbon element in the strip steel and stabilize the residual austenite structure in the strip steel. Then, it was heated to 460° C. by secondary reheating. After passing through a furnace nose, it was immersed in a zinc pot for hot-dip galvanizing. After the coating weight was controlled by an air knife, the strip steel entered an alloying heating furnace to be heated to 510° C., and held at 500° C. in an alloying soaking furnace for 18 seconds. Then, the strip steel was cooled to about 140° C. by a post-plating cooling device, and then cooled to 45° C. or lower by final water cooling. After being temper rolled, it entered an outlet looper, and then it was coiled to complete the production. The final strip steel product had a yield strength of 1088 MPa, a tensile strength of 1203 MPa, and an elongation at break of 15%.

### Rapid Production Line for Hot-Dip Galvanized Ultra-High-Strength Strip Steel

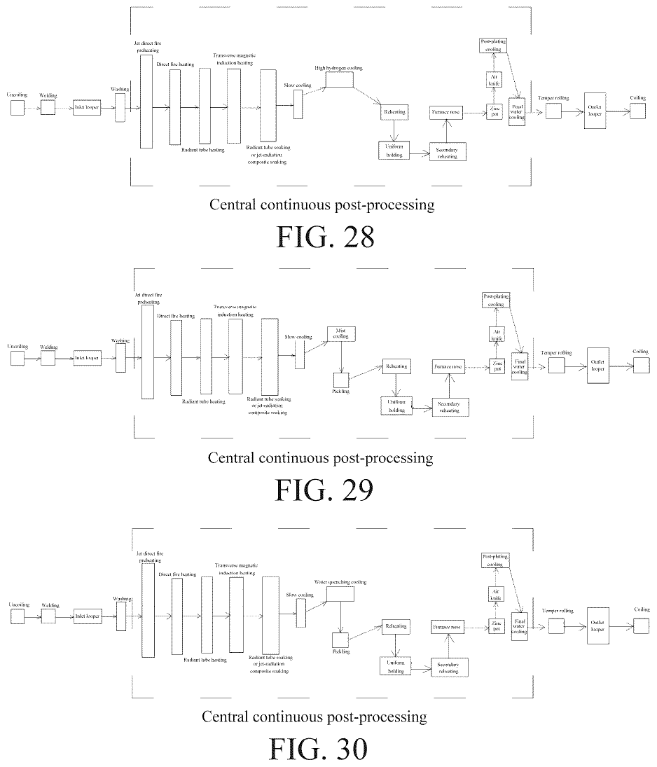

Referring to FIG. 28 which shows Example 1 of the present disclosure, in Example 1, the rapid production line for pure zinc hot-dip galvanized ultra-high-strength strip steel includes the following stations in sequence: uncoiling—welding—inlet looper—washing—central continuous post-processing—temper rolling—outlet looper—coiling.

The central continuous post-processing station includes in sequence a jet direct fire preheating section, a direct fire heating section, a radiant tube heating section, a transverse magnetic induction heating section, a radiant tube soaking section, a slow cooling section, a high hydrogen cooling section, a reheating section, a uniform holding section, a secondary reheating section, a furnace nose section, a zinc pot section, an air knife section, a post-plating cooling section and a final water cooling section.

In the jet direct fire preheating section, the combustion exhaust gas from the direct fire heating section is used to heat the recycled nitrogen-hydrogen protective gas, and then the nitrogen-hydrogen protective gas is jetted onto the upper and lower surfaces of the strip steel to achieve forced convection heat exchange.

A longitudinal magnetic induction heating device is used in both the reheating section and the secondary reheating section to heat the strip steel quickly.

Referring to FIG. 29 which shows Example 2 of the present disclosure, in Example 2, the rapid production line for pure zinc hot-dip galvanized ultra-high-strength strip steel includes the following stations in sequence: uncoiling—welding—inlet looper—washing—central continuous post-processing—temper rolling—outlet looper—coiling.

The central continuous post-processing station includes in sequence a jet direct fire preheating section, a direct fire heating section, a radiant tube heating section, a transverse magnetic induction heating section, a radiant tube soaking section, a slow cooling section, a mist cooling section, a pickling section, a reheating section, a uniform holding section, a secondary reheating section, a furnace nose section, a zinc pot section, an air knife section, a post-plating cooling section and a final water cooling section.

The jet direct fire preheating section is characterized in that the combustion exhaust gas from the direct fire heating section is used to heat the recycled nitrogen-hydrogen protective gas, and then the nitrogen-hydrogen protective gas is jetted onto the upper and lower surfaces of the strip steel to realize forced convection heat exchange.

A longitudinal magnetic induction heating device is used in both the reheating section and the secondary reheating section to heat the strip steel quickly.

Referring to FIG. 30 which shows Example 3 of the present disclosure, in Example 3, the rapid production line for pure zinc hot-dip galvanized ultra-high-strength strip steel includes the following stations in sequence: uncoiling—welding—inlet looper—washing—central continuous post-processing—temper rolling—outlet looper—coiling.

The central continuous post-processing station includes in sequence a jet direct fire preheating section, a direct fire heating section, a radiant tube heating section, a transverse magnetic induction heating section, a radiant tube soaking section, a slow cooling section, a water quenching cooling section, a pickling section, a reheating section, a uniform holding section, a secondary reheating section, a furnace nose section, a zinc pot section, an air knife section, a post-plating cooling section and a final water cooling section.

In the jet direct fire preheating section, the combustion exhaust gas from the direct fire heating section is used to heat the recycled nitrogen-hydrogen protective gas, and then the nitrogen-hydrogen protective gas is jetted onto the upper and lower surfaces of the strip steel to achieve forced convection heat exchange.

A longitudinal magnetic induction heating device is used in both the reheating section and the secondary reheating section to heat the strip steel quickly.

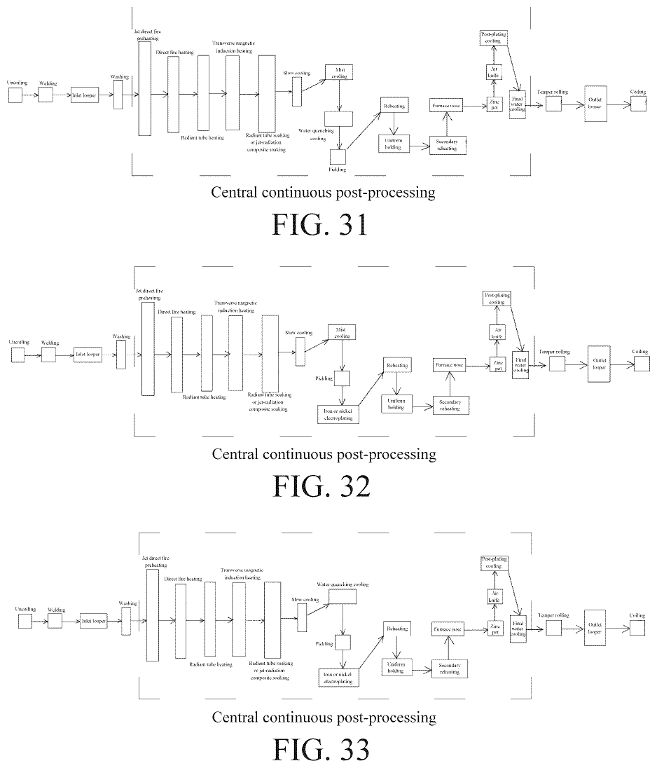

Referring to FIG. 31 which shows Example 4 of the present disclosure, in Example 4, the rapid production line for pure zinc hot-dip galvanized ultra-high-strength strip steel includes the following stations: uncoiling—welding—inlet looper—washing—central continuous post-processing—temper rolling—outlet looper—coiling.

The central continuous post-processing station includes in sequence a jet direct fire preheating section, a direct fire heating section, a radiant tube heating section, a transverse magnetic induction heating section, a radiant tube soaking section, a slow cooling section, a mist cooling section, a water quenching cooling section, a pickling section, a reheating section, a uniform holding section, a secondary reheating section, a furnace nose section, a zinc pot section, an air knife section, a post-plating cooling section and a final water cooling section.

In the jet direct fire preheating section, the combustion exhaust gas from the direct fire heating section is used to heat the recycled nitrogen-hydrogen protective gas, and then the nitrogen-hydrogen protective gas is jetted onto the upper and lower surfaces of the strip steel to achieve forced convection heat exchange.

A longitudinal magnetic induction heating device is used in both the reheating section and the secondary reheating section to heat the strip steel quickly.

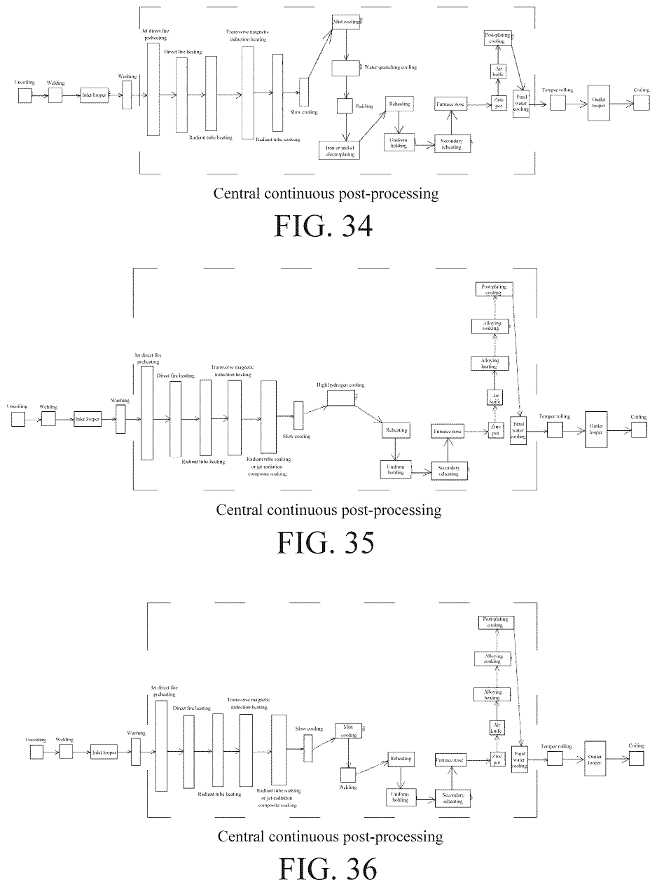

Referring to FIGS. 32 to 34, preferably, Examples 5 to 7 of the present disclosure are based on Examples 2 to 4, and an iron flash plating or nickel flash plating section is added after the pickling section. The strip steel is flash plated before subsequent treatments.

Preferably, a selectable mobile post-plating rapid cooling section is provided after the air knife section device and before the post-plating cooling section. After the strip steel is hot-dip galvanized in the zinc pot section and the coating weight is controlled by the air knife section device, the mobile post-plating rapid cooling section may be chosen to carry out post-plating rapid cooling. Alternatively, the mobile post-plating rapid cooling section may not be used; instead, natural cooling may be carried out before post-plating cooling, thereby enabling continuous production of the hot-dip galvanized strip steel.

Referring to FIG. 35 which shows Example 8 of the present disclosure, in Example 8, the rapid production line for hot-dip galvanized ultra-high-strength strip steel includes the following stations in sequence: uncoiling—welding—inlet looper—washing—central continuous post-processing—temper rolling—outlet looper—coiling.

The central continuous post-processing station includes in sequence a jet direct fire preheating section, a direct fire heating section, a radiant tube heating section, a transverse magnetic induction heating section, a radiant tube soaking section, a slow cooling section, a high hydrogen cooling section, a reheating section, a uniform holding section, a secondary reheating section, a furnace nose section, a zinc pot section, an air knife section, an alloying heating section, an alloying soaking section, a post-plating cooling section and a final water cooling section.

Referring to FIG. 36 which shows Example 9 of the present disclosure, in Example 9, the rapid production line for hot-dip galvanized ultra-high-strength strip steel includes the following stations: uncoiling—welding—inlet looper—washing—central continuous post-processing—temper rolling—outlet looper—coiling.

The central continuous post-processing station includes in sequence a jet direct fire preheating section, a direct fire heating section, a radiant tube heating section, a transverse magnetic induction heating section, a radiant tube soaking section, a slow cooling section, a mist cooling section, a pickling section, a reheating section, a uniform holding section, a secondary reheating section, a furnace nose section, a zinc pot section, an air knife section, an alloying heating section, an alloying soaking section, a post-plating cooling section and a final water cooling section.

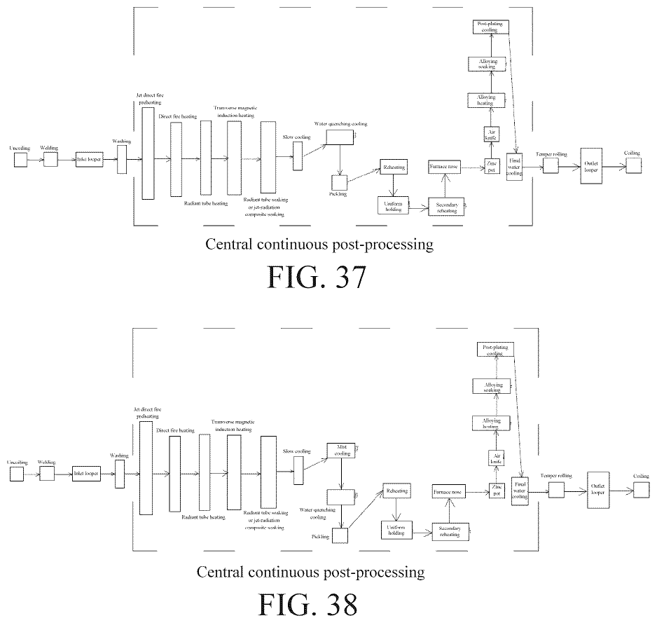

Referring to FIG. 37 which shows Example 10 of the present disclosure, in Example 10, the rapid production line for hot-dip galvanized ultra-high-strength strip steel includes the following stations in sequence: uncoiling—welding—inlet looper—washing—central continuous post-processing—temper rolling—outlet looper—coiling.

The central continuous post-processing station includes in sequence a jet direct fire preheating section, a direct fire heating section, a radiant tube heating section, a transverse magnetic induction heating section, a radiant tube soaking section, a slow cooling section, a water quenching cooling section, a pickling section, a reheating section, a uniform holding section, a secondary reheating section, a furnace nose section, a zinc pot section, an air knife section, an alloying heating section, an alloying soaking section, a post-plating cooling section and a final water cooling section.

Referring to FIG. 38 which shows Example 11 of the present disclosure, in Example 11, the rapid production line for hot-dip galvanized ultra-high-strength strip steel includes the following stations in sequence: uncoiling—welding—inlet looper—washing—central continuous post-processing—temper rolling—outlet looper—coiling.

The central continuous post-processing station includes in sequence a jet direct fire preheating section, a direct fire heating section, a radiant tube heating section, a transverse magnetic induction heating section, a radiant tube soaking section, a slow cooling section, a mist cooling section, a water quenching cooling section, a pickling section, a reheating section, a uniform holding section, a secondary reheating section, a furnace nose section, a zinc pot section, an air knife section, an alloying heating section, an alloying soaking section, a post-plating cooling section and a final water cooling section.

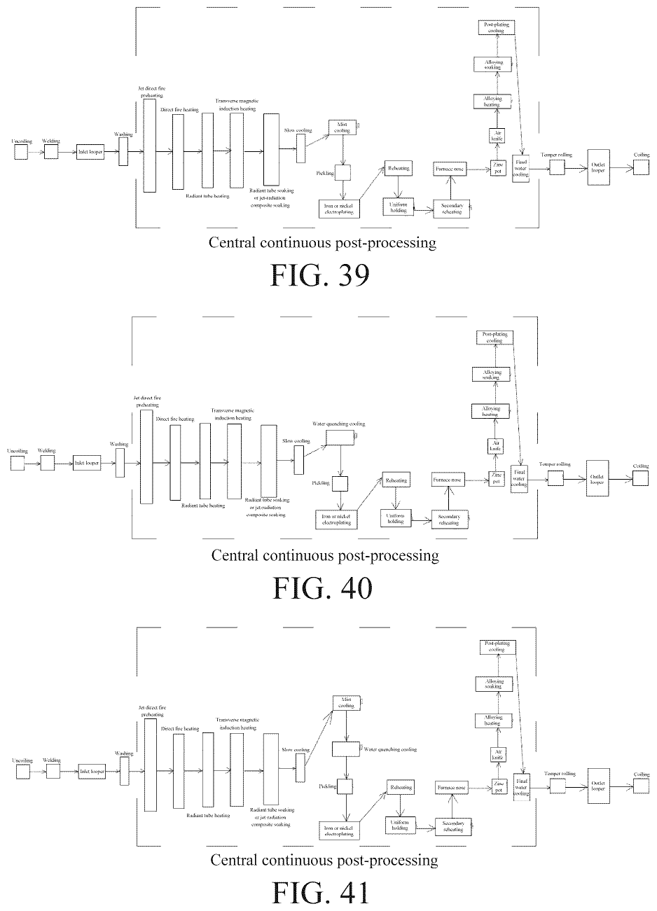

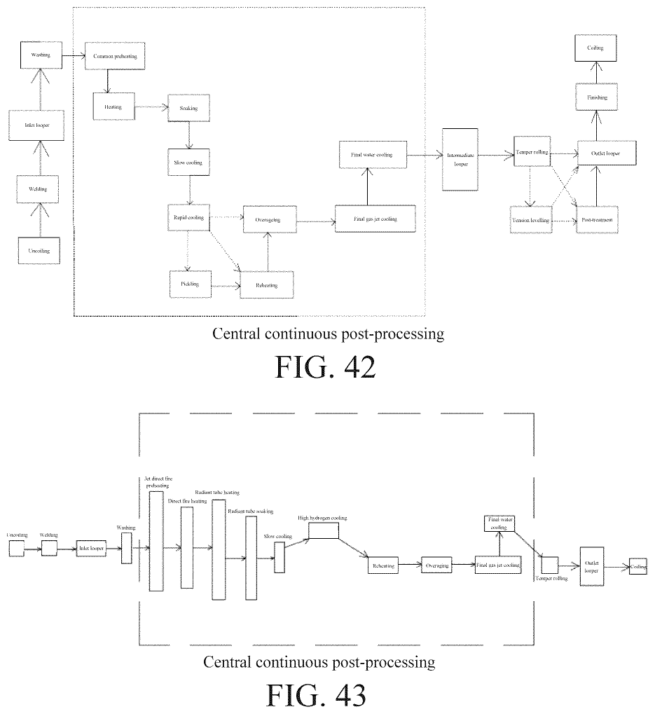

Referring to FIGS. 39 to 41, preferably, Examples 12 to 14 of the present disclosure are based on Examples 9 to 11, and an iron flash plating or nickel flash plating section is added after the pickling section. The strip steel is flash plated before subsequent treatments.

Preferably, after the air knife section, a selectable mobile post-plating rapid cooling section device is provided in parallel with the alloying heating section. After the strip steel is hot-dip galvanized in the zinc pot section and the coating weight is controlled by the air knife section, if a pure zinc hot-dip galvanized product is to be produced, the mobile post-plating rapid cooling section is switched online for use and the alloying heating section is switched offline; if a hot-dip galvannealed product is to be produced, the mobile post-plating rapid cooling section is switched offline, and the alloying heating section device is switched online for use.

Preferably, the radiant tube soaking section is replaced with a jet-radiation composite soaking section to achieve rapid regulation of the soaking temperature of the strip steel when the working conditions change, such as changes in strip steel thickness specification, target temperature, unit speed, etc.

Preferably, a washing station is provided before the inlet looper station.

Preferably, washing stations are provided before and after the inlet looper station.

Preferably, a central looper station is provided before the temper rolling station and after the central continuous post-processing station.

Preferably, a finishing station is provided between the coiling station and the outlet looper station, and the strip steel is finished before coiling.

Preferably, a tension levelling station is provided between the temper rolling station and the outlet looper station, and the strip steel may be subjected to tension levelling treatment before entering the outlet looper.

Preferably, a surface post-treatment station such as that for passivation or anti-fingerprint treatment is further provided between the temper rolling station and the outlet looper station, and the strip steel may be subjected to surface treatment such as passivation or anti-fingerprint treatment before entering the outlet looper.

Preferably, both a tension levelling station device and a surface post-treatment station such as that for passivation or anti-fingerprint treatment are provided between the temper rolling station and the outlet looper station, and the strip steel may be subjected to tension levelling and/or surface treatment such as passivation or anti-fingerprint treatment before entering the outlet looper.

### Example 1

The production line for preparing a hot-dip galvanized ultra-high-strength strip steel is shown in FIG. 3. A strip steel with the main chemical composition (mass %) of the substrate being 0.16% C-1.8% Si-2.3% Mn was uncoiled, welded, passed through an inlet looper, and washed. The strip steel was then preheated to 365° C. by jet direct fire preheating, then heated to 715° C. by direct fire heating, then heated to 815° C. by radiant tube heating, then heated to 915° C. by transverse magnetic induction heating, then soaked at 915° C. by radiant tube soaking for 60 seconds, then slowly cooled to 675° C., and then cooled to 230° C. by high hydrogen cooling. Then, it was reheated to 420° C., uniformly held at 420° C., and then heated to 460° C. by secondary reheating. After passing through a furnace nose, it was immersed in a zinc pot for hot-dip galvanizing. After the coating weight was controlled by an air knife, the strip steel was subjected to post-plating cooling to 150° C. or lower. Then, the strip steel was cooled to room temperature by final water cooling. After being temper rolled, it entered an outlet looper, and then it was coiled to complete the production. The final strip steel product had a yield strength of 702 MPa, a tensile strength of 1051 MPa, and an elongation at break of 22%.

### Example 2

The production line for preparing a hot-dip galvanized ultra-high-strength strip steel is shown in FIG. 4. A strip steel was uncoiled, welded, passed through an inlet looper, and washed. The strip steel was then preheated to 355° C. by jet direct fire preheating, then heated to 705° C. by direct fire heating, then heated to 805° C. by radiant tube heating, then heated to 905° C. by transverse magnetic induction heating, then soaked at 905° C. by radiant tube soaking for 65 seconds, then slowly cooled to 675° C., and then cooled to 50° C. or lower by mist cooling for pickling. Then, it was reheated to 390° C., uniformly held at 390° C., and then heated to 460° C. by secondary reheating. After passing through a furnace nose, it was immersed in a zinc pot for hot-dip galvanizing. After the coating weight was controlled by an air knife, the strip steel was subjected to post-plating cooling to 150° C. or lower. Then, the strip steel was cooled to room temperature by final water cooling. After being temper rolled, it entered an outlet looper, and then it was coiled to complete the production.

### Example 3

The production line for preparing a hot-dip galvanized ultra-high-strength strip steel is shown in FIG. 5. A strip steel was uncoiled, welded, passed through an inlet looper, and washed. The strip steel was then preheated to 357° C. by jet direct fire preheating, then heated to 720° C. by direct fire heating, then heated to 820° C. by radiant tube heating, then heated to 910° C. by transverse magnetic induction heating, then soaked at 910° C. by radiant tube soaking for 56 seconds, then slowly cooled to 670° C., then cooled to room temperature by water quenching cooling, and then pickled. Then, it was reheated to 400° C., uniformly held at 400° C., and then heated to 455° C. by secondary reheating. After passing through a furnace nose, it was immersed in a zinc pot for hot-dip galvanizing. After the coating weight was controlled by an air knife, the strip steel was subjected to post-plating cooling to 150° C. or lower. Then, the strip steel was cooled to room temperature by final water cooling. After being temper rolled, it entered an outlet looper, and then it was coiled to complete the production.

### Example 4

The production line for preparing a hot-dip galvanized ultra-high-strength strip steel is shown in FIG. 6. A strip steel was uncoiled, welded, passed through an inlet looper, and washed. The strip steel was then preheated to 353° C. by jet direct fire preheating, then heated to 700° C. by direct fire heating, then heated to 800° C. by radiant tube heating, then heated to 900° C. by transverse magnetic induction heating, then soaked at 900° C. by radiant tube soaking for 68 seconds, then slowly cooled to 660° C., then cooled first to 410° C. by mist cooling, then to room temperature by water quenching cooling, and then pickled. Then, it was reheated to 385° C., uniformly held at 385° C., and then heated to 455° C. by secondary reheating. After passing through a furnace nose, it was immersed in a zinc pot for hot-dip galvanizing. After the coating weight was controlled by an air knife, the strip steel was subjected to post-plating cooling to 150° C. or lower. Then, the strip steel was cooled to room temperature by final water cooling. After being temper rolled, it entered an outlet looper, and then it was coiled to complete the production.

### Example 5

The production line for preparing a hot-dip galvanized ultra-high-strength strip steel is shown in FIG. 7. To prepare a high-strength steel, a strip steel with the main chemical composition (mass %) of the substrate being 0.08% C-0.35% Si-2.1% Mn was uncoiled, welded, passed through an inlet looper, and washed. The strip steel was then preheated to 360° C. by jet direct fire preheating, then heated to 720° C. by direct fire heating, then heated to 820° C. by radiant tube heating, then heated to 920° C. by transverse magnetic induction heating, then soaked at 920° C. by radiant tube soaking for 40 seconds, then slowly cooled to 750° C., and then cooled first to 500° C. by mist cooling, then to about 50° C. by water quenching cooling. Then, it was pickled, and then flash plated with nickel. Then, it was reheated to 410° C., uniformly held at 410° C., and then heated to 455° C. by secondary reheating. After passing through a furnace nose, it was immersed in a zinc pot for hot-dip galvanizing. After the coating weight was controlled by an air knife, the strip steel was subjected to post-plating cooling to 150° C. or lower. Then, the strip steel was cooled to room temperature by final water cooling. After being temper rolled, it entered an outlet looper, and then it was coiled to complete the production. The final strip steel product had a yield strength of 951 MPa, a tensile strength of 1239 MPa, and an elongation at break of 8%.

### Example 6

The production line for preparing a hot-dip galvanized ultra-high-strength strip steel is shown in FIG. 8. A strip steel was uncoiled, welded, passed through an inlet looper, and washed. The strip steel was then preheated to 357° C. by jet direct fire preheating, then heated to 720° C. by direct fire heating, then heated to 820° C. by radiant tube heating, then heated to 910° C. by transverse magnetic induction heating, then soaked at 910° C. by radiant tube soaking for 56 seconds, then slowly cooled to 670° C., and then cooled to room temperature by water quenching cooling. Then, it was pickled, and then flash plated with nickel. Then, it was reheated to 400° C., uniformly held at 400° C., and then heated to 455° C. by secondary reheating. After passing through a furnace nose, it was immersed in a zinc pot for hot-dip galvanizing. After the coating weight was controlled by an air knife, the strip steel was subjected to post-plating cooling to 150° C. or lower. Then, the strip steel was cooled to room temperature by final water cooling. After being temper rolled, it entered an outlet looper, and then it was coiled to complete the production.

### Example 7

The production line for preparing a hot-dip galvanized ultra-high-strength strip steel is shown in FIG. 9. A strip steel was uncoiled, welded, passed through an inlet looper, and washed. The strip steel was then preheated to 353° C. by jet direct fire preheating, then heated to 700° C. by direct fire heating, then heated to 800° C. by radiant tube heating, then heated to 900° C. by transverse magnetic induction heating, then soaked at 900° C. by radiant tube soaking for 68 seconds, then slowly cooled to 660° C., and then cooled first to 410° C. by mist cooling, and then to room temperature by water quenching cooling. Then, it was pickled, and then flash plated with iron. Then, it was reheated to 385° C., uniformly held at 385° C., and then heated to 455° C. by secondary reheating. After passing through a furnace nose, it was immersed in a zinc pot for hot-dip galvanizing. After the coating weight was controlled by an air knife, the strip steel was subjected to post-plating cooling to 150° C. or lower. Then, the strip steel was cooled to room temperature by final water cooling. After being temper rolled, it entered an outlet looper, and then it was coiled to complete the production.

### Example 8

The production line for preparing a hot-dip galvanized ultra-high-strength strip steel is shown in FIG. 10. A strip steel with the main chemical composition (mass %) of the substrate being 0.15% C-1.72% Si-2.28% Mn was uncoiled, welded, passed through an inlet looper, and washed. The strip steel was then preheated to 355° C. by jet direct fire preheating, then heated to 720° C. by direct fire heating, then heated to 820° C. by radiant tube heating, then heated to 920° C. by transverse magnetic induction heating, then soaked at 920° C. by radiant tube soaking for 80 seconds, then slowly cooled to 670° C., and then cooled to 260° C. by high hydrogen cooling. Then, it was reheated to 410° C., uniformly held at 410° C., and then heated to 455° C. by secondary reheating. After passing through a furnace nose, it was immersed in a zinc pot for hot-dip galvanizing. After the coating weight was controlled by an air knife, the strip steel entered an alloying heating furnace to be heated to 510° C., and then it was subjected to alloying soaking at 505° C. for 20 seconds. Then, the strip steel was subjected to post-plating cooling to 200° C. or lower. Then, the strip steel was cooled to room temperature by final water cooling. After being temper rolled, it entered an outlet looper, and then it was coiled to complete the production. The final strip steel product had a yield strength of 693 MPa, a tensile strength of 1018 MPa, and an elongation at break of 21.5%.

### Example 9

The production line for preparing a hot-dip galvanized ultra-high-strength strip steel is shown in FIG. 11. A strip steel was uncoiled, welded, passed through an inlet looper, and washed. The strip steel was then preheated to 352° C. by jet direct fire preheating, then heated to 705° C. by direct fire heating, then heated to 805° C. by radiant tube heating, then heated to 905° C. by transverse magnetic induction heating, then soaked at 905° C. by radiant tube soaking for 65 seconds, then slowly cooled to 675° C., and then cooled to 50° C. or lower by mist cooling for pickling. Then, it was reheated to 390° C., uniformly held at 390° C., and then heated to 460° C. by secondary reheating. After passing through a furnace nose, it was immersed in a zinc pot for hot-dip galvanizing. After the coating weight was controlled by an air knife, the strip steel entered an alloying heating section to be heated to 510° C., and then it was subjected to alloying soaking at 510° C. for 20 seconds. Then, the strip steel was subjected to post-plating cooling to 200° C. or lower. Then, the strip steel was cooled to room temperature by final water cooling. After being temper rolled, it entered an outlet looper, and then it was coiled to complete the production.

### Example 10

The production line for preparing a hot-dip galvanized ultra-high-strength strip steel is shown in FIG. 12. A strip steel was uncoiled, welded, passed through an inlet looper, and washed. The strip steel was then preheated to 357° C. by jet direct fire preheating, then heated to 720° C. by direct fire heating, then heated to 820° C. by radiant tube heating, then heated to 910° C. by transverse magnetic induction heating, then soaked at 910° C. by radiant tube soaking for 56 seconds, then slowly cooled to 670° C., then cooled to room temperature by water quenching cooling, and then pickled. Then, it was reheated to 400° C., uniformly held at 400° C., and then heated to 460° C. by secondary reheating. After passing through a furnace nose, it was immersed in a zinc pot for hot-dip galvanizing. After the coating weight was controlled by an air knife, the strip steel entered an alloying heating section to be heated to 515° C., and then it was subjected to alloying soaking at 510° C. for 18 seconds. Then, the strip steel was subjected to post-plating cooling to 200° C. or lower. Then, the strip steel was cooled to room temperature by final water cooling. After being temper rolled, it entered an outlet looper, and then it was coiled to complete the production.

### Example 11

The production line for preparing a hot-dip galvanized ultra-high-strength strip steel is shown in FIG. 13. A strip steel was uncoiled, welded, passed through an inlet looper, and washed. The strip steel was then preheated to 363° C. by jet direct fire preheating, then heated to 700° C. by direct fire heating, then heated to 800° C. by radiant tube heating, then heated to 900° C. by transverse magnetic induction heating, then soaked at 900° C. by radiant tube soaking for 68 seconds, then slowly cooled to 660° C., then cooled first to 410° C. by mist cooling, then to room temperature by water quenching cooling, and then pickled. Then, it was reheated to 385° C., uniformly held at 385° C., and then heated to 460° C. by secondary reheating. After passing through a furnace nose, it was immersed in a zinc pot for hot-dip galvanizing. After the coating weight was controlled by an air knife, the strip steel entered an alloying heating section to be heated to 520° C., and then it was subjected to alloying soaking at 515° C. for 16 seconds. Then, the strip steel was subjected to post-plating cooling to 200° C. or lower. Then, the strip steel was cooled to room temperature by final water cooling. After being temper rolled, it entered an outlet looper, and then it was coiled to complete the production.

### Example 12

The production line for preparing a hot-dip galvanized ultra-high-strength strip steel is shown in FIG. 14. A strip steel was uncoiled, welded, passed through an inlet looper, and washed. The strip steel was then preheated to 366° C. by jet direct fire preheating, then heated to 720° C. by direct fire heating, then heated to 820° C. by radiant tube heating, then heated to 920° C. by transverse magnetic induction heating, then soaked at 920° C. by radiant tube soaking for 40 seconds, then slowly cooled to 750° C., and then cooled first to 500° C. by mist cooling, and then to about 50° C. by water quenching cooling. Then, the strip steel was pickled, and then flash plated with nickel. Then, it was reheated to 410° C., uniformly held at 410° C., and then heated to 465° C. by secondary reheating. After passing through a furnace nose, it was immersed in a zinc pot for hot-dip galvanizing. After the coating weight was controlled by an air knife, the strip steel entered an alloying heating section to be heated to 500° C., and then it was subjected to alloying soaking at 500° C. for 25 seconds. Then, the strip steel was subjected to post-plating cooling to 200° C. or lower. Then, the strip steel was cooled to room temperature by final water cooling. After being temper rolled, it entered an outlet looper, and then it was coiled to complete the production.

### Example 13

The production line for preparing a hot-dip galvanized ultra-high-strength strip steel is shown in FIG. 15. A strip steel was uncoiled, welded, passed through an inlet looper, and washed. The strip steel was then preheated to 357° C. by jet direct fire preheating, then heated to 720° C. by direct fire heating, then heated to 820° C. by radiant tube heating, then heated to 910° C. by transverse magnetic induction heating, then soaked at 910° C. by radiant tube soaking for 56 seconds, then slowly cooled to 670° C., and then cooled to room temperature by water quenching cooling. Then, the strip steel was pickled, and then flash plated with nickel. Then, it was reheated to 400° C., uniformly held at 400° C., and then heated to 460° C. by secondary reheating. After passing through a furnace nose, it was immersed in a zinc pot for hot-dip galvanizing. After the coating weight was controlled by an air knife, the strip steel entered an alloying heating section to be heated to 530° C., and then it was subjected to alloying soaking at 520° C. for 15 seconds. Then, the strip steel was subjected to post-plating cooling to 200° C. or lower. Then, the strip steel was cooled to room temperature by final water cooling. After being temper rolled, it entered an outlet looper, and then it was coiled to complete the production.

### Example 14

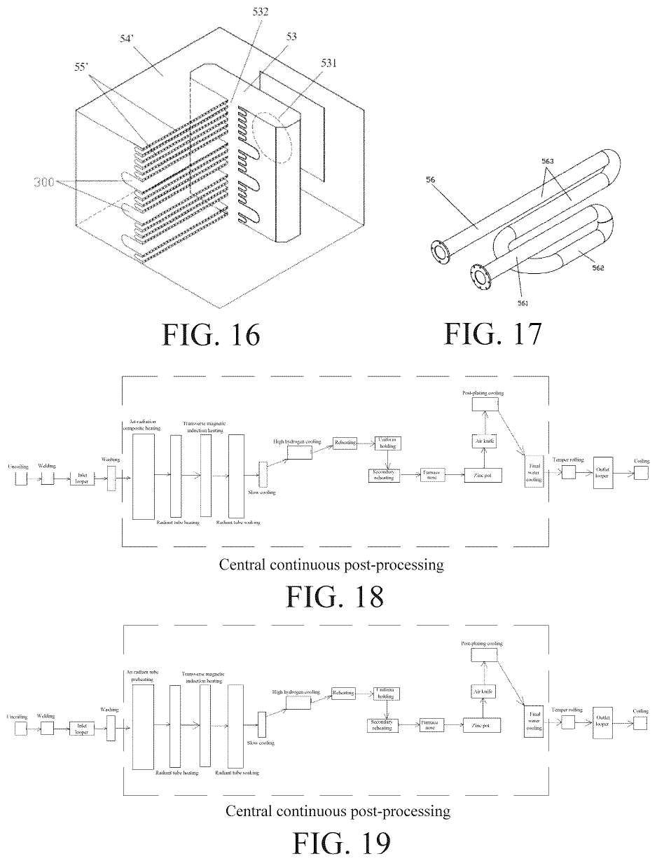

The production line for preparing a hot-dip galvanized ultra-high-strength strip steel is shown in FIG. 16. A strip steel was uncoiled, welded, passed through an inlet looper, and washed. The strip steel was then preheated to 353° C. by jet direct fire preheating, then heated to 700° C. by direct fire heating, then heated to 800° C. by radiant tube heating, then heated to 900° C. by transverse magnetic induction heating, then soaked at 900° C. by radiant tube soaking for 68 seconds, then slowly cooled to 660° C., and then cooled first to 410° C. by mist cooling, then to room temperature by water quenching cooling. Then, the strip steel was pickled, and then flash plated with iron. Then, it was reheated to 385° C., uniformly held at 385° C., and then heated to 465° C. by secondary reheating. After passing through a furnace nose, it was immersed in a zinc pot for hot-dip galvanizing. After the coating weight was controlled by an air knife, the strip steel entered an alloying heating section to be heated to 525° C., and then it was subjected to alloying soaking at 520° C. for 18 seconds. Then, the strip steel was subjected to post-plating cooling to 200° C. or lower. Then, the strip steel was cooled to room temperature by final water cooling. After being temper rolled, it entered an outlet looper, and then it was coiled to complete the production.

### Rapid Production Line for Annealed Strip Steel

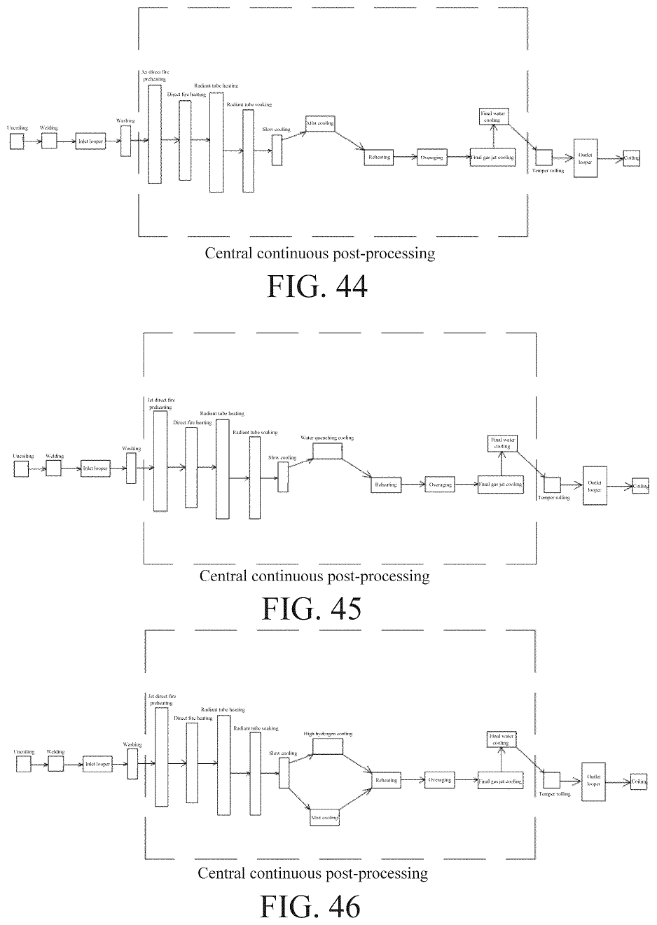

Referring to FIGS. 43 to 45 which show Examples 1 to 3 of the present disclosure, the rapid production line for annealed strip steel includes the following stations in sequence: uncoiling—welding—inlet looper—washing—central continuous post-processing—temper rolling—outlet looper—coiling.

The central continuous post-processing station includes in sequence a preheating section, a heating section, a soaking section, a slow cooling section, a rapid cooling section, a reheating section, an overaging section, a final gas jet cooling section, and a final water cooling section.

A jet direct fire preheating device is used for the preheating section.

A direct fire heating section is used for the heating section.

Radiant tube soaking is used for the soaking section.

High hydrogen cooling, or mist cooling, or water quenching cooling is used for the rapid cooling section.

Examples 1 to 3 of the present disclosure allows for the use of a jet direct fire preheating device and high hydrogen cooling or mist cooling or water quenching cooling on a single production line to carry out rapid heating and rapid cooling treatments, thereby enabling continuous production of ultra-high-strength strip steel.

Referring to FIG. 46 which shows Example 4 of the present disclosure, in Example 4, the rapid production line for annealed strip steel includes the following stations in sequence: uncoiling—welding—inlet looper—washing—central continuous post-processing—temper rolling—outlet looper—coiling.

The central continuous post-processing station includes in sequence a preheating section, a heating section, a radiant tube soaking section, a slow cooling section, a high hydrogen cooling section and a water quenching cooling section, a reheating section, an overaging section, a final gas jet cooling section, and a final water cooling section.

A jet direct fire preheating device is used for the preheating section.

A direct fire heating section is used for the heating section.

In the rapid cooling section, high hydrogen cooling and mist cooling are provided in parallel.

The strip steel may pass through the high hydrogen cooling section for high hydrogen cooling, or may pass through the mist cooling section for mist cooling.

The production line of Example 4 utilizes a jet direct fire preheating device, high hydrogen cooling and mist cooling concurrently to carry out rapid heating and selectable rapid cooling treatment to enable continuous production of ultra-high-strength strip steel.

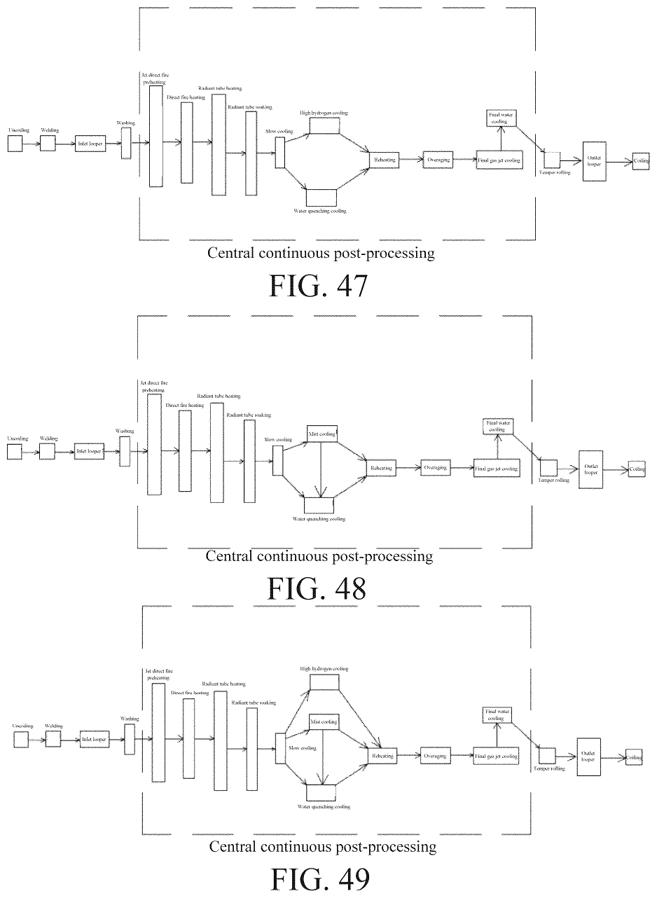

Referring to FIG. 47 which shows Example 5 of the present disclosure, the rapid production line for annealed strip steel includes the following stations in sequence: uncoiling—welding—inlet looper—washing—central continuous post-processing—temper rolling—outlet looper—coiling.

The central continuous post-processing station includes in sequence a preheating section, a heating section, a radiant tube soaking section, a slow cooling section, a rapid cooling section, a reheating section, an overaging section, a final gas jet cooling section, and a final water cooling section.

A jet direct fire preheating device is used for the preheating section.

A direct fire heating section is used for the heating section.

In the rapid cooling section, high hydrogen cooling and water quenching cooling are provided in parallel. The strip steel may pass through the high hydrogen cooling section for high hydrogen cooling, or may pass through the water quenching section for water quenching cooling.

The production line of Example 5 utilizes a jet direct fire preheating device, high hydrogen cooling and water quenching cooling concurrently to carry out rapid heating and selectable rapid cooling treatment to enable continuous production of ultra-high-strength strip steel.

Referring to FIG. 48 which shows Example 6 of the present disclosure, in Example 6, the rapid production line for annealed strip steel includes the following stations in sequence: uncoiling—welding—inlet looper—washing—central continuous post-processing—temper rolling—outlet looper—coiling.

The central continuous post-processing station includes in sequence a preheating section, a heating section, a radiant tube soaking section, a slow cooling section, a rapid cooling section, a reheating section, an overaging section, a final gas jet cooling section, and a final water cooling section.

A jet direct fire preheating device is used for the preheating section.

A direct fire heating section is used for the heating section.

In the rapid cooling section, mist cooling and water quenching cooling are provided in parallel, and a connecting channel is provided between the mist cooling and the water quenching cooling. The strip steel may be subjected to mist cooling followed by water quenching cooling, or may be subjected to mist cooling only or water quenching cooling only.

The production line of Example 6 utilizes a jet direct fire preheating device, a mist cooling section and a water quenching cooling section concurrently to carry out rapid heating and selectable rapid cooling treatment to enable continuous production of ultra-high-strength strip steel.

Referring to FIG. 49 which shows Example 7 of the present disclosure, the rapid production line for annealed strip steel includes the following stations in sequence: uncoiling—welding—inlet looper—washing—central continuous post-processing—temper rolling—outlet looper—coiling.

The central continuous post-processing station includes in sequence a preheating section, a heating section, a radiant tube soaking section, a slow cooling section, a rapid cooling section, a reheating section, an overaging section, a final gas jet cooling section, and a final water cooling section.

A jet direct fire preheating device is used for the preheating section.

A direct fire heating section is used for the heating section.

In the rapid cooling section, high hydrogen cooling is provided in parallel with mist cooling and water quenching cooling, and a connecting channel is provided between the mist cooling and the water quenching cooling.

The mist cooling section and the water quenching cooling section are provided in series, wherein the strip steel may be subjected to mist cooling followed by water quenching cooling, or may be subjected to mist cooling only or water quenching cooling only; and the high hydrogen cooling section is provided in parallel with (the mist cooling section+the water quenching cooling section), wherein the strip steel may pass through the high hydrogen cooling section, or may pass through the mist cooling section+the water quenching cooling section to carry out rapid cooling treatment.

The production line of Example 7 utilizes a jet direct fire preheating device, a high hydrogen cooling section and (a mist cooling section+a water quenching cooling section) concurrently to carry out rapid heating and selectable rapid cooling treatment to enable continuous production of ultra-high-strength strip steel.

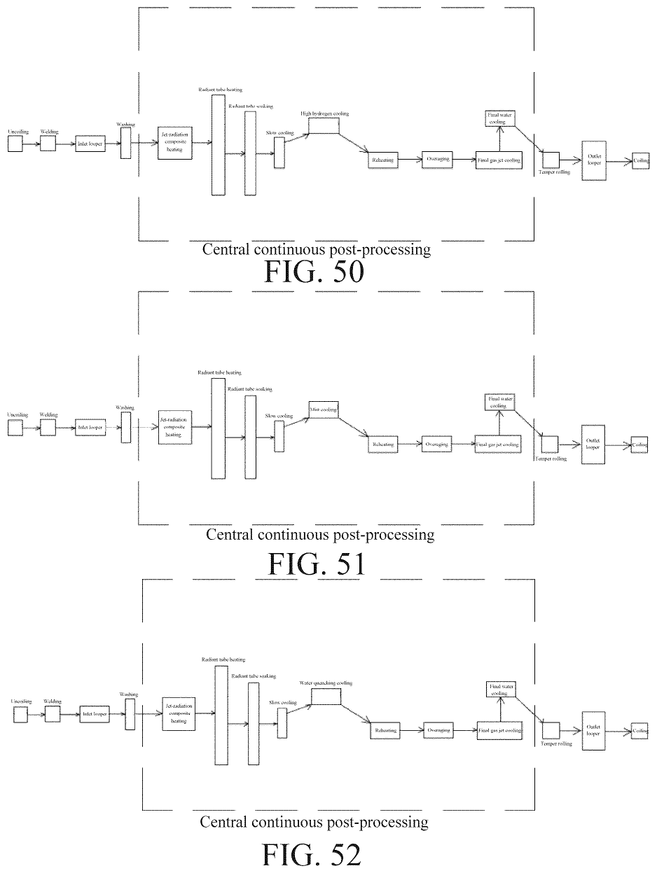

Referring to FIGS. 50 to 52 which show Examples 8 to 10 of the present disclosure, the rapid production line for annealed strip steel includes the following stations in sequence: uncoiling—welding—inlet looper—washing—central continuous post-processing—temper rolling—outlet looper—coiling.

The central continuous post-processing station includes in sequence a preheating section, a heating section, a soaking section, a slow cooling section, a rapid cooling section, a reheating section, an overaging section, a final gas jet cooling section, and a final water cooling section.

A jet-radiation composite heating device is used for the preheating section.

A radiant tube heating section is used for the heating section.

High hydrogen cooling, or mist cooling, or water quenching cooling is used for the rapid cooling section.

Radiant tube soaking is used for the soaking section.

The production line of Examples 8 to 10 utilizes a jet-radiation composite heating device together with a rapid cooling means selected from high hydrogen cooling or mist cooling or water quenching cooling to carry out rapid heating and rapid cooling treatments to enable continuous production of ultra-high-strength strip steel.

Referring to FIG. 53 which shows Example 11 of the present disclosure, based on Example 8, a high-hydrogen cooling section and a mist cooling section are provided in parallel in the rapid cooling section. The strip steel may pass through the high-hydrogen cooling section for high-hydrogen cooling, or may pass through the mist cooling section for mist cooling.

The production line of Example 11 utilizes a jet-radiation composite heating device, high-hydrogen cooling and mist cooling concurrently to carry out rapid heating and selectable rapid cooling treatment to enable continuous production of ultra-high-strength strip steel.

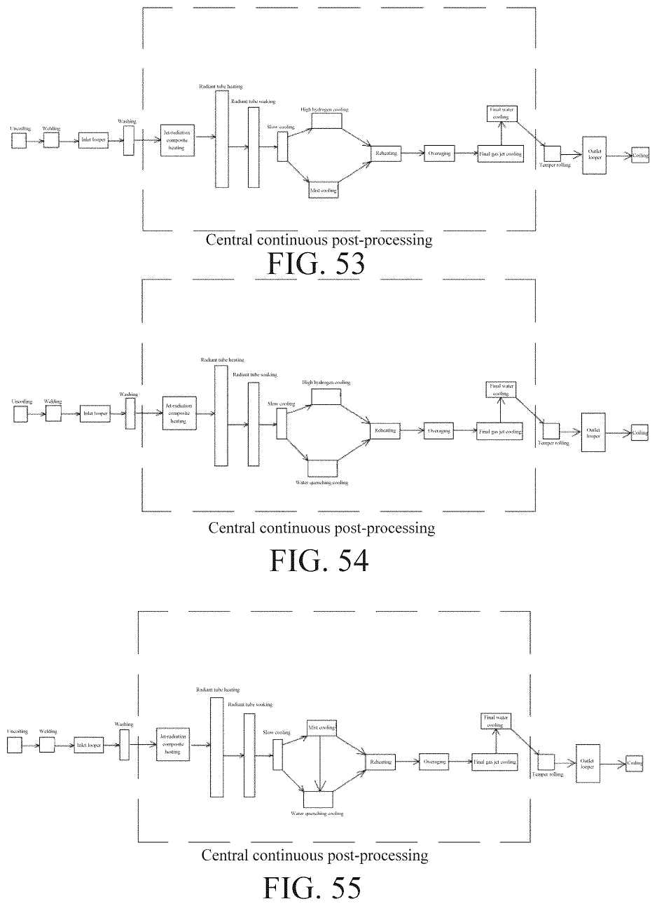

Referring to FIG. 54 which shows Example 12 of the present disclosure, based on Example 8, a high-hydrogen cooling section and a water quenching cooling section are provided in parallel in the rapid cooling section. The strip steel may pass through the high-hydrogen cooling section for high-hydrogen cooling, or may pass through the water quenching cooling section for water quenching cooling.

The production line of Example 12 utilizes a jet-radiation composite heating device, high-hydrogen cooling and water quenching cooling concurrently to carry out rapid heating and selectable rapid cooling treatment to enable continuous production of ultra-high-strength strip steel.

Referring to FIG. 55 which shows Example 13 of the present disclosure, the rapid production line for annealed strip steel includes the following stations in sequence: uncoiling—welding—inlet looper—washing—central continuous post-processing—temper rolling—outlet looper—coiling.

The central continuous post-processing station includes in sequence a preheating section, a heating section, a radiant tube soaking section, a slow cooling section, a rapid cooling section, a reheating section, an overaging section, a final gas jet cooling section, and a final water cooling section.

A jet-radiation composite heating device is used for the preheating section.

A radiant tube heating section is used for the heating section.

In the rapid cooling section, mist cooling and water quenching cooling are provided in parallel, and a connecting channel is provided between the mist cooling and the water quenching cooling, so that the mist cooling section and the water quenching cooling section are provided in series. The strip steel may be subjected to mist cooling followed by water quenching cooling, or may be subjected to mist cooling only or water quenching cooling only.

The production line of Example 13 utilizes a jet-radiation composite heating device, a mist cooling section and a water quenching cooling section concurrently to carry out rapid heating and selectable rapid cooling treatment to enable continuous production of ultra-high-strength strip steel.

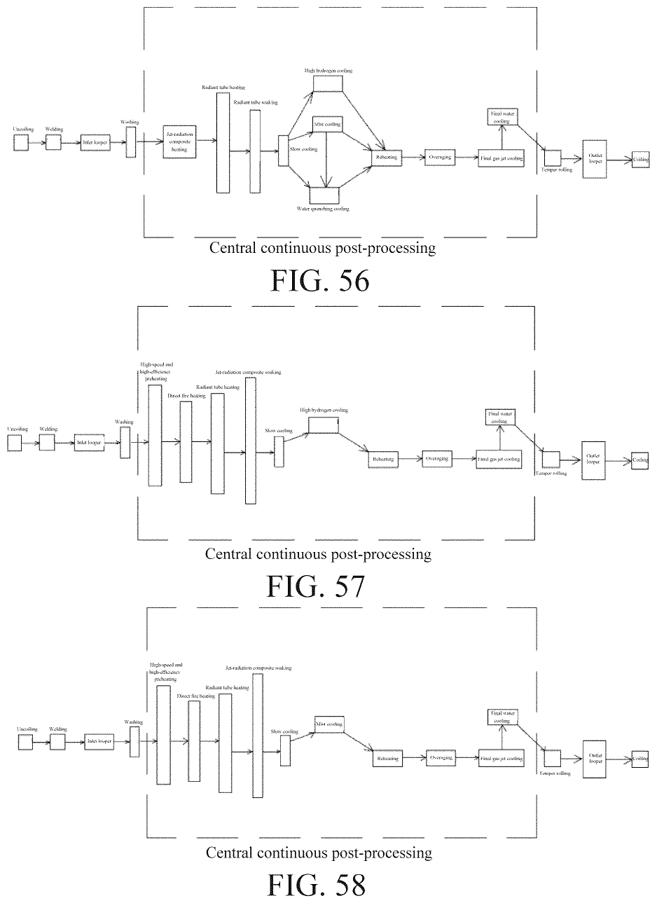

Referring to FIG. 56 which shows Example 14 of the present disclosure, the rapid production line for annealed strip steel includes the following stations in sequence: uncoiling—welding—inlet looper—washing—central continuous post-processing—temper rolling—outlet looper—coiling.

The central continuous post-processing station includes in sequence a preheating section, a heating section, a radiant tube soaking section, a slow cooling section, a rapid cooling section, a reheating section, an overaging section, a final gas jet cooling section, and a final water cooling section.

A jet-radiation composite heating device is used for the preheating section.

A radiant tube heating section is used for the heating section.

In the rapid cooling section, high hydrogen cooling is provided in parallel with mist cooling and water quenching cooling, and a connecting channel is provided between the mist cooling and the water quenching cooling, so that the mist cooling section and the water quenching cooling section are provided in series.

The strip steel may be subjected to mist cooling followed by water quenching cooling, or may be subjected to mist cooling only or water quenching cooling only; and the high hydrogen cooling section is provided in parallel with (the mist cooling section+the water quenching cooling section), wherein the strip steel may pass through the high hydrogen cooling section, or may pass through the mist cooling section+the water quenching cooling section to carry out rapid cooling treatment.

The production line of Example 14 utilizes a jet-radiation composite heating device, a high hydrogen cooling section and (a mist cooling section+a water quenching cooling section) concurrently to carry out rapid heating and selectable rapid cooling treatment to enable continuous production of ultra-high-strength strip steel.

Referring to FIGS. 57 to 59 which show Examples 15 to 17 of the present disclosure, the rapid production line for annealed strip steel includes the following stations in sequence: uncoiling—welding—inlet looper—washing—central continuous post-processing—temper rolling—outlet looper—coiling.

The central continuous post-processing station includes in sequence a preheating section, a heating section, a soaking section, a slow cooling section, a rapid cooling section, a reheating section, an overaging section, a final gas jet cooling section, and a final water cooling section.

A jet direct fire preheating device is used for the preheating section.

A direct fire heating section is used for the heating section.

In the soaking section, a jet-radiation composite heating device is used for soaking.

High hydrogen cooling, or mist cooling, or water quenching cooling is used for the rapid cooling section.

The production line of Examples 15-17 utilizes a jet direct fire preheating device together with a rapid cooling means selected from high hydrogen cooling, mist cooling and water quenching cooling to carry out rapid heating and rapid cooling treatments, and a jet-radiation composite soaking device is used to carry out soaking, so as to enable continuous production of ultra-high-strength strip steel.

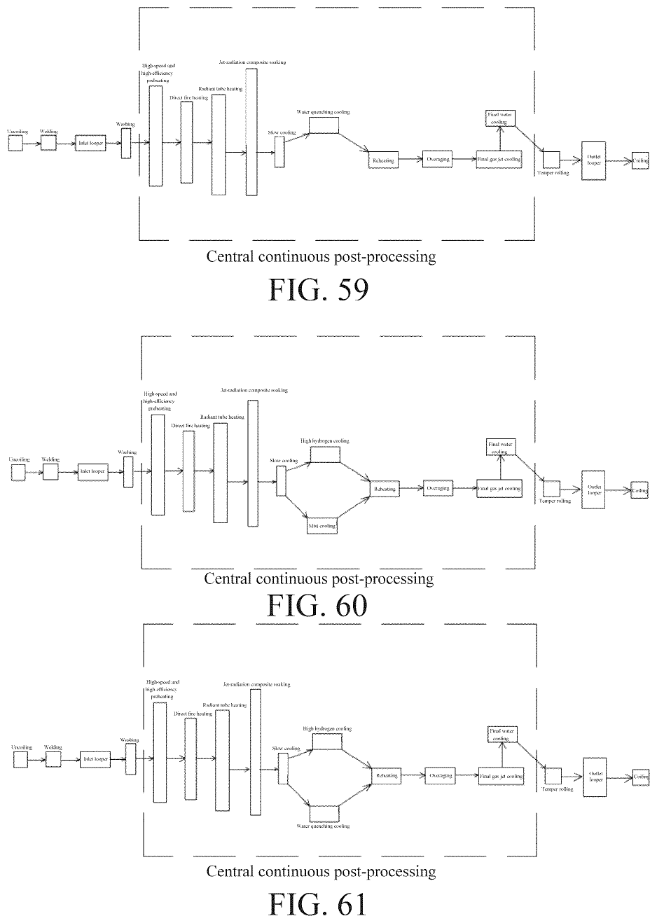

Referring to FIGS. 60 and 61 which show Examples 18 and 19 of the present disclosure, based on Example 15, high hydrogen cooling and mist cooling or water quenching cooling are provided in parallel in the rapid cooling section.

The high hydrogen cooling section and the mist cooling section are provided in parallel, so that the strip steel may pass through the high hydrogen cooling section for high hydrogen cooling, or may pass through the mist cooling section for mist cooling. Alternatively, the high hydrogen cooling section and the water quenching cooling section are provided in parallel, so that the strip steel may pass through the high hydrogen cooling section for high hydrogen cooling, or may pass through the water quenching cooling section for water quenching cooling.

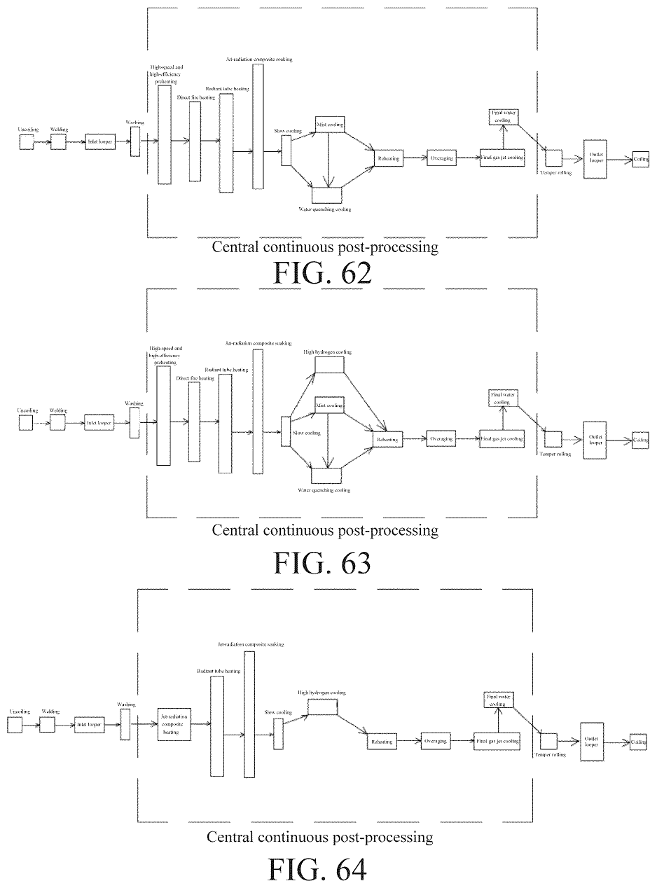

Referring to FIG. 62 which shows Example 20 of the present disclosure, the rapid production line for annealed strip steel includes the following stations in sequence: uncoiling—welding—inlet looper—washing—central continuous post-processing—temper rolling—outlet looper—coiling.

The central continuous post-processing station includes in sequence a preheating section, a heating section, a radiant tube soaking section, a slow cooling section, a rapid cooling section, a reheating section, an overaging section, a final gas jet cooling section, and a final water cooling section.

A jet direct fire preheating device is used for the preheating section.

A direct fire heating section is used for the heating section.

In the soaking section, a jet-radiation composite heating device is used for soaking.

In the rapid cooling section, mist cooling and water quenching cooling are provided in parallel, and a connecting channel is provided between the mist cooling and the water quenching cooling, so that the mist cooling section and the water quenching cooling section are provided in series. The strip steel may be subjected to mist cooling followed by water quenching cooling, or may be subjected to mist cooling only or water quenching cooling only.

The production line of Example 20 utilizes a jet direct fire preheating device, a mist cooling section and a water quenching cooling section device concurrently to carry out rapid heating and selectable rapid cooling treatment, and a jet-radiation composite soaking section is used to carry out soaking, thereby enabling continuous production of ultra-high-strength strip steel.

Referring to FIG. 63 which shows Example 21 of the present disclosure, the rapid production line for annealed strip steel includes the following stations in sequence: uncoiling—welding—inlet looper—washing—central continuous post-processing—temper rolling—outlet looper—coiling.

The central continuous post-processing station includes in sequence a preheating section, a heating section, a radiant tube soaking section, a slow cooling section, a rapid cooling section, a reheating section, an overaging section, a final gas jet cooling section, and a final water cooling section.

A jet direct fire preheating device is used for the preheating section.

A direct fire heating section is used for the heating section.

In the soaking section, a jet-radiation composite heating device is used for soaking.

In the rapid cooling section, high hydrogen cooling is provided in parallel with mist cooling and water quenching cooling, and a connecting channel is provided between the mist cooling and the water quenching cooling, so that the mist cooling section and the water quenching cooling section are provided in series. The strip steel may be subjected to mist cooling followed by water quenching cooling, or may be subjected to mist cooling only or water quenching cooling only; and the high hydrogen cooling section is provided in parallel with (the mist cooling section+the water quenching cooling section), wherein the strip steel may pass through the high hydrogen cooling section, or may pass through the mist cooling section+the water quenching cooling section to carry out rapid cooling treatment.

The production line of Example 21 utilizes a jet direct fire preheating device, a high hydrogen cooling section and (a mist cooling section+a water quenching cooling section) concurrently to carry out rapid heating and selectable rapid cooling treatment, and a jet-radiation composite heating device is used to carry out soaking, thereby enabling continuous production of ultra-high-strength strip steel.

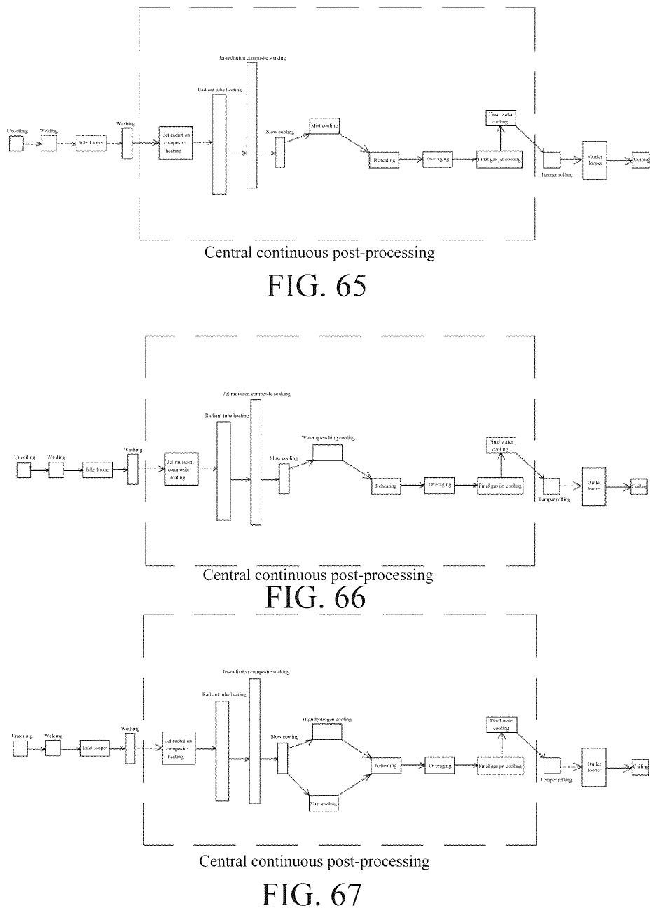

Referring to FIGS. 64 to 66 which show Examples 22 to 24 of the present disclosure, the rapid production line for annealed strip steel includes the following stations in sequence: uncoiling—welding—inlet looper—washing—central continuous post-processing—temper rolling—outlet looper—coiling.

The central continuous post-processing station includes in sequence a preheating section, a heating section, a soaking section, a slow cooling section, a rapid cooling section, a reheating section, an overaging section, a final gas jet cooling section, and a final water cooling section.

A jet-radiation composite heating device is used for the preheating section.

A radiant tube heating section is used for the heating section.

High hydrogen cooling, or mist cooling, or water quenching cooling is used for the rapid cooling section.

In the soaking section, a jet-radiation composite heating device is used for soaking.

The production line of Examples 22 to 24 utilizes a jet-radiation composite heating device together with a rapid cooling means selected from high hydrogen cooling, mist cooling or water quenching cooling to carry out rapid heating and rapid cooling treatments, and a jet-radiation composite soaking device is used to carry out soaking, thereby enabling continuous production of ultra-high-strength strip steel.

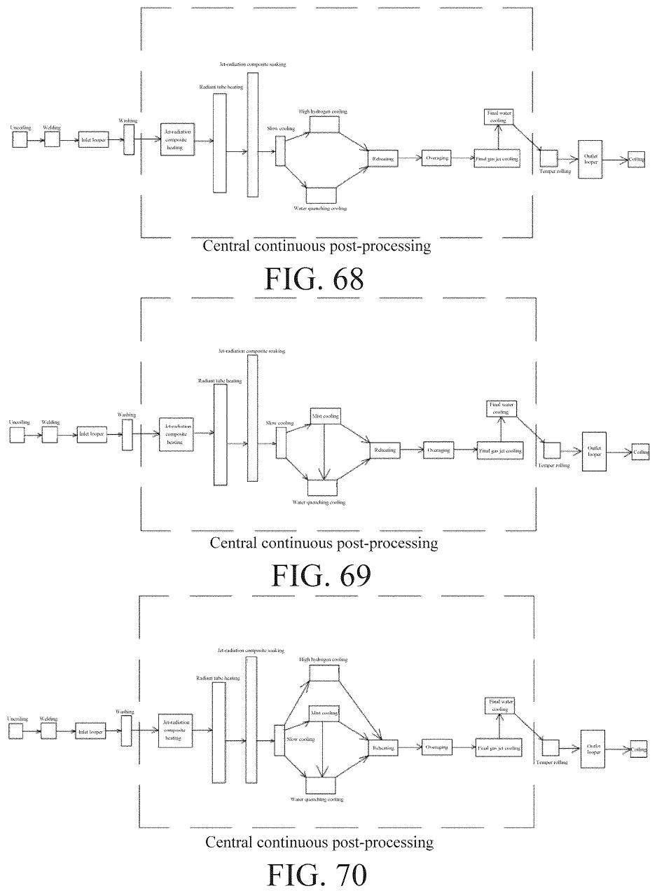

Referring to FIGS. 67 and 68 which show Examples 25 and 26 of the present disclosure, based on Example 22, high hydrogen cooling and mist cooling or water quenching cooling are provided in parallel in the rapid cooling section.

The high hydrogen cooling section and the mist cooling section are provided in parallel, so that the strip steel may pass through the high hydrogen cooling section for high hydrogen cooling, or may pass through the mist cooling section for mist cooling. Alternatively, the high hydrogen cooling section and the water quenching cooling section are provided in parallel, so that the strip steel may pass through the high hydrogen cooling section for high hydrogen cooling, or may pass through the water quenching cooling section for water quenching cooling.

Referring to FIG. 69 which shows Example 27 of the present disclosure, the rapid production line for annealed strip steel includes the following stations in sequence: uncoiling—welding—inlet looper—washing—central continuous post-processing—temper rolling—outlet looper—coiling.

The central continuous post-processing station includes in sequence a preheating section, a heating section, a soaking section, a slow cooling section, a rapid cooling section, a reheating section, an overaging section, a final gas jet cooling section, and a final water cooling section.

A jet-radiation composite heating device is used for the preheating section.

A radiant tube heating section is used for the heating section.

In the soaking section, a jet-radiation composite heating device is used for soaking.

In the rapid cooling section, mist cooling and water quenching cooling are provided in parallel, and a connecting channel is provided between the mist cooling and the water quenching cooling, so that the mist cooling section and the water quenching cooling section are provided in series. The strip steel may be subjected to mist cooling followed by water quenching cooling, or may be subjected to mist cooling only or water quenching cooling only.

The production line of Example 27 utilizes a jet-radiation composite heating device, mist cooling and water quenching cooling concurrently to carry out rapid heating and selectable rapid cooling treatment, and a jet-radiation composite soaking device is used to carry out soaking, thereby enabling continuous production of ultra-high-strength strip steel.

Referring to FIG. 70 which shows Example 28 of the present disclosure, based on Example 27, high hydrogen cooling is provided in parallel with mist cooling and water quenching cooling in the rapid cooling section, and a connecting channel is provided between the mist cooling and the water quenching cooling, so that the mist cooling section and the water quenching cooling section are provided in series. The strip steel may be subjected to mist cooling followed by water quenching cooling, or may be subjected to mist cooling only or water quenching cooling only.

The high hydrogen cooling section is provided in parallel with (the mist cooling section+the water quenching cooling section), so that the strip steel may pass through the high hydrogen cooling section, or may pass through the mist cooling section+the water quenching cooling section for rapid cooling treatment.

The production line of Example 28 utilizes a jet-radiation composite heating device, a high hydrogen cooling section and (a mist cooling section+a water quenching cooling section) concurrently to carry out rapid heating and selectable rapid cooling treatment, and a jet-radiation composite heating device is used to carry out soaking, thereby enabling continuous production of ultra-high-strength strip steel.

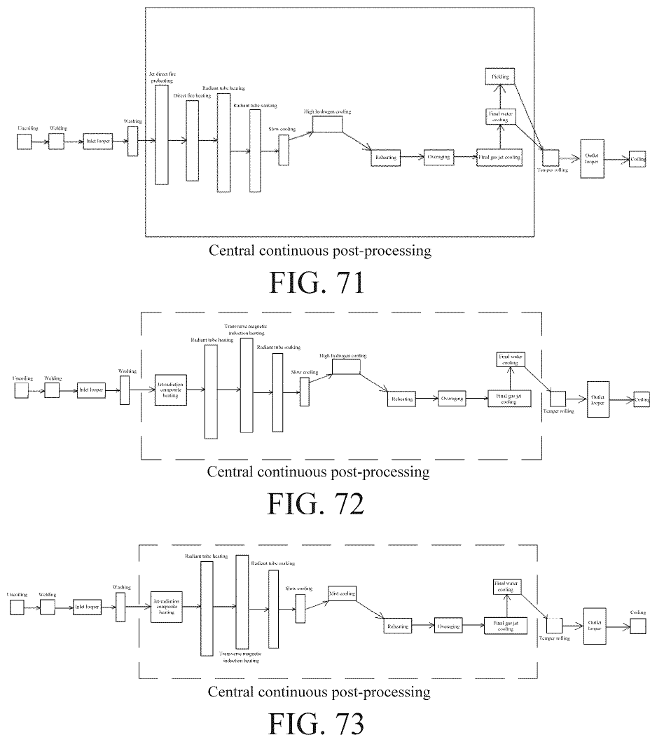

Referring to FIG. 71 which shows Example 29 of the present disclosure, based on Example 1, a selectable pickling section is provided after the final water cooling section, and the strip steel may pass through the pickling section or bypass the pickling section.

### Example 1

A strip steel with the main chemical composition (mass %) of the substrate being 0.07% C-0.01% Si-0.8% Mn was uncoiled, welded and washed. The strip steel was then preheated to 358° C. by jet direct fire preheating, then heated to 650° C. by direct fire heating, then heated to 790° C. by radiant tube heating, then soaked at 790° C. by radiant tube soaking for 50 seconds, then slowly cooled to 670° C., and then cooled to 250° C. by high hydrogen cooling. Then, the strip steel was subjected to overaging treatment (the reheating didn't need to be activated). Finally, it was cooled by gas jet cooling to about 140° C., and then cooled by final water cooling to room temperature. After temper rolling, it was coiled to complete the production. The final strip steel product had a yield strength of 502 MPa, a tensile strength of 613 MPa, and an elongation at break of 16%.

### Example 2

A strip steel with the main chemical composition (mass %) of the substrate being 0.06% C-0.01% Si-0.75% Mn was uncoiled, welded and washed. The strip steel was then preheated to 351° C. by jet direct fire preheating, then heated to 650° C. by direct fire heating, then heated to 790° C. by radiant tube heating, then soaked at 790° C. by radiant tube soaking for 50 seconds, then slowly cooled to 670° C., and then cooled to 270° C. by mist cooling. Then, the strip steel was subjected to overaging treatment (the reheating didn't need to be activated). Finally, it was cooled by gas jet cooling to about 140° C., and then cooled by final water cooling to room temperature. After temper rolling, it was coiled to complete the production. The final strip steel product had a yield strength of 536 MPa, a tensile strength of 628 MPa, and an elongation at break of 15%.

### Example 3

A strip steel with the main chemical composition (mass %) of the substrate being 0.06% C-0.008% Si-0.7% Mn was uncoiled, welded and washed. The strip steel was then preheated to 360° C. by jet direct fire preheating, then heated to 660° C. by direct fire heating, then heated to 790° C. by radiant tube heating, then soaked at 790° C. by radiant tube soaking for 50 seconds, then slowly cooled to 670° C., and then cooled to 50° C. by water quenching cooling. Then, the strip steel entered an overaging section in which it was heated to 230° C. for overaging treatment. Finally, it was cooled by gas jet cooling to about 140° C., and then cooled by final water cooling to room temperature. After temper rolling, it was coiled to complete the production. The final strip steel product had a yield strength of 567 MPa, a tensile strength of 689 MPa, and an elongation at break of 13%.

### Example 4

A strip steel with the main chemical composition (mass %) of the substrate being 0.065% C-0.009% Si-0.77% Mn was uncoiled, welded and washed. The strip steel was then preheated to 355° C. by jet direct fire preheating, then heated to 650° C. by direct fire heating, then heated to 785° C. by radiant tube heating, then soaked at 785° C. by radiant tube soaking for 40 seconds, then slowly cooled to 675° C., then cooled to 500° C. by mist cooling, and then cooled to about 50° C. by water quenching cooling. Then, the strip steel was reheated to 230° C. by a longitudinal magnetic induction heater, and it entered an overaging section for overaging treatment. Finally, it was cooled by gas jet cooling to about 140° C., and then cooled by final water cooling to room temperature. After temper rolling, it was coiled to complete the production. The final strip steel product had a yield strength of 537 MPa, a tensile strength of 663 MPa, and an elongation at break of 15%.

### Example 5

A strip steel with the main chemical composition (mass %) of the substrate being 0.095% C-0.17% Si-2.0% Mn was uncoiled, welded and washed. The strip steel was then heated to 670° C. by jet-radiation composite heating, then heated to 810° C. by radiant tube heating, then soaked at 810° C. by radiant tube soaking for 30 seconds, then slowly cooled to 675° C., and then cooled to about 250° C. by high hydrogen jet cooling. Then, the strip steel entered an overaging section (the reheating didn't need to be activated) for overaging treatment. Finally, it was cooled by gas jet cooling to about 140° C., and then cooled by final water cooling to room temperature. After temper rolling, it was coiled to complete the production. The final strip steel product had a yield strength of 530 MPa, a tensile strength of 920 MPa, and an elongation at break of 19%.

### Example 6

A strip steel with the main chemical composition (mass %) of the substrate being 0.085% C-0.3% Si-2.3% Mn was uncoiled, welded and washed. The strip steel was then preheated to 355° C. by jet direct fire preheating, then heated to 680° C. by direct fire heating, then heated to 800° C. by radiant tube heating, then soaked at 800° C. by jet-radiation composite soaking for 40 seconds, then slowly cooled to 675° C., and then cooled to about 230° C. by high hydrogen jet cooling. Then, the strip steel entered an overaging section (the reheating didn't need to be activated) for overaging treatment. Finally, it was cooled by gas jet cooling to about 140° C., and then cooled by final water cooling to room temperature. After temper rolling, it was coiled to complete the production. The final strip steel product had a yield strength of 908 MPa, a tensile strength of 1098 MPa, and an elongation at break of 9%.

### Example 7

A strip steel with the main chemical composition (mass %) of the substrate being 0.12% C-0.28% Si-2.5% Mn was uncoiled, welded and washed. The strip steel was then preheated to 365° C. by jet direct fire preheating, then heated to 680° C. by direct fire heating, then heated to 830° C. by radiant tube heating, then soaked at 830° C. by jet-radiation composite soaking for 40 seconds, then slowly cooled to 700° C., then cooled to 600° C. by mist cooling, and then cooled to about 50° C. by water quenching cooling. Then, the strip steel was reheated to 220° C., and it entered an overaging section for overaging treatment. Finally, it was cooled by gas jet cooling to about 140° C., and then cooled by final water cooling to room temperature. After temper rolling, it was coiled to complete the production. The final strip steel product had a yield strength of 1086 MPa, a tensile strength of 1343 MPa, and an elongation at break of 7%.

### Example 8

A strip steel with the main chemical composition (mass %) of the substrate being 0.08% C-0.012% Si-0.83% Mn was uncoiled, welded and washed. The strip steel was then heated to 500° C. by jet-radiation composite heating, then heated to 790° C. by radiant tube heating, then soaked at 790° C. by jet-radiation composite soaking for 30 seconds, then slowly cooled to 700° C., and then cooled to about 250° C. by high hydrogen jet cooling. Then, the strip steel entered an overaging section (the reheating didn't need to be activated) for overaging treatment. Finally, it was cooled by gas jet cooling to about 140° C., and then cooled by final water cooling to room temperature. After temper rolling, it was coiled to complete the production. The final strip steel product had a yield strength of 456 MPa, a tensile strength of 539 MPa, and an elongation at break of 23%.

### Example 9

A strip steel with the main chemical composition (mass %) of the substrate being 0.065% C-0.012% Si-0.85% Mn was uncoiled, welded and washed. The strip steel was then preheated to 360° C. by jet direct fire preheating, then heated to 670° C. by direct fire heating, then heated to 800° C. by radiant tube heating, then soaked at 800° C. by radiant tube soaking for 60 seconds, then slowly cooled to 675° C., and then cooled to 260° C. by mist cooling. Then, the strip steel was subjected to overaging treatment (the reheating didn't need to be activated). Finally, it was cooled by gas jet cooling to about 140° C., and then cooled by final water cooling to room temperature. Subsequently, the strip steel was pickled. After pickling, it was temper rolled and coiled to complete the production. The final strip steel product had a yield strength of 556 MPa, a tensile strength of 658 MPa, and an elongation at break of 14%.

Rapid production line for annealed high-strength strip steel Referring to FIGS. 72 to 74 which show Examples 1 to 3 of the present disclosure, in Examples 1 to 3, the rapid production line for annealed high-strength strip steel includes the following stations in sequence: uncoiling—welding—inlet looper—washing—central continuous post-processing—temper rolling—outlet looper—coiling.

The central continuous post-processing station includes in sequence a jet-radiation composite heating section, a radiant tube heating section, a transverse magnetic induction heating section, a radiant tube soaking section, a slow cooling section, a rapid cooling section (a high hydrogen cooling section, or a mist cooling section, or a water quenching cooling section), a reheating section, an overaging section, a final gas jet cooling section, and a final water cooling section.

In the jet-radiation composite heating section, a radiant tube is installed inside a high-speed gas jet heating bellows to rapidly transfer the heat generated by the combustion gas of the radiant tube to the strip steel through both high-speed gas jet and radiation, thereby enabling rapid heating of the strip steel.

The transverse magnetic induction heating section is used to further increase the temperature of the high-temperature strip steel quickly.

In this production line, a combination of a jet-radiation composite heating section+a transverse magnetic induction heating section is utilized together with a rapid cooling means selected from a high hydrogen cooling section or a mist cooling section or a water quenching cooling section to carry out rapid heating and rapid cooling treatments, thereby enabling continuous production of the ultra-high-strength strip steel.

Referring to FIG. 75 which shows Example 4 of the present disclosure, in Example 4, the rapid production line for annealed high-strength strip steel includes the following stations in sequence: uncoiling—welding—inlet looper—washing—central continuous post-processing—temper rolling—outlet looper—coiling.

The central continuous post-processing station includes in sequence a jet-radiation composite heating section, a radiant tube heating section, a transverse magnetic induction heating section, a radiant tube soaking section, a slow cooling section, a rapid cooling section (a high hydrogen cooling section and a mist cooling section), a reheating section, an overaging section, a final gas jet cooling section, and a final water cooling section.

In the jet-radiation composite heating section, a radiant tube is installed inside a high-speed high-temperature gas jet heating bellows to rapidly transfer the heat generated by the combustion gas of the radiant tube to the strip steel through both high-speed high-temperature gas jet and radiation, thereby enabling rapid heating of the strip steel.

The transverse magnetic induction heating section is used to further increase the temperature of the high-temperature strip steel quickly.

The high hydrogen cooling section and the mist cooling section are provided in parallel, so that the strip steel may pass through the high hydrogen cooling section for high hydrogen cooling, or may pass through the mist cooling section for mist cooling.

In this production line, a jet-radiation composite heating section, a high hydrogen cooling section and a mist cooling section are used concurrently to carry out rapid heating and selectable rapid cooling treatment, thereby enabling continuous production of the ultra-high-strength strip steel.

Referring to FIG. 76 which shows Example 5 of the present disclosure, in Example 5, the rapid production line for annealed high-strength strip steel includes the following stations in sequence: uncoiling—welding—inlet looper—washing—central continuous post-processing—temper rolling—outlet looper—coiling.

The central continuous post-processing station includes in sequence a jet-radiation composite heating section, a radiant tube heating section, a transverse magnetic induction heating section, a radiant tube soaking section, a slow cooling section, a rapid cooling section (a high hydrogen cooling section and a water quenching cooling section), a reheating section, an overaging section, a final gas jet cooling section, and a final water cooling section.

In the jet-radiation composite heating section, a radiant tube is installed inside a high-speed gas jet bellows to rapidly transfer the heat generated by the combustion gas of the radiant tube to the strip steel through both high-speed high-temperature gas jet and radiation, thereby enabling rapid heating of the strip steel.

The transverse magnetic induction heating section is used to further increase the temperature of the high-temperature strip steel quickly.

The high hydrogen cooling section and the water quenching cooling section are provided in parallel, so that the strip steel may pass through the high hydrogen cooling section for high hydrogen cooling, or may pass through the water quenching cooling section for water quenching cooling.

In this production line, a jet-radiation composite heating section, a high hydrogen cooling section and a water quenching cooling section are used concurrently to carry out rapid heating and selectable rapid cooling treatment, thereby enabling continuous production of the ultra-high-strength strip steel.

Referring to FIG. 77 which shows Example 6 of the present disclosure, in Example 6, the rapid production line for annealed strip steel includes the following stations in sequence: uncoiling—welding—inlet looper—washing—central continuous post-processing—temper rolling—outlet looper—coiling.

The central continuous post-processing station includes in sequence a jet-radiation composite heating section, a radiant tube heating section, a transverse magnetic induction heating section, a radiant tube soaking section, a slow cooling section, a rapid cooling section (a mist cooling section and a water quenching cooling section), a reheating section, an overaging section, a final gas jet cooling section, and a final water cooling section.

In the jet-radiation composite heating section, a radiant tube is installed inside a high-speed gas jet bellows to rapidly transfer the heat generated by the combustion gas of the radiant tube to the strip steel through both high-speed high-temperature gas jet and radiation, thereby enabling rapid heating of the strip steel.

The transverse magnetic induction heating section is used to further increase the temperature of the high-temperature strip steel quickly.

The mist cooling section and the water quenching cooling section are provided in parallel, and a connecting channel is provided between the mist cooling section and the water quenching cooling section, so that the strip steel may be subjected to mist cooling followed by water quenching cooling, or may be subjected to mist cooling only or water quenching cooling only.

In this production line, a jet-radiation composite heating section, a transverse magnetic induction heating section, a mist cooling section and a water quenching cooling section are used concurrently to carry out rapid heating and selectable rapid cooling treatment, thereby enabling continuous production of the ultra-high-strength strip steel.

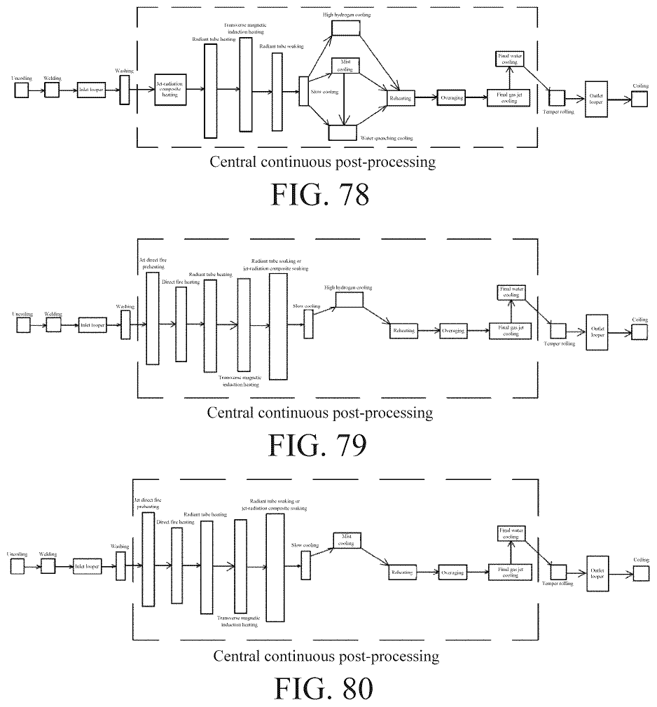

Referring to FIG. 78 which shows Example 7 of the present disclosure, in Example 7, the rapid production line for annealed high-strength strip steel includes the following stations in sequence: uncoiling—welding—inlet looper—washing—central continuous post-processing—temper rolling—outlet looper—coiling.

The central continuous post-processing station includes in sequence a jet-radiation composite heating section, a radiant tube heating section, a transverse magnetic induction heating section, a radiant tube soaking section, a slow cooling section, a rapid cooling section (a high hydrogen cooling section and a mist cooling section and a water quenching cooling section), a reheating section, an overaging section, a final gas jet cooling section, and a final water cooling section.

In the jet-radiation composite heating section, a radiant tube is installed inside a high-speed gas jet bellows to rapidly transfer the heat generated by the combustion gas of the radiant tube to the strip steel through both high-speed high-temperature gas jet and radiation, thereby enabling rapid heating of the strip steel.

The transverse magnetic induction heating section is used to further increase the temperature of the high-temperature strip steel quickly.

The high hydrogen cooling section, the mist cooling section and the water quenching cooling section are provided in parallel, and a connecting channel is provided between the mist cooling section and the water quenching cooling section.

The strip steel may be subjected to high hydrogen cooling only, or mist cooling only or water quenching cooling only, or may be subjected to mist cooling followed by water quenching cooling, so as to carry out the rapid cooling treatment.

In this production line, a jet-radiation composite heating section, a transverse magnetic induction heating section, a high hydrogen cooling section and (a mist cooling section+a water quenching cooling section) are used concurrently to carry out rapid heating and selectable rapid cooling treatment to enable continuous production of ultra-high-strength strip steel.

Preferably, the radiant tube soaking section is replaced with a jet-radiation composite heating device to soak the strip steel, so as to achieve rapid regulation of the soaking temperature of the strip steel when the working conditions change, such as changes in strip steel thickness specification, target temperature, unit speed, etc.

Preferably, a selectable pickling section is provided after the final water cooling section, and the strip steel may pass through the pickling section or bypass the pickling section.

Preferably, a selectable flash plating section is provided after the pickling section, and the strip steel may be flash plated with nickel or zinc after pickling, or the flash plating section may be skipped to directly produce a product with a pickled surface.

Preferably, a washing station is provided between the welding station and the inlet looper station. Further preferably, washing stations are provided before and after the inlet looper station. The strip steel is washed for the first time, introduced into the looper, then washed for the second time, and then introduced into the central continuous post-processing station.

Preferably, a finishing station is provided before the coiling station, and the strip steel is finished before coiling.

Preferably, an intermediate looper station is provided before the temper rolling station. After central continuous post-processing, the strip steel enters the central looper, and then enters the temper rolling, such that the working rolls of the temper rolling machine can be replaced without reducing the speed of the central continuous post-processing.

Preferably, a tension levelling station is further provided between the temper rolling station and the outlet looper station, and the strip steel may be subjected to tension levelling treatment before entering the outlet looper.

Preferably, a surface post-treatment station such as that for passivation or anti-fingerprint treatment is further provided between the temper rolling station and the outlet looper station, and the strip steel may be subjected to surface treatment such as passivation or anti-fingerprint treatment before entering the outlet looper.

Preferably, both a tension levelling station and a surface post-treatment station such as that for passivation or anti-fingerprint treatment are further provided between the temper rolling station and the outlet looper station, and the strip steel may be subjected to tension levelling and/or surface post-treatment such as passivation or anti-fingerprint treatment before entering the outlet looper.

Referring to FIG. 72, a high-strength strip steel was produced using the production line of Example 1. A strip steel with the main chemical composition (mass %) of the substrate being 0.10% C-0.18% Si-1.96% Mn was uncoiled, welded, passed through an inlet looper, and washed. The strip steel was then heated to 600° C. by jet-radiation composite heating, then heated to 810° C. by radiant tube heating, then heated to 920° C. by transverse magnetic induction heating, then soaked at 920° C. by radiant tube soaking for 40 seconds, then slowly cooled to 670° C., and then cooled to about 250° C. by high hydrogen jet cooling. Then, the strip steel entered an overaging section (the reheating didn't need to be activated) for overaging treatment. Finally, it was cooled by gas jet cooling to about 140° C., and then cooled by final water cooling to room temperature. After temper rolling, it passed through an outlet looper, and was coiled to complete the production. The final strip steel product had a yield strength of 519 MPa, a tensile strength of 955 MPa, and an elongation at break of 20%.

Referring to FIG. 73, a high-strength strip steel was produced based on the production line of Example 2, wherein a pickling section was provided after the final water cooling section. A strip steel with the main chemical composition (mass %) of the substrate being 0.06% C-0.010% Si-0.90% Mn was uncoiled, welded, passed through an inlet looper, and washed. The strip steel was then heated to 500° C. by jet-radiation composite heating, then heated to 710° C. by radiant tube heating, then heated to 810° C. by transverse magnetic induction heating, then soaked at 810° C. by radiant tube soaking for 60 seconds, then slowly cooled to 675° C., then cooled to about 500° C. by mist cooling, and then cooled to room temperature by water quenching. Subsequently, the strip steel was reheated to 230° C., and then subjected to overaging treatment. Finally, it was cooled by gas jet cooling to about 140° C., and then cooled by final water cooling to room temperature. Subsequently, it was pickled. After pickling, it was temper rolled, passed through an outlet looper, and was coiled to complete the production. The final strip steel product had a yield strength of 585 MPa, a tensile strength of 696 MPa, and an elongation at break of 13%.

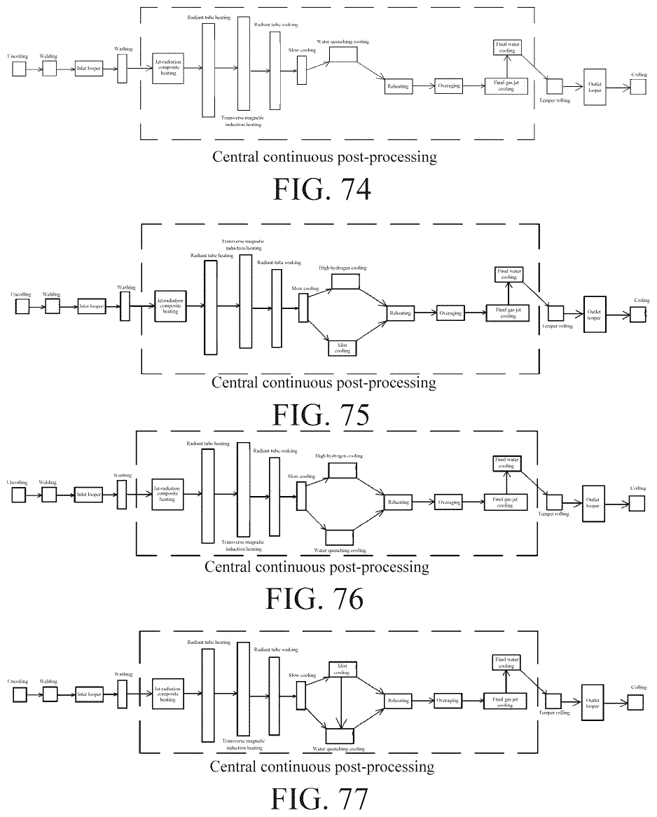

Referring to FIG. 74, an ultra-high-strength strip steel was produced based on the production line of Example 3, wherein a pickling section, a flash plating section were provided after the final water cooling section. A strip steel with the main chemical composition (mass %) of the substrate being 0.11% C-0.23% Si-2.38% Mn was uncoiled, welded, passed through an inlet looper, and washed. The strip steel was then heated to 565° C. by jet-radiation composite heating, then heated to 730° C. by radiant tube heating, then heated to 830° C. by transverse magnetic induction heating, then soaked at 830° C. by radiant tube soaking for 60 seconds, then slowly cooled to 700° C., then cooled to about 50° C. by water quenching cooling. Subsequently, the strip steel was reheated to 230° C., and then subjected to overaging treatment. Finally, it was cooled by gas jet cooling to about 140° C., and then cooled by final water cooling to room temperature. Subsequently, it was pickled, and then flash plated with nickel. Finally, it was temper rolled, passed through an outlet looper, and was coiled to complete the production. The final strip steel product had a yield strength of 1093 MPa, a tensile strength of 1359 MPa, and an elongation at break of 5%.

### Rapid Production Line for Annealed Ultra-High-Strength Strip Steel

Referring to FIG. 79 which shows Example 1 of the present disclosure, the rapid production line for annealed ultra-high-strength strip steel includes the following stations in sequence: uncoiling—welding—inlet looper—washing—central continuous post-processing—temper rolling—outlet looper—coiling, wherein
the central continuous post-processing station includes in sequence a jet direct fire preheating section, a direct fire heating section, a radiant tube heating section, a transverse magnetic induction heating section, a soaking section, a slow cooling section, a fast cooling section, a reheating section, an overaging section, a final gas jet cooling section and a final water cooling section;
a radiant tube soaking section or a jet-radiation composite soaking section is used for the soaking section;
a high hydrogen cooling section is used for the rapid cooling section;

In this production line, a jet direct fire preheating section, a transverse magnetic induction heating section and a high hydrogen cooling section are used to carry out rapid heating and rapid cooling treatments, thereby enabling continuous production of ultra-high-strength strip steel.

Referring to FIG. 80 which shows Example 2 of the present disclosure, in Example 2, the rapid production line for annealed ultra-high-strength strip steel includes the following stations in sequence: uncoiling—welding—inlet looper—washing—central continuous post-processing—temper rolling—outlet looper—coiling; wherein
the central continuous post-processing station includes in sequence a jet direct fire preheating section, a direct fire heating section, a radiant tube heating section, a soaking section, a slow cooling section, a fast cooling section, a reheating section, an overaging section, a final gas jet cooling section and a final water cooling section;
a radiant tube soaking section or a jet-radiation composite soaking section is used for the soaking section;
a mist cooling section is used for the rapid cooling section.

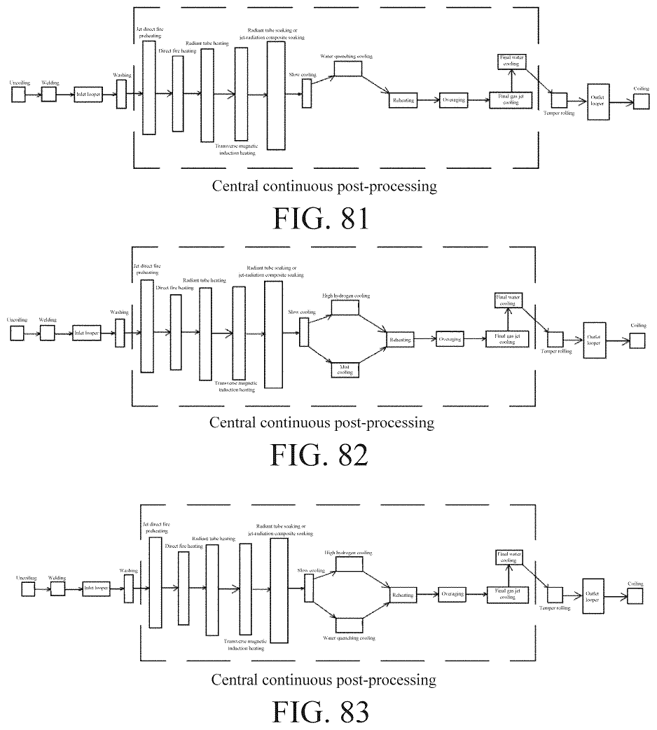

Referring to FIG. 81 which shows Example 3 of the present disclosure, in Example 3, the rapid production line for annealed ultra-high-strength strip steel includes the following stations in sequence: uncoiling—welding—inlet looper—washing—central continuous post-processing—temper rolling—outlet looper—coiling; wherein
the central continuous post-processing station includes in sequence a jet direct fire preheating section, a direct fire heating section, a radiant tube heating section, a soaking section, a slow cooling section, a fast cooling section, a reheating section, an overaging section, a final gas jet cooling section and a final water cooling section;
a radiant tube soaking section or a jet-radiation composite soaking section is used for the soaking section;
a water quenching cooling section is used for the rapid cooling section.

Referring to FIG. 82 which shows Example 4 of the present disclosure, in Example 4, the rapid production line for annealed ultra-high-strength strip steel includes the following stations in sequence: uncoiling—welding—inlet looper—washing—central continuous post-processing—temper rolling—outlet looper—coiling; wherein
the central continuous post-processing station includes in sequence a jet direct fire preheating section, a direct fire heating section, a radiant tube heating section, a soaking section, a slow cooling section, a fast cooling section, a reheating section, an overaging section, a final gas jet cooling section and a final water cooling section;
a radiant tube soaking section or a jet-radiation composite soaking section is used for the soaking section;

In the rapid cooling section, a high hydrogen cooling section and a mist cooling section are provided in parallel, so that the strip steel may pass through the high hydrogen cooling section for high hydrogen cooling, or may pass through the mist cooling section for mist cooling.

In this production line, a jet direct fire preheating section, a high hydrogen cooling section and a mist cooling section may be used concurrently to carry out rapid heating and selectable rapid cooling treatment, thereby enabling continuous production of ultra-high-strength strip steel.

Referring to FIG. 83 which shows Example 5 of the present disclosure, in Example 5, the rapid production line for annealed ultra-high-strength strip steel includes the following stations in sequence: uncoiling—welding—inlet looper—washing—central continuous post-processing—temper rolling—outlet looper—coiling; wherein
the central continuous post-processing station includes in sequence a jet direct fire preheating section, a direct fire heating section, a radiant tube heating section, a soaking section, a slow cooling section, a fast cooling section, a reheating section, an overaging section, a final gas jet cooling section and a final water cooling section;
a radiant tube soaking section or a jet-radiation composite soaking section is used for the soaking section;

In the rapid cooling section, a high hydrogen cooling section and a water quenching cooling section are provided in parallel, so that the strip steel may pass through the high hydrogen cooling section for high hydrogen cooling, or may pass through the water quenching cooling section for water quenching cooling.

In this production line, a jet direct fire preheating section, a high hydrogen cooling section and a water quenching cooling section are used concurrently to carry out rapid heating and selectable rapid cooling treatment, thereby enabling continuous production of ultra-high-strength strip steel.

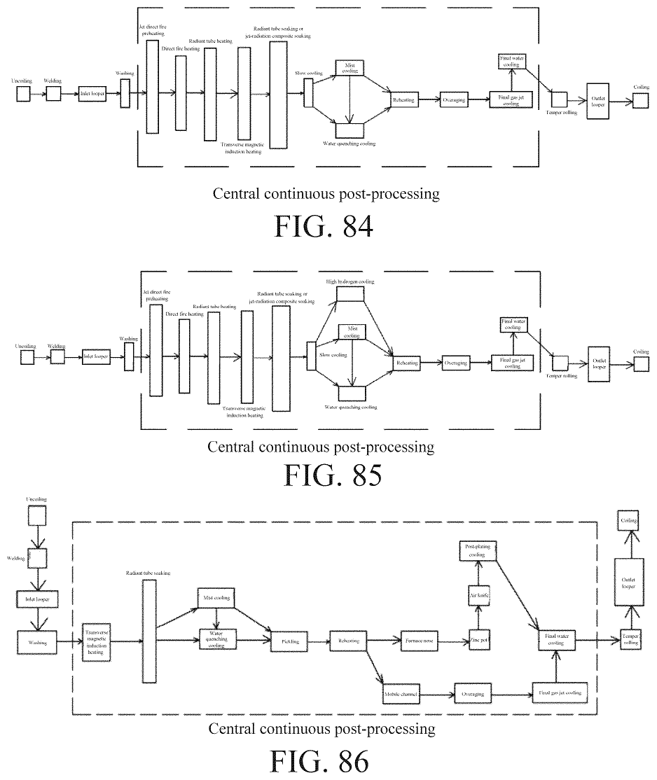

Referring to FIG. 84 which shows Example 6 of the present disclosure, in Example 6, the rapid production line for annealed ultra-high-strength strip steel includes the following stations in sequence: uncoiling—welding—inlet looper—washing—central continuous post-processing—temper rolling—outlet looper—coiling; wherein
the central continuous post-processing station includes in sequence a jet direct fire preheating section, a direct fire heating section, a radiant tube heating section, a soaking section, a slow cooling section, a fast cooling section, a reheating section, an overaging section, a final gas jet cooling section and a final water cooling section;
a radiant tube soaking section or a jet-radiation composite soaking section is used for the soaking section;
in the rapid cooling section, a mist cooling section and a water quenching cooling section are provided in parallel, and a connecting channel is provided between the mist cooling section and the water quenching cooling section, thereby forming three rapid cooling modes in which the strip steel may pass through first the mist cooling section and then the water quenching cooling section, or pass through the mist cooling section only, or pass through the water quenching section only.

A mist cooling section and a water quenching cooling section are used for the rapid cooling section.

In this production line, a jet direct fire preheating section, a mist cooling section and a water quenching cooling section are used concurrently to carry out rapid heating and selectable rapid cooling treatment, thereby enabling continuous production of ultra-high-strength strip steel.

Referring to FIG. 85 which shows Example 7 of the present disclosure, in Example 7, the rapid production line for annealed ultra-high-strength strip steel includes the following stations in sequence: uncoiling—welding—inlet looper—washing—central continuous post-processing—temper rolling—outlet looper—coiling; wherein
the central continuous post-processing station includes in sequence a jet direct fire preheating section, a direct fire heating section, a radiant tube heating section, a soaking section, a slow cooling section, a fast cooling section, a reheating section, an overaging section, a final gas jet cooling section and a final water cooling section;
a radiant tube soaking section or a jet-radiation composite soaking section is used for the soaking section;
the rapid cooling section further includes a high hydrogen cooling section which is provided in parallel with a mist cooling section and a water quenching cooling section, and the mist cooling section and the water quenching cooling section are provided in series, thereby forming four rapid cooling modes, namely, only the high hydrogen cooling section, or only the mist cooling section, or only the water quenching cooling section, or the mist cooling section followed by the water quenching cooling section.

The strip steel may be subjected to mist cooling followed by water quenching cooling, or may be subjected to mist cooling only or water quenching cooling only; and the high hydrogen cooling section is provided in parallel with (the mist cooling section+the water quenching cooling section), wherein the strip steel may pass through the high hydrogen cooling section, or may pass through the mist cooling section+the water quenching cooling section to carry out rapid cooling treatment.

In this production line, a jet-radiation direct fire preheating section, a high hydrogen cooling section and (a mist cooling section+a water quenching cooling section) are used concurrently to carry out rapid heating and selectable rapid cooling treatment to enable continuous production of ultra-high-strength strip steel.

### Example 1

A high-strength strip steel was prepared using the production line whose layout is shown in FIG. 2. After a strip steel was uncoiled, welded, passed through an inlet looper, and washed, it was preheated to 355° C. by jet direct fire preheating, then heated to 655° C. by direct fire heating, then heated to 810° C. by radiant tube heating, then heated to 910° C. by transverse magnetic induction heating, then soaked at 910° C. by jet-radiation composite soaking for 60 seconds, then slowly cooled to 700° C., then cooled to 320° C. by high hydrogen cooling, then overaged at 320° C. (the reheating didn't need to be activated), then cooled to about 140° C. by final gas jet cooling, and then cooled to room temperature by final water cooling. Then, after being temper rolled, it entered an outlet looper, and then it was coiled to complete the production.

### Example 2

A high-strength strip steel was prepared using the production line whose layout is shown in FIG. 3. After a strip steel with the main chemical composition (mass %) of the substrate being 0.10% C-0.23% Si-2.1% Mn was uncoiled, welded, passed through an inlet looper, and washed, it was preheated to 360° C. by jet direct fire preheating, then heated to 660° C. by direct fire heating, then heated to 830° C. by radiant tube heating, then heated to 930° C. by transverse magnetic induction heating, then soaked at 930° C. by radiant tube soaking for 50 seconds, then slowly cooled to 750° C., then cooled to 300° C. by mist cooling, then overaged at 280° C. (the reheating didn't need to be activated), then cooled to about 140° C. by final gas jet cooling, and then cooled to room temperature by final water cooling. Subsequently, it was pickled. Then, after being temper rolled, it entered an outlet looper, and then it was coiled to complete the production. The final strip steel product had a yield strength of 972 MPa, a tensile strength of 1196 MPa, and an elongation at break of 11%.

### Example 3

A high-strength strip steel was prepared using the production line whose layout is shown in FIG. 4. After a strip steel was uncoiled, welded, passed through an inlet looper, and washed, it was preheated to 375° C. by jet direct fire preheating, then heated to 635° C. by direct fire heating, then heated to 800° C. by radiant tube heating, then heated to 850° C. by transverse magnetic induction heating, then soaked at 850° C. by jet-radiation composite soaking for 70 seconds, then slowly cooled to 740° C., then cooled to about 50° C. by water quenching cooling, then reheated to 320° C., then overaged at 320° C., then cooled to about 140° C. by final gas jet cooling, and then cooled to room temperature by final water cooling. Then, after being temper rolled, it entered an outlet looper, and then it was coiled to complete the production.

### Example 4

A high-strength strip steel was prepared using the production line whose layout is shown in FIG. 5. After a strip steel with the main chemical composition (mass %) of the substrate being 0.09% C-0.013% Si-0.87% Mn was uncoiled, welded, passed through an inlet looper, and washed, it was preheated to 370° C. by jet direct fire preheating, then heated to 700° C. by direct fire heating, then heated to 800° C. by radiant tube heating, then heated to 850° C. by transverse magnetic induction heating, then soaked at 850° C. by jet-radiation composite soaking for 50 seconds, and then slowly cooled to 670° C. At this point, high hydrogen cooling or mist cooling may be chosen. In this Example, the strip steel was cooled to about 230° C. by high hydrogen jet cooling, and then entered an overaging section (the reheating didn't need to be activated) to carry out overaging. Then, it was cooled to about 140° C. by final gas jet cooling, and then cooled to room temperature by final water cooling. After being temper rolled, it entered an outlet looper, and then it was coiled to complete the production. The final strip steel product had a yield strength of 476 MPa, a tensile strength of 556 MPa, and an elongation at break of 24%.

### Example 5

A high-strength strip steel was prepared using the production line whose layout is shown in FIG. 6. After a strip steel was uncoiled, welded, passed through an inlet looper, and washed, it was preheated to 358° C. by jet direct fire preheating, then heated to 690° C. by direct fire heating, then heated to 790° C. by radiant tube heating, then heated to 890° C. by transverse magnetic induction heating, then soaked at 890° C. by jet-radiation composite soaking for 50 seconds, and then slowly cooled to 670° C. At this point, high hydrogen cooling or water quenching cooling may be chosen. In this Example, the strip steel was cooled to room temperature by water quenching cooling, then reheated to 280° C., and then entered an overaging section to carry out overaging at 280° C. Then, it was cooled to about 140° C. by final gas jet cooling, and then cooled to room temperature by final water cooling. Then, after being temper rolled, it entered an outlet looper, and then it was coiled to complete the production.

### Example 6

A high-strength strip steel was prepared using the production line whose layout is shown in FIG. 7. After a strip steel with the main chemical composition (mass %) of the substrate being 0.10% C-0.18% Si-2.0% Mn was uncoiled, welded, passed through an inlet looper, and washed, it was preheated to 365° C. by jet direct fire preheating, then heated to 665° C. by direct fire heating, then heated to 820° C. by radiant tube heating, then heated to 920° C. by transverse magnetic induction heating, then soaked at 920° C. by radiant tube soaking for 60 seconds, and then slowly cooled to 750° C. At this point, mist cooling or water quenching cooling or mist cooling followed by water quenching cooling may be chosen. In this Example, the strip steel was first cooled to 500° C. by mist cooling, and then cooled to about 50° C. by water quenching cooling. Then, it was reheated to 230° C. to carry out overaging. Then, it was cooled to about 140° C. by final gas jet cooling, and then cooled to room temperature by final water cooling. Then, it was temper rolled, and entered an outlet looper. Finally, it was coiled to complete the production. The final strip steel product had a yield strength of 956 MPa, a tensile strength of 1183 MPa, and an elongation at break of 13%.

### Example 7

A high-strength strip steel was prepared using the production line whose layout is shown in FIG. 8. After a strip steel was uncoiled, welded, passed through an inlet looper, and washed, it was preheated to 395° C. by jet direct fire preheating, then heated to 700° C. by direct fire heating, then heated to 800° C. by radiant tube heating, then heated to 890° C. by transverse magnetic induction heating, then soaked at 890° C. by jet-radiation composite soaking for 60 seconds, and then slowly cooled to 750° C. At this point, high hydrogen cooling or mist cooling or water quenching cooling or mist cooling followed by water quenching cooling may be chosen. In this Example, the strip steel was cooled to about 50° C. by mist cooling, and then reheated to 260° C. to carry out overaging. Then, it was cooled to about 140° C. by final gas jet cooling, and then cooled to room temperature by final water cooling. Then, it was temper rolled, and entered an outlet looper. Finally, it was coiled to complete the production.

### Ultra-Short-Process Production Line for Dual-Purpose Strip Steel

Referring to FIG. 86, the ultra-short-process production line for dual-purpose strip steel according to the present disclosure includes the following stations in sequence: uncoiling-welding—inlet looper—central continuous post-processing—temper rolling—outlet looper—coiling; wherein
the central continuous post-processing station includes in sequence a transverse magnetic induction heating section, a radiant tube soaking section, a mist cooling section and/or a water quenching cooling section, a pickling section, a reheating section, a parallel arrangement of (a furnace nose section+a zinc pot section+an air knife section+a post-plating cooling section) and (a mobile channel section+an overaging section+a final gas jet cooling section), and a final water cooling section.

Transverse magnetic induction heating is selected for rapid heating of the strip steel, and mist cooling and/or water quenching cooling is selected for rapid cooling, thereby enabling such a rapid heat treatment process of rapid heating and rapid cooling for the strip steel.

As for the mist cooling section and/or the water quenching cooling section, the strip steel may be subjected to mist cooling, or water quenching cooling, or mist cooling followed by water quenching cooling.

With the parallel arrangement of (a furnace nose section+a zinc pot section+an air knife section+a post-plating cooling section) and (a mobile channel section+an overaging section+a final gas jet cooling section), the strip steel may go through the furnace nose section+zinc pot section+air knife section+post-plating cooling section, that is, taking a hot-dip galvanizing process path to produce a pure zinc hot-dip galvanized product; alternatively, it may go through the mobile channel section+the overaging section+the final gas jet cooling section, that is, taking a continuous annealing process path to produce a continuously annealed product.

The mobile channel section is provided in parallel with the furnace nose section, and the mobile channel section may be movably switched to an online position, or movably switched to an offline position. The switching between the continuous annealing process path and the pure zinc hot-dip galvanizing process path is achieved by cutting the strip steel and reloading the strip steel.

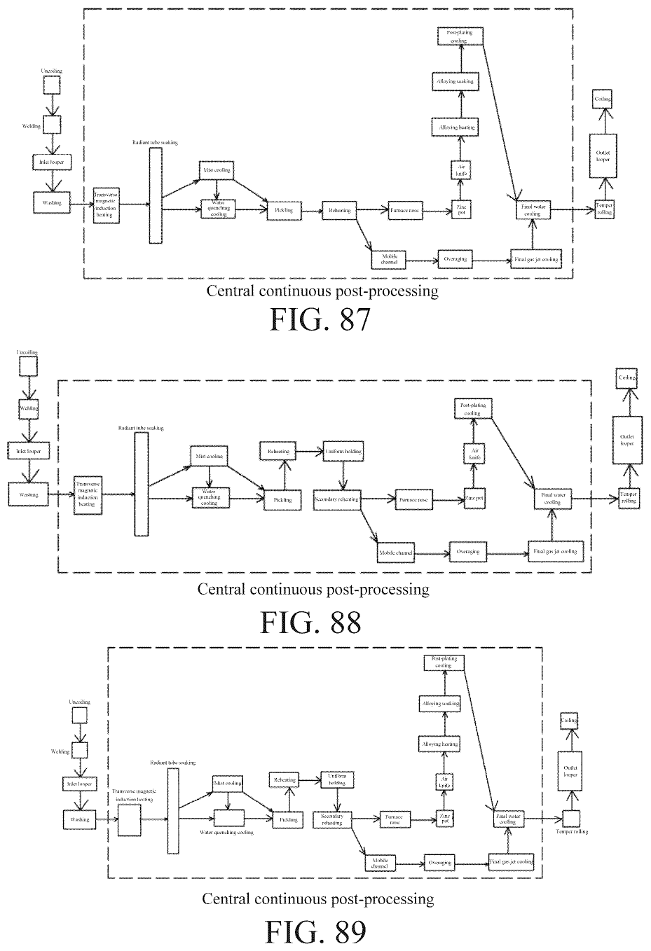

Referring to FIG. 87 which shows Example 2 of the present disclosure, in Example 2, the ultra-short-process production line for dual-purpose strip steel according to the present disclosure includes the following stations in sequence: uncoiling—welding—inlet looper—central continuous post-processing—temper rolling—outlet looper—coiling; wherein
the central continuous post-processing station includes in sequence a transverse magnetic induction heating section, a radiant tube soaking section, a mist cooling section and/or a water quenching cooling section, a pickling section, a reheating section, a parallel arrangement of (a furnace nose section+a zinc pot section+an air knife section+an alloying heating section+an alloying soaking section+a post-plating cooling section) and (a mobile channel section+an overaging section+a final gas jet cooling section), and a final water cooling section.

Transverse magnetic induction heating is selected for rapid heating of the strip steel, and mist cooling and/or water quenching cooling is selected for rapid cooling, thereby enabling such a rapid heat treatment process of rapid heating and rapid cooling for the strip steel.

As for the mist cooling section and/or the water quenching cooling section, the strip steel may be subjected to mist cooling, or water quenching cooling, or mist cooling followed by water quenching cooling.

With the parallel arrangement of (a furnace nose section+a zinc pot section+an air knife section+an alloying heating section+an alloying soaking section+a post-plating cooling section) and (a mobile channel section+an overaging section+a final gas jet cooling section) designed according to the present disclosure, the strip steel may go through the furnace nose section+zinc pot section+air knife section+alloying heating section+alloying soaking section+post-plating cooling section, that is, taking a hot-dip galvannealing process path to produce a hot-dip galvannealed product. When the alloying heating section+alloying soaking section is not started for operation, the strip steel passes through these process sections with no action on it, and thus a pure zinc hot-dip galvanized product will be produced. The strip steel may also go through the mobile channel section+the overaging section+the final gas jet cooling section, that is, taking a continuous annealing process path to produce a continuously annealed product.

The mobile channel section is designed in parallel with the furnace nose section. The mobile channel section may be movably switched to an online position, or movably switched to an offline position. The continuous annealing process path and the hot-dip galvanizing process path can be switched by cutting the strip steel and reloading the strip steel.

Referring to FIG. 88 which shows Example 3 of the present disclosure, in Example 3, the ultra-short-process production line for dual-purpose strip steel according to the present disclosure includes the following stations in sequence: uncoiling—welding—inlet looper—central continuous post-processing—temper rolling—outlet looper—coiling; wherein
the central continuous post-processing station includes in sequence a transverse magnetic induction heating section, a radiant tube soaking section, a mist cooling section or/and a water quenching cooling section, a pickling section, a reheating section, a uniform holding section, a secondary reheating section, a parallel arrangement of (a furnace nose section+a zinc pot section+an air knife section+a post-plating cooling section) and (a mobile channel section+an overaging section+a final gas jet cooling section), and a final water cooling section.

Transverse magnetic induction heating is selected for rapid heating of the strip steel, and mist cooling and/or water quenching cooling is selected for rapid cooling, thereby enabling such a rapid heat treatment process of rapid heating and rapid cooling for the strip steel.

According to the design of the present disclosure, a uniform holding section+a secondary reheating section is utilized, which can realize a secondary reheating process for high-strength steel such as QP steel.

As for the mist cooling section and/or the water quenching cooling section, the strip steel may be subjected to mist cooling, or water quenching cooling, or mist cooling followed by water quenching cooling.

With the parallel arrangement of (a furnace nose section+a zinc pot section+an air knife section+a post-plating cooling section) and (a mobile channel section+an overaging section+a final gas jet cooling section) designed according to the design of the present disclosure, the strip steel may go through the furnace nose section+zinc pot section+air knife section+post-plating cooling section, that is, taking a hot-dip galvanizing process path to produce a pure zinc hot-dip galvanized product; alternatively, it may go through the mobile channel section+the overaging section+the final gas jet cooling section, that is, taking a continuous annealing process path to produce a continuously annealed product.

The mobile channel section is designed in parallel with the furnace nose section, and the mobile channel section may be movably switched to an online position, or movably switched to an offline position. The switching between the continuous annealing process path and the pure zinc hot-dip galvanizing process path is achieved by cutting the strip steel and reloading the strip steel.

Referring to FIG. 89 which shows Example 4 of the present disclosure, in Example 4, the ultra-short-process production line for dual-purpose strip steel according to the present disclosure includes the following stations in sequence: uncoiling—welding—inlet looper—central continuous post-processing—temper rolling—outlet looper—coiling; wherein
the central continuous post-processing station includes in sequence a transverse magnetic induction heating section, a radiant tube soaking section, a mist cooling section and/or a water quenching cooling section, a pickling section, a reheating section, a uniform holding section, a secondary reheating section, a parallel arrangement of (a furnace nose section+a zinc pot section+an air knife section+an alloying heating section+an alloying soaking section+a post-plating cooling section) and (a mobile channel section+an overaging section+a final gas jet cooling section), and a final water cooling section.

Transverse magnetic induction heating is selected for rapid heating of the strip steel, and mist cooling and/or water quenching cooling is selected for rapid cooling, thereby enabling such a rapid heat treatment process of rapid heating and rapid cooling for the strip steel.

According to the design of the present disclosure, a uniform holding section+a secondary reheating section is utilized, which can realize a secondary reheating process for high-strength steel such as QP steel. The design is also characterized by the mist cooling section and/or water quenching cooling section, wherein the strip steel may be subjected to mist cooling, or water quenching cooling, or mist cooling followed by water quenching cooling.

With the parallel arrangement of (a furnace nose section+a zinc pot section+an air knife section+an alloying heating section+an alloying soaking section+a post-plating cooling section) and (a mobile channel section+an overaging section+a final gas jet cooling section) designed according to the present disclosure, the strip steel may go through the furnace nose section+zinc pot section+air knife section+alloying heating section+alloying soaking section+post-plating cooling section, that is, taking a hot-dip galvannealing process path to produce a hot-dip galvannealed product. When the alloying heating section+alloying soaking section is not started for operation, the strip steel passes through these process sections with no action on it, and thus a pure zinc hot-dip galvanized product will be produced. The strip steel may also go through the mobile channel section+the overaging section+the final gas jet cooling section, that is, taking a continuous annealing process path to produce a continuously annealed product.

The mobile channel section is designed in parallel with the furnace nose section, and the mobile channel section may be movably switched to an online position, or movably switched to an offline position. The switching between the continuous annealing process path and the pure zinc hot-dip galvanizing process path is achieved by cutting the strip steel and reloading the strip steel.

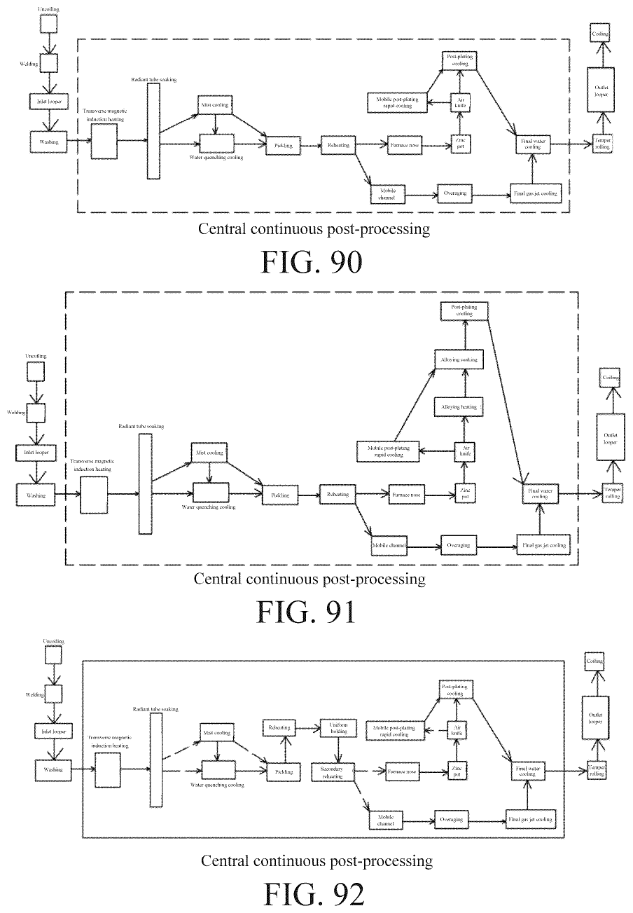

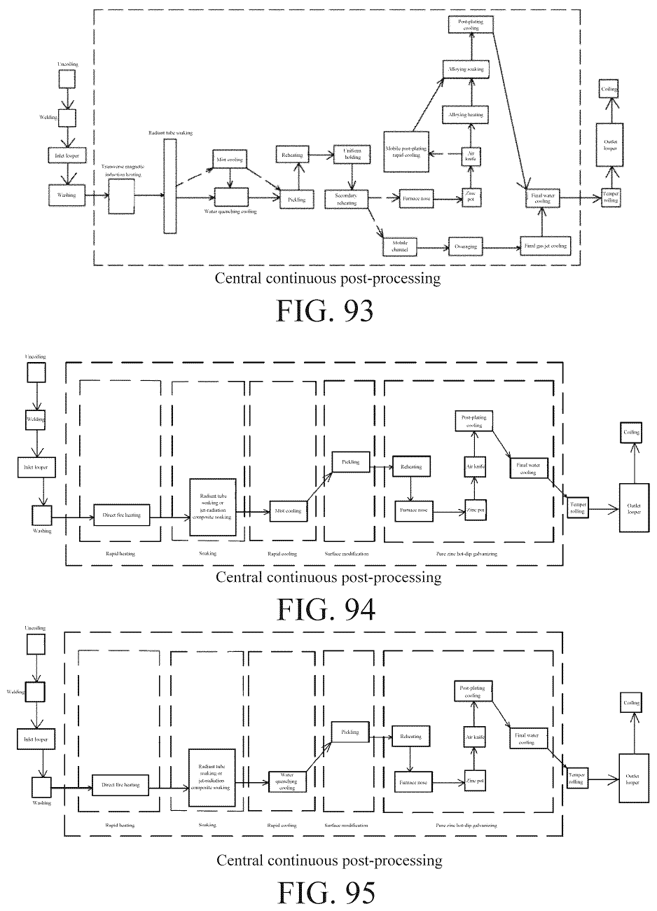

Referring to FIGS. 90 to 93 which show Examples 5 to 8 of the present disclosure, in Examples 5 to 8, a mobile post-plating rapid cooling section is further provided after the air knife section according to the present disclosure. The mobile post-plating rapid cooling section is configured to be switchable between online and offline, and is provided in parallel with the alloying heating section (designed to be mobile, convenient for maintenance). When producing a pure zinc hot-dip galvanized product, the mobile post-plating rapid cooling section is online to quickly cool the galvanized strip steel, and the alloying heating section is offline at this time; when producing a hot-dip galvannealed product, the mobile post-plating rapid cooling section is offline, and the alloying heating section is online to implement alloying heating of the strip steel.

Preferably, a selectable washing station is provided between the welding station and the inlet looper station, and the strip steel may be washed by passing through the washing station, or may bypass the washing station.

Preferably, the washing station is provided after the inlet looper station, and the strip steel may be washed by passing through the washing station, or may bypass the washing station.

Preferably, washing stations are provided before and after the inlet looper station to perform secondary washing on the strip steel to further improve the surface quality of the strip steel.

Preferably, a longitudinal magnetic induction heating section is further provided before the transverse magnetic induction heating section. The strip steel may be subjected to longitudinal magnetic induction heating by passing through the longitudinal magnetic induction heating section; alternatively, it may pass through the longitudinal magnetic induction heating section without being heated and directly enter the transverse magnetic induction heating section to be heated.

Preferably, an iron or nickel flash plating station is provided after the pickling section, and the pickled strip steel may be flash plated with iron or nickel to improve the platability of the strip steel.

Preferably, a finishing station is provided before the coiling station, and the strip steel is finished before coiling.

Preferably, an intermediate looper station is further provided before the temper rolling station to ensure that the quality of the strip steel is not lost when the working rolls of the temper rolling machine are replaced online.

Preferably, a tension levelling station is provided between the temper rolling station and the outlet looper station, and the strip steel may enter the outlet looper after tension levelling.

Preferably, a surface post-treatment station such as that for passivation or anti-fingerprint treatment is provided between the temper rolling station and the outlet looper station, and the strip steel may be subjected to surface post-treatment such as passivation or anti-fingerprint treatment before entering the outlet looper.

Preferably, both a tension levelling station and a corresponding surface post-treatment station such as that for passivation or anti-fingerprint treatment are provided between the temper rolling station and the outlet looper station. The strip steel may be subjected to surface post-treatment such as passivation or anti-fingerprint treatment before entering the outlet looper.

### Example 1

A strip steel with the main chemical composition (mass %) of the substrate being 0.10% C-0.07% Si-1.908% Mn was uncoiled and welded. The strip steel was then heated to 810° C. by transverse magnetic induction heating, then cooled to 230° C. by mist cooling, then cooled naturally, then pickled, and then reheated to 220° C. for overaging. Then, it was cooled to about 140° C. by final gas jet cooling, and then cooled to room temperature by final water cooling. Then, it was temper rolled and coiled to complete the production. The final strip steel product had a yield strength of 720 MPa, a tensile strength of 998 MPa, and an elongation at break of 8%.

### Example 2

A strip steel with the main chemical composition (mass %) of the substrate being 0.05% C-0.23% Si-1.35% Mn was uncoiled and welded. The strip steel was then heated to 800° C. by transverse magnetic induction heating, then soaked at 800° C. by radiant tube soaking for 30 seconds, then cooled to 650° C. by mist cooling, then cooled to room temperature by water quenching cooling, then pickled, and then reheated to 460° C. for hot-dip galvanizing. After the coating weight was controlled by an air knife, it was heated to 500° C. by alloying heating. After soaking at 500° C. by alloying soaking for 20 seconds, it was subjected to post-plating cooling. Then, it was cooled to room temperature by final water cooling. Then, it was temper rolled and coiled to complete the production. The final strip steel product had a yield strength of 582 MPa, a tensile strength of 809 MPa, and an elongation at break of 15%.

### Example 3

A strip steel with the main chemical composition (mass %) of the substrate being 0.18% C-1.65% Si-2.1% Mn was uncoiled and welded. The strip steel was then heated to 846° C. by transverse magnetic induction heating, then soaked at 845° C. for 60 seconds, then cooled to 700° C. by mist cooling, then cooled to room temperature by water quenching cooling, then pickled, then reheated to 400° C. for uniform holding, and then reheated to 455° C. for hot-dip galvanizing. After the coating weight was controlled by an air knife, it was subjected to post-plating cooling. Then, it was cooled to room temperature by final water cooling. Then, it was temper rolled and coiled to complete the production. The final strip steel product had a yield strength of 742 MPa, a tensile strength of 1108 MPa, and an elongation at break of 13%.

Under the current situation that the market demand for ultra-high-strength steel is increasing year by year and CO₂ and NOx emissions are increasingly strictly restricted, the present disclosure has very broad application prospects, especially in urban steel mills in which the promotion and application prospects are even broader.

### Ultra-Short-Process Production Line for Pure Zinc Hot-Dip Galvanized High-Strength Strip Steel

Referring to FIG. 94 which shows Example 1 of the present disclosure, in Example 1, the ultra-short-process production line for pure zinc hot-dip galvanized high-strength strip steel according to the present disclosure includes the following stations in sequence: uncoiling-welding—inlet looper—central continuous post-processing—outlet looper—temper rolling-coiling.

The central continuous post-processing station includes in sequence a rapid heating station, a soaking station, a rapid cooling station, a surface modification station and a pure zinc hot-dip galvanizing station.

A direct fire heating device is used for the rapid heating station.

A radiant tube soaking device or a jet-radiation composite soaking device is used for the soaking station.

A mist cooling device is used for the rapid cooling station.

A pickling device is used for the surface modification station.

The pure zinc hot-dip galvanizing station is provided with a reheating section, a furnace nose section, a zinc pot section, an air knife section, a post-plating cooling section and a final water cooling section in sequence.

Thus, both a direct fire heating device and a mist cooling device are used in this production line for rapid heating and rapid cooling treatments, and a pickling device is used for surface modification, so as to improve the platability of the ultra-high-strength steel and enable continuous production of the hot-dip galvanized ultra-high-strength strip steel.

Referring to FIG. 95 which shows Example 2 of the present disclosure, in Example 2, the ultra-short-process production line for pure zinc hot-dip galvanized high-strength strip steel according to the present disclosure includes the following stations in sequence: uncoiling—welding—inlet looper—central continuous post-processing—outlet looper—temper rolling—coiling.

The central continuous post-processing station includes in sequence a rapid heating station, a soaking station, a rapid cooling station, a surface modification station and a pure zinc hot-dip galvanizing station.

A direct fire heating device is used for the rapid heating station.

A radiant tube soaking device or a jet-radiation composite soaking device is used for the soaking station.

A water quenching cooling device is used for the rapid cooling station.

A pickling device is used for the surface modification station.

The pure zinc hot-dip galvanizing station is provided with a reheating section, a furnace nose section, a zinc pot section, an air knife section, a post-plating cooling section and a final water cooling section in sequence.

Thus, both a direct fire heating device and a water quenching cooling device are used in this production line for rapid heating and rapid cooling treatments, and a pickling device is used for surface modification, so as to improve the platability of the ultra-high-strength steel and enable continuous production of the hot-dip galvanized ultra-high-strength strip steel.

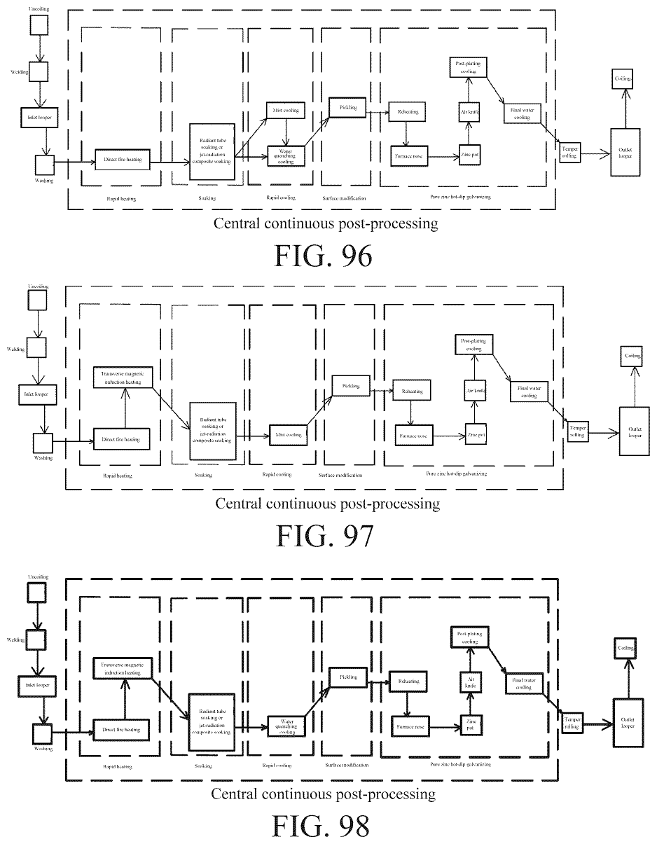

Referring to FIG. 96 which shows Example 3 of the present disclosure, in Example 3, the ultra-short-process production line for pure zinc hot-dip galvanized high-strength strip steel according to the present disclosure includes the following stations in sequence: uncoiling—welding—inlet looper—central continuous post-processing—outlet looper—temper rolling—coiling.

The central continuous post-processing station includes in sequence a rapid heating station, a soaking station, a rapid cooling station, a surface modification station and a pure zinc hot-dip galvanizing station.

A direct fire heating device is used for the rapid heating station.

A radiant tube soaking device or a jet-radiation composite soaking device is used for the soaking station.

The rapid cooling station includes both a mist cooling device and a water quenching cooling device.

A pickling device is used for the surface modification station.

The pure zinc hot-dip galvanizing station is provided with a reheating section, a furnace nose section, a zinc pot section, an air knife section, a post-plating cooling section and a final water cooling section in sequence. In the rapid cooling station, the strip steel may be subjected to water quenching cooling treatment directly, or may be subjected to mist cooling followed by water quenching cooling treatment.

Thus, both a direct fire heating device and a mist cooling device+a water quenching cooling device are used in this production line for rapid heating and rapid cooling treatments, and a pickling device is used for surface modification, so as to improve the platability of the ultra-high-strength steel and enable continuous production of the hot-dip galvanized ultra-high-strength strip steel.

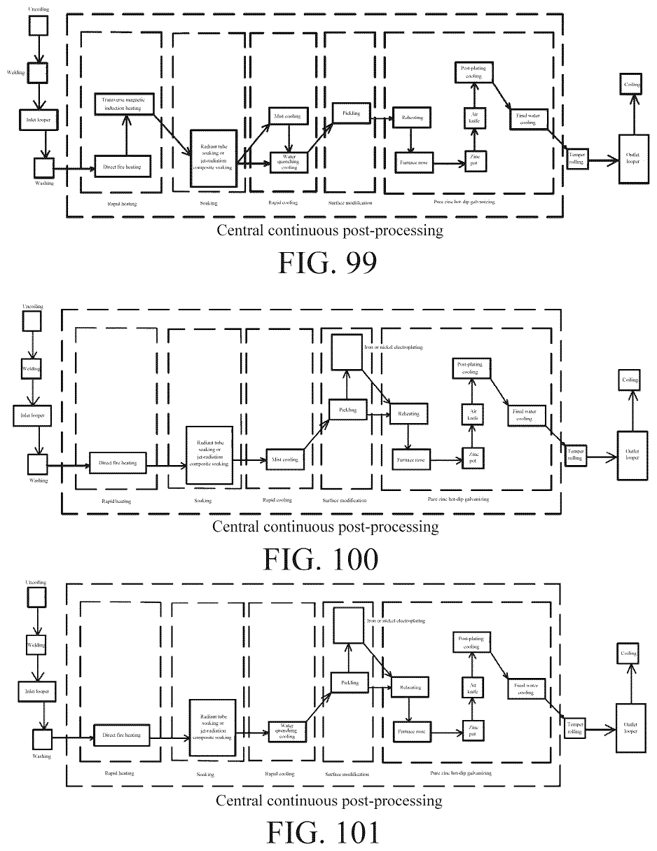

Referring to FIGS. 97 to 99 which show Examples 4 to 6 of the present disclosure, in Examples 4 to 6, a direct fire heating device and a transverse magnetic induction heating device provided in series are used for the rapid heating station. In the rapid heating station, the strip steel is subjected to direct fire heating followed by transverse magnetic induction heating to complete the rapid heating process, and then subsequent processing is carried out.

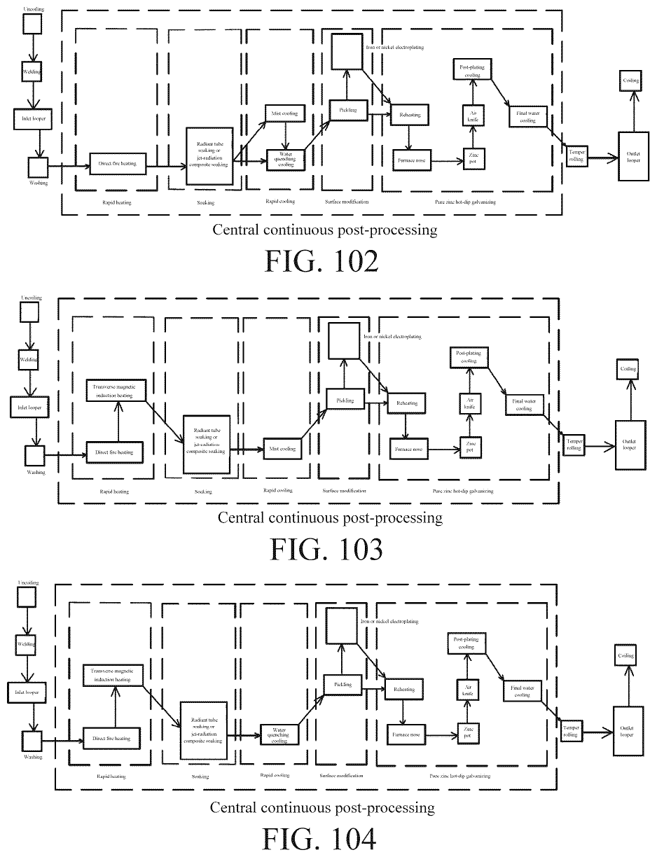

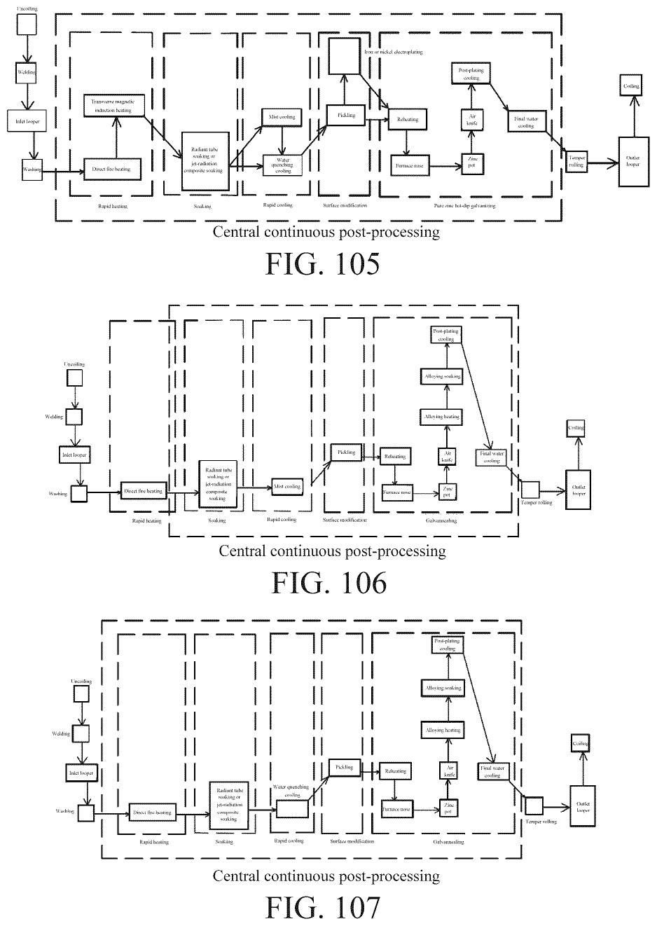

Referring to FIGS. 100 to 105 which show Examples 7 to 12 of the present disclosure, in Examples 7 to 12, in the surface modification station, an iron electroplating or nickel flash plating device is further provided after the pickling section. After the strip steel is pickled, a layer of iron or nickel may be flash plated on the surface of the strip steel, and then subsequent hot-dip galvanizing may be performed.

Referring to FIG. 106 which shows Example 13 of the present disclosure, in Example 13, the ultra-short-process production line for hot-dip galvannealed ultra-high-strength strip steel according to the present disclosure includes the following stations in sequence: uncoiling—welding—inlet looper—central continuous post-processing—outlet looper—temper rolling—coiling.

The central continuous post-processing station includes in sequence a rapid heating station, a soaking station, a rapid cooling station, a surface modification station and a hot-dip galvannealing station.

A direct fire heating device is used for the rapid heating station.

A radiant tube soaking device or a jet-radiation composite soaking device is used for the soaking station.

A mist cooling device is used for the rapid cooling station.

A pickling device is used for the surface modification station.

The hot-dip galvannealing station is provided with a reheating section, a furnace nose section, a zinc pot section, an air knife section, an alloying heating section, an alloying soaking section, a post-plating cooling section and a final water cooling section in sequence.

Thus, both a direct fire heating device and a mist cooling device are used in this production line for rapid heating and rapid cooling treatments, and a pickling device is used to improve the platability of the ultra-high-strength steel, thereby enabling continuous production of the hot-dip galvannealed ultra-high-strength strip steel.

Referring to FIG. 107 which shows Example 14 of the present disclosure, in Example 14, the ultra-short-process production line for hot-dip galvannealed ultra-high-strength strip steel according to the present disclosure includes the following stations in sequence: uncoiling—welding—inlet looper—central continuous post-processing—outlet looper—temper rolling—coiling.

The central continuous post-processing station includes in sequence a rapid heating station, a soaking station, a rapid cooling station, a surface modification station and a hot-dip galvannealing station.

A direct fire heating section device is used for the rapid heating station.

A radiant tube soaking device or a jet-radiation composite soaking device is used for the soaking station.

A water quenching cooling device is used for the rapid cooling station.

A pickling device is used for the surface modification station.

The hot-dip galvannealing station is provided with a reheating section, a furnace nose section, a zinc pot section, an air knife section, an alloying heating section, an alloying soaking section, a post-plating cooling section and a final water cooling section in sequence.

Thus, both a direct fire heating section device and a water quenching cooling section device are used in this production line for rapid heating and rapid cooling treatments, and a pickling device is used to improve the platability of the ultra-high-strength steel, thereby enabling continuous production of the hot-dip galvannealed ultra-high-strength strip steel.

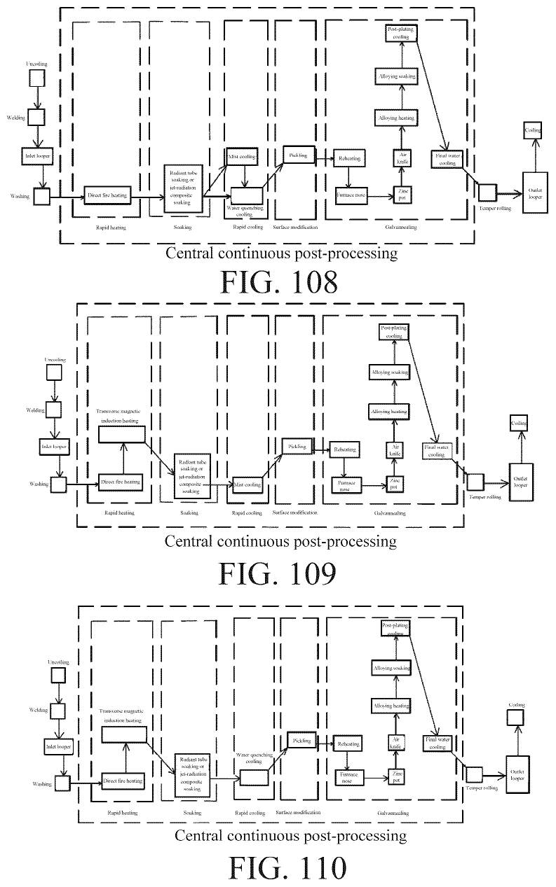

Referring to FIG. 108 which shows Example 15 of the present disclosure, in Example 15, the ultra-short-process production line for hot-dip galvannealed ultra-high-strength strip steel according to the present disclosure includes the following stations in sequence: uncoiling—welding—inlet looper—central continuous post-processing—outlet looper—temper rolling—coiling.

The central continuous post-processing station includes in sequence a rapid heating station, a soaking station, a rapid cooling station, a surface modification station and a hot-dip galvannealing station.

A direct fire heating section device is used for the rapid heating station.

A radiant tube soaking device or a jet-radiation composite soaking device is used for the soaking station.

The rapid cooling station includes both a mist cooling device and a water quenching cooling device.

A pickling device is used for the surface modification station.

The hot-dip galvannealing station is provided with a reheating section, a furnace nose section, a zinc pot section, an air knife section, an alloying heating section, an alloying soaking section, a post-plating cooling section and a final water cooling section in sequence.

Thus, both a direct fire heating section device and a mist cooling section device+a water quenching cooling section device are used in this production line for rapid heating and rapid cooling treatments, and a pickling device is used to improve the platability of the ultra-high-strength steel, thereby enabling continuous production of the hot-dip galvannealed ultra-high-strength strip steel.

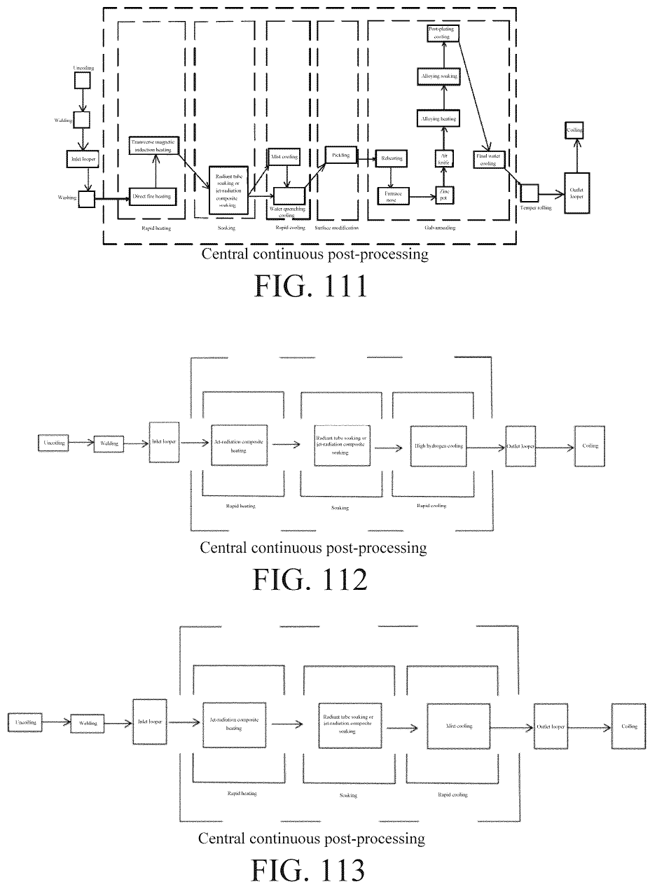

Referring to FIGS. 109 to 111 which show Examples 16 to 18 of the present disclosure, in Examples 16 to 18, in the ultra-short-process production line for hot-dip galvannealed ultra-high-strength strip steel according to the present disclosure, a direct fire heating device and a transverse magnetic induction heating device provided in series are used for the rapid heating station in the central continuous post-processing station. In the rapid heating station, the strip steel is subjected to direct fire heating followed by transverse magnetic induction heating to complete the rapid heating process, and then subsequent processing is carried out.

In the surface modification station of the central continuous post-processing station according to the present disclosure, an iron flash plating or nickel flash plating device is further provided after the pickling device. After the strip steel is pickled, a layer of iron or nickel may be flash plated on the surface of the strip steel, and then subsequent hot-dip galvannealing may be performed.

In the hot-dip galvannealing station of the central continuous post-processing station, a mobile post-plating rapid cooling section device is provided in parallel with an alloying heating section device after an air knife section. After the strip steel is hot-dip galvanized in a zinc pot section device and the coating weight is controlled by the air knife section device, if a pure zinc hot-dip galvanized product is to be produced, the mobile post-plating rapid cooling section device is switched online for use and the alloying heating section device is switched offline; if a hot-dip galvannealed product is to be produced, the mobile post-plating rapid cooling section device is switched offline, and the alloying heating section device is switched online for use.

Preferably, a washing station device is provided between a welding station and an inlet looper station. The strip steel may be washed by passing through the washing station device; alternatively, the strip steel may bypass the washing station.

Preferably, the washing station device is provided immediately after the inlet looper station. The strip steel may be washed by passing through the washing station device; alternatively, the strip steel may bypass the washing station.

Preferably, a central looper device is provided before a temper rolling station.

Preferably, a finishing station is provided between a coiling station and an outlet looper station, and the strip steel is finished before coiling.

Preferably, a tension levelling station is provided between the temper rolling station and the outlet looper station, and the strip steel may be subjected to tension levelling treatment before entering the outlet looper.

Preferably, a surface post-treatment station device such as that for passivation or anti-fingerprint treatment is further provided between the temper rolling station and the outlet looper station, and the strip steel may be subjected to surface treatment such as passivation or anti-fingerprint treatment before entering the outlet looper.

Preferably, both a tension levelling station and a surface post-treatment station such as that for passivation or anti-fingerprint treatment are provided between the temper rolling station and the outlet looper station, and the strip steel may be subjected to tension levelling and/or surface treatment such as passivation or anti-fingerprint treatment before entering the outlet looper.

Preferably, an electric radiant tube soaking section device, or a resistance wire soaking section device or a resistance belt soaking section device is used instead of a radiant tube soaking section device or a jet-radiation composite soaking section device to construct the production line of the present disclosure for producing hot-dip galvanized high-strength strip steel in places where fuel gas supply is tight.

### Example 1

A pure zinc hot-dip galvanized high-strength strip steel was prepared using the production line shown in FIG. 3. After a hot-rolled and pickled strip steel with the main chemical composition (mass %) of the substrate being 0.12% C-0.50% Si-2.0% Mn was uncoiled, welded, and passed through an inlet looper, it was heated to 700° C. by direct fire heating, then soaked by radiant tube soaking for 40 seconds, then cooled to about 80° C. by mist cooling, then pickled, and then reheated to 460° C. After passing through a furnace nose, it was immersed in a zinc pot for hot-dip galvanizing. After the coating weight was controlled by an air knife, it was subjected to post-plating cooling. Then, it was cooled by final water cooling. Then, it was temper rolled, and passed through an outlet looper. Then, it was coiled to complete the production. The final strip steel product had a yield strength of 800 MPa, a tensile strength of 1196 MPa, and an elongation at break of 11%.

### Example 2

A pure zinc hot-dip galvanized high-strength strip steel was prepared using the production line shown in FIG. 7. After a strip steel with the main chemical composition (mass %) of the substrate being 0.085% C-0.16% Si-2.0% Mn was uncoiled, welded, and passed through an inlet looper, it was heated to 700° C. by direct fire heating, then heated to 820° C. by transverse magnetic induction heating, then soaked by radiant tube soaking for 30 seconds, then cooled to about 50° C. by water quenching cooling, then pickled, and then reheated to 460° C. After passing through a furnace nose, it was immersed in a zinc pot for hot-dip galvanizing. After the coating weight was controlled by an air knife, it was subjected to post-plating cooling. Then, it was cooled by final water cooling. Then, it was temper rolled, and passed through an outlet looper. Then, it was coiled to complete the production. The final strip steel product had a yield strength of 595 MPa, a tensile strength of 998 MPa, and an elongation at break of 10.5%.

### Example 3

A pure zinc hot-dip galvanized high-strength strip steel was prepared using the production line shown in FIG. 11. After a hot-rolled and pickled strip steel with the main chemical composition (mass %) of the substrate being 0.095% C-1.5% Si-2.4% Mn was uncoiled, welded, and passed through an inlet looper, it was heated to 700° C. by direct fire heating, then soaked by jet-radiation composite soaking for 20 seconds, then cooled to about 400° C. by mist cooling, then cooled to about 50° C. by water quenching cooling, then pickled, then electrically plated with nickel, and then reheated to 455° C. After passing through a furnace nose, it was immersed in a zinc pot for hot-dip galvanizing. After the coating weight was controlled by an air knife, it was subjected to post-plating cooling. Then, it was cooled to room temperature by final water cooling. Then, it was temper rolled, and passed through an outlet looper. Then, it was coiled to complete the production. The final strip steel product had a yield strength of 816 MPa, a tensile strength of 1190 MPa, and an elongation at break of 9%.

### Example 4

A pure zinc hot-dip galvanized high-strength strip steel was prepared using the production line shown in FIG. 14. After a strip steel with the main chemical composition (mass %) of the substrate being 0.12% C-0.27% Si-2.5% Mn was uncoiled, welded, and passed through an inlet looper, it was heated to 680° C. by direct fire heating, then heated to 830° C. by transverse magnetic induction heating, then soaked by radiant tube soaking for 40 seconds, then cooled to 720° C. by mist cooling, then cooled to about 50° C. by water quenching cooling, then pickled, and then reheated to 460° C. After passing through a furnace nose, it was immersed in a zinc pot for hot-dip galvanizing. After the coating weight was controlled by an air knife, it was subjected to post-plating cooling. Then, it was cooled by final water cooling. Then, it was temper rolled, and passed through an outlet looper. Then, it was coiled to complete the production. The final strip steel product had a yield strength of 1013 MPa, a tensile strength of 1296 MPa, and an elongation at break of 7%.

### Example 5

A pure zinc hot-dip galvanized high-strength strip steel was prepared using the production line shown in FIG. 20. After a strip steel with the main chemical composition (mass %) of the substrate being 0.08% C-0.3% Si-2.33% Mn was uncoiled, welded, and passed through an inlet looper, it was heated to 670° C. by direct fire heating, then heated to 810° C. by transverse magnetic induction heating, then soaked by radiant tube soaking for 40 seconds, then cooled to about 500° C. by mist cooling, then cooled to about 50° C. by water quenching, then pickled, and then reheated to 455° C. After passing through a furnace nose, it was immersed in a zinc pot for hot-dip galvanizing. After the coating weight was controlled by an air knife, it entered an alloying heating section to be heated to 520° C. for alloying. Then, it entered an alloying soaking section to be soaked at 515° C. for 25 seconds. Then, it was subjected to post-plating cooling. Then, it was cooled by final water cooling. Then, it was temper rolled, and passed through an outlet looper. Then, it was coiled to complete the production. The final strip steel product had a yield strength of 816 MPa, a tensile strength of 1190 MPa, and an elongation at break of 9%.

### Example 6

A pure zinc hot-dip galvanized high-strength strip steel was prepared based on the production line shown in FIG. 20, wherein a uniform holding section and a secondary reheating section were added after the reheating section. After a strip steel with the main chemical composition (mass %) of the substrate being 0.185% C-1.75% Si-2.75% Mn was uncoiled, welded, and passed through an inlet looper, it was heated to 730° C. by direct fire heating, then heated to 910° C. by transverse magnetic induction heating, then soaked by radiant tube soaking for 40 seconds, then cooled to about 230° C. by mist cooling, then cooled to about 50° C. by water quenching, then pickled, then reheated to 400° C. in a first step, then held for 80 seconds in the uniform holding section, and then reheated to 460° C. in a second step. After passing through a furnace nose, it was immersed in a zinc pot for hot-dip galvanizing. After the coating weight was controlled by an air knife, it entered an alloying heating section to be heated to 510° C. for alloying. Then, it entered an alloying soaking section to be soaked at 500° C. for 30 seconds. Then, it was subjected to post-plating cooling. Then, it was cooled by final water cooling to room temperature. Then, it was temper rolled, and passed through an outlet looper. Then, it was coiled to complete the production. The final strip steel product had a yield strength of 1015 MPa, a tensile strength of 1212 MPa, and an elongation at break of 14.6%.

### Ultra-Short-Process Production Line for Ultra-High-Strength Strip Steel

Referring to FIG. 112 which shows Example 1 of the present disclosure, in Example 1, the ultra-short-process production line for ultra-high-strength strip steel according to the present disclosure includes the following stations in sequence: uncoiling—welding—inlet looper—central continuous post-processing—outlet looper—coiling; wherein
the central continuous post-processing station includes in sequence a rapid heating station, a soaking station and a rapid cooling station;
a jet-radiation composite heating device is used for the rapid heating station;
a radiant tube soaking device or a jet-radiation composite soaking device is used for the soaking station;
a high hydrogen cooling device is used for the rapid cooling station.

Referring to FIG. 113 which shows Example 2 of the present disclosure, in Example 2, the ultra-short-process production line for ultra-high-strength strip steel according to the present disclosure includes the following stations in sequence: uncoiling—welding—inlet looper—central continuous post-processing—outlet looper—coiling; wherein
the central continuous post-processing station includes in sequence a rapid heating station, a soaking station and a rapid cooling station;
a jet-radiation composite heating device is used for the rapid heating station;
a radiant tube soaking device or a jet-radiation composite soaking device is used for the soaking station;
a mist cooling device is used for the rapid cooling station.

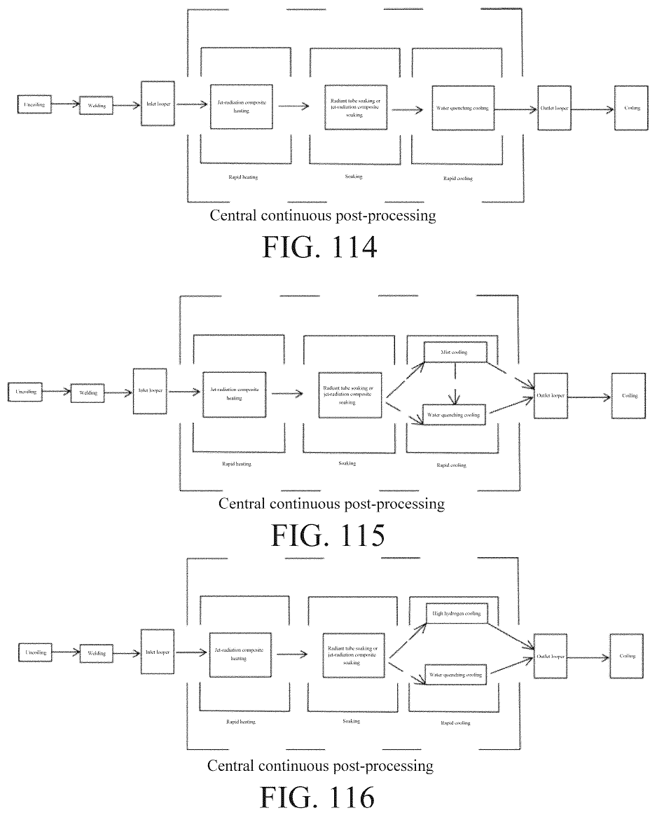

Referring to FIG. 114 which shows Example 3 of the present disclosure, in Example 3, the ultra-short-process production line for ultra-high-strength strip steel according to the present disclosure includes the following stations in sequence: uncoiling—welding—inlet looper—central continuous post-processing—outlet looper—coiling; wherein
the central continuous post-processing station includes in sequence a rapid heating station, a soaking station and a rapid cooling station;
a jet-radiation composite heating device is used for the rapid heating station;
a radiant tube soaking device or a jet-radiation composite soaking device is used for the soaking station;
a water quenching cooling device is used for the rapid cooling station.

Referring to FIG. 115 which shows Example 4 of the present disclosure, in Example 4, in the rapid heating station, a jet-radiation composite heating device and a transverse magnetic induction heating device are provided in series, and in the rapid cooling station, a mist cooling device and a water quenching cooling device are provided in series or in parallel.

Referring to FIG. 116 which shows Example 5 of the present disclosure, in Example 5, in the rapid heating station, a jet-radiation composite heating device and a transverse magnetic induction heating device are provided in series, and in the rapid cooling station, a high hydrogen cooling device and a water quenching cooling device are provided in parallel.

Referring to FIG. 117 which shows Example 6 of the present disclosure, in Example 6, in the rapid heating station, a jet-radiation composite heating device and a transverse magnetic induction heating device are provided in series, and in the rapid cooling station, a high hydrogen cooling device and a mist cooling device are provided in parallel.

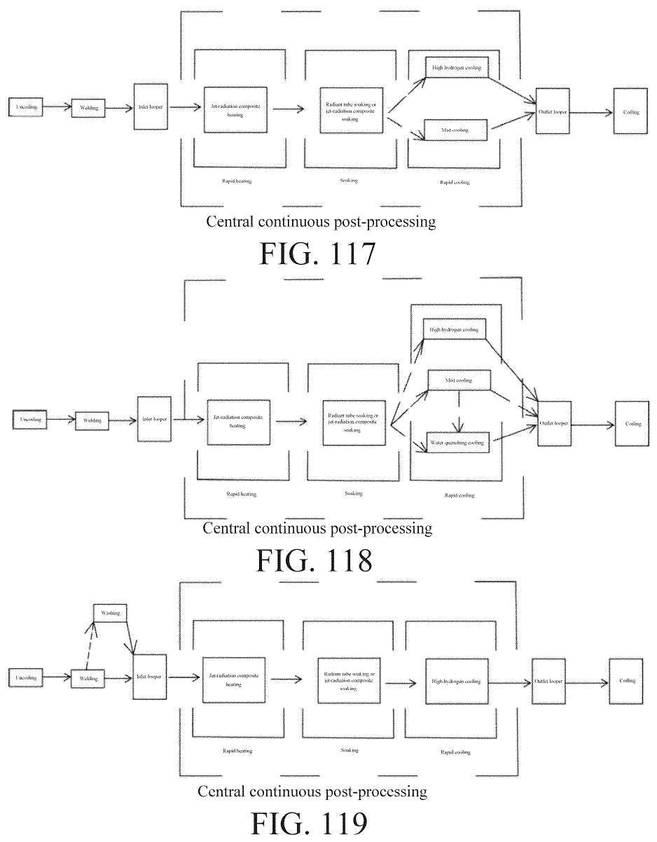

Referring to FIG. 118 which shows Example 7 of the present disclosure, in Example 7, in the rapid heating station, a jet-radiation composite heating device and a transverse magnetic induction heating device are provided in series, and in the rapid cooling station, a high hydrogen cooling device, a water quenching cooling device and a mist cooling device are provided in parallel, wherein the mist cooling device and the water quenching cooling device are provided in series.

Referring to FIGS. 119 to 125 which show Examples 8 to 14 of the present disclosure, Examples 8 to 14 were based on Examples 1 to 7, wherein a selectable washing station was provided between the welding station and the inlet looper station respectively.

Referring to FIGS. 126 to 132 which show Examples 15 to 21 of the present disclosure, Examples 15 to 21 were based on Examples 1 to 7, wherein a jet-radiation composite heating device+a transverse magnetic induction heating device provided in series was used in the rapid heating station for rapid heating.

Referring to FIGS. 133 to 139 which show Examples 22 to 28 of the present disclosure, Examples 22 to 28 were based on Examples 1 to 7, wherein in the rapid heating station, a selectable longitudinal magnetic induction heating device was provided further in series with a jet-radiation composite heating device+a transverse magnetic induction heating device provided in series. The strip steel may be heated by the longitudinal magnetic induction heating device first, or it may bypass the longitudinal magnetic induction heating device and directly enter the jet-radiation composite heating device+the transverse magnetic induction heating provided in series for heating.

### Example 1

As shown in FIG. 112, after a strip steel was uncoiled, welded, and entered an inlet looper, it was heated to 780° C. by jet-radiation composite heating, then soaked at 780° C. by jet-radiation composite soaking, and then cooled to room temperature by high hydrogen cooling. Then, it entered an outlet looper, and finally coiled to complete the production.

### Example 2

As shown in FIG. 113, after a strip steel with the main chemical composition (mass %) of the substrate being 0.095% C-0.05% Si-1.88% Mn was uncoiled, welded, and entered an inlet looper, it was heated to 820° C. by jet-radiation composite heating, then soaked by radiant tube soaking for 40 seconds, then cooled to 250° C. by mist cooling, and then cooled to room temperature naturally. Then, it entered an outlet looper, and was finally coiled to complete the production. The final strip steel product had a yield strength of 710 MPa, a tensile strength of 993 MPa, and an elongation at break of 9%.

### Example 3

As shown in FIG. 114, after a strip steel was uncoiled, welded, and entered an inlet looper, it was heated to 800° C. by jet-radiation composite heating, then soaked at 800° C. by jet-radiation composite soaking, and then cooled to room temperature by water quenching cooling. Then, it entered an outlet looper, and finally coiled to complete the production.

### Example 4

As shown in FIG. 115, after a strip steel was uncoiled, welded, and entered an inlet looper, it was heated to 800° C. by jet-radiation composite heating, then soaked at 800° C. by jet-radiation composite soaking, and then cooled to room temperature by water quenching cooling. Then, it entered an outlet looper, and finally coiled to complete the production.

### Example 5

As shown in FIG. 116, after a strip steel was uncoiled, welded, and entered an inlet looper, it was heated to 820° C. by jet-radiation composite heating, then soaked at 820° C. by jet-radiation composite soaking, and then cooled to room temperature by high hydrogen cooling or by water quenching cooling. Then, it entered an outlet looper, and finally coiled to complete the production.

### Example 6

As shown in FIG. 117, after a strip steel was uncoiled, welded, and entered an inlet looper, it was heated to 850° C. by jet-radiation composite heating, then soaked at 850° C. by jet-radiation composite soaking, and then cooled to room temperature by high hydrogen cooling or by mist cooling. Then, it entered an outlet looper, and finally coiled to complete the production.

### Example 7

As shown in FIG. 118, after a strip steel was uncoiled, welded, and entered an inlet looper, it was heated to 870° C. by jet-radiation composite heating, then soaked at 870° C. by jet-radiation composite soaking, and then cooled to room temperature by high hydrogen cooling or by mist cooling or by water quenching cooling. Then, it entered an outlet looper, and finally coiled to complete the production.

### Example 8

As shown in FIG. 119, after a strip steel was uncoiled and welded, it entered an inlet looper after washing or entered the inlet looper directly. Then, it was heated to 815° C. by jet-radiation composite heating, then soaked at 815° C. by jet-radiation composite soaking, and then cooled to room temperature by high hydrogen cooling. Then, it entered an outlet looper, and finally coiled to complete the production.

### Example 9

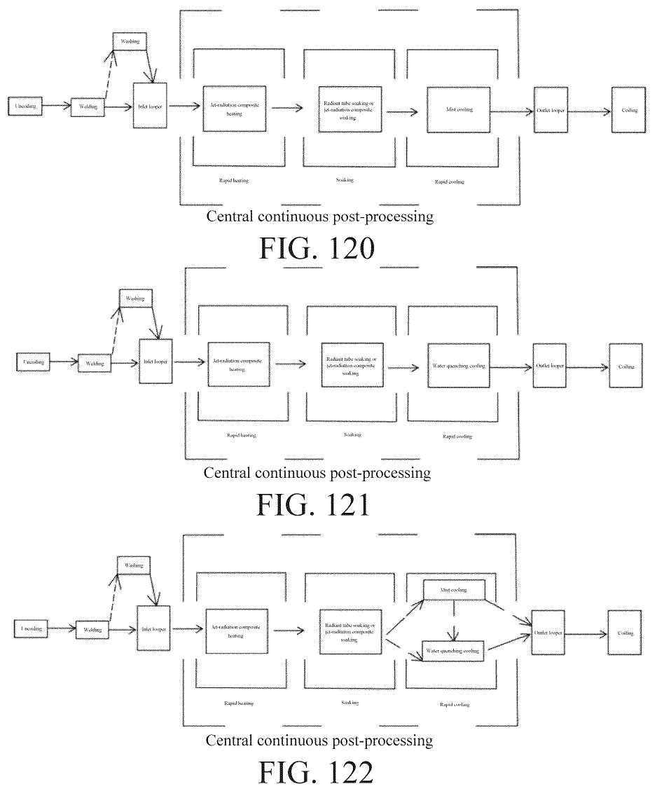

As shown in FIG. 120, after a strip steel with the main chemical composition (mass %) of the substrate being 0.095% C-0.05% Si-1.88% Mn was uncoiled and welded, it entered an inlet looper after washing or entered the inlet looper directly. Then, it was heated to 825° C. by jet-radiation composite heating, then soaked by radiant tube soaking for 50 seconds, then cooled to 235° C. by mist cooling, and then cooled to room temperature naturally. Then, it entered an outlet looper, and finally coiled to complete the production. The final strip steel product had a yield strength of 775 MPa, a tensile strength of 1053 MPa, and an elongation at break of 7%.

### Example 10

As shown in FIG. 121, after a strip steel was uncoiled and welded, it entered an inlet looper after washing or entered the inlet looper directly. Then, it was heated to 805° C. by jet-radiation composite heating, then soaked at 805° C. by jet-radiation composite soaking, and then cooled to room temperature by water quenching cooling. Then, it entered an outlet looper, and finally coiled to complete the production.

### Example 11

As shown in FIG. 122, after a strip steel was uncoiled and welded, it entered an inlet looper after washing or entered the inlet looper directly. Then, it was heated to 825° C. by jet-radiation composite heating, then soaked at 825° C. by jet-radiation composite soaking, and then cooled to room temperature by water quenching cooling. Then, it entered an outlet looper, and finally coiled to complete the production.

### Example 12

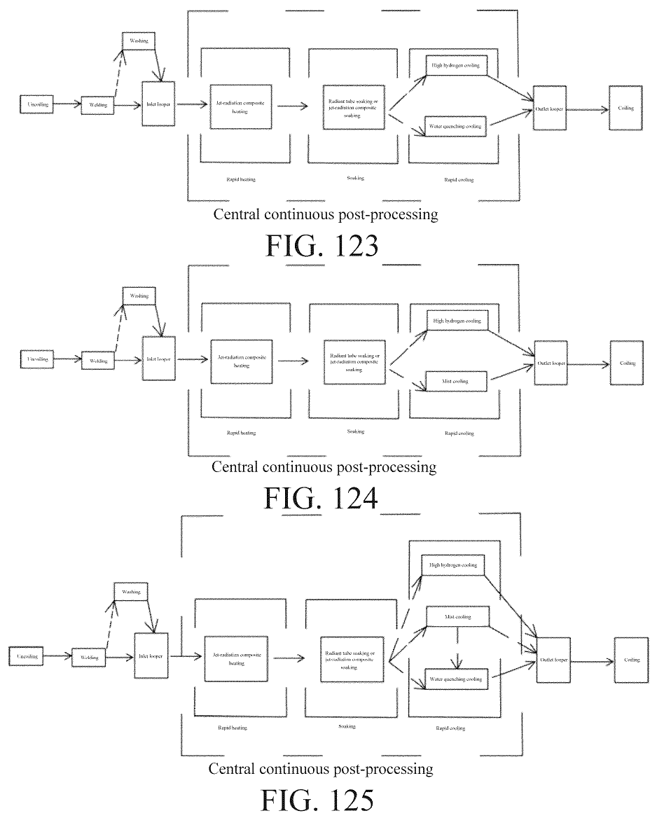

As shown in FIG. 123, after a strip steel was uncoiled and welded, it entered an inlet looper after washing or entered the inlet looper directly. Then, it was heated to 835° C. by jet-radiation composite heating, then soaked at 835° C. by jet-radiation composite soaking, and then cooled to room temperature by high hydrogen cooling or by water quenching cooling. Then, it entered an outlet looper, and finally coiled to complete the production.

### Example 13

As shown in FIG. 124, after a strip steel was uncoiled and welded, it entered an inlet looper after washing or entered the inlet looper directly. Then, it was heated to 855° C. by jet-radiation composite heating, then soaked at 855° C. by jet-radiation composite soaking, and then cooled to room temperature by high hydrogen cooling or by mist cooling. Then, it entered an outlet looper, and finally coiled to complete the production.

### Example 14

As shown in FIG. 125, after a strip steel was uncoiled, welded, and entered an inlet looper, it was heated to 870° C. by jet-radiation composite heating, then soaked at 870° C. by jet-radiation composite soaking, and then cooled to room temperature by high hydrogen cooling or by mist cooling or by water quenching cooling. Then, it entered an outlet looper, and finally coiled to complete the production.

### Example 15

As shown in FIG. 126, after a strip steel was uncoiled, welded, and entered an inlet looper, it was heated to 780° C. by jet-radiation composite heating, then heated to 880° C. by transverse magnetic induction heating, then soaked at 880° C. by jet-radiation composite soaking, and then cooled to room temperature by high hydrogen cooling. Then, it entered an outlet looper, and finally coiled to complete the production.

### Example 16

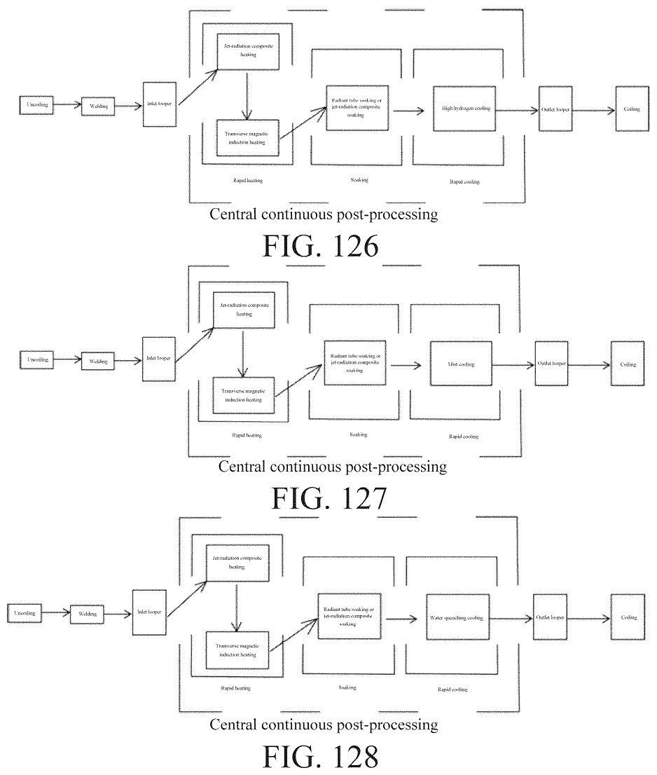

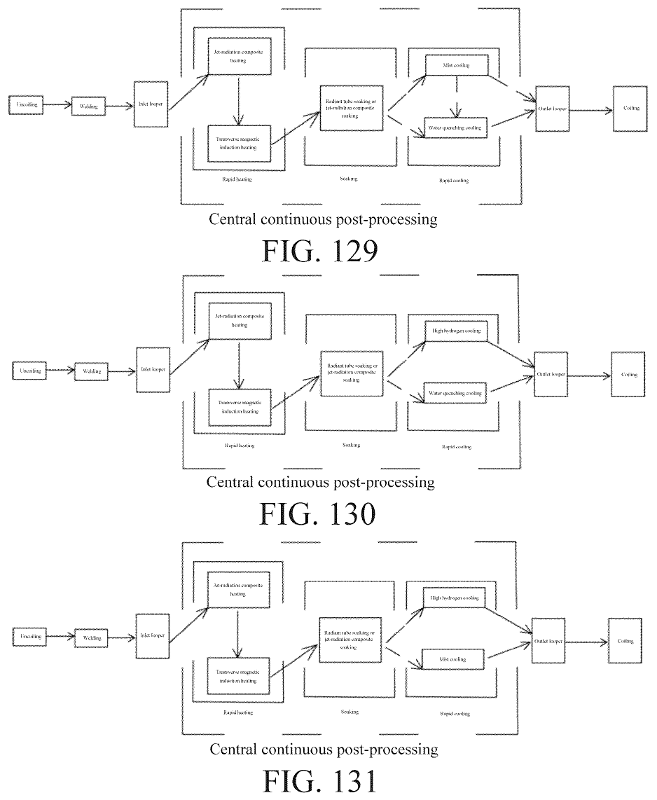

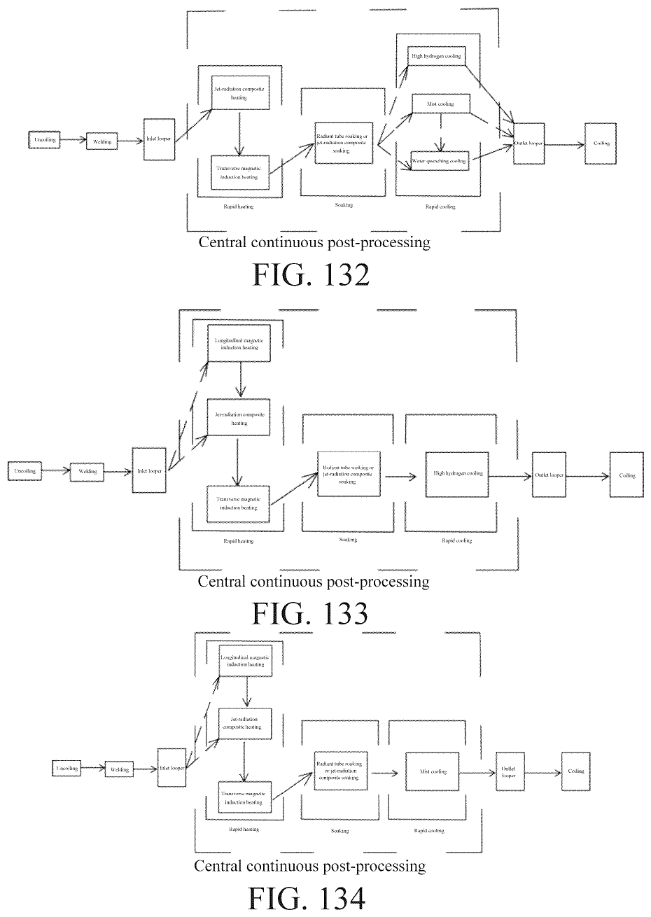

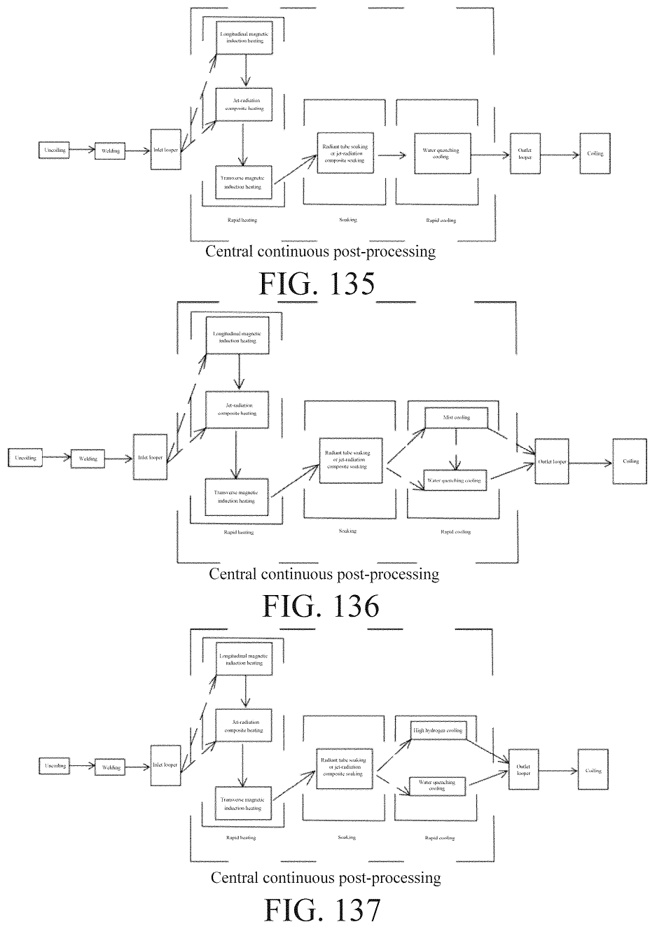

As shown in FIG. 127, after a strip steel with the main chemical composition (mass %) of the substrate being 0.095% C-0.05% Si-1.88% Mn was uncoiled, welded, and entered an inlet looper, it was heated to 820° C. by jet-radiation composite heating, then heated to 920° C. by transverse magnetic induction heating, then soaked by radiant tube soaking for 40 seconds, then cooled to 250° C. by mist cooling, and then cooled to room temperature naturally. Then, it entered an outlet looper, and finally coiled to complete the production. The final strip steel product had a yield strength of 765 MPa, a tensile strength of 1043 MPa, and an elongation at break of 8%.

### Example 17

As shown in FIG. 128, after a strip steel was uncoiled, welded, and entered an inlet looper, it was heated to 800° C. by jet-radiation composite heating, then heated to 900° C. by transverse magnetic induction heating, then soaked at 900° C. by jet-radiation composite soaking, and then cooled to room temperature by water quenching cooling. Then, it entered an outlet looper, and finally coiled to complete the production.

### Example 18

As shown in FIG. 129, after a strip steel was uncoiled, welded, and entered an inlet looper, it was heated to 800° C. by jet-radiation composite heating, then heated to 900° C. by transverse magnetic induction heating, and then cooled to room temperature by water quenching cooling. Then, it entered an outlet looper, and finally coiled to complete the production.

### Example 19

As shown in FIG. 130, after a strip steel was uncoiled, welded, and entered an inlet looper, it was heated to 820° C. by jet-radiation composite heating, then heated to 920° C. by transverse magnetic induction heating, and then cooled to room temperature by high hydrogen cooling or by water quenching cooling. Then, it entered an outlet looper, and finally coiled to complete the production.

### Example 20

As shown in FIG. 131, after a strip steel was uncoiled, welded, and entered an inlet looper, it was heated to 750° C. by jet-radiation composite heating, then heated to 850° C. by transverse magnetic induction heating, and then cooled to room temperature by high hydrogen cooling or by mist cooling. Then, it entered an outlet looper, and finally coiled to complete the production.

### Example 21

As shown in FIG. 132, after a strip steel was uncoiled, welded, and entered an inlet looper, it was heated to 770° C. by jet-radiation composite heating, then heated to 870° C. by transverse magnetic induction heating, then soaked at 870° C. by jet-radiation composite soaking, and then cooled to room temperature by high hydrogen cooling or by mist cooling or by water quenching cooling. Then, it entered an outlet looper, and finally coiled to complete the production.

### Example 22

As shown in FIG. 133, after a strip steel was uncoiled, welded, and entered an inlet looper, it was heated to 420° C. by longitudinal magnetic induction heating, then heated to 780° C. by jet-radiation composite heating, then heated to 880° C. by transverse magnetic induction heating, then soaked at 880° C. by jet-radiation composite soaking, and then cooled to room temperature by high hydrogen cooling. Then, it entered an outlet looper, and finally coiled to complete the production.

### Example 23

As shown in FIG. 134, after a strip steel was uncoiled, welded, and entered an inlet looper, it was heated to 450° C. by longitudinal magnetic induction heating, then heated to 820° C. by jet-radiation composite heating, then heated to 920° C. by transverse magnetic induction heating, then soaked by radiant tube soaking for 40 seconds, then cooled to 250° C. by mist cooling, and then cooled to room temperature naturally. Then, it entered an outlet looper, and finally coiled to complete the production.

### Example 24

As shown in FIG. 135, after a strip steel was uncoiled, welded, and entered an inlet looper, it was heated to 400° C. by longitudinal magnetic induction heating, then heated to 800° C. by jet-radiation composite heating, then heated to 900° C. by transverse magnetic induction heating, then soaked at 900° C. by jet-radiation composite soaking, and then cooled to room temperature by water quenching cooling. Then, it entered an outlet looper, and finally coiled to complete the production.

### Example 25

As shown in FIG. 136, after a strip steel was uncoiled, welded, and entered an inlet looper, it was heated to 480° C. by longitudinal magnetic induction heating, then heated to 820° C. by jet-radiation composite heating, then heated to 900° C. by transverse magnetic induction heating, and then cooled to room temperature by water quenching cooling. Then, it entered an outlet looper, and finally coiled to complete the production.

### Example 26

As shown in FIG. 137, after a strip steel was uncoiled, welded, and entered an inlet looper, it was heated to 350° C. by longitudinal magnetic induction heating, then heated to 840° C. by jet-radiation composite heating, then heated to 920° C. by transverse magnetic induction heating, and then cooled to room temperature by high hydrogen cooling or water quenching cooling. Then, it entered an outlet looper, and finally coiled to complete the production.

### Example 27

As shown in FIG. 138, after a strip steel was uncoiled, welded, and entered an inlet looper, it was heated to 410° C. by longitudinal magnetic induction heating, then heated to 700° C. by jet-radiation composite heating, then heated to 850° C. by transverse magnetic induction heating, and then cooled to room temperature by high hydrogen cooling or mist cooling. Then, it entered an outlet looper, and finally coiled to complete the production.

### Example 28

As shown in FIG. 139, after a strip steel was uncoiled, welded, and entered an inlet looper, it was heated to 500° C. by longitudinal magnetic induction heating, then heated to 800° C. by jet-radiation composite heating, then heated to 930° C. by transverse magnetic induction heating, then soaked at 930° C. by jet-radiation composite soaking, and then cooled to room temperature by high hydrogen cooling, or by mist cooling, or by water quenching cooling. Then, it entered an outlet looper, and finally coiled to complete the production.

Under the current situation that the market demand for ultra-high-strength steel is increasing year by year and CO₂ and NOx emissions are increasingly strictly restricted, the present disclosure has very broad application prospects, especially in urban steel mills in which the promotion and application prospects are even broader.

### Ultra-Short-Process Production Line for Hot-Dip Galvanized High-Strength Strip Steel

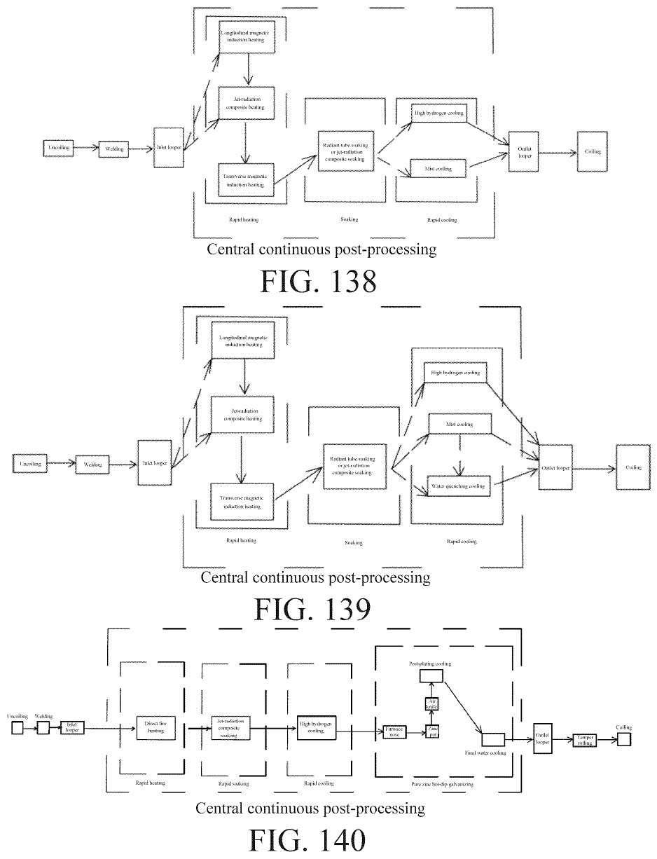

Referring to FIG. 140 which shows Example 1 of the present disclosure, in Example 1, the ultra-short-process production line for pure zinc hot-dip galvanized high-strength strip steel includes the following stations in sequence: uncoiling—welding—inlet looper—central continuous post-processing—outlet looper—temper rolling—coiling; wherein the central continuous post-processing station includes in sequence a rapid heating section, a soaking section, a rapid cooling section and a hot-dip galvanizing section;
direct fire heating is used for the rapid heating section; jet-radiation composite soaking is used for the soaking section; and high hydrogen cooling is used for the rapid cooling section;
the hot-dip galvanizing station consists of a furnace nose, a zinc pot, an air knife, a post-plating cooling device and a final water cooling device in sequence.

In this production line, direct fire heating, high hydrogen cooling and jet-radiation composite soaking are used concurrently to carry out rapid heating and rapid cooling treatments, thereby enabling continuous production of hot-dip galvanized high-strength strip steel.

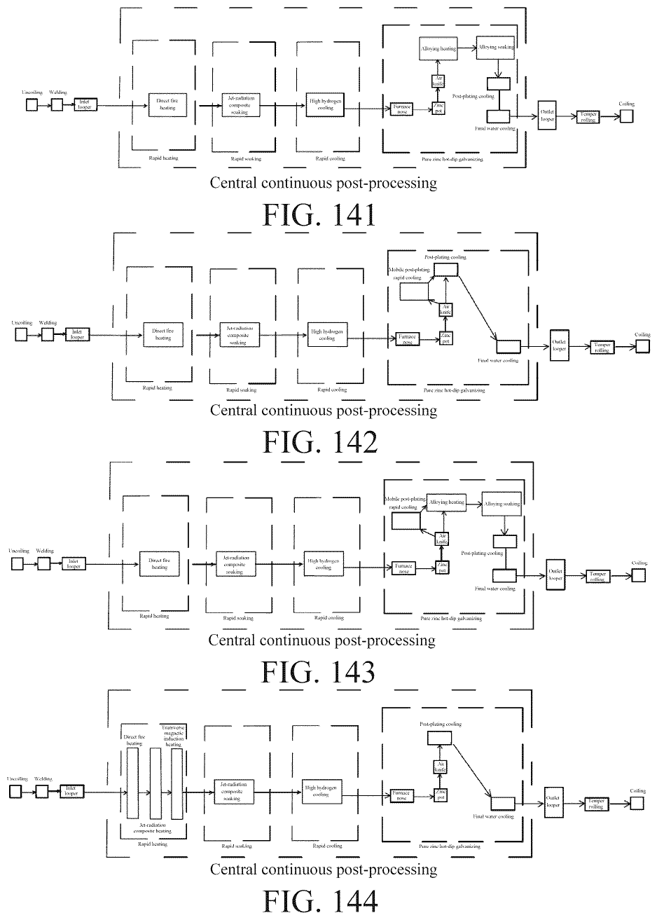

Referring to FIG. 141 which shows Example 2 of the present disclosure, in Example 2, the ultra-short-process production line for hot-dip galvannealed high-strength strip steel according to the present disclosure includes the following stations in sequence: uncoiling—welding—inlet looper—central continuous post-processing—outlet looper—temper rolling—coiling; wherein
the central continuous post-processing station includes in sequence a rapid heating section, a soaking section, a rapid cooling section, and a hot-dip galvannealing section;
direct fire heating is used for the rapid heating section;
jet-radiation composite soaking is used for the soaking section;
high hydrogen cooling is used for the rapid cooling section;
the hot-dip galvannealing section includes a furnace nose, a zinc pot, an air knife, an alloying heating device, an alloying soaking device, a post-plating cooling device and a final water cooling device in sequence.

In this production line, direct fire heating, high hydrogen cooling and jet-radiation composite soaking are used concurrently to carry out rapid heating and rapid cooling treatments, thereby enabling continuous production of hot-dip galvannealed high-strength strip steel.

Referring to FIG. 142 which shows Example 3 of the present disclosure, based on Example 1, in the hot-dip galvanizing section of the central continuous post-processing station, a selectable mobile post-plating rapid cooling device is provided after the air knife and before the post-plating cooling device. After the strip steel is immersed in the zinc pot to carry out hot-dip galvanizing, the coating weight is controlled by the air knife. Then, the mobile post-plating rapid cooling device may be chosen to carry out post-plating rapid cooling. Alternatively, the mobile post-plating rapid cooling device may not be used; instead, natural cooling may be carried out before post-plating cooling, thereby enabling continuous production of the hot-dip galvanized high-strength strip steel.

Referring to FIG. 143 which shows Example 4 of the present disclosure, based on Example 2, in the hot-dip galvanizing section of the central continuous post-processing station, a selectable mobile post-plating rapid cooling device is provided after the air knife and before the post-plating cooling device. After the strip steel is immersed in the zinc pot to carry out hot-dip galvanizing, the coating weight is controlled by the air knife section. Then, the mobile post-plating rapid cooling device may be chosen to carry out post-plating rapid cooling. Alternatively, the mobile post-plating rapid cooling device may not be used; instead, natural cooling may be carried out before post-plating cooling, thereby enabling continuous production of the hot-dip galvanized high-strength strip steel.

Referring to FIG. 144 which shows Example 5 of the present disclosure, in Example 5, the ultra-short-process production line for hot-dip galvanized high-strength strip steel according to the present disclosure includes the following stations in sequence: uncoiling—welding—inlet looper-central continuous post-processing—outlet looper—temper rolling—coiling; wherein
the central continuous post-processing station includes in sequence a rapid heating section, a soaking section, a rapid cooling section, and a hot-dip galvanizing section;
direct fire heating and (jet-radiation composite heating+transverse magnetic induction heating) provided in series are used for the rapid heating section;
jet-radiation composite soaking is used for the soaking section;
high hydrogen cooling is used for the rapid cooling section;
the hot-dip galvanizing station consists of a furnace nose, a zinc pot, an air knife, a post-plating cooling device and a final water cooling device in sequence.

In this production line, direct fire heating device+transverse magnetic induction heating provided in series are used concurrently to form the rapid heating section to perform rapid heating, and then high hydrogen cooling is used to perform rapid cooling, so as to carry out rapid heating and rapid cooling treatments of the high-strength steel, thereby finally enabling continuous production of the hot-dip galvanized high-strength strip steel.

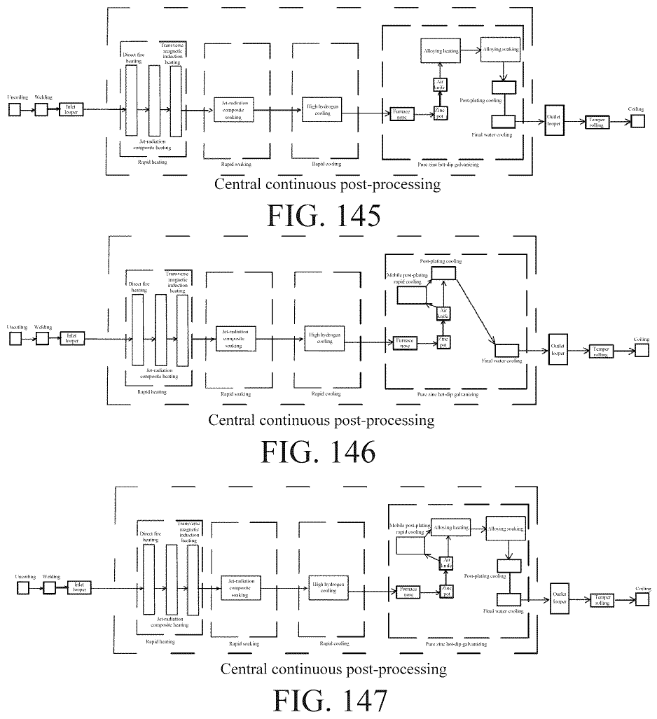

Referring to FIG. 145 which shows Example 6 of the present disclosure, in Example 6, the ultra-short-process production line for hot-dip galvannealed high-strength strip steel according to the present disclosure includes the following stations in sequence: uncoiling—welding—inlet looper—central continuous post-processing—outlet looper—temper rolling—coiling; wherein
the central continuous post-processing station includes in sequence a rapid heating section, a soaking section, a rapid cooling section, and a hot-dip galvannealing section;
direct fire heating and (jet-radiation composite heating+transverse magnetic induction heating) provided in series are used for the rapid heating section;
jet-radiation composite soaking is used for the soaking section;
high hydrogen cooling is used for the rapid cooling section;
the hot-dip galvannealing section includes a furnace nose, a zinc pot, an air knife, an alloying heating device, an alloying soaking device, a post-plating cooling device and a final water cooling device in sequence.

In this production line, direct fire heating device+ (jet-radiation composite heating+transverse magnetic induction heating) provided in series are used concurrently to form the rapid heating section to perform rapid heating, and then high hydrogen cooling is used to perform rapid cooling, so as to carry out rapid heating and rapid cooling treatments of the high-strength steel, thereby eventually enabling continuous production of the hot-dip galvannealed high-strength strip steel.

Referring to FIG. 146 which shows Example 7 of the present disclosure, based on Example 5, in the hot-dip galvanizing section of the central continuous post-processing station, a selectable mobile post-plating rapid cooling device is provided after the air knife and before the post-plating cooling device. After the strip steel is immersed in the zinc pot to carry out hot-dip galvanizing, the coating weight is controlled by the air knife section. Then, the mobile post-plating rapid cooling device may be chosen to carry out post-plating rapid cooling. Alternatively, the mobile post-plating rapid cooling device may not be used; instead, natural cooling may be carried out before post-plating cooling, thereby enabling continuous production of the hot-dip galvanized high-strength strip steel.

Referring to FIG. 147 which shows Example 8 of the present disclosure, based on Example 6, in the hot-dip galvanizing section of the central continuous post-processing station, a selectable mobile post-plating rapid cooling device is provided after the air knife and before the post-plating cooling device. After the strip steel is immersed in the zinc pot to carry out hot-dip galvanizing, the coating weight is controlled by the air knife. Then, the mobile post-plating rapid cooling device may be chosen to carry out post-plating rapid cooling. Alternatively, the mobile post-plating rapid cooling device may not be used; instead, natural cooling may be carried out before post-plating cooling, thereby enabling continuous production of the hot-dip galvanized high-strength strip steel.

### Example 1

A high-strength steel was manufactured using the production line whose layout is shown in FIG. 140. After a hot-rolled and pickled strip steel with the main chemical composition (mass %) of the substrate being 0.05% C-0.01% Si-1.3% Mn was uncoiled, welded, and passed through an inlet looper, it was heated to 700° C. by direct fire heating, then soaked by jet-radiation composite soaking for 20 seconds, and then cooled to 460° C. by high hydrogen cooling. Then, it passed through a furnace nose, and was immersed in a zinc pot for hot-dip galvanizing. After the coating weight was controlled by an air knife, the strip steel was subjected to post-plating cooling, followed by final water cooling. After passing through an outlet looper, it was temper rolled and coiled to complete the production. The final strip steel product had a yield strength of 326 MPa, a tensile strength of 442 MPa, and an elongation at break of 35%.

### Example 2

A high-strength steel was manufactured using the production line whose layout is shown in FIG. 141. After a hot-rolled and pickled strip steel with the main chemical composition (mass %) of the substrate being 0.06% C-0.015% Si-1.35% Mn was uncoiled, welded, and passed through an inlet looper, it was heated to 700° C. by direct fire heating, then soaked by jet-radiation composite soaking for 30 seconds, and then cooled to 460° C. by high hydrogen cooling. Then, it passed through a furnace nose, and was immersed in a zinc pot for hot-dip galvanizing. After the coating weight was controlled by an air knife, the strip steel entered an alloying heating furnace to be heated to 510° C., and then it was subjected to alloying soaking at 500° C. for 20 seconds. Then, it was subjected to post-plating cooling, followed by final water cooling. After passing through an outlet looper, it was temper rolled and coiled to complete the production. The final strip steel product had a yield strength of 370 MPa, a tensile strength of 435 MPa, and an elongation at break of 34%.

### Example 3

A high-strength steel was manufactured using the production line whose layout is shown in FIG. 144. After a strip steel with the main chemical composition (mass %) of the substrate being 0.095% C-0.18% Si-2.0% Mn was uncoiled, welded, and passed through an inlet looper, it was heated to 650° C. by direct fire heating, then heated to 750° C. by jet-radiation composite heating, then heated to 800° C. by transverse magnetic induction heating, then soaked by jet-radiation composite soaking for 30 seconds, and then cooled to 460° C. by high hydrogen cooling. Then, it passed through a furnace nose, and was immersed in a zinc pot for hot-dip galvanizing. After the coating weight was controlled by an air knife, the strip steel was subjected to post-plating cooling, followed by final water cooling. After passing through an outlet looper, it was temper rolled and coiled to complete the production. The final strip steel product had a yield strength of 565 MPa, a tensile strength of 912 MPa, and an elongation at break of 16%.

### Example 4

A high-strength steel was manufactured using the production line whose layout is shown in FIG. 145. After a strip steel with the main chemical composition (mass %) of the substrate being 0.09% C-0.17% Si-1.96% Mn was uncoiled, welded, and passed through an inlet looper, it was heated to 650° C. by direct fire heating, then heated to 780° C. by jet-radiation composite heating, then heated to 850° C. by transverse magnetic induction heating, then soaked by jet-radiation composite soaking for 40 seconds, and then cooled to 460° C. by high hydrogen cooling. Then, it passed through a furnace nose, and was immersed in a zinc pot for hot-dip galvanizing. After the coating weight was controlled by an air knife, the strip steel entered an alloying heating furnace to be heated to 515° C., and then it was subjected to alloying soaking at 510° C. for 25 seconds. Then, it was subjected to post-plating cooling, followed by final water cooling. After passing through an outlet looper, it was temper rolled and coiled to complete the production. The final strip steel product had a yield strength of 530 MPa, a tensile strength of 890 MPa, and an elongation at break of 17%.

### Example 5

A high-strength steel was manufactured using the production line whose layout is shown in FIG. 146. After a strip steel with the main chemical composition (mass %) of the substrate being 0.085% C-0.26% Si-2.3% Mn was uncoiled, welded, and passed through an inlet looper, it was heated to 730° C. by direct fire heating, then heated to 810° C. by jet-radiation composite heating, then heated to 910° C. by transverse magnetic induction heating, then soaked by jet-radiation composite soaking for 30 seconds, and then cooled to 460° C. by high hydrogen cooling. Then, it passed through a furnace nose, and was immersed in a zinc pot for hot-dip galvanizing. After the coating weight was controlled by an air knife, the strip steel was cooled to 365° C. by mobile post-plating rapid cooling, and then it was subjected to post-plating cooling, followed by final water cooling. After passing through an outlet looper, it was temper rolled and coiled to complete the production. The final strip steel product had a yield strength of 908 MPa, a tensile strength of 1192 MPa, and an elongation at break of 9%.

### Example 6

A high-strength steel was manufactured using the production line whose layout is shown in FIG. 147. After a strip steel with the main chemical composition (mass %) of the substrate being 0.055% C-0.008% Si-1.25% Mn was uncoiled, welded, and passed through an inlet looper, it was heated to 600° C. by direct fire heating, then heated to 700° C. by jet-radiation composite heating, then heated to 730° C. by transverse magnetic induction heating, then soaked by jet-radiation composite soaking for 30 seconds, and then cooled to 460° C. by high hydrogen cooling. Then, it passed through a furnace nose, and was immersed in a zinc pot for hot-dip galvanizing. After the coating weight was controlled by an air knife, the strip steel entered an alloying heating furnace to be heated to 505° C., and then it was subjected to alloying soaking at 505° C. for 22 seconds. Then, it was subjected to post-plating cooling, followed by final water cooling. After passing through an outlet looper, it was temper rolled and coiled to complete the production. The final strip steel product had a yield strength of 336 MPa, a tensile strength of 436 MPa, and an elongation at break of 37%.

### Flexible Cold-Rolled Strip Steel Post-Processing Production Line Suitable for Producing a Variety of High-Strength Steels

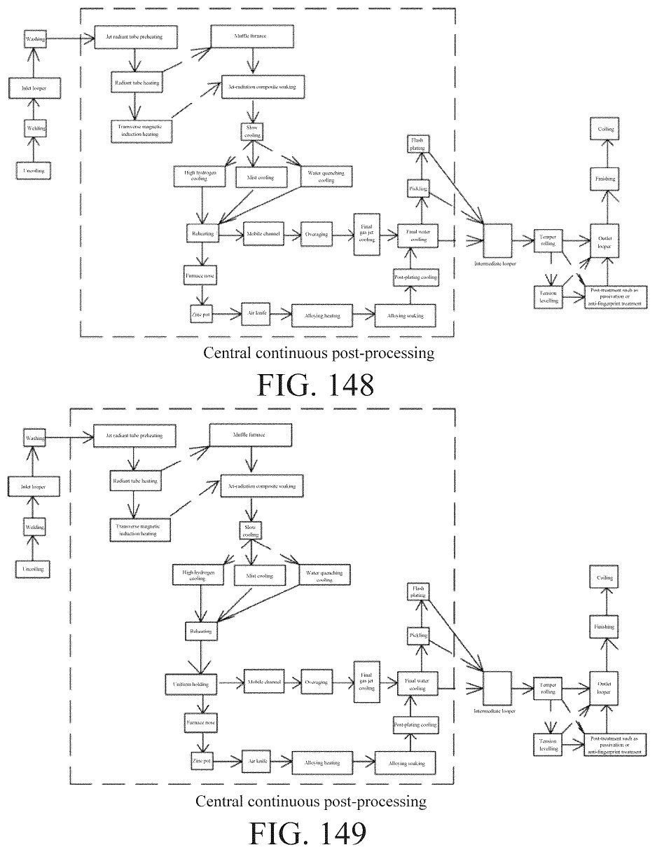

Referring to FIG. 148, the flexible cold-rolled strip steel post-processing production line suitable for producing a variety of high-strength steels according to the present disclosure includes the following stations in sequence: uncoiling—welding—inlet looper—washing—central continuous post-processing-intermediate looper—temper rolling—outlet looper-finishing-coiling; wherein
the central continuous post-processing station includes in sequence a jet radiant tube preheating section, a radiant tube heating section, a selectable transverse magnetic induction heating section or a muffle furnace section provided in parallel, a jet-radiation composite soaking section, a slow cooling section, a rapid cooling section, and a reheating section; the rapid cooling section includes a high hydrogen cooling section and/or a mist cooling section and/or a water quenching cooling section;
the reheating section is followed by a furnace nose section, a zinc pot section, an air knife section, an alloying heating section, an alloying soaking section, a post-plating cooling section, and a final water cooling section; or connected to the final water cooling section through a mobile channel, an overaging section, and a final gas jet cooling section;
the final water cooling section may be followed by a pickling section or (a pickling section+a flash plating section) in sequence; the strip steel may pass through the pickling section for producing a cold-rolled pickled product, or it may bypass the pickling section to produce a cold-rolled annealed product; the pickled strip steel may further enter a flash plating section for producing a flash-plated product which is flash plated with nickel or zinc;
a gas fuel such as natural gas or liquefied petroleum gas or coal gas is combusted in the radiant tube heating section, and high-temperature exhaust gas is generated during the combustion process;
the jet radiant tube preheating section uses the combustion exhaust gas from the heating section and/or the soaking section to heat a recycled nitrogen-hydrogen protective gas by heat exchange in the furnace, and then the nitrogen-hydrogen protective gas is jetted onto the upper and lower surfaces of the strip steel to realize forced convection heat exchange;
the radiant tube heating section is provided in series with (a selectable transverse magnetic induction heating section or muffle furnace section provided in parallel);
the jet-radiation composite soaking section utilizes forced convection and radiation in combination to quickly soak the strip steel, so as to improve the uniformity of the strip steel temperature and realize rapid regulation of the soaking temperature of the strip steel;
in addition to the use of the jet radiant tube preheating section, the cold-rolled strip steel post-processing production line further utilizes a rapid cooling treatment, then reheating, and then galvanizing or overaging treatment;
the furnace nose section is provided in parallel with the mobile channel; the strip steel passes through the furnace nose section to produce a pure zinc hot-dip galvanized product or a hot-dip galvannealed product, or the strip steel passes through the mobile channel to produce a cold-rolled annealed product, or a pickled product or a flash-plated product;
thus, the processing line has at least three or more process paths for selection, and enables production of five types of high-strength steel: cold-rolled annealed steel, pickled steel, flash plated steel, pure zinc hot-dip galvanized steel, and hot-dip galvannealed steel.

Referring to FIG. 148 which shows Example 1 of the present disclosure, in Example 1, a selectable tension levelling station and/or a surface post-treatment station such as that for passivation or anti-fingerprint treatment is provided between the temper rolling station and the outlet looper station, and the strip steel may be subjected to temper rolling and/or surface post-treatment.

Preferably, the muffle furnace section device includes built-in sealing devices at the front and rear, and the muffle furnace section device is further equipped with an atmosphere regulating device, so that the hydrogen content, oxygen content and dew point therein can be regulated and controlled separately.

Referring to FIG. 149 which shows Example 2 of the present disclosure, in Example 2, a uniform holding section device is further provided between the reheating section and the furnace nose section to hold the temperature of the strip steel before hot-dip galvanizing.

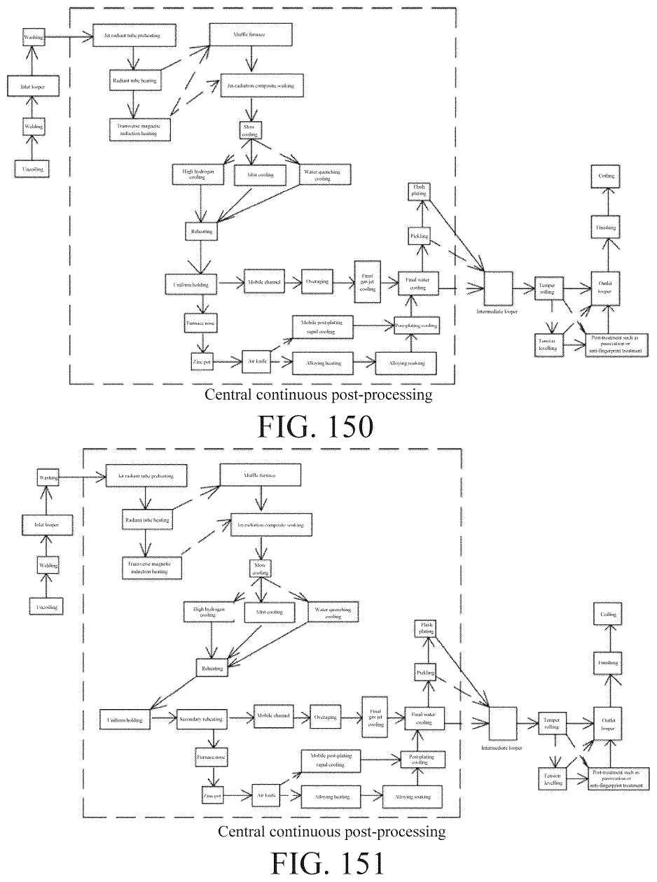

Referring to FIG. 150 which shows Example 3 of the present disclosure, in Example 3, a mobile post-plating rapid cooling section device is further provided between the air knife section and the post-plating cooling section. The mobile post-plating rapid cooling section is provided in parallel with the alloying heating device to achieve rapid cooling of the strip steel after galvanizing for producing a pure zinc hot-dip galvanized high-strength steel product. Preferably, the mobile post-plating rapid cooling section device is disposed within 10 meters above the air knife section.

Referring to FIG. 151 which shows Example 4 of the present disclosure, in Example 4, a secondary reheating section device is provided after the uniform holding section to perform secondary reheating on the uniformly held strip steel, and then perform hot-dip galvanizing or overaging treatment.

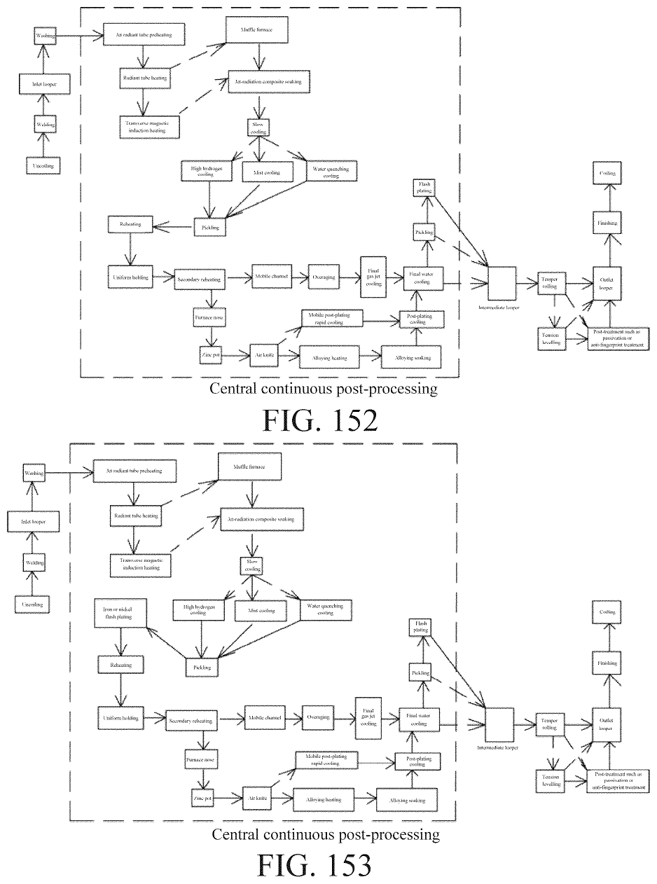

Referring to FIG. 152 which shows Example 5 of the present disclosure, in Example 5, a pickling section device is provided between the rapid cooling section and the reheating section. The pickling section device includes a pickling unit, a hot water brushing unit, a hot water rinsing unit, and a hot air drying unit to implement pickling of the strip steel surface. It may be used to remove the oxide layer on the strip steel surface after mist cooling and/or water quenching cooling. For a pure zinc hot-dip galvanized product or a hot-dip galvannealed product, it may also be used to improve the platability of high-strength strip steel, especially ultra-high-strength strip steel.

Referring to FIG. 153 which shows Example 6 of the present disclosure, in Example 6, preferably, an iron flash plating or nickel flash plating section device is provided after the pickling section, and then reheating treatment is performed to further improve the platability of the ultra-high-strength strip steel.

Preferably, a mobile gas jet rapid cooling device or a mobile mist cooling device is used for the mobile post-plating rapid cooling section.

### Example 1

A high-strength strip steel was prepared using the production line shown in FIG. 148. A strip steel with the main chemical composition (mass %) of the substrate being 0.08% C-0.02% Si-0.85% Mn was uncoiled, welded, passed through an inlet looper, and washed. It was then preheated to 280° C. in a jet radiant tube preheating furnace, then heated to 700° C. by radiant tube heating, then heated to 800° C. by transverse magnetic induction heating, then soaked at 800° C. by jet-radiation composite soaking for 60 seconds, then slowly cooled to 675° C., and then cooled to 260° C. by high hydrogen cooling. Then, it passed through a longitudinal magnetic induction heater (a reheating device; the longitudinal magnetic induction heater didn't need to be started in this Example), passed through a mobile channel section, and then entered an overaging section for overaging treatment at about 260° C. Then, it was cooled to about 145° C. using a final gas jet cooling device, and then cooled to 45° C. or lower by final water cooling. Then, it passed through an intermediate looper, followed by temper rolling and tension levelling. Then, it passed through an outlet looper, and then it was finished and coiled to complete the production. The final strip steel product had a yield strength of 453 MPa, a tensile strength of 512 MPa, and an elongation at break of 24%.

### Example 2

A high-strength strip steel was prepared using the production line shown in FIG. 149. A strip steel with the main chemical composition (mass %) of the substrate being 0.085% C-0.28% Si-2.3% Mn was uncoiled, welded, passed through an inlet looper, and washed. It was then preheated to 280° C. in a jet radiant tube preheating furnace, then heated to 710° C. by radiant tube heating, then heated to 810° C. by transverse magnetic induction heating, then soaked at 810° C. by jet-radiation composite soaking for 60 seconds, then slowly cooled to 670° C., and then cooled to 460° C. by high hydrogen cooling. Then, it passed through a longitudinal magnetic induction heater (a reheating device; the longitudinal magnetic induction heater didn't need to be started in this Example), and entered a uniform holding section for uniform holding at 460° C. Then, it passed through a furnace nose, and was immersed in a zinc pot for hot-dip galvanizing. After the coating weight was controlled by an air knife, it passed through an alloying heating section and an alloying soaking section with no action on it (the functions of the devices were not activated). Then, it was cooled to about 145° C. by post-plating cooling, and then cooled to 45° C. or lower by final water cooling. Then, it passed through an intermediate looper, followed by temper rolling. Then, it passed through an outlet looper, and then it was finished and coiled to complete the production. The final strip steel product had a yield strength of 912 MPa, a tensile strength of 1093 MPa, and an elongation at break of 9%.

### Example 3

A high-strength strip steel was prepared using the production line shown in FIG. 150. A strip steel with the main chemical composition (mass %) of the substrate being 0.080% C-0.80% Si-1.7% Mn was uncoiled, welded, passed through an inlet looper, and washed. It was then preheated to 275° C. in a jet radiant tube preheating furnace, then heated to 845° C. by radiant tube heating, then passed through a muffle furnace (into which nitrogen mixed with a trace amount of air was introduced) for trace surface pre-oxidation, then soaked at 845° C. by jet-radiation composite soaking for 60 seconds (a nitrogen-hydrogen protective gas was introduced into the soaking section), then slowly cooled to 680° C., and then cooled to 230° C. by high hydrogen jet cooling. Then, it was heated to 465° C. in a reheating section, and uniformly held. Then, it passed through a furnace nose, and was immersed in a zinc pot for hot-dip galvanizing. After the coating weight was controlled by an air knife, it was subjected to mobile post-plating cooling, and was cooled to about 140° C. by the post-plating cooling. Then, it was cooled to room temperature by final water cooling. Then, it passed through an intermediate looper, followed by temper rolling. Then, it passed through an outlet looper, and then it was finished and coiled to complete the production. The final strip steel product had a yield strength of 765 MPa, a tensile strength of 998 MPa, and an elongation at break of 14.9%.

### Example 4

A high-strength strip steel was prepared using the production line shown in FIG. 151. A strip steel with the main chemical composition (mass %) of the substrate being 0.10% C-0.16% Si-1.90% Mn was uncoiled, welded, passed through an inlet looper, and washed. It was then preheated to 265° C. in a jet radiant tube preheating furnace, then heated to 800° C. by radiant tube heating, then heated to 850° C. by transverse magnetic induction heating, then soaked at 850° C. by jet-radiation composite soaking for 60 seconds, then slowly cooled to 730° C., and then cooled to about 50° C. by mist cooling. Then, it was reheated to 230° C., passed through a uniform holding section, a secondary reheating section (the function of the device was not activated) and a mobile channel, and was overaged at 230° C. by overaging treatment. Then, it was cooled to about 140° C. by final gas jet cooling, and then cooled to room temperature by final water cooling. Subsequently, it was subjected to pickling treatment, followed by nickel flash plating. Then, it passed through an intermediate looper, followed by temper rolling. Then, it passed through an outlet looper, and then it was finished and coiled to complete the production. The final strip steel product had a yield strength of 936 MPa, a tensile strength of 1153 MPa, and an elongation at break of 14%.

### Example 5

A high-strength strip steel was prepared using the production line shown in FIG. 152. A strip steel with the main chemical composition (mass %) of the substrate being 0.155% C-0.32% Si-2.63% Mn was uncoiled, welded, passed through an inlet looper, and washed. It was then preheated to 265° C. in a jet radiant tube preheating furnace, and then heated to 835° C. by radiant tube heating. After passing through a muffle furnace with no action on it, it was soaked at 835° C. by jet-radiation composite soaking for 40 seconds, then slowly cooled to 755° C., then cooled to room temperature by water quenching cooling, then pickled, then heated to 230° C. in a reheating section, and then uniformly held. Then, it passed through a mobile channel, and entered an overaging section where it was subjected to overaging treatment at about 220° C. Then, it was cooled to about 140° C. by final gas jet cooling, and then cooled to room temperature by final water cooling. Then, it passed through an intermediate looper, followed by temper rolling. Then, it passed through an outlet looper, and then it was finished and coiled to complete the production. The final product had a yield strength of 1228 MPa, a tensile strength of 1501 MPa, and an elongation at break of 4.1%.

### Flexible Post-Cold-Rolling Processing Production Line Suitable for Producing a Variety of Ultra-High-Strength Strip Steels

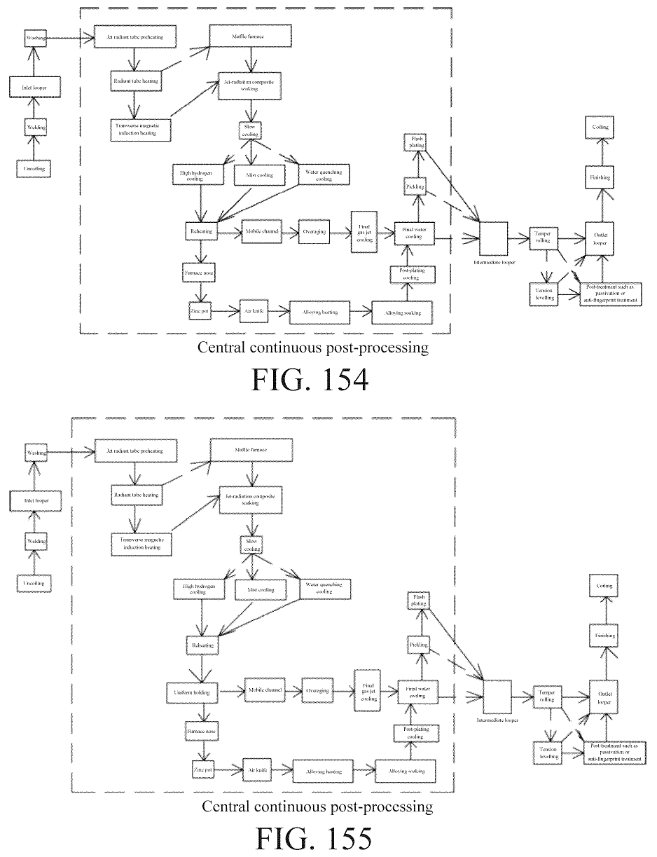

Referring to FIG. 154, the flexible post-cold-rolling processing production line suitable for producing a variety of ultra-high-strength strip steels according to the present disclosure includes the following stations in sequence: uncoiling—welding—inlet looper—washing—central continuous post-processing-inlet looper—temper rolling—outlet looper-finishing-coiling; wherein
the central continuous post-processing station includes in sequence a jet radiant tube preheating section, a radiant tube heating section, a selectable transverse magnetic induction heating section or muffle furnace section provided in parallel, a radiant tube soaking section, a slow cooling section, a rapid cooling section, a reheating section;
starting from the reheating section, two parallel routes are provided, one of which includes a furnace nose section, a zinc pot section, an air knife section, an alloying heating section, an alloying soaking section, and a post-plating cooling section, and is connected to a final water cooling section, and the other of which includes a mobile channel section, an overaging section, a final gas jet cooling section, and is connected to the final water cooling section;
the final water cooling section may be followed by a selectable pickling section and a selectable flash plating section in sequence;
a gas fuel such as natural gas or liquefied petroleum gas or coal gas is used in the heating section;
the jet radiant tube preheating section uses the combustion exhaust gas from the radiant tube heating section and/or the radiant tube soaking section to heat a recycled nitrogen-hydrogen protective gas by heat exchange in the furnace, and then the nitrogen-hydrogen protective gas is jetted onto the upper and lower surfaces of the strip steel to realize forced convection heat exchange;
the rapid cooling section includes a high hydrogen cooling section and/or a mist cooling section and/or a water quenching cooling section.

In addition to the jet direct fire preheating section, the production line uses high hydrogen cooling or mist cooling and/or water quenching cooling to implement rapid cooling treatment, followed by reheating, and then followed by galvanizing or over-aging treatment.

The furnace nose section is provided in parallel with the mobile channel section. The strip steel passes through the furnace nose section to produce pure zinc a hot-dip galvanized product or a hot-dip galvannealed product, and the strip steel passes through the mobile channel section to produce a cold-rolled annealed product, a pickled product or a flash-plated product.

A pickling section and a flash plating section are provided after the final water cooling section. The strip steel may pass through the pickling section for producing a cold-rolled pickled product, or may bypass the pickling section to produce a cold-rolled annealed product. The pickled strip steel may further enter the flash plating section for producing a product which is flash plated with nickel or zinc.

Thus, the production line has at least three process paths for selection, and enables production of five types of high-strength steel: cold-rolled annealed steel, pickled steel, flash plated steel, pure zinc hot-dip galvanized steel, and hot-dip galvannealed steel.

Referring to FIG. 154 which shows Example 1 of the present disclosure, in Example 1, a selectable tension levelling station and/or a selectable surface post-treatment station such as that for passivation or anti-fingerprint treatment is provided between the temper rolling station and the outlet looper station, and the strip steel may be subjected to tension leveling and/or surface post-treatment.

Preferably, the muffle furnace section device includes built-in sealing devices at the front and rear, and the muffle furnace section device is also equipped with an atmosphere regulating device, so that the hydrogen content, oxygen content and dew point therein can be regulated and controlled separately.

Referring to FIG. 155 which shows Example 2 of the present disclosure, in Example 2, a uniform holding section is further provided between the reheating section and the furnace nose section to hold the temperature of the strip steel before hot-dip galvanizing.

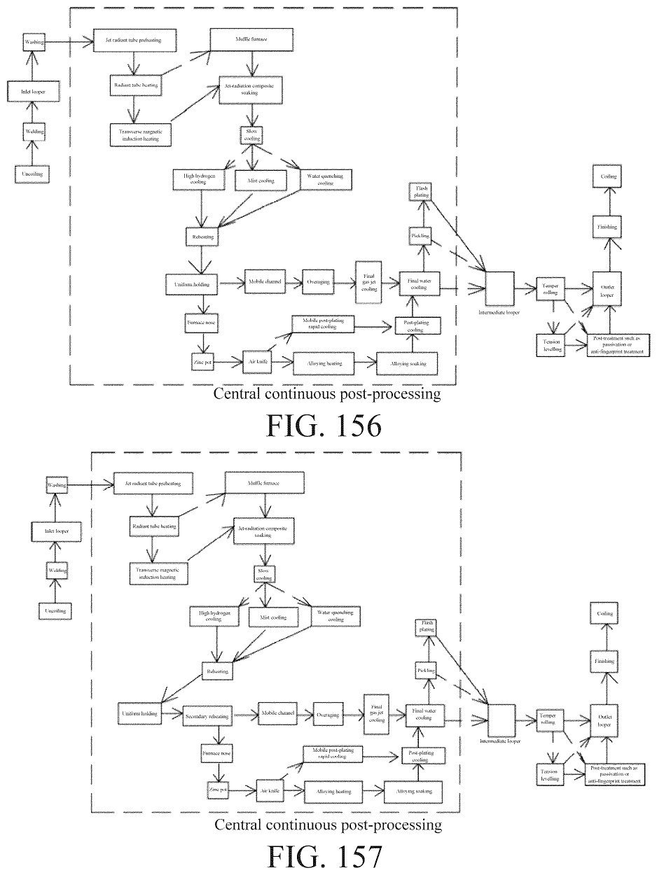

Referring to FIG. 156 which shows Example 3 of the present disclosure, in Example 3, a mobile post-plating rapid cooling section is further provided between the air knife section and the post-plating cooling section. The mobile post-plating rapid cooling section is provided in parallel with the alloying heating section to achieve rapid cooling of the strip steel after galvanizing for producing the pure zinc hot-dip galvanized high-strength steel product. Preferably, the mobile post-plating rapid cooling section device is disposed within 10 meters above the air knife section.

Referring to FIG. 157 which shows Example 4 of the present disclosure, in Example 4, a secondary reheating section device is provided after the uniform holding section to perform secondary reheating on the uniformly held strip steel, and then perform hot-dip galvanizing or overaging treatment.

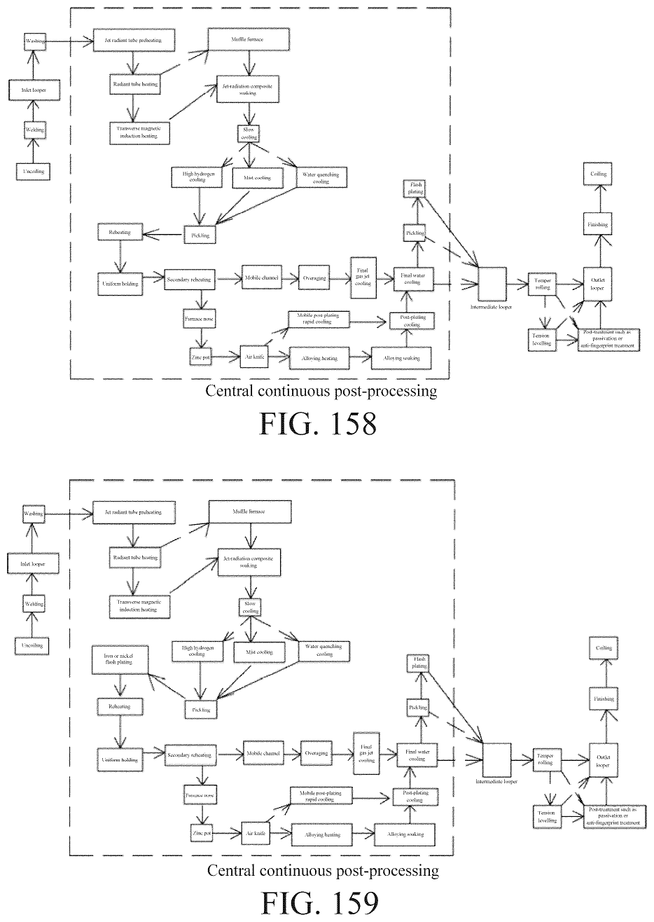

Referring to FIG. 158 which shows Example 5 of the present disclosure, in Example 5, a pickling section is provided between the high hydrogen cooling or mist cooling and/or water quenching cooling section and the reheating section. The pickling section includes a pickling unit, a hot water brushing unit, a hot water rinsing unit, and a hot air drying unit to implement pickling of the strip steel surface. It may be used to remove the oxide layer on the strip steel surface after mist cooling and/or water quenching cooling. For a pure zinc hot-dip galvanized product or a hot-dip galvannealed product, it may also be used to improve the platability of high-strength strip steel, especially ultra-high-strength strip steel.

Referring to FIG. 159 which shows Example 6 of the present disclosure, in Example 6, an iron flash plating or nickel flash plating section is provided after the pickling section and before the reheating section, and then reheating treatment is performed to further improve the platability of the ultra-high-strength strip steel.

Preferably, a mobile gas jet rapid cooling device or a mobile mist cooling device is used for the mobile post-plating rapid cooling section.

### Example 1

An ultra-high-strength strip steel was prepared using the production line shown in FIG. 154. A strip steel with the main chemical composition (mass %) of the substrate being 0.095% C-0.30% Si-1.7% Mn was uncoiled, welded, passed through an inlet looper, and washed. It was then preheated to 280° C. by jet radiant tube preheating, and then heated to 720° C. by radiant tube heating. A transverse magnetic induction heating device and a muffle furnace were provided in parallel after the radiant tube heating device. In this Example, the strip steel was heated to 820° C. by transverse magnetic induction heating, and soaked at 820° C. by radiant tube soaking for 60 seconds. Then, it was slowly cooled to 670° C. In this Example, the rapid cooling section was provided in parallel with high hydrogen cooling, mist cooling and water quenching cooling. In this Example, the strip steel was cooled to 230° C. by high hydrogen jet cooling. Then, it passed through a reheating section (the reheating device didn't need to be started to work) and a mobile channel, and entered an overaging section where it was subjected to overaging treatment at 230° C. Then, it was cooled to about 145° C. by final gas jet cooling, and then cooled to room temperature by final water cooling. Then, it entered an intermediate looper, followed by temper rolling and tension levelling. Then, it entered an outlet looper, and then it was finished and coiled to complete the production. The final strip steel product had a yield strength of 765 MPa, a tensile strength of 1026 MPa, and an elongation at break of 12.5%.

### Example 2

An ultra-high-strength strip steel was prepared using the production line shown in FIG. 155.

A strip steel with the main chemical composition (mass %) of the substrate being 0.085% C-0.85% Si-1.8% Mn was uncoiled, welded, passed through an inlet looper, and washed. It was then preheated to 270° C. by jet radiant tube preheating, and then heated to 810° C. by radiant tube heating. In this Example, a transverse magnetic induction heating device and a muffle furnace were provided in parallel after the radiant tube heating device. In this Example, the strip steel passed through the muffle furnace (into which nitrogen mixed with a trace amount of air was introduced) for trace surface pre-oxidation, and was soaked at 810° C. by radiant tube soaking for 50 seconds (a nitrogen-hydrogen protective gas was introduced into the soaking section). Then, it was slowly cooled to 670° C. In this Example, the rapid cooling section was provided in parallel with high hydrogen cooling, mist cooling and water quenching cooling. In this Example, the strip steel was cooled to 470° C. by high hydrogen jet cooling. Then, it passed through a reheating section (the reheating device didn't need to be started to work) and a uniform holding section, and entered a furnace nose. Then, it was immersed in a zinc pot for hot-dip galvanizing. After the coating weight was controlled by an air knife, it entered an alloying soaking section (the alloying heating furnace was offline, and the alloying soaking furnace was not put into use). Then, the strip steel was cooled to about 140° C. by post-plating cooling, and then cooled to room temperature by final water cooling. Then, it entered an intermediate looper, followed by temper rolling and passivation treatment. Then, it entered an outlet looper, and then it was finished and coiled to complete the production. The final strip steel product had a yield strength of 781 MPa, a tensile strength of 1015 MPa, and an elongation at break of 13.6%.

### Example 3

An ultra-high-strength strip steel was prepared using the production line shown in FIG. 156. A strip steel with the main chemical composition (mass %) of the substrate being 0.085% C-1.5% Si-2.3% Mn was uncoiled, welded, passed through an inlet looper, and washed. It was then preheated to 270° C. by jet radiant tube preheating, and then heated to 810° C. by radiant tube heating. In this Example, a transverse magnetic induction heating device and a muffle furnace were provided in parallel after the radiant tube heating device. In this Example, the strip steel was heated to 910° C. by transverse magnetic induction heater, and soaked at 910° C. by radiant tube soaking for 70 seconds. Then, it was slowly cooled to 675° C. In this Example, the rapid cooling section was provided in parallel with high hydrogen cooling, mist cooling and water quenching cooling. In this Example, the strip steel was cooled to 235° C. by high hydrogen jet cooling. Then, it was reheated to 460° C. in a reheating section, and subjected to uniform holding at 460° C. Then, it passed through a furnace nose, and was immersed in a zinc pot for hot-dip galvanizing. The coating weight was controlled by an air knife. In this Example, a mobile post-plating rapid cooling section was provided within 10 meters above the air knife section. The mobile post-plating rapid cooling section was provided in parallel with the alloying heating section and the alloying soaking section. In this Example, the strip steel was cooled rapidly in the mobile post-plating rapid cooling section, and then entered a post-plating cooling section for further cooling. Subsequently, it was cooled to room temperature by final water cooling. Then, it entered an intermediate looper, followed by temper rolling and tension levelling. The tension levelling was performed by a strong tension levelling device that could perform tension levelling on the ultra-high-strength steel to improve its plate shape. Then, it entered an outlet looper, and then it was finished and coiled to complete the production. The final strip steel product had a yield strength of 671 MPa, a tensile strength of 993 MPa, and an elongation at break of 16.6%.

### Example 4

An ultra-high-strength strip steel was prepared using the production line shown in FIG. 157. A strip steel with the main chemical composition (mass %) of the substrate being 0.16% C-1.8% Si-2.3% Mn was uncoiled, welded, passed through an inlet looper, and washed. It was then preheated to 269° C. by jet radiant tube preheating, and then heated to 815° C. by radiant tube heating. In this Example, a transverse magnetic induction heating device and a muffle furnace were provided in parallel after the radiant tube heating device. In this Example, the strip steel was heated to 915° C. by transverse magnetic induction heating, and soaked at 915° C. by radiant tube soaking for 80 seconds. Then, it was slowly cooled to 670° C. In this Example, the rapid cooling section was provided in parallel with high hydrogen cooling, mist cooling and water quenching cooling. In this Example, the strip steel was cooled to 230° C. by high hydrogen cooling. Then, it was reheated to 420° C., subjected to uniform holding at 420° C., and then heated to 460° C. by secondary reheating. Then, it passed through a furnace nose, and was immersed in a zinc pot for hot-dip galvanizing. After the coating weight was controlled by an air knife, the strip steel entered an alloying heating section to be heated to 510° C., and was subjected to alloying soaking at about 505° C. for 20 seconds. Then, it was subjected to post-plating cooling, and then cooled to room temperature by final water cooling. Then, it entered an intermediate looper, followed by temper rolling. Then, it entered an outlet looper directly, and then it was finished and coiled to complete the production. The final strip steel product had a yield strength of 786 MPa, a tensile strength of 1055 MPa, and an elongation at break of 21%.

### Example 5

An ultra-high-strength strip steel was prepared using the production line shown in FIG. 158. A strip steel with the main chemical composition (mass %) of the substrate being 0.11% C-0.17% Si-1.95% Mn was uncoiled, welded, passed through an inlet looper, and washed. It was then preheated to 265° C. by jet radiant tube preheating, and then heated to 820° C. by radiant tube heating. In this Example, a transverse magnetic induction heating device and a muffle furnace were provided in parallel after the radiant tube heating device. In this Example, the strip steel was heated to 920° C. by transverse magnetic induction heating, and soaked at 920° C. by radiant tube soaking for 60 seconds. Then, it was slowly cooled to 750° C. In this Example, the rapid cooling section was provided in parallel with high hydrogen cooling, mist cooling and water quenching cooling. In this Example, the strip steel was cooled to about 50° C. by mist cooling. Then, it was pickled, and then reheated to 230° C. After passing through a uniform holding section, a secondary reheating section (the heating function was not activated) and a mobile channel, the strip steel entered an overaging section for overaging treatment. Then, it was cooled to about 140° C. by final gas jet cooling, and then cooled to room temperature by final water cooling. Subsequently, it was subjected to pickling treatment, followed by nickel flash plating. Then, it entered an intermediate looper, followed by temper rolling. Then, it entered an outlet looper, and then it was finished and coiled to complete the production of a product flash-plated with nickel. The final strip steel product had a yield strength of 987 MPa, a tensile strength of 1199 MPa, and an elongation at break of 13.1%.

### Example 6

An ultra-high-strength strip steel was prepared using the production line shown in FIG. 159. A strip steel with the main chemical composition (mass %) of the substrate being 0.15% C-0.3% Si-2.6% Mn was uncoiled, welded, passed through an inlet looper, and washed. It was then preheated to 275° C. by jet radiant tube preheating, and then heated to 835° C. by radiant tube heating. In this Example, a transverse magnetic induction heating device and a muffle furnace were provided in parallel after the radiant tube heating device. In this Example, after the strip steel passed through the muffle furnace with no action on it, it was soaked at 835° C. by radiant tube soaking for 40 seconds. Then, it was slowly cooled to 750° C. In this Example, the rapid cooling section was provided in parallel with high hydrogen cooling, mist cooling and water quenching cooling. In this Example, the strip steel was cooled to room temperature by water quenching cooling, pickled, and then flash plated with nickel. Then, it was heated to 235° C. in a reheating section. After passing through a uniform holding section, a secondary reheating section (the secondary reheating function was not activated) and a mobile channel, it entered an overaging section where it was subjected to overaging treatment at 230° C. Then, it was cooled to about 140° C. by final gas jet cooling, and then cooled to room temperature by final water cooling. Then, the strip steel passed through an intermediate looper, followed by temper rolling. Then, it passed through an outlet looper, and then it was finished and coiled to complete the production. The final product had a yield strength of 1286 MPa, a tensile strength of 1502 MPa, and an elongation at break of 4.1%.

### Flexible Cold-Rolled Strip Steel Post-Processing Line Suitable for Producing a Variety of High-Strength Steels

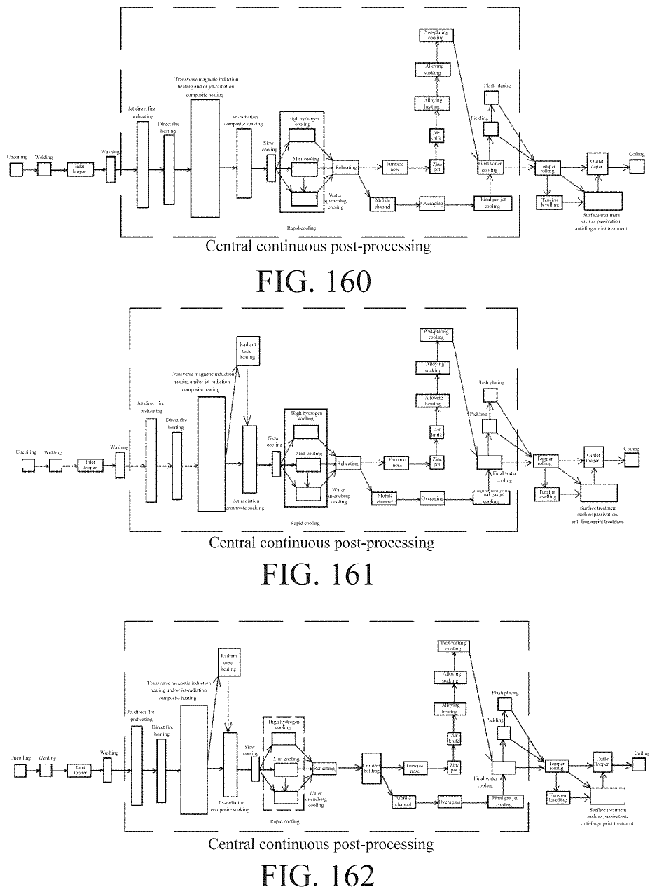

Referring to FIG. 160, the flexible cold-rolled strip steel post-processing line suitable for producing a variety of high-strength steels according to the present disclosure includes the following stations in sequence: uncoiling—welding—inlet looper—washing—central continuous post-processing—intermediate looper—temper rolling—outlet looper—finishing—coiling; wherein
the central continuous post-processing station includes in sequence a jet direct fire preheating section, a direct fire heating section, a transverse magnetic induction heating section or a jet-radiation composite heating section, a jet-radiation composite soaking section, a slow cooling section, a rapid cooling section, and a reheating section;
starting from the reheating section, two parallel routes are provided, one of which includes a furnace nose section, a zinc pot section, an air knife section, an alloying heating section, an alloying soaking section, and a post-plating cooling section, and is further connected to a final water cooling section, and the other of which includes a mobile channel section, an overaging section, a final gas jet cooling section, and is further connected to the final water cooling section;
the final water cooling section may be followed by a selectable pickling section and a flash plating section;
the rapid cooling section includes a high hydrogen cooling section or a mist cooling section and/or a water quenching cooling section;
a gas fuel such as natural gas or liquefied petroleum gas is combusted in the direct fire heating section;
the jet direct fire preheating section uses the combustion exhaust gas from the direct fire heating section to heat a recycled nitrogen-hydrogen protective gas by heat exchange in the furnace, and then the nitrogen-hydrogen protective gas is jetted onto the upper and lower surfaces of the strip steel to realize forced convection heat exchange;
the transverse magnetic induction heating section or the jet-radiation composite heating section is provided in parallel or in series;
a selectable tension levelling station and/or a selectable surface post-treatment station such as that for passivation or anti-fingerprint treatment is provided between the temper rolling station and the outlet looper station;
the jet-radiation composite soaking section utilizes a rapid soaking mode combining forced convection and radiation;
thus, the production line has at least three process paths for selection, and enables production of five types of high-strength steel: cold-rolled annealed steel, pickled steel, flash plated steel, pure zinc hot-dip galvanized steel, and hot-dip galvannealed steel.

Referring to FIG. 161 which shows Example 2 of the present disclosure, Example 2 is based on Example 1, wherein a radiant tube heating section is provided between the jet-radiation composite heating section and the jet-radiation composite soaking section.

Referring to FIG. 162 which shows Example 3 of the present disclosure, Example 3 is based on Example 2, wherein a uniform holding section is provided between the reheating section and the furnace nose section to hold the temperature of the strip steel before hot-dip galvanizing.

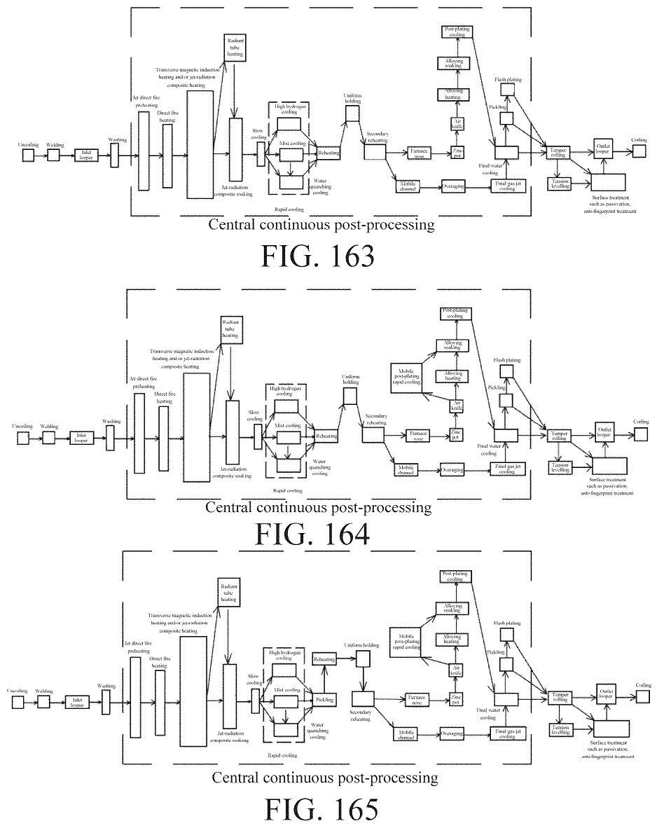

Referring to FIG. 163 which shows Example 4 of the present disclosure, Example 4 is based on Example 3, wherein a secondary reheating section is provided between the uniform holding section and the furnace nose section so that the strip steel is subjected to secondary reheating before hot-dip galvanizing.

Referring to FIG. 164 which shows Example 5 of the present disclosure, Example 5 is based on Example 4, wherein a mobile post-plating rapid cooling section is provided between the air knife section and the post-plating cooling section. The mobile post-plating rapid cooling section is provided in parallel with the alloying heating section, thereby enabling rapid cooling of a pure zinc hot-dip galvanized high-strength steel product. Preferably, the mobile post-plating rapid cooling section device is disposed within 10 meters above the air knife section.

Referring to FIG. 165 which shows Example 6 of the present disclosure, Example 6 is based on Example 5, wherein a pickling section is provided before the reheating section, and the pickling section includes a pickling unit, a hot water brushing unit, a hot water rinsing unit, and a hot air drying unit to implement pickling of the strip steel surface. It may be used to remove the oxide layer on the strip steel surface after mist cooling and/or water quenching cooling. For a pure zinc hot-dip galvanized product or a hot-dip galvannealed product, it may also be used to improve the platability of high-strength strip steel, especially ultra-high-strength strip steel.

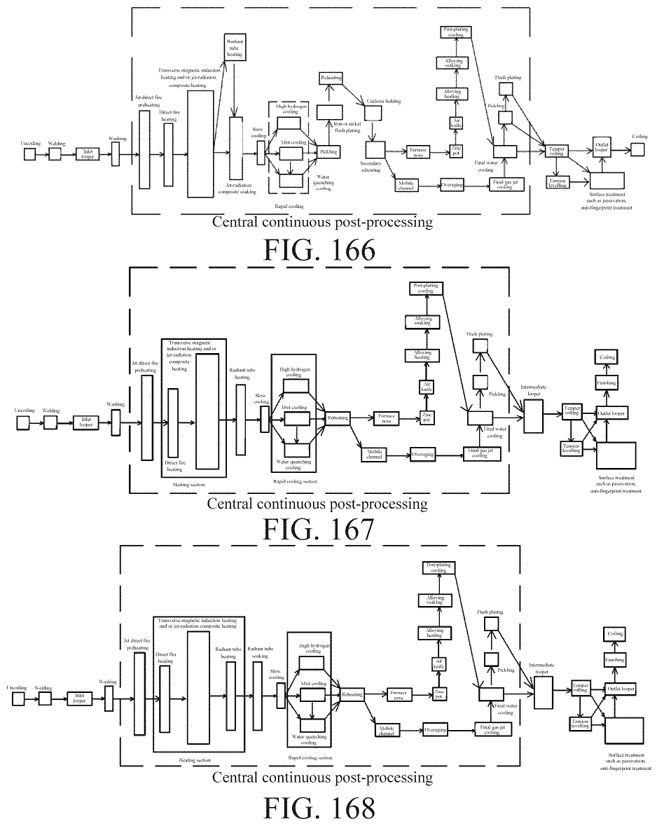

Referring to FIG. 166 which shows Example 7 of the present disclosure, Example 7 is based on Example 6, wherein an iron flash plating or nickel flash plating section is provided after the pickling section and before the reheating section, and then reheating treatment is carried out, which may further improve the platability of ultra-high-strength strip steel.

### Example 1

A high-strength strip steel was produced using the production line whose layout is shown in FIG. 160. A strip steel with the main chemical composition (mass %) of the substrate being 0.09% C-0.32% Si-2.15% Mn was uncoiled, welded, passed through an inlet looper, and washed. It was then preheated to 380° C. by jet direct fire preheating, then heated to 680° C. by direct fire heating, then heated to 800° C. by jet-radiation composite heating, then soaked at 800° C. by jet-radiation composite soaking for 60 seconds, then slowly cooled to 675° C., and then cooled to 480° C. by high hydrogen cooling. Then, it passed first through a longitudinal magnetic induction heater (a reheating device; the longitudinal magnetic induction heater didn't need to be started in this Example), then passed through a furnace nose, and then was immersed in a zinc pot for hot-dip galvanizing. After the coating weight was controlled by an air knife, the strip steel was heated to 520° C. to alloy the coating, and soaked at 510° C. by alloying soaking for 20 seconds. Then, the strip steel was cooled to about 145° C. using a post-plating cooling device, and then cooled to 45° C. or lower by final water cooling. Then, it entered an intermediate looper, followed by temper rolling and surface L treatment (a method for post-treatment of the coating surface of a hot-dip galvannealed product). Then, it passed through an outlet looper, and then it was finished and coiled to complete the production. The final strip steel product had a yield strength of 692 MPa, a tensile strength of 997 MPa, and an elongation at break of 14%.

### Example 2

A high-strength strip steel was produced using the production line whose layout is shown in FIG. 161. A strip steel with the main chemical composition (mass %) of the substrate being 0.07% C-0.49% Si-2.10% Mn was uncoiled, welded, passed through an inlet looper, and washed. It was then preheated to 360° C. by jet direct fire preheating, then heated to 690° C. by direct fire heating, then heated to 820° C. by transverse magnetic induction heating, then soaked at 820° C. by jet-radiation composite soaking for 60 seconds, then slowly cooled to 670° C., and then cooled to 230° C. by high hydrogen cooling. Then, it passed first through a longitudinal magnetic induction heater (a reheating device; the longitudinal magnetic induction heater didn't need to be started in this Example), then passed through a mobile channel section, and entered an overaging section for overaging treatment at about 230° C. Then, the strip steel was cooled to about 140° C. by final gas jet cooling, and then cooled to 45° C. or lower by final water cooling. Then, it entered an intermediate looper, followed by strong tension levelling. Then, it passed through an outlet looper, and then it was finished and coiled to complete the production. The final strip steel product had a yield strength of 679 MPa, a tensile strength of 1023 MPa, and an elongation at break of 15%.

### Example 3

A high-strength strip steel was produced using the production line whose layout is shown in FIG. 162. A strip steel with the main chemical composition (mass %) of the substrate being 0.17% C-1.7% Si-2.3% Mn was uncoiled, welded, passed through an inlet looper, and washed. It was then preheated to 375° C. by jet direct fire preheating, then heated to 740° C. by direct fire heating, then heated to 850° C. by transverse magnetic induction heating, then soaked at 850° C. by jet-radiation composite soaking for 80 seconds, then slowly cooled to 675° C., and then cooled to 250° C. by high hydrogen cooling. Then, it passed first through a longitudinal magnetic induction heater (a reheating device) to be reheated to 460° C., uniformly held for 100 seconds, then passed through a furnace nose, and then was immersed in a zinc pot for hot-dip galvanizing. After the coating weight was controlled by an air knife, the strip steel entered an alloying heating furnace (in this Example, the strip steel only passed through with no action on it, and the device didn't need to be started to work) and an alloying soaking furnace (in this Example, the strip steel only passed through with no action on it, and the device didn't need to be started to work). Then, the strip steel was cooled to about 140° C. using a post-plating cooling device, and then cooled to 45° C. or lower by final water cooling. Then, it entered an intermediate looper, followed by temper rolling and strong tension levelling. Then, it passed through an outlet looper, and then it was finished and coiled to complete the production. The final strip steel product had a yield strength of 752 MPa, a tensile strength of 1086 MPa, and an elongation at break of 15%.

### Example 4

A high-strength strip steel was produced using the production line whose layout is shown in FIG. 163. A strip steel with the main chemical composition (mass %) of the substrate being 0.18% C-1.8% Si-2.70% Mn was uncoiled, welded, passed through an inlet looper, and washed. It was then preheated to 370° C. by jet direct fire preheating, then heated to 730° C. by direct fire heating, then heated to 845° C. by transverse magnetic induction heating, then soaked at 845° C. by jet-radiation composite soaking for 80 seconds, then slowly cooled to 675° C., and then cooled to 270° C. by high hydrogen cooling. Then, it passed first through a longitudinal magnetic induction heater (a reheating device) to be reheated to 410° C., uniformly held for 100 seconds, then heated to 465° C. by secondary reheating, then passed through a furnace nose, and then was immersed in a zinc pot for hot-dip galvanizing. After the coating weight was controlled by an air knife, the strip steel entered an alloying heating furnace to be heated to 510° C., and held at 500° C. in an alloying soaking furnace for 20 seconds. Then, the strip steel was cooled to about 140° C. using a post-plating cooling device, and then cooled to 45° C. or lower by final water cooling. Then, it entered an intermediate looper, followed by temper rolling. Then, it passed through an outlet looper, and then it was finished and coiled to complete the production. The final strip steel product had a yield strength of 938 MPa, a tensile strength of 1216 MPa, and an elongation at break of 16%.

### Example 5

A high-strength strip steel was produced using the production line whose layout is shown in FIG. 165. A strip steel with the main chemical composition (mass %) of the substrate being 0.16% C-0.50% Si-1.70% Mn was uncoiled, welded, passed through an inlet looper, and washed. It was then preheated to 360° C. by jet direct fire preheating, then heated to 730° C. by direct fire heating, then heated to 830° C. by transverse magnetic induction heating, then heated to 850° C. by jet-radiation composite heating, then soaked at 850° C. by jet-radiation composite soaking for 60 seconds, then slowly cooled to 740° C., then cooled to room temperature by water quenching cooling, then pickled, and then reheated to 230° C. Then, it passed through a mobile channel, and entered an overaging section for overaging treatment at about 230° C. Then, the strip steel was cooled to 130° C. by final gas jet cooling, and then cooled to 45° C. or lower by final water cooling. Then, it was pickled, and entered an intermediate looper, followed by temper rolling. Then, it passed through an outlet looper, and then it was finished and coiled to complete the production. The final strip steel product had a yield strength of 1203 MPa, a tensile strength of 1436 MPa, and an elongation at break of 7%.

### Example 6

A high-strength strip steel was produced using the production line whose layout is shown in FIG. 166. A strip steel with the main chemical composition (mass %) of the substrate being 0.17% C-1.72% Si-2.65% Mn was uncoiled, welded, passed through an inlet looper, and washed. It was then preheated to 372° C. by jet direct fire preheating, then heated to 750° C. by direct fire heating, then heated to 850° C. by transverse magnetic induction heating, then soaked at 850° C. by jet-radiation composite soaking for 80 seconds, then slowly cooled to 675° C., then cooled to 260° C. by mist cooling, and then cooled to about 50° C. by water quenching. Then, it was pickled first, and then flash plated with nickel. After it was reheated to 400° C., it was uniformly held at 400° C. to achieve redistribution of the carbon element in the strip steel and stabilize the residual austenite structure in the strip steel. Then, it was heated to 460° C. by secondary reheating, then passed through a furnace nose, and then was immersed in a zinc pot for hot-dip galvanizing. After the coating weight was controlled by an air knife, the strip steel entered an alloying heating furnace to be heated to 510° C., and held at 500° C. for 18 seconds. Then, the strip steel was cooled to 150° C. or lower by post-plating cooling, and then cooled to 45° C. or lower by final water cooling. Then, it entered an intermediate looper, followed by temper rolling. Then, it passed through an outlet looper, and then it was finished and coiled to complete the production. The final strip steel product had a yield strength of 988 MPa, a tensile strength of 1201 MPa, and an elongation at break of 16%.

As the largest automobile production base and market in the world, China has a considerable need for high-strength and ultra-high-strength steel for the development of lightweight automobiles. Under this situation, the jet direct fire preheating, transverse magnetic induction heating, jet-radiation composite heating and jet-radiation composite soaking provided by the present disclosure are very suitable for production lines for producing a variety of ultra-high-strength strip steels, and are also very suitable for producing various high-strength steels and ultra-high-strength steels. Moreover, the core processes of the present disclosure have been realized in industrial applications. Under the current situation where the demand for ultra-high-strength steel in the market is increasing year by year, it has a very broad application prospect.

### Flexible Production Line for Various High-Strength/Ultra-High-Strength Steels

Referring to FIG. 167 which shows Example 1 of the present disclosure, the flexible production line for producing various high-strength/ultra-high-strength steels includes the following stations in sequence: uncoiling—welding—inlet looper—washing—central continuous post-processing—intermediate looper—temper rolling—outlet looper—finishing—coiling, wherein
the central continuous post-processing station includes in sequence a jet direct fire preheating section, a heating section, a radiant tube soaking section, a slow cooling section, a rapid cooling section, a reheating section and two parallel processing lines, a final water cooling section and a selectable pickling section and a selectable flash plating section;
one of the processing lines includes a furnace nose section, a zinc pot section, an air knife section, an alloying heating section, an alloying soaking section, and a post-plating cooling section; and the other processing line includes a mobile channel section, an over-aging section, and a final gas jet cooling section;
a direct fire heating section and a transverse magnetic induction heating section and/or a jet-radiation composite heating section are used for the heating section;
the transverse magnetic induction heating section and the jet-radiation composite heating section are provided in parallel or in series for rapid heating of the strip steel; preferably, they are provided in series, and the transverse magnetic induction heating may be selected for use in light of the peak and valley electricity prices to reduce production cost;
the rapid cooling section includes high hydrogen cooling or mist cooling and/or water quenching cooling;
the furnace nose section and the mobile channel section device are provided in parallel, and the strip steel passes through the furnace nose section to produce a pure zinc hot-dip galvanized product or a hot-dip galvannealed product, or the strip steel passes through the mobile channel section to produce a cold-rolled annealed product, or a flash-plated product;
the final water cooling section may be followed by a selectable pickling section and a selectable flash plating section, and the strip steel may pass through the flash plating section to produce a cold-rolled flash-plated product that is flash plated with nickel or zinc, or bypass the flash plating section to produce a cold-rolled annealed product;
a selectable tension levelling station and/or a selectable surface post-treatment station such as that for passivation or anti-fingerprint treatment is further provided between the temper rolling station and the outlet looper station.

In addition to the jet direct fire preheating section, this production line uses high hydrogen cooling or mist cooling and/or water quenching cooling to implement rapid cooling treatment, followed by reheating, and then followed by galvanizing or overaging treatment.

This production line has at least three process paths for selection, and enables production of five types of high-strength steel: cold-rolled annealed steel, pickled steel, flash plated steel, pure zinc hot-dip galvanized steel, and hot-dip galvannealed steel.

Preferably, the selectable pickling section device includes a pickling unit, a hot water brushing unit, a hot water rinsing unit, and a hot air drying unit to implement pickling of the strip steel surface. It may be used to remove the oxide layer on the strip steel surface after mist cooling and/or water quenching cooling, and may also be used to improve the bonding strength of the coating obtained by subsequent flash plating.

Referring to FIG. 168, according to Example 2 of the present disclosure, the production line is characterized in that a radiant tube heating section is further provided between the jet-radiation composite heating section and the radiant tube soaking section, and the strip steel may be further heated by radiant tube heating after being heated by transverse magnetic induction heating or jet-radiation composite heating, followed by radiant tube soaking. Of course, the strip steel may also be subjected to radiant tube soaking directly after being heated by jet-radiation composite heating.

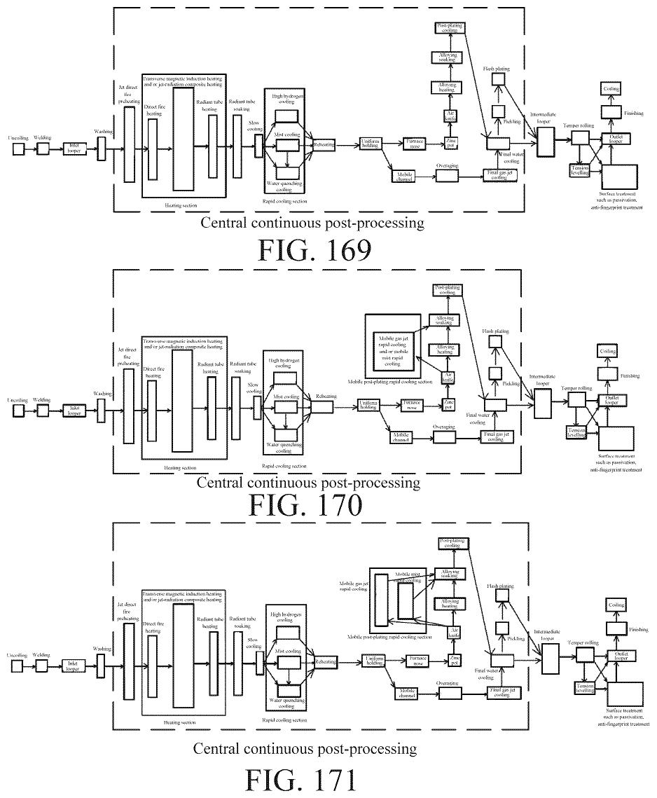

Referring to FIG. 169, according to Example 3 of the present disclosure, the production line is characterized in that a uniform holding section is further provided between the reheating section and the furnace nose section to hold the temperature of the strip steel before hot-dip galvanizing.

Referring to FIG. 170, according to Example 4 of the present disclosure, the production line is characterized in that a mobile post-plating rapid cooling section is provided between the air knife section and the post-plating cooling section. The mobile post-plating rapid cooling section is provided in parallel with the alloying heating section to achieve rapid cooling of the strip steel after galvanizing for producing a pure zinc hot-dip galvanized high-strength steel product. More preferably, the mobile post-plating rapid cooling section device is disposed within 10 meters above the air knife section.

Referring to FIG. 171, according to Example 5 of the present disclosure, the production line is characterized in that a mobile gas jet rapid cooling section and/or a mobile mist rapid cooling section is used for the mobile post-plating rapid cooling section. When both the mobile gas jet rapid cooling section device and the mobile mist rapid cooling section device are provided, the two section devices are provided in parallel, and one of them is selected during production to achieve post-plating rapid cooling of the strip steel.

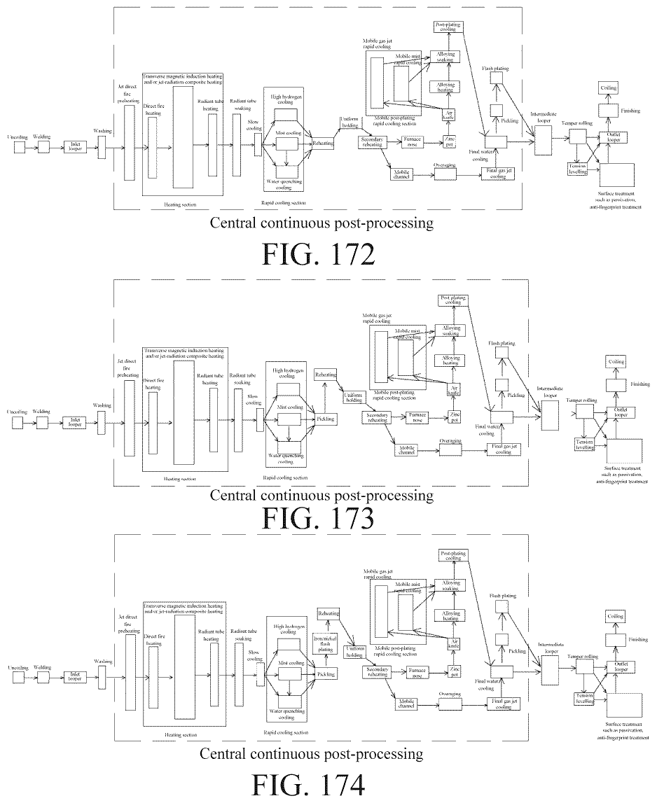

Referring to FIG. 172, according to Example 6 of the present disclosure, the production line is characterized in that a secondary reheating section is provided after the uniform holding section to perform secondary reheating on the uniformly held strip steel, followed by hot-dip galvanizing or overaging treatment.

Referring to FIG. 173, according to Example 7 of the present disclosure, the production line is characterized in that a pickling section is provided between the high hydrogen cooling or mist cooling and/or water quenching cooling section and the reheating section, and the pickling section includes a pickling unit, a hot water brushing unit, a hot water rinsing unit, and a hot air drying unit to implement pickling of the strip steel surface. It may be used to remove the oxide layer on the strip steel surface after mist cooling and/or water quenching cooling. For a pure zinc hot-dip galvanized product or a hot-dip galvannealed product, it may also be used to improve the platability of high-strength strip steel, especially ultra-high-strength strip steel.

Referring to FIG. 174, according to Example 8 of the present disclosure, the production line is characterized in that an iron flash plating or nickel flash plating section is provided after the pickling section and before the reheating section, and then reheating treatment is performed to further improve the platability of the ultra-high-strength strip steel.

### Example 1

Referring to FIG. 167, a high-strength strip steel was prepared. A strip steel with the main chemical composition (mass %) of the substrate being 0.08% C-0.45% Si-2.2% Mn was uncoiled, welded, passed through an inlet looper, and washed. It was then preheated to 350° C. by jet direct fire preheating, then heated to 700° C. by direct fire heating, then heated to 820° C. by transverse magnetic induction heating, then soaked at 820° C. by radiant tube soaking, then slowly cooled to 690° C., and then cooled to 490° C. by high hydrogen cooling. Then, it passed first through a longitudinal magnetic induction heater (a reheating device; the longitudinal magnetic induction heater didn't need to be started in this Example), then passed through a furnace nose, and then was immersed in a zinc pot for hot-dip galvanizing. After the coating weight was controlled by an air knife, it entered an alloying heating furnace (in this Example, the strip steel only passed through with no action on it, and the device didn't need to be started to work) and an alloying soaking furnace (in this Example, the strip steel only passed through with no action on it, and the device didn't need to be started to work). Then, it was cooled to about 140° C. using a post-plating cooling device, and then cooled to 45° C. or lower by final water cooling. Then, it entered an intermediate looper, followed by temper rolling. Then, it passed through an outlet looper, and then it was finished and coiled to complete the production. The final strip steel product had a yield strength of 712 MPa, a tensile strength of 1039 MPa, and an elongation at break of 11%.

### Example 2

Referring to FIG. 168, a high-strength strip steel was prepared. A strip steel with the main chemical composition (mass %) of the substrate being 0.18% C-0.4% Si-1.8% Mn was uncoiled, welded, passed through an inlet looper, and washed. It was then preheated to 260° C. by jet direct fire preheating, then heated to 630° C. by direct fire heating, then heated to 750° C. by jet-radiation composite heating, then heated to 850° C. by radiant tube heating, then slowly cooled to 750° C., then cooled to 380° C. by mist cooling, then cooled to room temperature by water quenching cooling, and then reheated to 230° C. Then, it passed through a mobile channel, and entered an overaging section for overaging treatment at about 230° C. Then, it was cooled to 140° C. by final gas jet cooling, then cooled to 45° C. or lower by final water cooling, then pickled, and then flash plated with nickel. Then, it entered an intermediate looper, followed by temper rolling. Then, it passed through an outlet looper, and then it was finished and coiled to complete the production. The final strip steel product had a yield strength of 1310 MPa, a tensile strength of 1540 MPa, and an elongation at break of 4%.

### Example 3

Referring to FIG. 169, a high-strength strip steel was prepared. A strip steel with the main chemical composition (mass %) of the substrate being 0.09% C-0.3% Si-2.1% Mn was uncoiled, welded, passed through an inlet looper, and washed. It was then preheated to 350° C. by jet direct fire preheating, then heated to 600° C. by direct fire heating, then heated to 700° C. by transverse magnetic induction heating, then heated to 790° C. by radiant tube heating, then soaked at 790° C. by radiant tube soaking, then slowly cooled to 680° C., and then cooled to 475° C. by high hydrogen cooling. Then, it passed first through a longitudinal magnetic induction heater (a reheating device; the longitudinal magnetic induction heater didn't need to be started in this Example), then uniformly held at 475° C., then passed through a furnace nose, and then was immersed in a zinc pot for hot-dip galvanizing. After the coating weight was controlled by an air knife, it entered an alloying heating furnace (in this Example, the strip steel only passed through with no action on it, and the device didn't need to be started to work) and an alloying soaking furnace (in this Example, the strip steel only passed through with no action on it, and the device didn't need to be started to work). Then, it was cooled to about 140° C. using a post-plating cooling device, and then cooled to 45° C. or lower by final water cooling. Then, it entered an intermediate looper, followed by temper rolling and tension levelling. Then, it passed through an outlet looper, and then it was finished and coiled to complete the production. The final strip steel product had a yield strength of 682 MPa, a tensile strength of 998 MPa, and an elongation at break of 13%.

### Example 4

Referring to FIG. 170, a high-strength strip steel was prepared. A strip steel with the main chemical composition (mass %) of the substrate being 0.08% C-0.45% Si-2.15% Mn was uncoiled, welded, passed through an inlet looper, and washed. It was then preheated to 350° C. by jet direct fire preheating, then heated to 650° C. by direct fire heating, then heated to 750° C. by jet-radiation composite heating, then heated to 820° C. by radiant tube heating, then soaked at 820° C. by radiant tube soaking, then slowly cooled to 670° C., then cooled to 320° C. by high hydrogen cooling, then reheated to 460° C. using a longitudinal magnetic induction heater, and then uniformly held at 460° C. Then, it passed through a furnace nose, and then was immersed in a zinc pot for hot-dip galvanizing. After the coating weight was controlled by an air knife, it entered a mobile gas jet rapid cooling section to be cooled rapidly to 370° C., and then entered an alloying soaking furnace (in this Example, the strip steel only passed through with no action on it, and the device didn't need to be started to work). Then, it was cooled to about 140° C. using a post-plating cooling device, and then cooled to 45° C. or lower by final water cooling. Then, it entered an intermediate looper, followed by temper rolling. Then, it passed through an outlet looper, and then it was finished and coiled to complete the production. The final strip steel product had a yield strength of 681 MPa, a tensile strength of 1022 MPa, and an elongation at break of 12%.

### Example 5

Referring to FIG. 171, a high-strength strip steel was prepared. A strip steel with the main chemical composition (mass %) of the substrate being 0.09% C-0.32% Si-2.15% Mn was uncoiled, welded, passed through an inlet looper, and washed. It was then preheated to 353° C. by jet direct fire preheating, then heated to 615° C. by direct fire heating, then heated to 715° C. by transverse magnetic induction heating, then heated to 790° C. by radiant tube heating, then soaked at 790° C. by radiant tube soaking for 60 seconds, then slowly cooled to 675° C., and then cooled to 470° C. by high hydrogen cooling. Then, it passed first through a longitudinal magnetic induction heater (a reheating device; the longitudinal magnetic induction heater didn't need to be started in this Example), then uniformly held at 470° C., then passed through a furnace nose, and then was immersed in a zinc pot for hot-dip galvanizing. After the coating weight was controlled by an air knife, it entered a mobile mist rapid cooling section to be cooled rapidly to 360° C., and then entered an alloying soaking furnace (in this Example, the strip steel only passed through with no action on it, and the device didn't need to be started to work). Then, it was cooled to about 140° C. using a post-plating cooling device, and then cooled to 45° C. or lower by final water cooling. Then, it entered an intermediate looper, followed by temper rolling, tension levelling and passivation treatment. Then, it passed through an outlet looper, and then it was finished and coiled to complete the production. The final strip steel product had a yield strength of 632 MPa, a tensile strength of 938 MPa, and an elongation at break of 15%.

### Example 6

Referring to FIG. 172, a high-strength strip steel was prepared. A strip steel with the main chemical composition (mass %) of the substrate being 0.185% C-1.7% Si-2.7% Mn was uncoiled, welded, passed through an inlet looper, and washed. It was then preheated to 375° C. by jet direct fire preheating, then heated to 700° C. by direct fire heating, then heated to 800° C. by transverse magnetic induction heating, then heated to 850° C. by radiant tube heating, then soaked at 850° C. by radiant tube soaking for 80 seconds, then slowly cooled to 670° C., and then cooled to 260° C. by mist cooling. Then, it was reheated to 400° C., and uniformly held at 400° C. to achieve redistribution of the carbon element in the strip steel and stabilize the residual austenite structure in the strip steel. Then, it was heated to 460° C. by secondary reheating, then passed through a furnace nose, and then was immersed in a zinc pot for hot-dip galvanizing. After the coating weight was controlled by an air knife, it entered an alloying heating furnace to be heated to 510° C., and held at 500° C. in an alloying soaking furnace for 18 seconds. Then, it was cooled to about 150° C. using a post-plating cooling device, and then cooled to 45° C. or lower by final water cooling. Then, it entered an intermediate looper, followed by temper rolling, tension levelling and surface anti-fingerprint treatment. Then, it passed through an outlet looper, and then it was finished and coiled to complete the production. The final strip steel product had a yield strength of 986 MPa, a tensile strength of 1241 MPa, and an elongation at break of 14%.

### Example 7

Referring to FIG. 173, a high-strength strip steel was prepared. A strip steel with the main chemical composition (mass %) of the substrate being 0.183% C-1.71% Si-2.75% Mn was uncoiled, welded, passed through an inlet looper, and washed. It was then preheated to 371° C. by jet direct fire preheating, and then heated to 740° C. by direct fire heating. In the production, the air-fuel ratio of the direct fire was adjusted. The air-fuel ratio of the direct fire heating at the end was adjusted from a conventional value of 0.90 to 0.95 to achieve pre-oxidation of the strip steel. In the subsequent radiant tube soaking process, the strip steel was reduced under the action of the nitrogen-hydrogen protective gas to improve the platability of the strip steel. Then, the strip steel was heated to 810° C. by jet-radiation composite heating, then heated to 850° C. by radiant tube heating, then soaked at 850° C. by radiant tube soaking for 80 seconds, then slowly cooled to 670° C., and then cooled to 260° C. by mist cooling. Then, it was first pickled, then reheated to 400° C., and uniformly held at 400° C. to achieve redistribution of the carbon element in the strip steel and stabilize the residual austenite structure in the strip steel. Then, it was heated to 460° C. by secondary reheating, then passed through a furnace nose, and then was immersed in a zinc pot for hot-dip galvanizing. After the coating weight was controlled by an air knife, it entered an alloying heating furnace to be heated to 510° C., and held at 500° C. for 18 seconds. Then, it was cooled to about 150° C. using a post-plating cooling device, and then cooled to 45° C. or lower by final water cooling. Then, it entered an intermediate looper, followed by temper rolling and tension levelling. Then, it passed through an outlet looper, and then it was finished and coiled to complete the production. The final strip steel product had a yield strength of 1012 MPa, a tensile strength of 1252 MPa, and an elongation at break of 14%.

### Example 8

Referring to FIG. 174, a high-strength strip steel was prepared. A strip steel with the main chemical composition (mass %) of the substrate being 0.186% C-1.76% Si-2.77% Mn was uncoiled, welded, passed through an inlet looper, and washed. It was then preheated to 376° C. by jet direct fire preheating, then heated to 750° C. by direct fire heating, then heated to 850° C. by transverse magnetic induction heating, then heated to 900° C. by radiant tube heating, then soaked at 900° C. by radiant tube soaking for 80 seconds, then slowly cooled to 670° C., and then cooled to room temperature by mist cooling. Then, it was pickled first, and then flash plated with iron. Then, it was reheated to 400° C., and uniformly held at 400° C. to achieve redistribution of the carbon element in the strip steel and stabilize the residual austenite structure in the strip steel. It passed through a secondary reheating section (the secondary reheating device was not put into use), passed through a mobile channel, and entered an overaging section for overaging treatment at 400° C. Then, the strip steel was cooled to 140° C. by final gas jet cooling, and then cooled to 45° C. or lower by final water cooling. Then, it was pickled and flash plated with nickel, and entered an intermediate looper, followed by temper rolling. Then, it passed through an outlet looper, and then it was finished and coiled to complete the production. The final strip steel product had a yield strength of 1008 MPa, a tensile strength of 1216 MPa, and an elongation at break of 15.6%.

### Dual-Purpose Ultra-High-Strength Strip Steel Production Line for Continuous Annealing or Hot-Dip Galvanizing

Referring to FIG. 175 which shows Example 1 of the present disclosure, in Example 1, the dual-purpose ultra-high-strength strip steel production line for continuous annealing or hot-dip galvanizing according to the present disclosure includes the following stations in sequence: uncoiling—welding—inlet looper—washing—central continuous post-processing—temper rolling—outlet looper—coiling; wherein
the central continuous post-processing station includes in sequence a jet direct fire preheating section, a direct fire heating section, a transverse magnetic induction heating section, a radiant tube soaking section or a jet-radiation composite soaking section, a slow cooling section, a high hydrogen cooling section, and a reheating section; starting from the reheating section, two parallel processing lines are provided, one of which is provided with a furnace nose section, a zinc pot section, an air knife section, and a post-plating cooling section, and is connected to a final water cooling section, and the other of which is provided with a mobile channel section, an overaging section, and a final gas jet cooling section, and is connected to the final water cooling section;
the production line uses jet direct fire preheating to preheat the strip steel, and a transverse magnetic induction heating device is provided after the direct fire heating section to quickly increase the heating temperature, while high hydrogen cooling is selected for rapid cooling;
in the jet direct fire preheating section, the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to realize forced convection heat exchange;
a parallel arrangement of (the furnace nose section+the zinc pot section+the air knife section+the post-plating cooling section) and (the mobile channel section+the overaging section+the final gas jet cooling section) is provided so that the strip steel may go through the furnace nose section+the zinc pot section+the air knife section+the post-plating cooling section, that is, taking a hot-dip galvanizing process path for producing a pure zinc hot-dip galvanized product;
alternatively, it may go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position or an offline position. The switching between the continuous annealing process path and the pure zinc hot-dip galvanizing process path is achieved by cutting the strip steel and reloading the strip steel.

Referring to FIG. 176 which shows Example 2 of the present disclosure, the dual-purpose ultra-high-strength strip steel production line for continuous annealing or hot-dip galvanizing includes the following stations in sequence: uncoiling—welding—inlet looper—washing—central continuous post-processing—temper rolling—outlet looper—coiling, wherein
the central continuous post-processing station includes in sequence a jet direct fire preheating section, a direct fire heating section, a transverse magnetic induction heating section, a radiant tube soaking section or a jet-radiation composite soaking section, a slow cooling section, a high hydrogen cooling section and a reheating section;
starting from the reheating section, two parallel processing lines are provided, one of which is provided with a furnace nose section, a zinc pot section, an air knife section, an alloying heating section, an alloying soaking section, and a post-plating cooling section, and is connected to a final water cooling section, and the other of which is provided with a mobile channel section, an overaging section, and a final gas jet cooling section, and is connected to the final water cooling section;
in this production line, the strip steel is preheated in a jet direct fire preheating section, and a transverse magnetic induction heating section is provided after the direct fire heating section to quickly increase the heating temperature, while high hydrogen cooling is selected for rapid cooling.

In the jet direct fire preheating section, the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to achieve forced convection heat exchange.

A parallel arrangement of (the furnace nose section+the zinc pot section+the air knife section+the alloying heating section+the alloying soaking section+the post-plating cooling section) and (the mobile channel section+the overaging section+the final gas jet cooling section) is provided so that the strip steel may go through the furnace nose section+the zinc pot section+the air knife section+the alloying heating section+the alloying soaking section+the post-plating cooling section, that is, taking a hot-dip galvannealing process path for producing a hot-dip galvannealed product.

When the alloying heating section+the alloying soaking section is not started for operation, the strip steel passes through these process sections with no action on it, and thus a pure zinc hot-dip galvanized product will be produced. The strip steel may also go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the hot-dip galvanizing process path is achieved by cutting the strip steel and reloading the strip steel.

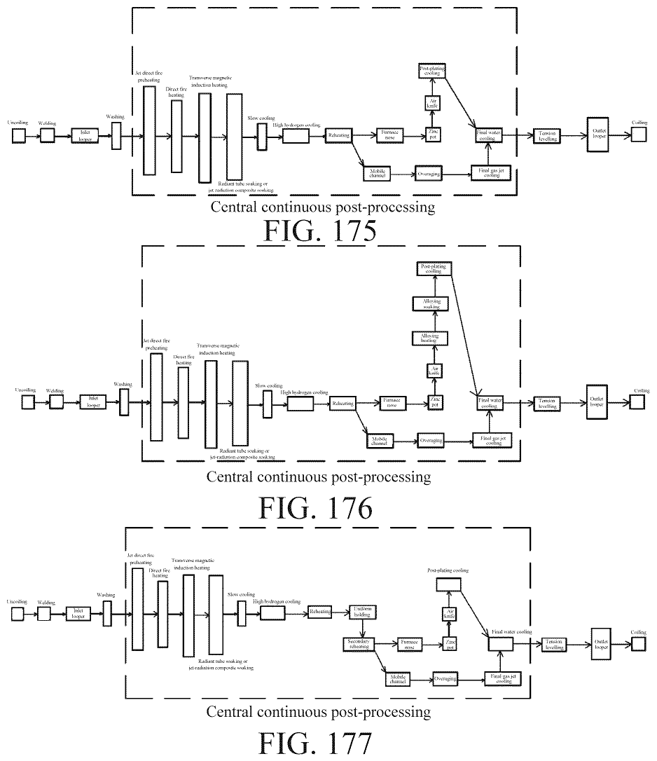

Referring to FIG. 177 which shows Example 3 of the present disclosure, in Example 3, the dual-purpose ultra-high-strength strip steel production line for continuous annealing or hot-dip galvanizing includes the following stations in sequence: uncoiling—welding—inlet looper-washing—central continuous post-processing—temper rolling—outlet looper—coiling; wherein
the central continuous post-processing station includes in sequence a jet direct fire preheating section, a direct fire heating section, a transverse magnetic induction heating section, a radiant tube soaking section or a jet-radiation composite soaking section, a slow cooling section, a high hydrogen cooling section, a reheating section, a uniform holding section, a secondary reheating section, a parallel arrangement of (a furnace nose section+a zinc pot section+an air knife section+a post-plating cooling section) and (a mobile channel section+an overaging section+a final gas jet cooling section), and a final water cooling section.

In this production line, the strip steel is preheated in a jet direct fire preheating section, and a transverse magnetic induction heating section is provided after the direct fire heating section to quickly increase the heating temperature, while high hydrogen cooling is selected for rapid cooling. Further, the uniform holding section+the secondary reheating section is utilized, which can realize a secondary reheating process for high-strength steel such as QP steel.

In the jet direct fire preheating section, the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to achieve forced convection heat exchange.

The parallel arrangement of (the furnace nose section+the zinc pot section+the air knife section+the post-plating cooling section) and (the mobile channel section+the overaging section+the final gas jet cooling section) is provided so that the strip steel may go through the furnace nose section+the zinc pot section+the air knife section+the post-plating cooling section, that is, taking a hot-dip galvanizing process path for producing a pure zinc hot-dip galvanized product, as shown in Example 1.

Alternatively, it may go through the mobile channel section+the overaging section+the final gas jet cooling section, that is, taking a continuous annealing process path for producing a continuously annealed product, as shown in Example 2.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

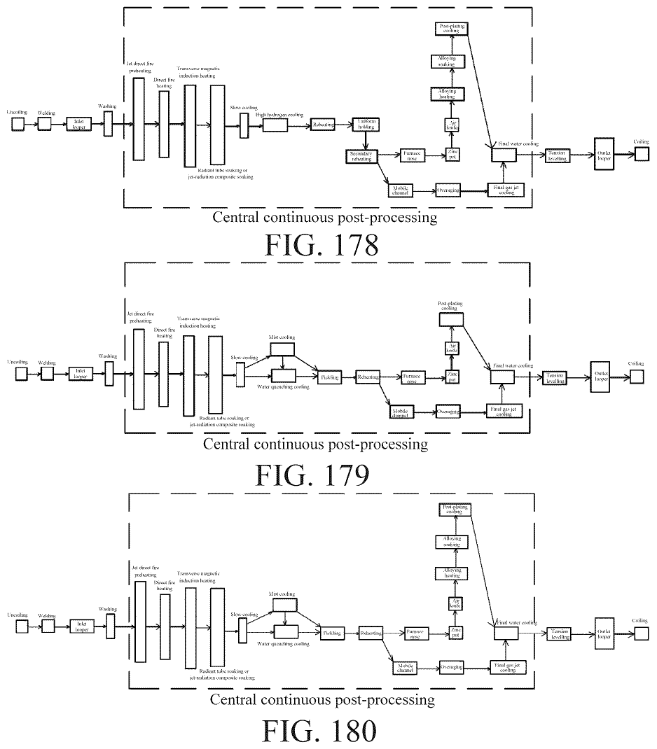

Referring to FIG. 178 which shows Example 4 of the present disclosure, the dual-purpose ultra-high-strength strip steel production line for continuous annealing or hot-dip galvanizing includes the following stations in sequence: uncoiling—welding—inlet looper—washing—central continuous post-processing—temper rolling—outlet looper—coiling, wherein
the central continuous post-processing station includes in sequence a jet direct fire preheating section, a direct fire heating section, a transverse magnetic induction heating section, a radiant tube soaking section or a jet-radiation composite soaking section, a slow cooling section, a high hydrogen cooling section, a reheating section, a uniform holding section, a secondary reheating section, a parallel arrangement of (a furnace nose section+a zinc pot section+an air knife section+an alloying heating section+an alloying soaking section+a post-plating cooling section) and (a mobile channel section+an overaging section+a final gas jet cooling section), and a final water cooling section.

In this production line, the strip steel is preheated in a jet direct fire preheating section, and a transverse magnetic induction heating section is provided after the direct fire heating section to quickly increase the heating temperature, while high hydrogen cooling is selected for rapid cooling. Further, the uniform holding section+the secondary reheating section is utilized, which can realize a secondary reheating process for high-strength steel such as QP steel.

In the jet direct fire preheating section, the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to achieve forced convection heat exchange.

The parallel arrangement of (the furnace nose section+the zinc pot section+the air knife section+the alloying heating section+the alloying soaking section+the post-plating cooling section) and (the mobile channel section+the overaging section+the final gas jet cooling section) is provided so that the strip steel may go through the furnace nose section+the zinc pot section+the air knife section+the alloying heating section+the alloying soaking section+the post-plating cooling section, that is, taking a hot-dip galvannealing process path for producing a hot-dip galvannealed product.

When the alloying heating section+the alloying soaking section is not started for operation, the strip steel passes through these process sections with no action on it, and thus a pure zinc hot-dip galvanized product will be produced.

Alternatively, it may go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the hot-dip galvanizing process path is achieved by cutting the strip steel and reloading the strip steel.

Referring to FIG. 179 which shows Example 5 of the present disclosure, the dual-purpose ultra-high-strength strip steel production line for continuous annealing or hot-dip galvanizing includes the following stations in sequence: uncoiling—welding—inlet looper—washing—central continuous post-processing—temper rolling—outlet looper—coiling, wherein
the central continuous post-processing station includes in sequence a jet direct fire preheating section, a direct fire heating section, a transverse magnetic induction heating section, a radiant tube soaking section or a jet-radiation composite soaking section, a slow cooling section, a mist cooling section and/or a water quenching cooling section, a pickling section, a reheating section, a parallel arrangement of (a furnace nose section+a zinc pot section+an air knife section+a post-plating cooling section) and (a mobile channel section+an overaging section+a final gas jet cooling section), and a final water cooling section.

In this production line, the strip steel is preheated in the jet direct fire preheating section; a transverse magnetic induction heating section is provided after the direct fire heating section to quickly increase the heating temperature; and mist cooling and/or water quenching cooling is provided for rapid cooling.

In the jet direct fire preheating section, the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to achieve forced convection heat exchange.

As for the mist cooling section and/or the water quenching cooling section, the strip steel may be subjected to mist cooling, or water quenching cooling, or mist cooling followed by water quenching cooling, as shown in Example 3.

The parallel arrangement of (the furnace nose section+the zinc pot section+the air knife section+the post-plating cooling section) and (the mobile channel section+the overaging section+the final gas jet cooling section) is provided so that the strip steel may go through the furnace nose section+the zinc pot section+the air knife section+the post-plating cooling section, that is, taking a hot-dip galvanizing process path for producing a pure zinc hot-dip galvanized product.

Alternatively, it may go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

Referring to FIG. 180 which shows Example 6 of the present disclosure, the dual-purpose ultra-high-strength strip steel production line for continuous annealing or hot-dip galvanizing includes the following stations in sequence: uncoiling—welding—inlet looper—washing—central continuous post-processing—temper rolling—outlet looper—coiling, wherein the central continuous post-processing station includes in sequence a jet direct fire preheating section, a direct fire heating section, a transverse magnetic induction heating section, a radiant tube soaking section or a jet-radiation composite soaking section, a slow cooling section, a mist cooling section and/or a water quenching cooling section, a pickling section, a reheating section, a parallel arrangement of (a furnace nose section+a zinc pot section+an air knife section+an alloying heating section+an alloying soaking section+a post-plating cooling section) and (a mobile channel section+an overaging section+a final gas jet cooling section), and a final water cooling section.

In this production line, the strip steel is preheated in the jet direct fire preheating section; a transverse magnetic induction heating section is provided after the direct fire heating section to quickly increase the heating temperature; and mist cooling and/or water quenching cooling is provided for rapid cooling.

The jet direct fire preheating section is characterized in that the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to achieve forced convection heat exchange.

As for the mist cooling section and/or the water quenching cooling section, the strip steel may be subjected to mist cooling, or water quenching cooling, or mist cooling followed by water quenching cooling.

The parallel arrangement of (the furnace nose section+the zinc pot section+the air knife section+the alloying heating section+the alloying soaking section+the post-plating cooling section) and (the mobile channel section+the overaging section+the final gas jet cooling section) is provided so that the strip steel may go through the furnace nose section+the zinc pot section+the air knife section+the alloying heating section+the alloying soaking section+the post-plating cooling section, that is, taking a hot-dip galvannealing process path for producing a hot-dip galvannealed product.

When the alloying heating section+the alloying soaking section is not started for operation, the strip steel passes through these process sections with no action on it, and thus a pure zinc hot-dip galvanized product will be produced. The strip steel may also go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the hot-dip galvanizing process path is achieved by cutting the strip steel and reloading the strip steel.

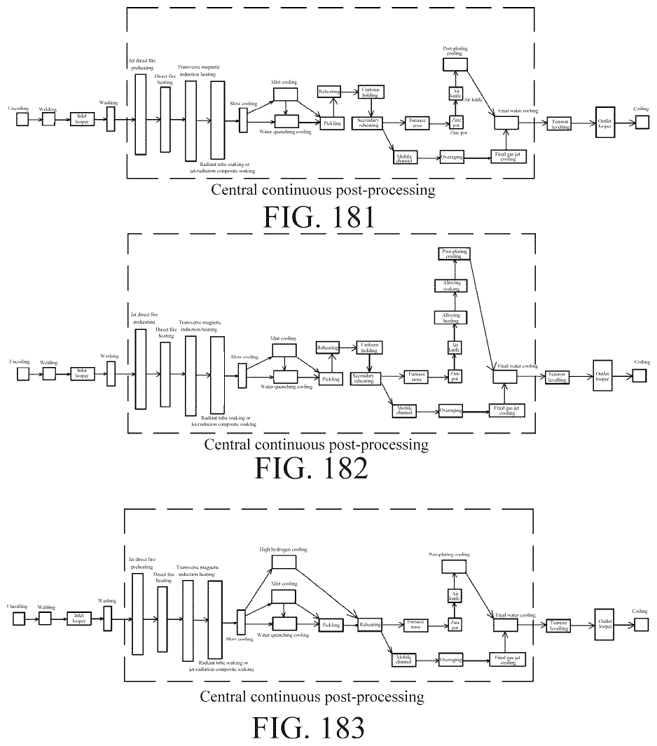

Referring to FIG. 181 which shows Example 7 of the present disclosure, the dual-purpose ultra-high-strength strip steel production line for continuous annealing or hot-dip galvanizing includes the following stations in sequence: uncoiling—welding—inlet looper—washing—central continuous post-processing—temper rolling—outlet looper—coiling, wherein
the central continuous post-processing station includes in sequence a jet direct fire preheating tube soaking section or a jet-radiation composite soaking section, a slow cooling section, a mist cooling section and/or a water quenching cooling section, a pickling section, a reheating section, a uniform holding section, a secondary reheating section, a parallel arrangement of (a furnace nose section+a zinc pot section+an air knife section+a post-plating cooling section) and (a mobile channel section+an overaging section+a final gas jet cooling section), and a final water cooling section.

In this production line, the strip steel is preheated in a jet direct fire preheating section, and a transverse magnetic induction heating section is provided after the direct fire heating section to quickly increase the heating temperature, while mist cooling and/or water quenching cooling is provided for rapid cooling. Further, the uniform holding section+the secondary reheating section is utilized, which can realize a secondary reheating process for high-strength steel such as QP steel.

In the jet direct fire preheating section, the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to achieve forced convection heat exchange.

As for the mist cooling section and/or the water quenching cooling section, the strip steel may be subjected to mist cooling, or water quenching cooling, or mist cooling followed by water quenching cooling.

The parallel arrangement of (the furnace nose section+the zinc pot section+the air knife section+the post-plating cooling section) and (the mobile channel section+the overaging section+the final gas jet cooling section) is provided so that the strip steel may go through the furnace nose section+the zinc pot section+the air knife section+the post-plating cooling section, that is, taking a hot-dip galvanizing process path for producing a pure zinc hot-dip galvanized product.

Alternatively, it may go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

Referring to FIG. 182 which shows Example 8 of the present disclosure, the dual-purpose ultra-high-strength strip steel production line for continuous annealing or hot-dip galvanizing includes the following stations in sequence: uncoiling—welding—inlet looper—washing—central continuous post-processing—temper rolling—outlet looper—coiling, wherein
the central continuous post-processing station includes in sequence a jet direct fire preheating section, a direct fire heating section, a transverse magnetic induction heating section, a radiant tube soaking section or a jet-radiation composite soaking section, a slow cooling section, a mist cooling section and/or a water quenching cooling section, a pickling section, a reheating section, a uniform holding section, a secondary reheating section, a parallel arrangement of (a furnace nose section+a zinc pot section+an air knife section+an alloying heating section+an alloying soaking section+a post-plating cooling section) and (a mobile channel section+an overaging section+a final gas jet cooling section), and a final water cooling section.

In this production line, the strip steel is preheated in a jet direct fire preheating section, and a transverse magnetic induction heating section is provided after the direct fire heating section to quickly increase the heating temperature, while mist cooling and/or water quenching cooling is provided for rapid cooling. Further, the uniform holding section+the secondary reheating section is utilized, which can realize a secondary reheating process for high-strength steel such as QP steel.

In the jet direct fire preheating section, the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to achieve forced convection heat exchange.

As for the mist cooling section and/or the water quenching cooling section, the strip steel may be subjected to mist cooling, or water quenching cooling, or mist cooling followed by water quenching cooling. Another feature is the parallel arrangement of (a furnace nose section+a zinc pot section+an air knife section+an alloying heating section+an alloying soaking section+a post-plating cooling section) and (a mobile channel section+an overaging section+a final gas jet cooling section), by which the strip steel may go through the furnace nose section+the zinc pot section+the air knife section+the alloying heating section+the alloying soaking section+the post-plating cooling section, that is, taking a hot-dip galvannealing process path to produce a hot-dip galvannealed product, as shown in Example 4.

When the alloying heating section+the alloying soaking section is not started for operation, the strip steel passes through these process sections with no action on it, and thus a pure zinc hot-dip galvanized product will be produced. The strip steel may also go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the hot-dip galvanizing process path is achieved by cutting the strip steel and reloading the strip steel.

Referring to FIG. 183 which shows Example 9 of the present disclosure, the dual-purpose ultra-high-strength strip steel production line for continuous annealing or hot-dip galvanizing includes the following stations in sequence: uncoiling—welding—inlet looper—washing—central continuous post-processing—temper rolling—outlet looper—coiling, wherein
the central continuous post-processing station includes in sequence a jet direct fire preheating section, a direct fire heating section, a transverse magnetic induction heating section, a radiant tube soaking section or a jet-radiation composite soaking section, a slow cooling section, a parallel arrangement of a high hydrogen cooling section and (a mist cooling section and/or a water quenching cooling section+a pickling section), a reheating section, a parallel arrangement of (a furnace nose section+a zinc pot section+an air knife section+a post-plating cooling section) and (a mobile channel section+an overaging section+a final gas jet cooling section), and a final water cooling section.

In this production line, the strip steel is preheated in a jet direct fire preheating section, and a transverse magnetic induction heating section is provided after the direct fire heating section to quickly increase the heating temperature, while the parallel arrangement of the high hydrogen cooling section and (the mist cooling section and/or the water quenching cooling section) is provided for rapid cooling.

In the jet direct fire preheating section, the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to achieve forced convection heat exchange.

With the parallel arrangement of the high hydrogen cooling section and (the mist cooling section and/or the water quenching cooling section+the pickling section), the strip steel may be subjected to high hydrogen cooling, or mist cooling, or water quenching cooling, or mist cooling followed by water quenching cooling.

The parallel arrangement of (the furnace nose section+the zinc pot section+the air knife section+the post-plating cooling section) and (the mobile channel section+the overaging section+the final gas jet cooling section) is provided so that the strip steel may go through the furnace nose section+the zinc pot section+the air knife section+the post-plating cooling section, that is, taking a hot-dip galvanizing process path for producing a pure zinc hot-dip galvanized product.

Alternatively, it may go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

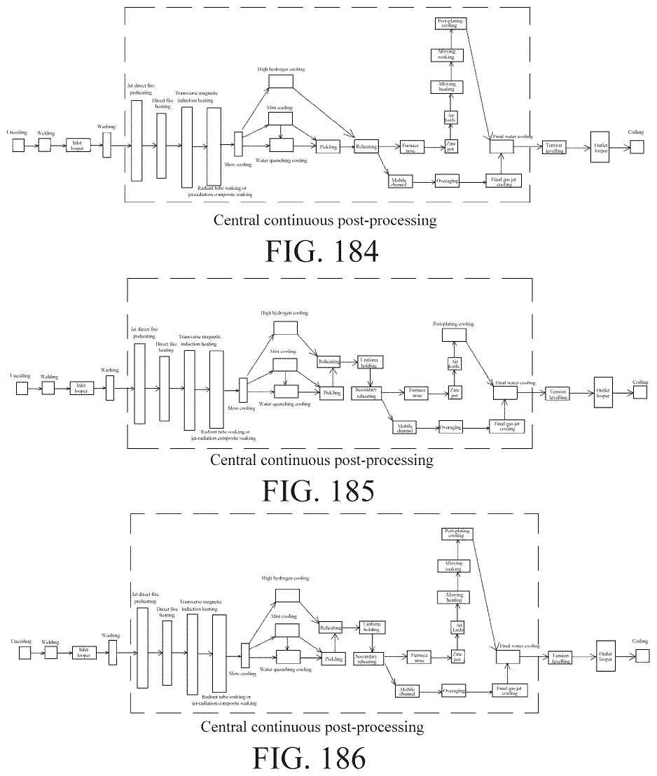

Referring to FIG. 184 which shows Example 10 of the present disclosure, the dual-purpose ultra-high-strength strip steel production line for continuous annealing or hot-dip galvanizing includes the following stations in sequence: uncoiling—welding—inlet looper—washing—central continuous post-processing—temper rolling—outlet looper—coiling, wherein
the central continuous post-processing station includes in sequence a jet direct fire preheating section, a direct fire heating section, a transverse magnetic induction heating section, a radiant tube soaking section or a jet-radiation composite soaking section, a slow cooling section, a parallel arrangement of a high hydrogen cooling section and (a mist cooling section and/or a water quenching cooling section+a pickling section), a reheating section, a parallel arrangement of (a furnace nose section+a zinc pot section+an air knife section+an alloying heating section+an alloying soaking section+a post-plating cooling section) and (a mobile channel section+an overaging section+a final gas jet cooling section), and a final water cooling section.

In this production line, the strip steel is preheated in a jet direct fire preheating section, and a transverse magnetic induction heating section is provided after the direct fire heating section to quickly increase the heating temperature, while the parallel arrangement of the high hydrogen cooling section and (the mist cooling section and/or the water quenching cooling section) is provided for rapid cooling.

In the jet direct fire preheating section, the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to achieve forced convection heat exchange.

With the parallel arrangement of the high hydrogen cooling section and (the mist cooling section and/or the water quenching cooling section+the pickling section), the strip steel may be subjected to high hydrogen cooling, or mist cooling, or water quenching cooling, or mist cooling followed by water quenching cooling.

The parallel arrangement of (the furnace nose section+the zinc pot section+the air knife section+the alloying heating section+the alloying soaking section+the post-plating cooling section) and (the mobile channel section+the overaging section+the final gas jet cooling section) is provided so that the strip steel may go through the furnace nose section+the zinc pot section+the air knife section+the alloying heating section+the alloying soaking section+the post-plating cooling section, that is, taking a hot-dip galvannealing process path for producing a hot-dip galvannealed product.

When the alloying heating section+the alloying soaking section is not started for operation, the strip steel passes through these process sections with no action on it, and thus a pure zinc hot-dip galvanized product will be produced. The strip steel may also go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the hot-dip galvanizing process path is achieved by cutting the strip steel and reloading the strip steel.

Referring to FIG. 185 which shows Example 11 of the present disclosure, the dual-purpose ultra-high-strength strip steel production line for continuous annealing or hot-dip galvanizing includes the following stations in sequence: uncoiling—welding—inlet looper—washing—central continuous post-processing—temper rolling—outlet looper—coiling, wherein
the central continuous post-processing station includes in sequence a jet direct fire preheating section, a direct fire heating section, a transverse magnetic induction heating section, a radiant tube soaking section or a jet-radiation composite soaking section, a slow cooling section, a parallel arrangement of a high hydrogen cooling section and (a mist cooling section and/or a water quenching cooling section+a pickling section), a reheating section, a uniform holding section, a secondary reheating section, a parallel arrangement of (a furnace nose section+a zinc pot section+an air knife section+a post-plating cooling section) and (a mobile channel section+an overaging section+a final gas jet cooling section), and a final water cooling section.

In this production line, the strip steel is preheated in a jet direct fire preheating section, and a transverse magnetic induction heating section is provided after the direct fire heating section to quickly increase the heating temperature, while the parallel arrangement of the high hydrogen cooling section and (the mist cooling section and/or the water quenching cooling section) is provided for rapid cooling. Further, the uniform holding section+the secondary reheating section is utilized, which can realize a secondary reheating process for high-strength steel such as QP steel.

In the jet direct fire preheating section, the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to achieve forced convection heat exchange.

With the parallel arrangement of the high hydrogen cooling section and (the mist cooling section and/or the water quenching cooling section+the pickling section), the strip steel may be subjected to high hydrogen cooling, or mist cooling, or water quenching cooling, or mist cooling followed by water quenching cooling.

With the parallel arrangement of (the furnace nose section+the zinc pot section+the air knife section+the post-plating cooling section) and (the mobile channel section+the overaging section+the final gas jet cooling section), the strip steel may go through the furnace nose section+zinc pot section+air knife section+post-plating cooling section, that is, taking a hot-dip galvanizing process path to produce a pure zinc hot-dip galvanized product; alternatively, it may go through the mobile channel section+the overaging section+the final gas jet cooling section, that is, taking a continuous annealing process path to produce a continuously annealed product.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

Referring to FIG. 186 which shows Example 12 of the present disclosure, the dual-purpose ultra-high-strength strip steel production line for continuous annealing or hot-dip galvanizing includes the following stations in sequence: uncoiling—welding—inlet looper—washing—central continuous post-processing—temper rolling—outlet looper—coiling, wherein
the central continuous post-processing station includes in sequence a jet direct fire preheating tube soaking section or a jet-radiation composite soaking section, a slow cooling section, a parallel arrangement of a high hydrogen cooling section and (a mist cooling section and/or a water quenching cooling section+a pickling section), a pickling section, a reheating section, a uniform holding section, a secondary reheating section, a parallel arrangement of (a furnace nose section+a zinc pot section+an air knife section+an alloying heating section+an alloying soaking section+a post-plating cooling section) and (a mobile channel section+an overaging section+a final gas jet cooling section), and a final water cooling section.

In this production line, the strip steel is preheated in a jet direct fire preheating section, and a transverse magnetic induction heating section is provided after the direct fire heating section to quickly increase the heating temperature, while the parallel arrangement of the high hydrogen cooling section and (the mist cooling section and/or the water quenching cooling section) is provided for rapid cooling. Further, the uniform holding section+the secondary reheating section is utilized, which can realize a secondary reheating process for high-strength steel such as QP steel.

In the jet direct fire preheating section, the combustion exhaust gas from the direct fire heating section is used to heat a recycled nitrogen-hydrogen protective gas in the furnace, and then the nitrogen-hydrogen protective gas is jetted onto the upper and lower surfaces of the strip steel to achieve forced convection heat exchange.

With the parallel arrangement of the high hydrogen cooling section and (the mist cooling section and/or the water quenching cooling section+the pickling section), the strip steel may be subjected to high hydrogen cooling, or mist cooling, or water quenching cooling, or mist cooling followed by water quenching cooling.

The parallel arrangement of (the furnace nose section+the zinc pot section+the air knife section+the alloying heating section+the alloying soaking section+the post-plating cooling section) and (the mobile channel section+the overaging section+the final gas jet cooling section) is provided so that the strip steel may go through the furnace nose section+the zinc pot section+the air knife section+the alloying heating section+the alloying soaking section+the post-plating cooling section, that is, taking a hot-dip galvannealing process path for producing a hot-dip galvannealed product.

When the alloying heating section+the alloying soaking section is not started for operation, the strip steel passes through these process sections with no action on it, and thus a pure zinc hot-dip galvanized product will be produced. The strip steel may also go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the hot-dip galvanizing process path is achieved by cutting the strip steel and reloading the strip steel.

Preferably, a mobile post-plating rapid cooling section is provided after the air knife section. The mobile post-plating rapid cooling section can be moved online or offline and is provided in parallel with the alloying heating section (designed to be mobile, convenient for maintenance). When producing a pure zinc hot-dip galvanized product, the mobile post-plating rapid cooling section is online to quickly cool the galvanized strip steel, and the alloying heating section is offline at this time; when producing a hot-dip galvannealed product, the mobile post-plating rapid cooling section is offline, and the alloying heating section is online to implement alloying heating of the strip steel.

Preferably, the radiant tube soaking section is replaced with a jet-radiation composite soaking section to achieve rapid regulation of the soaking temperature of the strip steel when the working conditions change, such as changes in strip steel thickness specification, target temperature, unit speed, etc.

Preferably, a radiant tube heating section is further provided between the direct fire heating section and the transverse magnetic induction heating section for further increasing the heating temperature of the strip steel.

Preferably, a nickel flash plating or iron flash plating section is provided after the pickling section to improve the corrosion resistance or platability of the strip steel.

Preferably, washing stations are provided both before and after the inlet looper station to perform secondary washing on the strip steel, so as to further improve the surface quality of the strip steel.

Preferably, a finishing station is provided before the coiling station, and the strip steel is finished before coiling.

Preferably, an intermediate looper station is provided before the temper rolling station to ensure that the quality of the strip steel is not lost when the working rolls of the temper rolling machine are replaced online.

Preferably, a selectable tension levelling station is provided between the temper rolling station and the outlet looper station, and the strip steel may be tension levelled before entering the outlet looper.

Preferably, a selectable surface post-treatment station such as that for passivation or anti-fingerprint treatment is provided between the temper rolling station and the outlet looper station, and the strip steel may be subjected to surface post-treatment such as passivation or anti-fingerprint treatment before entering the outlet looper.

Preferably, both a selectable tension levelling station and a selectable surface post-treatment station such as that for passivation or anti-fingerprint treatment are provided between the temper rolling station and the outlet looper station, and the strip steel may be subjected to surface post-treatment such as passivation or anti-fingerprint treatment before entering the outlet looper.

### Example 1

As an example for producing a strip steel with the layout of the unit being shown in FIG. 177, a strip steel with the main chemical composition (mass %) of the substrate being 0.16% C-1.8% Si-2.3% Mn was uncoiled, welded, passed through an inlet looper, and washed. The strip steel was then preheated to 365° C. by jet direct fire preheating, then heated to 750° C. by direct fire heating, then heated to 850° C. by transverse magnetic induction heating, then soaked at 850° C. by radiant tube soaking for 60 seconds, then slowly cooled to 675° C., and then cooled to 230° C. by high hydrogen cooling. Then, it was reheated to 420° C., uniformly held at 420° C., and then heated to 460° C. by secondary reheating. Then, a hot-dip galvanizing process path was selected. After passing through a furnace nose, the strip steel was immersed in a zinc pot for hot-dip galvanizing. After the coating weight was controlled by an air knife, the strip steel was cooled to 230° C. or lower by post-plating cooling. Then, the strip steel was cooled to room temperature by final water cooling. After being temper rolled, it entered an outlet looper, and then it was coiled to complete the production. The final strip steel product had a yield strength of 732 MPa, a tensile strength of 1068 MPa, and an elongation at break of 19%.

### Example 2

As an example for producing a strip steel with the layout of the unit being shown in FIG. 177, a strip steel with the main chemical composition (mass %) of the substrate being 0.09% C-0.013% Si-0.95% Mn was uncoiled, welded, passed through an inlet looper, and washed. The strip steel was then preheated to 360° C. by jet direct fire preheating, then heated to 750° C. by direct fire heating, then heated to 850° C. by transverse magnetic induction heating, then soaked at 850° C. by jet-radiation composite soaking for 60 seconds, then slowly cooled to 670° C., and then cooled to about 230° C. by high hydrogen jet cooling. After passing through a reheating section, a uniform holding section and a secondary reheating section (neither the reheating nor the secondary reheating needed to be activated), a continuous annealing process path was selected. The strip steel passed through a mobile channel and entered an overaging section to be overaged at 230° C. Then, it was cooled to about 140° C. by final gas jet cooling, and then cooled to room temperature by final water cooling. After being temper rolled, it entered an outlet looper, and then it was coiled to complete the production. The final strip steel product had a yield strength of 486 MPa, a tensile strength of 575 MPa, and an elongation at break of 22%.

### Example 3

As an example for producing a strip steel with the layout of the unit being shown in FIG. 179, a strip steel with the main chemical composition (mass %) of the substrate being 0.12% C-0.19% Si-2.1% Mn was uncoiled, welded, passed through an inlet looper, and washed. The strip steel was then preheated to 361° C. by jet direct fire preheating, then heated to 750° C. by direct fire heating, then heated to 850° C. by transverse magnetic induction heating, then soaked at 850° C. by radiant tube soaking for 60 seconds, then slowly cooled to 750° C., then cooled to 500° C. by mist cooling, then cooled to about 50° C. by water quenching cooling, and then pickled. Then, it was reheated to 235° C. Then, it passed through a mobile channel and entered an overaging section to be overaged at 230° C. Then, it was cooled to about 140° C. by final gas jet cooling, and then cooled to room temperature by final water cooling. After being temper rolled, it entered an outlet looper, and then it was coiled to complete the production. The final strip steel product had a yield strength of 982 MPa, a tensile strength of 1208 MPa, and an elongation at break of 12%.

### Example 4

As an example for producing a strip steel with the layout of the unit being shown in FIG. 182, a strip steel with the main chemical composition (mass %) of the substrate being 0.075% C-0.15% Si-1.70% Mn was uncoiled, welded, passed through an inlet looper, and washed. The strip steel was then heated to 353° C. by jet direct fire heating, then heated to 750° C. by direct fire heating, then heated to 820° C. by transverse magnetic induction heating, then soaked at 820° C. by jet-radiation composite soaking for 50 seconds, then slowly cooled to 670° C., then cooled to 500° C. by mist cooling, then cooled to room temperature by water quenching cooling, and then pickled. Then, it was reheated to 200° C. After passing through a uniform holding section, it was heated to 460° C. by secondary reheating. Then, it passed through a furnace nose, and was immersed in a zinc pot for hot-dip galvanizing. After the coating weight was controlled by an air knife, the strip steel was heated to 500° C. by alloying heating, and soaked at 500° C. by alloying soaking for 18 seconds. Then, the strip steel was subjected to post-plating cooling, and then cooled to room temperature by final water cooling. After being temper rolled, it entered an outlet looper, and then it was coiled to complete the production. The final strip steel product had a yield strength of 585 MPa, a tensile strength of 856 MPa, and an elongation at break of 14%.

### Dual-Purpose High-Strength Strip Steel Production Line for Continuous Annealing or Hot-Dip Galvanizing

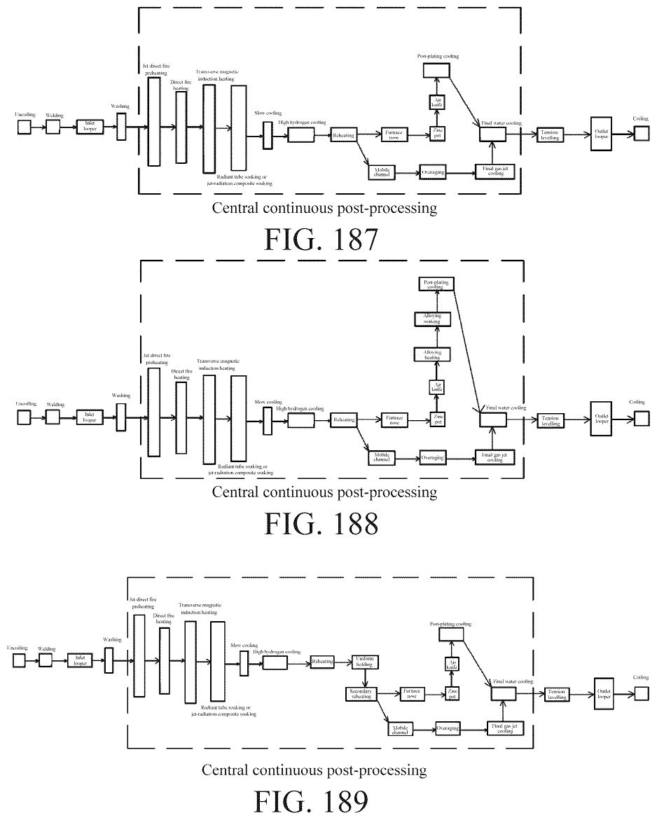

Referring to FIG. 187, the dual-purpose high-strength strip steel production line for continuous annealing or hot-dip galvanizing according to the present disclosure includes the following stations in sequence: uncoiling—welding—inlet looper—washing—central continuous post-processing—temper rolling—outlet looper—coiling; wherein
the central continuous post-processing station includes in sequence a jet radiant tube preheating section, a radiant tube heating section, a transverse magnetic induction heating section, a radiant tube soaking section or a jet-radiation composite soaking section, a slow cooling section, a high hydrogen cooling section, a reheating section, a parallel arrangement of (a furnace nose section+a zinc pot section+an air knife section+a post-plating cooling section) and (a mobile channel section+an overaging section+a final gas jet cooling section), and a final water cooling section.

In this production line, a jet radiant tube preheating section is used to preheat the strip steel, and a transverse magnetic induction heating section is provided after the radiant tube heating section to quickly increase the heating temperature, while high hydrogen cooling is selected for rapid cooling.

In the jet radiant tube preheating section, the combustion exhaust gas from the radiant tube heating section is used to heat a recycled nitrogen-hydrogen protective gas in the furnace, and then the nitrogen-hydrogen protective gas is jetted onto the upper and lower surfaces of the strip steel to achieve forced convection heat exchange.

The parallel arrangement of (the furnace nose section+the zinc pot section+the air knife section+the post-plating cooling section) and (the mobile channel section+the overaging section+the final gas jet cooling section) is provided so that the strip steel may go through the furnace nose section+the zinc pot section+the air knife section+the post-plating cooling section, that is, taking a hot-dip galvanizing process path for producing a pure zinc hot-dip galvanized product. Alternatively, it may go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

Referring to FIG. 188, the dual-purpose high-strength strip steel production line for continuous annealing or hot-dip galvanizing according to the present disclosure includes the following stations in sequence: uncoiling—welding—inlet looper—washing—central continuous post-processing—temper rolling—outlet looper—coiling; wherein the central continuous post-processing station includes in sequence a jet radiant tube preheating section, a radiant tube heating section, a transverse magnetic induction heating section, a radiant tube soaking section or a jet-radiation composite soaking section, a slow cooling section, a high hydrogen cooling section, a reheating section, a parallel arrangement of (a furnace nose section+a zinc pot section+an air knife section+the alloying heating section+the alloying soaking section+a post-plating cooling section) and (a mobile channel section+an overaging section+a final gas jet cooling section), and a final water cooling section.

In this production line, a jet radiant tube preheating section is used to preheat the strip steel, and a transverse magnetic induction heating section is provided after the radiant tube heating section to quickly increase the heating temperature, while high hydrogen cooling is selected for rapid cooling.

In the jet radiant tube preheating section, the combustion exhaust gas from the radiant tube heating section is used to heat a recycled nitrogen-hydrogen protective gas in the furnace, and then the nitrogen-hydrogen protective gas is jetted onto the upper and lower surfaces of the strip steel to achieve forced convection heat exchange.

The parallel arrangement of (the furnace nose section+the zinc pot section+the air knife section+the alloying heating section+the alloying soaking section+the post-plating cooling section) and (the mobile channel section+the overaging section+the final gas jet cooling section) is provided so that the strip steel may go through the furnace nose section+the zinc pot section+the air knife section+the alloying heating section+the alloying soaking section+the post-plating cooling section, that is, taking a hot-dip galvannealing process path for producing a hot-dip galvannealed product.

When the alloying heating section+the alloying soaking section is not started for operation, the strip steel passes through these process sections with no action on it, and thus a pure zinc hot-dip galvanized product will be produced. The strip steel may also go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the hot-dip galvanizing process path is achieved by cutting the strip steel and reloading the strip steel.

Referring to FIG. 189, the dual-purpose high-strength strip steel production line for continuous annealing or hot-dip galvanizing according to the present disclosure includes the following stations: uncoiling—welding—inlet looper—washing—central continuous post-processing—temper rolling—outlet looper—coiling; wherein
the central continuous post-processing station includes in sequence a jet radiant tube preheating section, a radiant tube heating section, a transverse magnetic induction heating section, a radiant tube soaking section or a jet-radiation composite soaking section, a slow cooling section, a high hydrogen cooling section, a reheating section, a uniform holding section, a secondary reheating section, a parallel arrangement of (a furnace nose section+a zinc pot section+an air knife section+a post-plating cooling section) and (a mobile channel section+an overaging section+a final gas jet cooling section), and a final water cooling section.

In this production line, the strip steel is preheated in a jet radiant tube preheating section, and a transverse magnetic induction heating section is provided after the radiant tube heating section to quickly increase the heating temperature, while high hydrogen cooling is selected for rapid cooling. Further, a uniform holding section+a secondary reheating section is utilized, which can realize a secondary reheating process for high-strength steel such as QP steel.

In the jet radiant tube preheating section, the combustion exhaust gas from the radiant tube heating section is used to heat a recycled nitrogen-hydrogen protective gas in the furnace, and then the nitrogen-hydrogen protective gas is jetted onto the upper and lower surfaces of the strip steel to achieve forced convection heat exchange.

With the parallel arrangement of (the furnace nose section+the zinc pot section+the air knife section+the post-plating cooling section) and (the mobile channel section+the overaging section+the final gas jet cooling section), the strip steel may go through the furnace nose section+zinc pot section+air knife section+post-plating cooling section, that is, taking a hot-dip galvanizing process path to produce a pure zinc hot-dip galvanized product; alternatively, it may go through the mobile channel section+the overaging section+the final gas jet cooling section, that is, taking a continuous annealing process path to produce a continuously annealed product.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

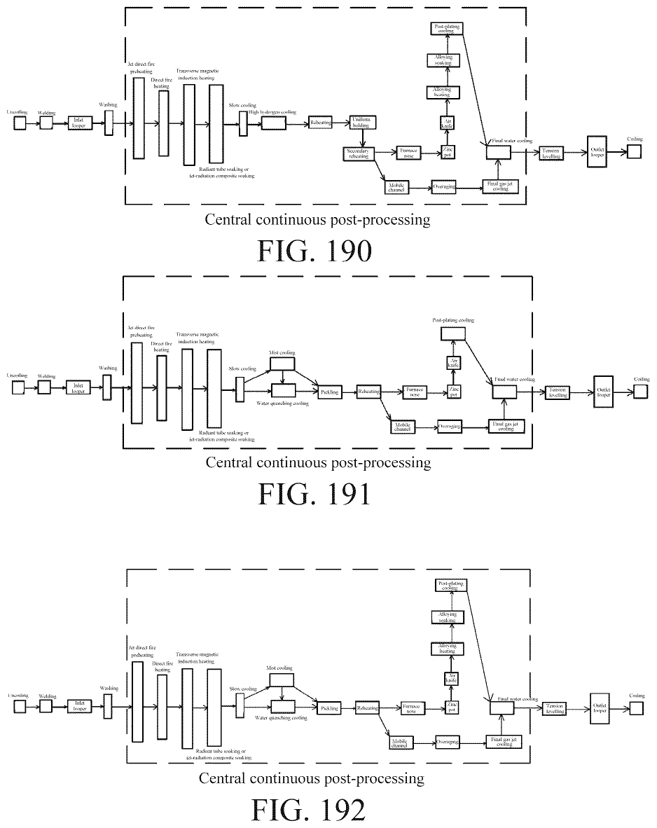

Referring to FIG. 190, the dual-purpose high-strength strip steel production line for continuous annealing or hot-dip galvanizing according to the present disclosure includes the following stations: uncoiling—welding—inlet looper—washing—central continuous post-processing—temper rolling—outlet looper—coiling; wherein
the central continuous post-processing station includes in sequence a jet radiant tube preheating section, a radiant tube heating section, a transverse magnetic induction heating section, a radiant tube soaking section or a jet-radiation composite soaking section, a slow cooling section, a high hydrogen cooling section, a reheating section, a uniform holding section, a secondary reheating section, a parallel arrangement of (a furnace nose section+a zinc pot section+an air knife section+the alloying heating section+the alloying soaking section+a post-plating cooling section) and (a mobile channel section+an overaging section+a final gas jet cooling section), and a final water cooling section.

In this production line, the strip steel is preheated in a jet radiant tube preheating section, and a transverse magnetic induction heating section is provided after the radiant tube heating section to quickly increase the heating temperature, while high hydrogen cooling is selected for rapid cooling. Further, a uniform holding section+a secondary reheating section is utilized, which can realize a secondary reheating process for high-strength steel such as QP steel.

In the jet radiant tube preheating section, the combustion exhaust gas from the radiant tube heating section is used to heat a recycled nitrogen-hydrogen protective gas in the furnace, and then the nitrogen-hydrogen protective gas is jetted onto the upper and lower surfaces of the strip steel to achieve forced convection heat exchange.

The parallel arrangement of (the furnace nose section+the zinc pot section+the air knife section+the alloying heating section+the alloying soaking section+the post-plating cooling section) and (the mobile channel section+the overaging section+the final gas jet cooling section) is provided so that the strip steel may go through the furnace nose section+the zinc pot section+the air knife section+the alloying heating section+the alloying soaking section+the post-plating cooling section, that is, taking a hot-dip galvannealing process path for producing a hot-dip galvannealed product.

When the alloying heating section+the alloying soaking section is not started for operation, the strip steel passes through these process sections with no action on it, and thus a pure zinc hot-dip galvanized product will be produced. The strip steel may also go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

Referring to FIG. 191, the dual-purpose high-strength strip steel production line for continuous annealing or hot-dip galvanizing according to the present disclosure includes the following stations: uncoiling—welding—inlet looper—washing—central continuous post-processing—temper rolling—outlet looper—coiling; wherein
the central continuous post-processing station includes in sequence a jet radiant tube preheating section, a radiant tube heating section, a transverse magnetic induction heating section, a radiant tube soaking section or a jet-radiation composite soaking section, a slow cooling section, a mist cooling section and/or a water quenching cooling section, a pickling section, a reheating section, a parallel arrangement of (a furnace nose section+a zinc pot section+an air knife section+a post-plating cooling section) and (a mobile channel section+an overaging section+a final gas jet cooling section), and a final water cooling section.

In this production line, the strip steel is preheated in a jet radiant tube preheating section, and a transverse magnetic induction heating section is provided after the radiant tube heating section to quickly increase the heating temperature, while mist cooling and/or water quenching cooling is selected for rapid cooling.

In the jet radiant tube preheating section, the combustion exhaust gas from the radiant tube heating section is used to heat a recycled nitrogen-hydrogen protective gas in the furnace, and then the nitrogen-hydrogen protective gas is jetted onto the upper and lower surfaces of the strip steel to achieve forced convection heat exchange.

As for the mist cooling section and/or the water quenching cooling section, the strip steel may be subjected to mist cooling, or water quenching cooling, or mist cooling followed by water quenching cooling.

With the parallel arrangement of (the furnace nose section+the zinc pot section+the air knife section+the post-plating cooling section) and (the mobile channel section+the overaging section+the final gas jet cooling section), the strip steel may go through the furnace nose section+zinc pot section+air knife section+post-plating cooling section, that is, taking a hot-dip galvanizing process path to produce a pure zinc hot-dip galvanized product; alternatively, it may go through the mobile channel section+the overaging section+the final gas jet cooling section, that is, taking a continuous annealing process path to produce a continuously annealed product.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

Referring to FIG. 192, the dual-purpose high-strength strip steel production line for continuous annealing or hot-dip galvanizing according to the present disclosure includes the following stations: uncoiling—welding—inlet looper—washing—central continuous post-processing—temper rolling—outlet looper—coiling; wherein
the central continuous post-processing station includes in sequence a jet radiant tube preheating section, a radiant tube heating section, a transverse magnetic induction heating section, a radiant tube soaking section or a jet-radiation composite soaking section, a slow cooling section, a mist cooling section and/or a water quenching cooling section, a pickling section, a reheating section, a parallel arrangement of (a furnace nose section+a zinc pot section+an air knife section+an alloying heating section+an alloying soaking section+a post-plating cooling section) and (a mobile channel section+an overaging section+a final gas jet cooling section), and a final water cooling section.

In this production line, the strip steel is preheated in a jet radiant tube preheating section, and a transverse magnetic induction heating section is provided after the radiant tube heating section to quickly increase the heating temperature, while mist cooling and/or water quenching cooling is selected for rapid cooling.

In the jet radiant tube preheating section, the combustion exhaust gas from the radiant tube heating section is used to heat a recycled nitrogen-hydrogen protective gas in the furnace, and then the nitrogen-hydrogen protective gas is jetted onto the upper and lower surfaces of the strip steel to achieve forced convection heat exchange.

As for the mist cooling section and/or the water quenching cooling section, the strip steel may be subjected to mist cooling, or water quenching cooling, or mist cooling followed by water quenching cooling.

The parallel arrangement of (the furnace nose section+the zinc pot section+the air knife section+the alloying heating section+the alloying soaking section+the post-plating cooling section) and (the mobile channel section+the overaging section+the final gas jet cooling section) is provided so that the strip steel may go through the furnace nose section+the zinc pot section+the air knife section+the alloying heating section+the alloying soaking section+the post-plating cooling section, that is, taking a hot-dip galvannealing process path for producing a hot-dip galvannealed product. When the alloying heating section+the alloying soaking section is not started for operation, the strip steel passes through these process sections with no action on it, and thus a pure zinc hot-dip galvanized product will be produced. Alternatively, it may go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the hot-dip galvanizing process path is achieved by cutting the strip steel and reloading the strip steel.

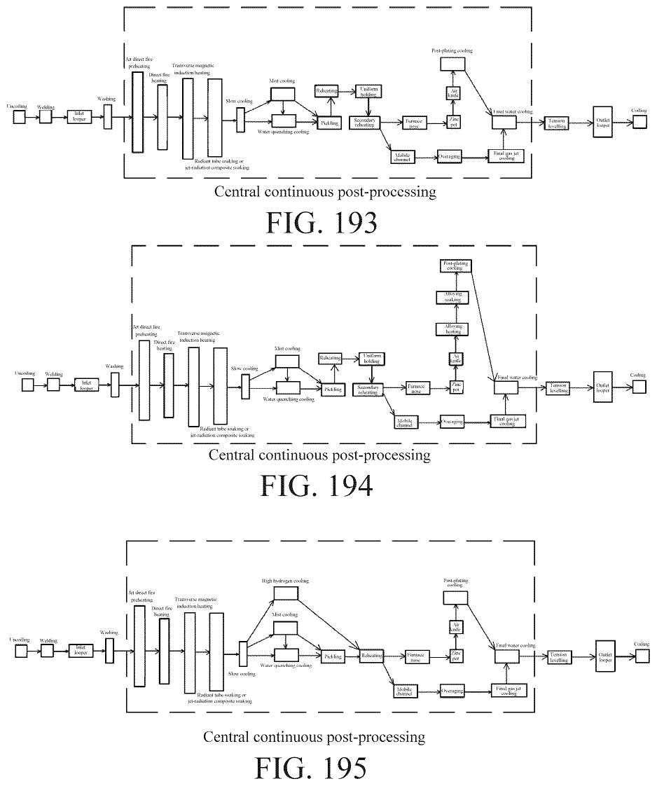

Referring to FIG. 193, the dual-purpose high-strength strip steel production line for continuous annealing or hot-dip galvanizing according to the present disclosure includes the following stations: uncoiling—welding—inlet looper—washing—central continuous post-processing—temper rolling—outlet looper—coiling; wherein
the central continuous post-processing station includes in sequence a jet radiant tube preheating section, a radiant tube heating section, a transverse magnetic induction heating section, a radiant tube soaking section or a jet-radiation composite soaking section, a slow cooling section, a mist cooling section and/or a water quenching cooling section, a pickling section, a reheating section, a uniform holding section, a secondary reheating section, a parallel arrangement of (a furnace nose section+a zinc pot section+an air knife section+a post-plating cooling section) and (a mobile channel section+an overaging section+a final gas jet cooling section), and a final water cooling section.

In this production line, the strip steel is preheated in a jet radiant tube preheating section, and a transverse magnetic induction heating section is provided after the radiant tube heating section to quickly increase the heating temperature, while mist cooling and/or water quenching cooling is provided for rapid cooling. Further, the uniform holding section+the secondary reheating section is utilized, which can realize a secondary reheating process for high-strength steel such as QP steel.

In the jet radiant tube preheating section, the combustion exhaust gas from the radiant tube heating section is used to heat a recycled nitrogen-hydrogen protective gas in the furnace, and then the nitrogen-hydrogen protective gas is jetted onto the upper and lower surfaces of the strip steel to achieve forced convection heat exchange.

As for the mist cooling section and/or the water quenching cooling section, the strip steel may be subjected to mist cooling, or water quenching cooling, or mist cooling followed by water quenching cooling.

With the parallel arrangement of (the furnace nose section+the zinc pot section+the air knife section+the post-plating cooling section) and (the mobile channel section+the overaging section+the final gas jet cooling section), the strip steel may go through the furnace nose section+zinc pot section+air knife section+post-plating cooling section, that is, taking a hot-dip galvanizing process path to produce a pure zinc hot-dip galvanized product; alternatively, it may go through the mobile channel section+the overaging section+the final gas jet cooling section, that is, taking a continuous annealing process path to produce a continuously annealed product.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

Referring to FIG. 194, the dual-purpose high-strength strip steel production line for continuous annealing or hot-dip galvanizing according to the present disclosure includes the following stations: uncoiling—welding—inlet looper—washing—central continuous post-processing—temper rolling—outlet looper—coiling; wherein
the central continuous post-processing station includes in sequence a jet radiant tube preheating section, a radiant tube heating section, a transverse magnetic induction heating section, a radiant tube soaking section or a jet-radiation composite soaking section, a slow cooling section, a mist cooling section and/or a water quenching cooling section, a pickling section, a reheating section, a uniform holding section, a secondary reheating section, a parallel arrangement of (a furnace nose section+a zinc pot section+an air knife section+an alloying heating section+an alloying soaking section+a post-plating cooling section) and (a mobile channel section+an overaging section+a final gas jet cooling section), and a final water cooling section.

In this production line, the strip steel is preheated in a jet radiant tube preheating section, and a transverse magnetic induction heating section is provided after the radiant tube heating section to quickly increase the heating temperature, while mist cooling and/or water quenching cooling is provided for rapid cooling. Further, the uniform holding section+the secondary reheating section is utilized, which can realize a secondary reheating process for high-strength steel such as QP steel.

In the jet radiant tube preheating section, the combustion exhaust gas from the radiant tube heating section is used to heat a recycled nitrogen-hydrogen protective gas in the furnace, and then the nitrogen-hydrogen protective gas is jetted onto the upper and lower surfaces of the strip steel to achieve forced convection heat exchange.

As for the mist cooling section and/or the water quenching cooling section, the strip steel may be subjected to mist cooling, or water quenching cooling, or mist cooling followed by water quenching cooling.

The parallel arrangement of (the furnace nose section+the zinc pot section+the air knife section+the alloying heating section+the alloying soaking section+the post-plating cooling section) and (the mobile channel section+the overaging section+the final gas jet cooling section) is provided so that the strip steel may go through the furnace nose section+the zinc pot section+the air knife section+the alloying heating section+the alloying soaking section+the post-plating cooling section, that is, taking a hot-dip galvannealing process path for producing a hot-dip galvannealed product. When the alloying heating section+the alloying soaking section is not started for operation, the strip steel passes through these process sections with no action on it, and thus a pure zinc hot-dip galvanized product will be produced. Alternatively, it may go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

Referring to FIG. 195, the dual-purpose high-strength strip steel production line for continuous annealing or hot-dip galvanizing according to the present disclosure includes the following stations: uncoiling—welding—inlet looper—washing—central continuous post-processing—temper rolling—outlet looper—coiling; wherein
the central continuous post-processing station includes in sequence a jet radiant tube preheating section, a radiant tube heating section, a transverse magnetic induction heating section, a radiant tube soaking section or a jet-radiation composite soaking section, a slow cooling section, a parallel arrangement of a high hydrogen cooling section and (a mist cooling section and/or a water quenching cooling section+a pickling section), a reheating section, a parallel arrangement of (a furnace nose section+a zinc pot section+an air knife section+a post-plating cooling section) and (a mobile channel section+an overaging section+a final gas jet cooling section), and a final water cooling section.

In this production line, the strip steel is preheated in a jet radiant tube preheating section, and a transverse magnetic induction heating section is provided after the radiant tube heating section to quickly increase the heating temperature, while the parallel arrangement of the high hydrogen cooling section and (the mist cooling section and/or the water quenching cooling section) is provided for rapid cooling.

In the jet radiant tube preheating section, the combustion exhaust gas from the radiant tube heating section is used to heat a recycled nitrogen-hydrogen protective gas in the furnace, and then the nitrogen-hydrogen protective gas is jetted onto the upper and lower surfaces of the strip steel to achieve forced convection heat exchange.

With the parallel arrangement of the high hydrogen cooling section and (the mist cooling section and/or the water quenching cooling section+the pickling section), the strip steel may be subjected to high hydrogen cooling, or mist cooling, or water quenching cooling, or mist cooling followed by water quenching cooling.

With the parallel arrangement of (the furnace nose section+the zinc pot section+the air knife section+the post-plating cooling section) and (the mobile channel section+the overaging section+the final gas jet cooling section), the strip steel may go through the furnace nose section+zinc pot section+air knife section+post-plating cooling section, that is, taking a hot-dip galvanizing process path to produce a pure zinc hot-dip galvanized product; alternatively, it may go through the mobile channel section+the overaging section+the final gas jet cooling section, that is, taking a continuous annealing process path to produce a continuously annealed product.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

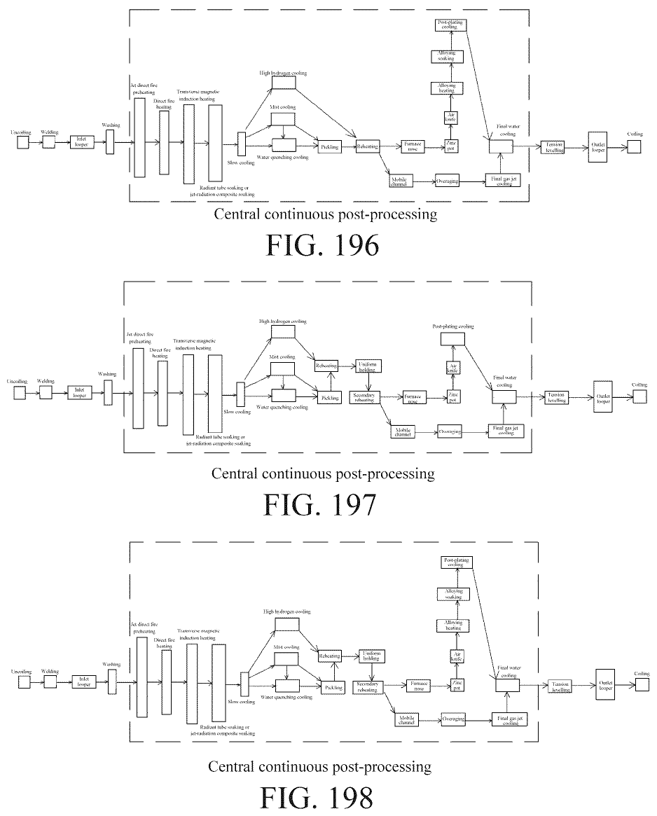

Referring to FIG. 196, the dual-purpose high-strength strip steel production line for continuous annealing or hot-dip galvanizing according to the present disclosure includes the following stations: uncoiling—welding—inlet looper—washing—central continuous post-processing—temper rolling—outlet looper—coiling; wherein
the central continuous post-processing station includes in sequence a jet radiant tube preheating section, a radiant tube heating section, a transverse magnetic induction heating section, a radiant tube soaking section or a jet-radiation composite soaking section, a slow cooling section, a parallel arrangement of a high hydrogen cooling section and (a mist cooling section and/or a water quenching cooling section+a pickling section), a reheating section, a parallel arrangement of (a furnace nose section+a zinc pot section+an air knife section+an alloying heating section+an alloying soaking section+a post-plating cooling section) and (a mobile channel section+an overaging section+a final gas jet cooling section), and a final water cooling section.

In this production line, the strip steel is preheated in a jet radiant tube preheating section, and a transverse magnetic induction heating section is provided after the radiant tube heating section to quickly increase the heating temperature, while the parallel arrangement of the high hydrogen cooling section and (the mist cooling section and/or the water quenching cooling section) is provided for rapid cooling.

In the jet radiant tube preheating section, the combustion exhaust gas from the radiant tube heating section is used to heat a recycled nitrogen-hydrogen protective gas in the furnace, and then the nitrogen-hydrogen protective gas is jetted onto the upper and lower surfaces of the strip steel to achieve forced convection heat exchange.

With the parallel arrangement of the high hydrogen cooling section and (the mist cooling section and/or the water quenching cooling section+the pickling section), the strip steel may be subjected to high hydrogen cooling, or mist cooling, or water quenching cooling, or mist cooling followed by water quenching cooling.

The parallel arrangement of (the furnace nose section+the zinc pot section+the air knife section+the alloying heating section+the alloying soaking section+the post-plating cooling section) and (the mobile channel section+the overaging section+the final gas jet cooling section) is provided so that the strip steel may go through the furnace nose section+the zinc pot section+the air knife section+the alloying heating section+the alloying soaking section+the post-plating cooling section, that is, taking a hot-dip galvannealing process path for producing a hot-dip galvannealed product. When the alloying heating section+the alloying soaking section is not started for operation, the strip steel passes through these process sections with no action on it, and thus a pure zinc hot-dip galvanized product will be produced. Alternatively, it may go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

Referring to FIG. 197, the dual-purpose high-strength strip steel production line for continuous annealing or hot-dip galvanizing according to the present disclosure includes the following stations: uncoiling—welding—inlet looper—washing—central continuous post-processing—temper rolling—outlet looper—coiling; wherein
the central continuous post-processing station includes in sequence a jet radiant tube preheating section, a radiant tube heating section, a transverse magnetic induction heating section, a radiant tube soaking section or a jet-radiation composite soaking section, a slow cooling section, a parallel arrangement of a high hydrogen cooling section and (a mist cooling section and/or a water quenching cooling section+a pickling section), a reheating section, a uniform holding section, a secondary reheating section, a parallel arrangement of (a furnace nose section+a zinc pot section+an air knife section+a post-plating cooling section) and (a mobile channel section+an overaging section+a final gas jet cooling section), and a final water cooling section.

In this production line, the strip steel is preheated in a jet radiant tube preheating section, and a transverse magnetic induction heating section is provided after the radiant tube heating section to quickly increase the heating temperature, while the parallel arrangement of the high hydrogen cooling section and (the mist cooling section and/or the water quenching cooling section) is provided for rapid cooling. Further, the uniform holding section+the secondary reheating section is utilized, which can realize a secondary reheating process for high-strength steel such as QP steel.

In the jet radiant tube preheating section, the combustion exhaust gas from the radiant tube heating section is used to heat a recycled nitrogen-hydrogen protective gas in the furnace, and then the nitrogen-hydrogen protective gas is jetted onto the upper and lower surfaces of the strip steel to achieve forced convection heat exchange.

With the parallel arrangement of the high hydrogen cooling section and (the mist cooling section and/or the water quenching cooling section+the pickling section), the strip steel may be subjected to high hydrogen cooling, or mist cooling, or water quenching cooling, or mist cooling followed by water quenching cooling.

With the parallel arrangement of (the furnace nose section+the zinc pot section+the air knife section+the post-plating cooling section) and (the mobile channel section+the overaging section+the final gas jet cooling section), the strip steel may go through the furnace nose section+zinc pot section+air knife section+post-plating cooling section, that is, taking a hot-dip galvanizing process path to produce a pure zinc hot-dip galvanized product; alternatively, it may go through the mobile channel section+the overaging section+the final gas jet cooling section, that is, taking a continuous annealing process path to produce a continuously annealed product.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

Referring to FIG. 198, the dual-purpose high-strength strip steel production line for continuous annealing or hot-dip galvanizing according to the present disclosure includes the following stations: uncoiling—welding—inlet looper—washing—central continuous post-processing—temper rolling—outlet looper—coiling; wherein
the central continuous post-processing station includes in sequence a jet radiant tube preheating section, a radiant tube heating section, a transverse magnetic induction heating section, a radiant tube soaking section or a jet-radiation composite soaking section, a slow cooling section, a parallel arrangement of a high hydrogen cooling section and (a mist cooling section and/or a water quenching cooling section+a pickling section), a pickling section, a reheating section, a uniform holding section, a secondary reheating section, a parallel arrangement of (a furnace nose section+a zinc pot section+an air knife section+an alloying heating section+an alloying soaking section+a post-plating cooling section) and (a mobile channel section+an overaging section+a final gas jet cooling section), and a final water cooling section.

In this production line, the strip steel is preheated in a jet radiant tube preheating section, and a transverse magnetic induction heating section is provided after the radiant tube heating section to quickly increase the heating temperature, while the parallel arrangement of the high hydrogen cooling section and (the mist cooling section and/or the water quenching cooling section) is provided for rapid cooling. Further, the uniform holding section+the secondary reheating section is utilized, which can realize a secondary reheating process for high-strength steel such as QP steel.

In the jet radiant tube preheating section, the combustion exhaust gas from the radiant tube heating section is used to heat a recycled nitrogen-hydrogen protective gas in the furnace, and then the nitrogen-hydrogen protective gas is jetted onto the upper and lower surfaces of the strip steel to achieve forced convection heat exchange.

With the parallel arrangement of the high hydrogen cooling section and (the mist cooling section and/or the water quenching cooling section+the pickling section), the strip steel may be subjected to high hydrogen cooling, or mist cooling, or water quenching cooling, or mist cooling followed by water quenching cooling.

The parallel arrangement of (the furnace nose section+the zinc pot section+the air knife section+the alloying heating section+the alloying soaking section+the post-plating cooling section) and (the mobile channel section+the overaging section+the final gas jet cooling section) is provided so that the strip steel may go through the furnace nose section+the zinc pot section+the air knife section+the alloying heating section+the alloying soaking section+the post-plating cooling section, that is, taking a hot-dip galvannealing process path for producing a hot-dip galvannealed product. When the alloying heating section+the alloying soaking section is not started for operation, the strip steel passes through these process sections with no action on it, and thus a pure zinc hot-dip galvanized product will be produced. Alternatively, it may go through the mobile channel section+the overaging section+the final gas jet cooling section, that is, taking a continuous annealing process path for producing a continuously annealed product.

The mobile channel section is provided in parallel with the furnace nose section, and the mobile channel section may be movably switched to an online position, or may be movably switched to an offline position. The switching between the continuous annealing process path and the pure zinc hot-dip galvanizing process path is achieved by cutting the strip steel and reloading the strip steel.

### Example 1

To produce a high-strength strip steel with a unit whose layout is shown in FIG. 188, a strip steel with the main chemical composition (mass %) of the substrate being 0.085% C-0.16% Si-1.90% Mn was uncoiled, welded, passed through an inlet looper, and washed. The strip steel was then preheated to 270° C. by jet radiant tube preheating, then heated to 750° C. by radiant tube heating, then heated to 830° C. by transverse magnetic induction heating, then soaked at 830° C. by radiant tube soaking for 40 seconds, then slowly cooled to 670° C., and then cooled to 465° C. by high hydrogen cooling. After passing through a reheating section (the reheating was not activated), the strip steel took a hot-dip galvannealing process path. It passed through a furnace nose, and was immersed in a zinc pot for hot-dip galvanizing. After the coating weight was controlled by an air knife, the strip steel was heated to 515° C. by alloying heating, and soaked at 510° C. by alloying soaking for 20 seconds. Then, the strip steel was subjected to post-plating cooling, and then cooled to room temperature by final water cooling. After being temper rolled, it entered an outlet looper, and then it was coiled to complete the production. The final strip steel product had a yield strength of 582 MPa, a tensile strength of 818 MPa, and an elongation at break of 19%.

### Example 2

To prepare a high-strength strip steel with a unit whose layout is shown in FIG. 189, a strip steel with the main chemical composition (mass %) of the substrate being 0.12% C-0.41% Si-1.90% Mn was uncoiled, welded, passed through an inlet looper, and washed. The strip steel was then preheated to 280° C. by jet radiant tube preheating, then heated to 710° C. by radiant tube heating, then heated to 810° C. by transverse magnetic induction heating, then soaked at 810° C. by jet-radiation composite soaking for 40 seconds, then slowly cooled to 670° C., and then cooled to 460° C. by high hydrogen cooling. After uniform holding at 460° C. (the heating function of the reheating and secondary reheating sections was not activated in this Example), the strip steel took a hot-dip galvanizing process path. It passed through a furnace nose, and was immersed in a zinc pot for hot-dip galvanizing. After the coating weight was controlled by an air knife, the strip steel was subjected to post-plating cooling, and then cooled to room temperature by final water cooling. After being temper rolled, it entered an outlet looper, and then it was coiled to complete the production. The final strip steel product had a yield strength of 346 MPa, a tensile strength of 658 MPa, and an elongation at break of 24%.

### Example 3

To prepare a high-strength strip steel with a unit whose layout is shown in FIG. 190, a strip steel with the main chemical composition (mass %) of the substrate being 0.19% C-1.70% Si-2.60% Mn was uncoiled, welded, passed through an inlet looper, and washed. The strip steel was then preheated to 275° C. by jet radiant tube preheating, then heated to 750° C. by radiant tube heating, then heated to 850° C. by transverse magnetic induction heating, then soaked at 850° C. by radiant tube soaking for 60 seconds, then slowly cooled to 670° C., and then cooled to 260° C. by high hydrogen cooling. After being heated to 420° C., the strip steel was uniformly held at 420° C. to achieve redistribution of the carbon element in the strip steel and stabilize the residual austenite structure in the strip steel. Then, it was heated to 465° C. by secondary reheating. The strip steel took a hot-dip galvannealing process path. It passed through a furnace nose, and was immersed in a zinc pot for hot-dip galvanizing. After the coating weight was controlled by an air knife, the strip steel entered an alloying heating furnace to be heated to 510° C., and then entered an alloying soaking furnace to be held at 505° C. for 20 seconds. Then, the strip steel was cooled to about 140° C. by a post-plating cooling device, and then cooled to 45° C. or lower by final water cooling. After being temper rolled, it entered an outlet looper, and then it was coiled to complete the production. The final strip steel product had a yield strength of 1063 MPa, a tensile strength of 1196 MPa, and an elongation at break of 14%.

### Example 4

To prepare a high-strength strip steel with a unit whose layout is shown in FIG. 191, a strip steel with the main chemical composition (mass %) of the substrate being 0.06% C-0.010% Si-0.95% Mn was uncoiled, welded, passed through an inlet looper, and washed. The strip steel was then preheated to 250° C. by jet radiant tube preheating, then heated to 710° C. by radiant tube heating, then heated to 810° C. by transverse magnetic induction heating, then soaked at 810° C. by jet-radiation composite soaking for 60 seconds, then slowly cooled to 675° C., then cooled to 500° C. by mist cooling, and then cooled to room temperature by water quenching cooling. Subsequently, it was pickled and reheated to 230° C. Then, the strip steel took a continuous annealing process path. It passed through a mobile channel, and entered an overaging section for overaging at 230° C. Then, it was cooled to about 140° C. by final gas jet cooling, and then cooled to room temperature by final water cooling. After being temper rolled, it entered an outlet looper, and then it was coiled to complete the production. The final strip steel product had a yield strength of 598 MPa, a tensile strength of 709 MPa, and an elongation at break of 12%.

### Example 5

To prepare a high-strength strip steel with a unit whose layout is shown in FIG. 182, a strip steel with the main chemical composition (mass %) of the substrate being 0.10% C-0.21% Si-2.2% Mn was uncoiled, welded, passed through an inlet looper, and washed. The strip steel was then preheated to 265° C. by jet radiant tube preheating, then heated to 830° C. by radiant tube heating, then heated to 910° C. by transverse magnetic induction heating, then soaked at 910° C. by radiant tube soaking for 60 seconds, then slowly cooled to 700° C., and then cooled to about 50° C. by water quenching cooling. Subsequently, it was pickled and reheated to 235° C. Then, the strip steel took a continuous annealing process path. It passed through a mobile channel, and entered an overaging section for overaging at 235° C. Then, it was cooled to about 140° C. by final gas jet cooling, and then cooled to room temperature by final water cooling. After being temper rolled, it entered an outlet looper, and then it was coiled to complete the production. The final strip steel product had a yield strength of 1011 MPa, a tensile strength of 1299 MPa, and an elongation at break of 6%.

The above Examples are only illustrative and are not intended to limit the scope of the present disclosure. Those technical solutions derived from the concept of the present disclosure are also within the protection scope of this application.

1. A rapid production line for hot-dip galvanized strip steel, for hot-dip galvanized high-strength strip steel, for hot-dip galvanized ultra-high-strength strip steel, for annealed strip steel, for annealed strip steel, for annealed high-strength strip steel or for annealed ultra-high-strength strip steel, wherein:
(1) the rapid production line for hot-dip galvanized strip steel includes the following stations in sequence: uncoiling—welding—inlet looper—washing—central continuous post-processing—outlet looper—temper rolling—coiling; wherein:
the central continuous post-processing station includes in sequence a preheating section, a heating section, a soaking section, a slow cooling section, a high hydrogen cooling section, a reheating section, a uniform holding section, a secondary reheating section, a furnace nose section, a zinc pot section, an air knife section, a post-plating cooling section and a final water cooling section;
a jet direct fire preheating device or a jet-radiation composite heating device is used for the preheating section;
a direct fire heating section and/or a radiant tube heating section is used for the heating section;
a radiant tube soaking section or a jet-radiation composite soaking section is used for the soaking section; and
a longitudinal magnetic induction heating device is used for both the reheating section and the secondary reheating section to heat a strip steel quickly;
(2). the rapid production line for hot-dip galvanized high-strength strip steel includes the following stations in sequence: uncoiling—welding—inlet looper—washing—central continuous post-processing—temper rolling—outlet looper—coiling, wherein
the central continuous post-processing station includes in sequence a preheating section, a radiant tube heating section, a transverse magnetic induction heating section, a radiant tube soaking section, a slow cooling section, a high hydrogen cooling section, a reheating section, a uniform holding section, a secondary reheating section, a furnace nose section, a zinc pot section, an air knife section, a post-plating cooling section and a final water cooling section;
a jet-radiation composite heating section or a jet radiant tube preheating section is used for the preheating section;
in the jet-radiation composite heating section, in addition to use of radiation of a radiant tube to heat a strip steel, combustion exhaust gas of the radiant tube is also used to heat a recycled nitrogen-hydrogen protective gas or an all-hydrogen gas, and then the nitrogen-hydrogen protective gas or all-hydrogen gas is jetted onto upper and lower surfaces of the strip steel to achieve forced convection heat exchange;
in the jet radiant tube preheating section, combustion exhaust gas from the radiant tube heating section and the radiant tube soaking section is used to heat a recycled nitrogen-hydrogen protective gas in a furnace, and then the nitrogen-hydrogen protective gas is jetted onto the upper and lower surfaces of the strip steel to realize forced convection heat exchange;
a radiant tube soaking section or a jet-radiation composite heating section is used for the soaking section; and
longitudinal magnetic induction heating is used for both the reheating section and the secondary reheating section to heat the strip steel quickly;
(3). the rapid production line for hot-dip galvanized ultra-high-strength strip steel includes the following stations in sequence: uncoiling—welding—inlet looper—washing—central continuous post-processing—temper rolling—outlet looper—coiling, wherein the central continuous post-processing station includes in sequence a jet direct fire preheating section, a direct fire heating section, a radiant tube heating section, a transverse magnetic induction heating section, a soaking section, a slow cooling section, a high hydrogen cooling section, a reheating section, a uniform holding section, a secondary reheating section, a furnace nose section, a zinc pot section, an air knife section, a post-plating cooling section and a final water cooling section; wherein a radiant tube soaking section or a jet-radiation composite soaking section is used for the soaking section; in the jet direct fire preheating section, combustion exhaust gas from the direct fire heating section is used to heat a recycled nitrogen-hydrogen protective gas, and then the nitrogen-hydrogen protective gas is jetted onto upper and lower surfaces of a strip steel to realize forced convection heat exchange; and a longitudinal magnetic induction heating device is used in both the reheating section and the secondary reheating section to heat the strip steel quickly; or
the rapid production line includes the following stations in sequence: uncoiling—welding-inlet looper—washing—central continuous post-processing—temper rolling—outlet looper—coiling, wherein the central continuous post-processing station includes in sequence a jet direct fire preheating section, a direct fire heating section, a radiant tube heating section, a transverse magnetic induction heating section, a soaking section, a slow cooling section, a rapid cooling section, a pickling section, a reheating section, a uniform holding section, a secondary reheating section, a furnace nose section, a zinc pot section, an air knife section, a post-plating cooling section and a final water cooling section; wherein a radiant tube soaking section or a jet-radiation composite soaking section is used for the soaking section; a mist cooling section and/or a water quenching cooling section is used for the rapid cooling section; in the jet direct fire preheating section, combustion exhaust gas from the direct fire heating section is used to heat a recycled nitrogen-hydrogen protective gas, and then the nitrogen-hydrogen protective gas is jetted onto upper and lower surfaces of a strip steel to realize forced convection heat exchange; and a longitudinal magnetic induction heating device is used for both the reheating section and the secondary reheating section to heat the strip steel quickly;
(4). the rapid production line for annealed strip steel includes the following stations in sequence: uncoiling—welding—inlet looper—washing—central continuous post-processing—temper rolling—outlet looper—coiling; wherein the central continuous post-processing station includes in sequence a preheating section, a heating section, a soaking section, a slow cooling section, a rapid cooling section, a reheating section, an overaging section, a final gas jet cooling section, and a final water cooling section; a jet direct fire preheating device or a jet-radiation composite heating device is used for the preheating section; a direct fire heating section and/or a radiant tube heating section is used for the heating section; high hydrogen cooling, or mist cooling, or water quenching cooling is used for the rapid cooling section; in the soaking section, a radiant tube soaking device or a jet-radiation composite heating device is used for soaking; or
the rapid production line includes the following stations in sequence: uncoiling—welding-inlet looper—washing—central continuous post-processing—temper rolling—outlet looper—coiling; wherein the central continuous post-processing station includes in sequence a preheating section, a heating section, a radiant tube soaking section, a slow cooling section, a rapid cooling section, a reheating section, an overaging section, a final gas jet cooling section, and a final water cooling section; a jet direct fire preheating device or a jet-radiation composite heating device is used for the preheating section; a direct fire heating section and/or a radiant tube heating section is used for the heating section; for the rapid cooling section, a high hydrogen cooling section is provided in parallel with a mist cooling or water quenching cooling section, or mist cooling and water quenching cooling are provided in parallel and a connecting channel is provided between the mist cooling and the water quenching cooling, or high hydrogen cooling is provided in parallel with mist cooling and water quenching cooling and a connecting channel is provided between the mist cooling and the water quenching cooling;
(5). the rapid production line for annealed high-strength strip steel includes the following stations in sequence: uncoiling—welding—inlet looper—washing—central continuous post-processing—temper rolling—outlet looper—coiling; wherein the central continuous post-processing station includes in sequence a jet-radiation composite heating section, a radiant tube heating section, a transverse magnetic induction heating section, a soaking section, a slow cooling section, a rapid cooling section, a reheating section, an overaging section, a final gas jet cooling section, and a final water cooling section; in the jet-radiation composite heating section, a radiant tube is installed inside a high-speed gas jet bellows to rapidly transfer heat generated by combustion gas of the radiant tube to a strip steel through both high-speed high-temperature gas jet and radiation, thereby enabling rapid heating of the strip steel; the rapid cooling section includes a high hydrogen cooling section or a mist cooling section or a water quenching cooling section; or the high hydrogen cooling section is provided in parallel with the mist cooling section; or the high hydrogen cooling section is provided in parallel with the water quenching cooling section; or the mist cooling section is provided in parallel with the water quenching cooling section, and a connecting channel is provided between the mist cooling section and the water quenching cooling section; or the high hydrogen cooling section, the mist cooling section and the water quenching cooling section are provided in parallel, and a connecting channel is provided between the mist cooling section and the water quenching cooling section; and a radiant tube heating device or a jet-radiation composite heating device is used for the soaking section;
(6). the rapid production line for annealed ultra-high-strength strip steel includes the following stations in sequence: uncoiling—welding—inlet looper—washing—central continuous post-processing—temper rolling—outlet looper—coiling, wherein the central continuous post-processing station includes in sequence a jet direct fire preheating section, a direct fire heating section, a radiant tube heating section, a transverse magnetic induction heating section, a soaking section, a slow cooling section, a fast cooling section, a reheating section, an overaging section, a final gas jet cooling section and a final water cooling section; wherein a radiant tube soaking section or a jet-radiation composite soaking section is used for the soaking section; in the rapid cooling section, a high hydrogen cooling section or a mist cooling section or a water quenching cooling section is used; or, a high hydrogen cooling section is provided in parallel with a mist cooling section or a water quenching cooling section; or, a mist cooling section is provided in parallel with a water quenching cooling section, and a connecting channel is provided between the mist cooling section and the water quenching cooling section; or, a high hydrogen cooling section, a mist cooling section, and a water quenching cooling section are provided in parallel, and a connecting channel is provided between the mist cooling section and the water quenching cooling section, wherein the high hydrogen cooling section is connected to the reheating section.

2.-6. (canceled)

7. An ultra-short-process production line for pure zinc hot-dip galvanized high-strength strip steel, for ultra-high-strength strip steel, for hot-dip galvanized high-strength strip steel, or for dual-purpose strip steel, wherein:
(1) the ultra-short-process production line for pure zinc hot-dip galvanized high-strength strip steel includes the following stations in sequence: uncoiling—welding—inlet looper-central continuous post-processing—outlet looper—temper rolling—coiling; wherein the central continuous post-processing station includes in sequence a rapid heating station, a soaking station, a rapid cooling station, a surface modification station and a pure zinc hot-dip galvanizing station; a direct fire heating device is used for the rapid heating station; a radiant tube soaking device or a jet-radiation composite soaking device or an electric radiant tube soaking device, or a resistance wire soaking device or a resistance belt soaking device is used for the soaking station; a mist cooling device or a water quenching cooling device is used for the rapid cooling station; a pickling device is used for the surface modification station; the pure zinc hot-dip galvanizing station is provided with a reheating section, a furnace nose section, a zinc pot section, an air knife section, a post-plating cooling section and a final water cooling section in sequence;
(2). the ultra-short-process production line for ultra-high-strength strip steel includes the following stations in sequence: uncoiling—welding—inlet looper—central continuous post-processing—outlet looper—coiling; wherein the central continuous post-processing station includes in sequence a rapid heating station, a soaking station and a rapid cooling station; a jet-radiation composite heating device is used for the rapid heating station; a radiant tube soaking device, a jet-radiation composite soaking device, an electric radiant tube soaking device, a resistance wire soaking device or a resistance belt soaking device is used for the soaking station; and a high hydrogen cooling device, a mist cooling device or a water quenching cooling device is used for the rapid cooling station;
(3). the ultra-short-process production line for hot-dip galvanized high-strength strip steel, includes the following stations in sequence: uncoiling—welding—inlet looper—central continuous post-processing—outlet looper—temper rolling—coiling; wherein the central continuous post-processing station includes in sequence a rapid heating section, a soaking section, a rapid cooling section, and a hot-dip galvanizing section; direct fire heating is used for the rapid heating section; or, direct fire heating and transverse magnetic induction heating are provided in series; or, direct fire heating, jet-radiation composite heating and transverse magnetic induction heating are provided in series; jet-radiation composite soaking, electric radiant tube soaking, resistance wire soaking or resistance belt soaking is used for the soaking section; high hydrogen cooling is used for the rapid cooling section; the hot-dip galvanizing section is provided with a furnace nose, a zinc pot, an air knife, a post-plating cooling device and a final water cooling device in sequence;
(4) the ultra-short-process production line for dual-purpose strip steel includes the following stations in sequence: uncoiling—welding—inlet looper—central continuous post-processing—temper rolling—outlet looper—coiling; wherein the central continuous post-processing station includes in sequence a transverse magnetic induction heating section, a radiant tube soaking section, a mist cooling section or/and a water quenching cooling section, a pickling section, a reheating section, a parallel arrangement of (a furnace nose section+a zinc pot section+an air knife section+a post-plating cooling section) and (a mobile channel section+an over-aging section+a final gas jet cooling section), and a final water cooling section; or
the ultra-short-process production line for dual-purpose strip steel includes the following stations in sequence: uncoiling—welding—inlet looper—central continuous post-processing—temper rolling—outlet looper—coiling; wherein the central continuous post-processing station includes in sequence a transverse magnetic induction heating section, a radiant tube soaking section, a mist cooling section or/and a water quenching cooling section, a pickling section, a reheating section, a parallel arrangement of (a furnace nose section+a zinc pot section+an air knife section+an alloying heating section+an alloying soaking section+a post-plating cooling section) and (a mobile channel section+an over-aging section+a final gas jet cooling section), and a final water cooling section; or
the ultra-short-process production line for dual-purpose strip steel includes the following stations in sequence: uncoiling—welding—inlet looper—central continuous post-processing—temper rolling—outlet looper—coiling; wherein the central continuous post-processing station includes in sequence a transverse magnetic induction heating section, a radiant tube soaking section, a mist cooling section or/and a water quenching cooling section, a pickling section, a reheating section, a uniform holding section, a secondary reheating section, a parallel arrangement of (a furnace nose section+a zinc pot section+an air knife section+a post-plating cooling section) and (a mobile channel section+an over-aging section+a final gas jet cooling section), and a final water cooling section; or
the ultra-short-process production line for dual-purpose strip steel includes the following stations in sequence: uncoiling—welding—inlet looper—central continuous post-processing—temper rolling—outlet looper—coiling; wherein the central continuous post-processing station includes in sequence a transverse magnetic induction heating section, a radiant tube soaking section, a mist cooling section or/and a water quenching cooling section, a pickling section, a reheating section, a uniform holding section, a secondary reheating section, a parallel arrangement of (furnace nose section+zinc pot section+air knife section+alloying heating section+alloying soaking section+post-plating cooling section) and (mobile channel section+over-aging section+final gas jet cooling section), and a final water cooling section.

8.-9. (canceled)

10. A flexible cold-rolled strip steel post-processing production line suitable for producing a variety of high-strength steels, or a flexible post-cold-rolling processing production line suitable for producing a variety of ultra-high-strength strip steels, or a flexible production line for producing a variety of high-strength/ultra-high-strength steels, or a dual-purpose ultra-high-strength strip steel production line for continuous annealing or hot-dip galvanizing or a dual-purpose high-strength strip steel production line for continuous annealing or hot-dip galvanizing, wherein:
(1) the flexible cold-rolled strip steel post-processing production line suitable for producing a variety of high-strength steels includes the following stations in sequence: uncoiling—welding—inlet looper—washing—central continuous post-processing-inlet looper—temper rolling—outlet looper-finishing-coiling; wherein
the central continuous post-processing station includes in sequence a jet radiant tube preheating section, a radiant tube heating section, a selectable transverse magnetic induction heating section or muffle furnace section provided in parallel, a jet-radiation composite soaking section, a slow cooling section, a rapid cooling section, and a reheating section; the rapid cooling section includes a high hydrogen cooling section and/or a mist cooling section and/or a water quenching cooling section;
the reheating section is followed by a furnace nose section, a zinc pot section, an air knife section, an alloying heating section, an alloying soaking section, a post-plating cooling section, and a final water cooling section; or connected to the final water cooling section through a mobile channel, an overaging section, and a final gas jet cooling section;
optionally, the final water cooling section is followed by a pickling section or a pickling section+a flash plating section in sequence; wherein a strip steel passes through the pickling section for producing a cold-rolled pickled product, or bypasses the pickling section to produce a cold-rolled annealed product; wherein a pickled strip steel optionally enters the flash plating section for producing a flash-plated product which is flash plated with nickel or zinc;
a gas fuel selected from natural gas or liquefied petroleum gas or coal gas is combusted in the radiant tube heating section;
the jet radiant tube preheating section uses combustion exhaust gas from the heating section and/or the soaking section to heat a recycled nitrogen-hydrogen protective gas by heat exchange in a furnace, and then the nitrogen-hydrogen protective gas is jetted onto upper and lower surfaces of the strip steel to realize forced convection heat exchange;
the radiant tube heating section is provided in series with (a selectable transverse magnetic induction heating section or muffle furnace section provided in parallel);
the jet-radiation composite soaking section utilizes forced convection and radiation in combination to quickly soak the strip steel, so as to improve temperature uniformity of the strip steel and realize rapid regulation of a soaking temperature of the strip steel;
in addition to use of the jet radiant tube preheating section, the cold-rolled strip steel post-processing production line further utilizes a rapid cooling treatment, then reheating, and then a galvanizing or overaging treatment; and
the furnace nose section and the mobile channel are provided in parallel, so that the strip steel passes through the furnace nose section to produce a pure zinc hot-dip galvanized product or a hot-dip galvannealed product, or the strip steel passes through the mobile channel to produce a cold-rolled annealed product, or a pickled product or a flash-plated product; or.
(2). the flexible post-cold-rolling processing production line suitable for producing a variety of ultra-high-strength strip steels includes the following stations in sequence: uncoiling—welding—inlet looper—washing—central continuous post-processing-intermediate looper—temper rolling—outlet looper-finishing-coiling; wherein
the central continuous post-processing station includes in sequence a jet radiant tube preheating section, a radiant tube heating section, a selectable transverse magnetic induction heating section or muffle furnace section provided in parallel, a radiant tube soaking section, a slow cooling section, a rapid cooling section, a reheating section;
starting from the reheating section, two parallel routes are provided, one of which includes a furnace nose section, a zinc pot section, an air knife section, an alloying heating section, an alloying soaking section, and a post-plating cooling section, and is connected to a final water cooling section, and the other of which includes a mobile channel section, an overaging section, a final gas jet cooling section, and is connected to the final water cooling section;
the final water cooling section is followed by a selectable pickling section and a selectable flash plating section in sequence;
a gas fuel such as natural gas or liquefied petroleum gas or coal gas is used in the heating section;
the jet radiant tube preheating section uses combustion exhaust gas from the heating section and/or the soaking section to heat a recycled nitrogen-hydrogen protective gas by heat exchange in a furnace, and then the nitrogen-hydrogen protective gas is jetted onto upper and lower surfaces of the strip steel to realize forced convection heat exchange;
the rapid cooling section includes a high hydrogen cooling section and/or a mist cooling section and/or a water quenching cooling section; or.
(3). the flexible cold-rolled strip steel post-processing line suitable for producing a variety of high-strength steels includes the following stations in sequence: uncoiling—welding—inlet looper—washing—central continuous post-processing—inlet looper—temper rolling—outlet looper—finishing—coiling; wherein
the central continuous post-processing station includes in sequence a jet direct fire preheating section, a direct fire heating section, a transverse magnetic induction heating section or a jet-radiation composite heating section, a jet-radiation composite soaking section, a slow cooling section, a rapid cooling section, and a reheating section;
starting from the reheating section, two parallel routes are provided, one of which includes a furnace nose section, a zinc pot section, an air knife section, an alloying heating section, an alloying soaking section, and a post-plating cooling section, and is further connected to a final water cooling section, and the other of which includes a mobile channel section, an overaging section, a final gas jet cooling section, and is further connected to the final water cooling section;
the final water cooling section is followed by a selectable pickling section and a selectable flash plating section;
the rapid cooling section includes a high hydrogen cooling section or a mist cooling section and/or a water quenching cooling section;
a gas fuel such as natural gas or liquefied petroleum gas is combusted in the direct fire heating section;
the jet direct fire preheating section uses combustion exhaust gas from the direct fire heating section to heat a recycled nitrogen-hydrogen protective gas by heat exchange in the furnace, and then the nitrogen-hydrogen protective gas is jetted onto upper and lower surfaces of a strip steel to realize forced convection heat exchange;
the transverse magnetic induction heating section or the jet-radiation composite heating section is provided in parallel or in series;
a selectable tension levelling station and/or a selectable surface post-treatment station such as that for passivation or anti-fingerprint treatment is provided between the temper rolling station and the outlet looper station;
the jet-radiation composite soaking section utilizes a rapid soaking mode combining forced convection and radiation;
thus, the production line has at least three process paths for selection, and enables production of five types of high-strength steel: cold-rolled annealed steel, pickled steel, flash plated steel, pure zinc hot-dip galvanized steel, and hot-dip galvannealed steel; or.
(4). the flexible production line for producing a variety of high-strength/ultra-high-strength steels includes the following stations in sequence: uncoiling—welding—inlet looper—washing—central continuous post-processing-intermediate looper—temper rolling—outlet looper-finishing—coiling; wherein:
the central continuous post-processing station includes in sequence a jet direct fire preheating section, a heating section, a radiant tube soaking section, a slow cooling section, a rapid cooling section, a reheating section and two parallel processing lines, a final water cooling section and a selectable pickling section and a selectable flash plating section;
one of the processing lines includes a furnace nose section, a zinc pot section, an air knife section, an alloying heating section, an alloying soaking section, and a post-plating cooling section;
and the other processing line includes a mobile channel section, an over-aging section, and a final gas jet cooling section;
a direct fire heating section and a transverse magnetic induction heating section and/or a jet-radiation composite heating section are used for the heating section;
the transverse magnetic induction heating section and the jet-radiation composite heating section are provided in parallel or in series;
the rapid cooling section includes high hydrogen cooling or mist cooling and/or water quenching cooling; and
a selectable tension levelling station and/or a selectable surface post-treatment station such as that for passivation or anti-fingerprint treatment is further provided between the temper rolling station and the outlet looper station;
(5). the dual-purpose ultra-high-strength strip steel production line for continuous annealing or hot-dip galvanizing includes the following stations in sequence: uncoiling—welding—inlet looper—washing—central continuous post-processing—temper rolling—outlet looper—coiling; wherein the central continuous post-processing station includes in sequence a jet direct fire preheating section, a direct fire heating section, a transverse magnetic induction heating section, a soaking section, a slow cooling section, a rapid cooling section, and a reheating section; starting from the reheating section, two parallel processing lines are provided, one of which is provided with a furnace nose section, a zinc pot section, an air knife section, and a post-plating cooling section, and is connected to a final water cooling section, and the other of which is provided with a mobile channel section, an overaging section, a final gas jet cooling section, and is connected to the final water cooling section; a radiant tube soaking section or a jet-radiation composite soaking section is used for the soaking section; a high hydrogen cooling section or a mist cooling section or a water quenching cooling section is used for the rapid cooling section; or
the ultra-high-strength strip steel production line includes the following stations in sequence: uncoiling—welding—inlet looper—washing—central continuous post-processing—temper rolling—outlet looper—coiling; wherein the central continuous post-processing station includes in sequence a jet direct fire preheating section, a direct fire heating section, a transverse magnetic induction heating section, a soaking section, a slow cooling section, a rapid cooling section, a pickling section and a reheating section; starting from the reheating section, two parallel processing lines are provided, one of which is provided with a furnace nose section, a zinc pot section, an air knife section, and a post-plating cooling section, and is connected to a final water cooling section, and the other of which is provided with a mobile channel section, an overaging section, a final gas jet cooling section, and is connected to the final water cooling section; a radiant tube soaking section or a jet-radiation composite soaking section is used for the soaking section; a mist cooling section and/or a water quenching cooling section is used for the rapid cooling section; or
the ultra-high-strength strip steel production line includes the following stations in sequence: uncoiling—welding—inlet looper—washing—central continuous post-processing—temper rolling—outlet looper—coiling; wherein the central continuous post-processing station includes in sequence a jet direct fire preheating section, a direct fire heating section, a transverse magnetic induction heating section, a soaking section, a slow cooling section, a rapid cooling section, a pickling section and a reheating section; starting from the reheating section, two parallel processing lines are provided, one of which is provided with a furnace nose section, a zinc pot section, an air knife section, and a post-plating cooling section, and is connected to a final water cooling section, and the other of which is provided with a mobile channel section, an overaging section, a final gas jet cooling section, and is connected to the final water cooling section; a radiant tube soaking section or a jet-radiation composite soaking section is used for the soaking section; a high hydrogen cooling section, a mist cooling section and/or a water quenching cooling section is used for the rapid cooling section; in addition, the high hydrogen cooling section is provided in parallel with the mist cooling section and/or the water quenching cooling section, and the high hydrogen cooling section is connected to the reheating section;
(6). the dual-purpose high-strength strip steel production line includes the following stations in sequence: uncoiling—welding—inlet looper—washing—central continuous post-processing—temper rolling—outlet looper—coiling; wherein the central continuous post-processing station includes in sequence a jet radiant tube preheating section, a radiant tube heating section, a transverse magnetic induction heating section, a soaking section, a slow cooling section, a rapid cooling section, a reheating section, a parallel arrangement of (a furnace nose section+a zinc pot section+an air knife section+a post-plating cooling section) and (a mobile channel section+an overaging section+a final gas jet cooling section), and a final water cooling section; a radiant tube soaking section or a jet-radiation composite soaking section is used for the soaking section; the rapid cooling section includes a high hydrogen cooling section or/a mist cooling section or/a water quenching cooling section; or
the high-strength production line includes the following stations in sequence: uncoiling—welding—inlet looper—washing—central continuous post-processing—temper rolling—outlet looper—coiling; wherein the central continuous post-processing station includes in sequence a jet radiant tube preheating section, a radiant tube heating section, a transverse magnetic induction heating section, a soaking section, a slow cooling section, a rapid cooling section, a pickling section, a reheating section, a parallel arrangement of (a furnace nose section+a zinc pot section+an air knife section+a post-plating cooling section) and (a mobile channel section+an overaging section+a final gas jet cooling section), and a final water cooling section; a radiant tube soaking section or a jet-radiation composite soaking section is used for the soaking section; the rapid cooling section includes a high hydrogen cooling section or/a mist cooling section or/a water quenching cooling section; or a mist cooling section is provided in parallel with a water quenching cooling section, and a connecting channel is provided between the mist cooling section and the water quenching cooling section; or, a high hydrogen cooling section is provided in parallel with a mist cooling section and a water quenching cooling section, a connecting channel is provided between the mist cooling section and the water quenching cooling section, and the high hydrogen cooling section is connected to the reheating section.

11.-15. (canceled)

16. The production line according to claim 1, wherein
(1) the jet direct fire preheating device comprises: a direct fire furnace and a preheating furnace; wherein
the direct fire furnace comprises:
a furnace housing, wherein a furnace top roller chamber and a furnace bottom roller chamber are provided at upper and lower ends thereof respectively; turning rollers are provided in the furnace top roller chamber and the furnace bottom roller chamber respectively; a plurality of direct fire heating zones are provided along a height direction in the furnace housing, and a plurality of direct fire burners are provided in the direct fire heating zone; at least two through holes are provided in an upper side wall of the furnace housing symmetrically on left and right;
the preheating furnace comprises:
a furnace body, wherein at least two connecting holes are provided in its upper side wall symmetrically on left and right, and are respectively connected to the through holes on an upper part of the furnace housing of the direct fire furnace through connecting pipes; a furnace throat corresponding to the top roller chamber of the direct fire furnace is provided at the top of the furnace body for the strip steel to pass through; a strip steel inlet, and correspondingly a sealing device and a turning roller are provided at the bottom of the furnace body; an upper baffle with a strip passing hole is provided in the upper part of the furnace body to form an upper collecting chamber for direct fire exhaust gas; a secondary combustion chamber for direct fire combustion exhaust gas is provided below the upper collecting chamber for direct fire combustion exhaust gas, and at least one open flame burner is provided in the secondary combustion chamber for direct fire combustion exhaust gas; a lower baffle with a strip passing hole is provided in the lower part of the furnace body to form a lower collecting chamber for direct fire exhaust gas, and is connected to an exhaust gas fan through an exhaust pipe; a control valve is provided on the exhaust pipe;
a plurality of heat exchange and jet bellows units provided on both sides below the secondary combustion chamber for direct fire combustion exhaust gas in the furnace body along a height direction of the furnace body, with a strip passing channel for the strip steel to pass through being formed in the middle; wherein each heat exchange and jet bellows unit comprises:
a bellows body, wherein a plurality of heat exchange tubes are provided vertically therein; a plurality of nozzles are provided on a side of the bellows body facing the strip passing channel; a secondary exhaust gas mixing chamber in communication with the heat exchange tube is provided between an upper bellows body and a lower bellows body; a nitrogen-hydrogen protective gas is introduced into the bellows body;
a circulating fan, wherein a port of its inlet pipe is provided in the strip passing channel, and a port of its outlet pipe is located in the bellows body;
a plurality of sealing devices through which the strip steel can pass, wherein they are respectively provided at upper and lower ports of the strip passing channel and the strip passing holes of the upper and lower baffles;
(2) the jet radiant tube preheating device comprises:
a radiant tube heating furnace, wherein a furnace top roller chamber is provided above the furnace body, and a turning roller is provided in the furnace top roller chamber;
a radiant tube exhaust gas collecting chamber connected to the furnace body of the radiant tube heating furnace via a connecting pipe;
a preheating furnace, comprising:
a preheating furnace body, wherein a connecting hole is provided through its upper side wall, and is communicated with the radiant tube exhaust gas collecting chamber through a connecting pipe; a furnace throat corresponding to the furnace top roller chamber of the radiant tube heating furnace is provided at the top of the preheating furnace body for strip steel to pass through; a strip steel inlet, an inlet sealing device and an inlet turning roller are provided at the bottom of the preheating furnace body; a preheating furnace gas collecting chamber is provided in an upper part of the preheating furnace body; a lower baffle with a strip passing hole is provided at a lower part of the furnace body of the preheating furnace to form an exhaust gas collecting chamber which is connected to an exhaust gas fan through an exhaust pipe; a control valve is provided on the exhaust pipe;
a plurality of heat exchange and jet bellows units provided on both sides below the preheating furnace gas collecting chamber in the preheating furnace body along a height direction of the furnace body, with a strip passing channel being formed in the middle for the strip steel to pass through, wherein each heat exchange and jet bellows unit comprises:
a bellows body, wherein a plurality of heat exchange tubes are vertically provided therein; a plurality of nozzles are provided on a side of the bellows body facing the strip passing channel; a secondary exhaust gas mixing chamber in communication with the heat exchange tube is provided between an upper bellows body and a lower bellows body; a protective gas is introduced into the bellows body;
a circulating fan, wherein a port of its inlet pipe is provided in the strip passing channel, and a port of its outlet pipe is located in the bellows body;
sealing devices through which the strip steel can pass, wherein they are respectively provided at a lower port of the strip passing channel and the strip passing hole of the lower baffle;
(3) the jet-radiation composite heating/soaking device comprises:
a furnace body provided therein with a composite heating body in a height direction; wherein the composite heating body comprises:
a heat insulated box having an insulating material provided on an inner wall of its housing body, wherein a mounting hole is provided at the center of a side face of the heat insulated box;
a circulating fan provided at the mounting hole of the heat insulated box, wherein a suction opening of the circulating fan aligns with an axis of the mounting hole, and a discharge opening is provided at a side face of a housing of the circulating fan;
a buffer cavity provided in the heat insulated box in alignment with the suction opening of the circulating fan, wherein a hot gas outlet is provided at a back side of the buffer cavity in alignment with the suction opening of the circulating fan, and a hot gas inlet is provided at a front side of the buffer cavity;
a pair of jet bellows provided vertically and symmetrically at opposite sides in front of the hot gas inlet at the front side of the buffer cavity in the heat insulated box, thereby forming therebetween a strip passing channel for strip steel to pass through; wherein a plurality of rows of jet nozzles are provided at intervals at a side of the pair of jet bellows located at both sides of the strip passing channel in a height direction, and a gap is provided between n rows of jet nozzles, wherein n≥1;
a plurality of radiant tubes symmetrically provided in the pair of jet bellows, wherein the radiant tube includes a connecting tube section connected to the nozzle, a radiation tube section extending sinuously from an end of the connecting tube section, and a heat exchange tube section extending sinuously from an end of the radiation tube section; the radiation tube section aligns with a gap provided between the n rows of jet nozzles in the jet bellows, thereby forming a structure with alternating jetting and radiation.

17. The production line according to claim 1, wherein the production line in any one of items (1)-(3) has one or more of the following features:
an alloying heating section and an alloying soaking section are provided between the air knife section and the post-plating cooling section, so that the hot-dip galvanizing is hot-dip galvannealing;
a mobile post-plating rapid cooling section that can be switched online/offline is provided after the air knife section device in the central continuous post-processing station; optionally, the mobile post-plating rapid cooling section is provided in parallel with the alloying heating section;
a washing station is provided before the inlet looper station, or washing stations are provided before and after the inlet looper station respectively;
a central looper is provided before the temper rolling station and after the central continuous post-processing station;
a finishing station is provided between the coiling station and the outlet looper station;
a tension levelling station is provided between the temper rolling station and the outlet looper station;
a surface post-treatment station such as that for passivation or anti-fingerprint treatment is provided between the temper rolling station and the outlet looper station;
a tension levelling station and a surface post-treatment station such as that for passivation or anti-fingerprint treatment are provided between the temper rolling station and the outlet looper station; and
in the rapid hot-dip galvanizing ultra-high-strength strip steel production line, an iron flash plating or nickel flash plating section is provided after the pickling section.

18. The production line according to claim 1, wherein the production line in any one of items (4)-(6) has any one or more of the following features:
a selectable pickling section is provided after the final water cooling section;
a selectable flash plating section is further provided after the pickling section;
a washing station is provided between the welding station and the inlet looper station;
a finishing station is provided before the coiling station;
an intermediate looper station is provided before the temper rolling station;
a tension levelling station is provided between the temper rolling station and the outlet looper station;
a surface post-treatment station such as that for passivation or anti-fingerprint treatment is provided between the temper rolling station and the outlet looper station, or both a tension levelling station device and a surface post-treatment station such as that for passivation or anti-fingerprint treatment are provided between the temper rolling station and the outlet looper station.

19. The production line according to claim 7, wherein:
(i) in item (1), the production line has any one or more of the following features:
the rapid heating station is provided with a direct fire heating device and a transverse magnetic induction heating device in sequence;
in the surface modification station, an optional iron flash plating or nickel flash plating device is further provided after the pickling section, and then connected to the subsequent pure zinc hot-dip galvanizing station;
in the pure zinc hot-dip galvanizing station, a mobile post-plating rapid cooling device is optionally provided between the air knife section and the post-plating cooling section;
the pure zinc hot-dip galvanizing station is replaced with a hot-dip galvannealing station, that is, an alloying heating section and an alloying soaking section are provided between the air knife section and the post-plating cooling section;
in the hot-dip galvanizing station, a selectable mobile post-plating rapid cooling section is provided in parallel with the alloying heating section after the air knife section;
a washing station is provided between the welding station and the inlet looper station; or, a washing station is provided after the inlet looper station;
a central looper device is provided before the temper rolling station;
a finishing station is provided between the coiling station and the outlet looper station, and the strip steel is finished before coiling;
a tension levelling station is provided between the temper rolling station and the outlet looper station; and
a surface post-treatment station device such as that for passivation or anti-fingerprint is provided between the temper rolling station and the outlet looper station; or, both a tension levelling station and a surface post-treatment station such as that for passivation or anti-fingerprint treatment are provided between the temper rolling station and the outlet looper station;
(ii) in item (2), the production line has any one or more of the following features:
in the rapid heating station, a jet-radiation composite heating device and a transverse magnetic induction heating device are provided in series, and in the rapid cooling station, a mist cooling device and a water quenching cooling device are provided in series or in parallel, or a high hydrogen cooling device and a water quenching cooling device are provided in parallel, or a high hydrogen cooling device and a mist cooling device are provided in parallel, or a high hydrogen cooling device, a mist cooling device and a water quenching cooling device are provided in parallel;
a selectable washing station is provided between the welding station and the inlet looper station;
in the rapid heating station, a selectable direct fire heating device is provided in parallel with a jet-radiation composite heating device+a transverse magnetic induction heating device provided in series, wherein the strip steel is heated by the direct fire heating device first and then by the jet-radiation composite heating device+the transverse magnetic induction heating device provided in series, or it bypasses the direct fire heating device and directly enters the jet-radiation composite heating device+the transverse magnetic induction heating device provided in series for heating;
or a selectable longitudinal magnetic induction heating device is provided in parallel or in series with a jet-radiation composite heating device+a transverse magnetic induction heating device provided in series, wherein the strip steel is heated by the longitudinal magnetic induction heating device first, or it bypasses the longitudinal magnetic induction heating device and directly enters the jet-radiation composite heating device+the transverse magnetic induction heating provided in series for heating;
a selectable washing station is provided after the inlet looper station;
a selectable pickling section is provided before the coiling station and after the central continuous post-processing station;
a temper rolling station is provided before the coiling station; and
a finishing station is provided between the coiling station and the temper rolling station;
(iii) in item (3), the production line has any one or more of the following features:
in the hot-dip galvanizing section, an alloying heating device and an alloying soaking device are provided between the air knife and the post-plating cooling device to enable production of hot-dip galvannealed products;
in the hot-dip galvanizing section, a selectable mobile post-plating rapid cooling device is provided after the air knife and before the post-plating cooling device;
a selectable washing station is provided between the welding station and the inlet looper station; or, a selectable washing station is provided after the inlet looper station;
a central looper station is provided before the temper rolling station and after the central continuous post-processing station;
a finishing station is provided between the coiling station and the outlet looper station;
a tension levelling station is provided between the temper rolling station and the outlet looper station; and
a surface post-treatment station such as that for passivation or anti-fingerprint treatment is provided between the temper rolling station and the outlet looper station; or, both a tension levelling station and a surface post-treatment station such as that for passivation or anti-fingerprint treatment are provided between the temper rolling station and the outlet looper station, and the strip steel is subjected to tension levelling and/or surface post-treatment such as passivation or anti-fingerprint treatment before entering the outlet looper station.

20-21. (canceled)

22. The production line according to claim 10, wherein:
(i) in item (1) and (2), the production line has one or more of the following features:
a selectable tension levelling station and/or a selectable surface post-treatment station such as that for passivation or anti-fingerprint treatment is provided between the temper rolling station and the outlet looper station to perform tension levelling and/or surface post-treatment on the strip steel;
the muffle furnace section includes built-in sealing devices at the front and rear, and the muffle furnace section is further equipped with an atmosphere regulating device, so that the hydrogen content, oxygen content and dew point therein can be regulated and controlled separately;
a uniform holding section device is provided between the reheating section and the furnace nose section to hold the temperature of the strip steel before hot-dip galvanizing;
a mobile post-plating rapid cooling section is further provided between the air knife section and the post-plating cooling section, wherein the mobile post-plating rapid cooling section is provided in parallel with the alloying heating section to achieve rapid cooling of the strip steel after galvanizing for producing a pure zinc hot-dip galvanized high-strength steel product;
a secondary reheating section is provided after the uniform holding section to perform secondary reheating on the strip steel after uniform holding, followed by hot-dip galvanizing or overaging treatment;
a pickling section is provided between the rapid cooling section and the reheating section, wherein the pickling section device includes a pickling unit, a hot water brushing unit, a hot water rinsing unit, and a hot air drying unit;
an iron flash plating or nickel flash plating section is provided after the pickling section, and then reheating treatment is performed; and
mobile gas jet rapid cooling or mobile mist cooling is used for the mobile post-plating rapid cooling section;
(ii) in item (3), the production line has any one or more of the following features:
a radiant tube heating section is provided between the jet-radiation composite heating section and the jet-radiation composite soaking section;
a uniform holding section is provided between the reheating section and the furnace nose section;
a secondary reheating section is provided after the uniform holding section, and the secondary reheating section is connected to the mobile channel section and the furnace nose section;
a mobile post-plating rapid cooling section is provided between the air knife section and the post-plating cooling section, wherein the mobile post-plating rapid cooling section is provided in parallel with the alloying heating device;
a pickling section is provided between the rapid cooling section and the reheating section, wherein the pickling section includes a pickling unit, a hot water brushing unit, a hot water rinsing unit, and a hot air drying unit; and
an iron flash plating or nickel flash plating section is provided after the pickling section and before the reheating section, and then connected to the reheating section;
(iii) in item (4), the production line has any one or more of the following features:
the selectable pickling section includes a pickling unit, a hot water brushing unit, a hot water rinsing unit, and a hot air drying unit;
a radiant tube heating device is provided between the jet-radiation composite heating section and the radiant tube soaking section;
a uniform holding section is provided between the reheating section and the furnace nose section;
a mobile post-plating rapid cooling section device is provided between the air knife section and the post-plating cooling section, wherein the mobile post-plating rapid cooling section is provided in parallel with the alloying heating section;
a mobile gas jet rapid cooling section and/or a mobile mist rapid cooling section is used for the mobile post-plating rapid cooling section; when both the mobile gas jet rapid cooling section and the mobile mist rapid cooling section are provided, the mobile gas jet rapid cooling section and the mobile mist rapid cooling section are provided in parallel;
a secondary reheating section is provided after the uniform holding section to perform secondary reheating on the strip steel after uniform holding, followed by hot-dip galvanizing or overaging treatment;
a pickling section is provided between the rapid cooling section and the reheating section, wherein the pickling section includes a pickling unit, a hot water brushing unit, a hot water rinsing unit, and a hot air drying unit; and
in the heating section, an iron flash plating/nickel flash plating section is provided after the pickling section and before the reheating section to improve platability of the strip steel;
(iv) in item (5), the production line has any one or more of the following features:
a uniform holding section and a secondary reheating section are provided in sequence after the reheating section, wherein the secondary reheating section is then connected to the two parallel processing lines;
the hot-dip galvanizing is hot-dip galvannealing, and an alloying heating section and an alloying soaking section are provided between the air knife section and the post-plating cooling section;
a mobile post-plating rapid cooling section is provided after the air knife section, wherein the mobile post-plating rapid cooling section can be moved online or offline and is provided in parallel with the alloying heating section;
a radiant tube heating section is further provided between the direct fire heating section and the transverse magnetic induction heating section;
washing stations are provided before and after the inlet looper station;
a finishing station is provided before the coiling station;
an intermediate looper station is provided before the temper rolling station; or, a selectable tension levelling station is provided between the temper rolling station and the outlet looper station; and
a selectable surface post-treatment station such as that for passivation or anti-fingerprint treatment is provided between the temper rolling station and the outlet looper station; or, both a selectable tension levelling station and a selectable surface post-treatment station such as that for passivation or anti-fingerprint treatment are provided between the temper rolling station and the outlet looper station;
(v) in item (6), the production line has any one or more of the following features:
a uniform holding section and a secondary reheating section are provided after the reheating section, and the secondary reheating section is then connected to the parallel arrangement of (a furnace nose section+a zinc pot section+an air knife section+a post-plating cooling section) and (a mobile channel section+an overaging section+a final gas jet cooling section);
the hot-dip galvanizing is hot-dip galvannealing, and an alloying heating section and an alloying soaking section are provided between the air knife section and the post-plating cooling section;
a mobile post-plating rapid cooling section is provided after the air knife section, and is provided in parallel with the alloying heating section, so that such a design is formed that the post-plating rapid cooling section can be switched between online and offline;
a nickel flash plating or iron flash plating section is provided before the reheating section;
washing stations are provided before and after the inlet looper station;
a finishing station is provided before the coiling station;
an intermediate looper station is provided before the temper rolling station;
a selectable tension levelling station is provided between the temper rolling station and the outlet looper station; and
a selectable surface post-treatment station such as that for passivation or anti-fingerprint treatment is provided between the temper rolling station and the outlet looper station; or, a selectable tension levelling station device and a selectable surface post-treatment station such as that for passivation or anti-fingerprint treatment are provided between the temper rolling station and the outlet looper station, so that the strip steel is subjected to surface post-treatment such as passivation or anti-fingerprint treatment before entering the outlet looper.

23.-27. (canceled)

28. The production line according to claim 127, wherein the ultra-short-process production line for dual-purpose strip steel has one or more of the following features:
a mobile post-plating rapid cooling section that can be switched online or offline is provided after the air knife section and is provided in parallel with the alloying heating section;
a selectable washing station is provided between the welding station and the inlet looper station, and the strip steel can be washed by passing through the washing station, or can bypass the washing station; a selectable washing station is provided after the inlet looper station, and the strip steel can be washed by passing through the washing station, or can bypass the washing station; or, washing stations are provided before and after the inlet looper station to perform secondary washing on the strip steel;
a longitudinal magnetic induction heating section is provided before the transverse magnetic induction heating section, so that the strip steel passes through the longitudinal magnetic induction heating section, wherein the strip steel is subjected to longitudinal magnetic induction heating, or the strip steel passes through the longitudinal magnetic induction heating section without being heated and directly enters the transverse magnetic induction heating section to be heated;
an iron flash plating or nickel flash plating station is provided after the pickling section;
a finishing station is provided before the coiling station;
an intermediate looper station is provided before the temper rolling station;
a tension levelling station is provided between the temper rolling station and the outlet looper station;
a surface post-treatment station such as that for passivation or anti-fingerprint treatment is provided between the temper rolling station and the outlet looper station;
both a tension levelling station and a surface post-treatment station such as that for passivation or anti-fingerprint treatment are provided between the temper rolling station and the outlet looper station.

29. The production line according to claim 16, wherein:
in the furnace body of the jet direct fire preheating device in (1): a combustion exhaust gas thermometer is further provided in the secondary combustion chamber for direct fire combustion exhaust gas; and/or the sealing device is a nitrogen sealing structure, wherein a nitrogen sealing chamber provided with a nitrogen injection pipe is used;
in the bellows body of the jet radiant tube preheating device of (2), a nitrogen-hydrogen protective gas is introduced into the bellows body; and/or the inlet sealing device and the sealing devices through which the strip steel can pass have a nitrogen sealing structure, wherein a nitrogen sealing chamber provided with a nitrogen injection pipe is used;
in the jet-radiation composite heating/soaking device of (3): the buffer cavity and the jet bellows form an integrated structure, the jet nozzle has diameter that is 1/10 to ⅕ of a distance from the jet nozzle to the strip steel, the jet nozzle has a circular hole structure, and/or the radiation tube section, the connecting tube section and the heat exchange tube section of the radiant tube are provided in parallel.

30. The production line according to claim 7, wherein:
(1) the jet direct fire preheating device comprises: a direct fire furnace and a preheating furnace; wherein
the direct fire furnace comprises:
a furnace housing, wherein a furnace top roller chamber and a furnace bottom roller chamber are provided at upper and lower ends thereof respectively; turning rollers are provided in the furnace top roller chamber and the furnace bottom roller chamber respectively; a plurality of direct fire heating zones are provided along a height direction in the furnace housing, and a plurality of direct fire burners are provided in the direct fire heating zone; at least two through holes are provided in an upper side wall of the furnace housing symmetrically on left and right;
the preheating furnace comprises:
a furnace body, wherein at least two connecting holes are provided in its upper side wall symmetrically on left and right, and are respectively connected to the through holes on an upper part of the furnace housing of the direct fire furnace through connecting pipes; a furnace throat corresponding to the top roller chamber of the direct fire furnace is provided at the top of the furnace body for the strip steel to pass through; a strip steel inlet, and correspondingly a sealing device and a turning roller are provided at the bottom of the furnace body; an upper baffle with a strip passing hole is provided in the upper part of the furnace body to form an upper collecting chamber for direct fire exhaust gas; a secondary combustion chamber for direct fire combustion exhaust gas is provided below the upper collecting chamber for direct fire combustion exhaust gas, and at least one open flame burner is provided in the secondary combustion chamber for direct fire combustion exhaust gas; a lower baffle with a strip passing hole is provided in the lower part of the furnace body to form a lower collecting chamber for direct fire exhaust gas, and is connected to an exhaust gas fan through an exhaust pipe; a control valve is provided on the exhaust pipe;
a plurality of heat exchange and jet bellows units provided on both sides below the secondary combustion chamber for direct fire combustion exhaust gas in the furnace body along a height direction of the furnace body, with a strip passing channel for the strip steel to pass through being formed in the middle; wherein each heat exchange and jet bellows unit comprises:
a bellows body, wherein a plurality of heat exchange tubes are provided vertically therein; a plurality of nozzles are provided on a side of the bellows body facing the strip passing channel; a secondary exhaust gas mixing chamber in communication with the heat exchange tube is provided between an upper bellows body and a lower bellows body; a nitrogen-hydrogen protective gas is introduced into the bellows body;
a circulating fan, wherein a port of its inlet pipe is provided in the strip passing channel, and a port of its outlet pipe is located in the bellows body;
a plurality of sealing devices through which the strip steel can pass, wherein they are respectively provided at upper and lower ports of the strip passing channel and the strip passing holes of the upper and lower baffles;
(2) the jet radiant tube preheating device comprises:
a radiant tube heating furnace, wherein a furnace top roller chamber is provided above the furnace body, and a turning roller is provided in the furnace top roller chamber;
a radiant tube exhaust gas collecting chamber connected to the furnace body of the radiant tube heating furnace via a connecting pipe;
a preheating furnace, comprising:
a preheating furnace body, wherein a connecting hole is provided through its upper side wall, and is communicated with the radiant tube exhaust gas collecting chamber through a connecting pipe; a furnace throat corresponding to the furnace top roller chamber of the radiant tube heating furnace is provided at the top of the preheating furnace body for strip steel to pass through; a strip steel inlet, an inlet sealing device and an inlet turning roller are provided at the bottom of the preheating furnace body; a preheating furnace gas collecting chamber is provided in an upper part of the preheating furnace body; a lower baffle with a strip passing hole is provided at a lower part of the furnace body of the preheating furnace to form an exhaust gas collecting chamber which is connected to an exhaust gas fan through an exhaust pipe; a control valve is provided on the exhaust pipe;
a plurality of heat exchange and jet bellows units provided on both sides below the preheating furnace gas collecting chamber in the preheating furnace body along a height direction of the furnace body, with a strip passing channel being formed in the middle for the strip steel to pass through, wherein each heat exchange and jet bellows unit comprises:
a bellows body, wherein a plurality of heat exchange tubes are vertically provided therein; a plurality of nozzles are provided on a side of the bellows body facing the strip passing channel; a secondary exhaust gas mixing chamber in communication with the heat exchange tube is provided between an upper bellows body and a lower bellows body; a protective gas is introduced into the bellows body;
a circulating fan, wherein a port of its inlet pipe is provided in the strip passing channel, and a port of its outlet pipe is located in the bellows body;
sealing devices through which the strip steel can pass, wherein they are respectively provided at a lower port of the strip passing channel and the strip passing hole of the lower baffle;
(3) the jet-radiation composite heating/soaking device comprises:
a furnace body provided therein with a composite heating body in a height direction; wherein the composite heating body comprises:
a heat insulated box having an insulating material provided on an inner wall of its housing body, wherein a mounting hole is provided at the center of a side face of the heat insulated box;
a circulating fan provided at the mounting hole of the heat insulated box, wherein a suction opening of the circulating fan aligns with an axis of the mounting hole, and a discharge opening is provided at a side face of a housing of the circulating fan;
a buffer cavity provided in the heat insulated box in alignment with the suction opening of the circulating fan, wherein a hot gas outlet is provided at a back side of the buffer cavity in alignment with the suction opening of the circulating fan, and a hot gas inlet is provided at a front side of the buffer cavity;
a pair of jet bellows provided vertically and symmetrically at opposite sides in front of the hot gas inlet at the front side of the buffer cavity in the heat insulated box, thereby forming therebetween a strip passing channel for strip steel to pass through; wherein a plurality of rows of jet nozzles are provided at intervals at a side of the pair of jet bellows located at both sides of the strip passing channel in a height direction, and a gap is provided between n rows of jet nozzles, wherein n≥1;
a plurality of radiant tubes symmetrically provided in the pair of jet bellows, wherein the radiant tube includes a connecting tube section connected to the nozzle, a radiation tube section extending sinuously from an end of the connecting tube section, and a heat exchange tube section extending sinuously from an end of the radiation tube section; the radiation tube section aligns with a gap provided between the n rows of jet nozzles in the jet bellows, thereby forming a structure with alternating jetting and radiation.

31. The production line according to claim 30, wherein:
in the furnace body of the jet direct fire preheating device in (1): a combustion exhaust gas thermometer is further provided in the secondary combustion chamber for direct fire combustion exhaust gas; and/or the sealing device is a nitrogen sealing structure, wherein a nitrogen sealing chamber provided with a nitrogen injection pipe is used;
in the bellows body of the jet radiant tube preheating device of (2), a nitrogen-hydrogen protective gas is introduced into the bellows body; and/or the inlet sealing device and the sealing devices through which the strip steel can pass have a nitrogen sealing structure, wherein a nitrogen sealing chamber provided with a nitrogen injection pipe is used;
in the jet-radiation composite heating/soaking device of (3): the buffer cavity and the jet bellows form an integrated structure, the jet nozzle has diameter that is 1/10 to ⅕ of a distance from the jet nozzle to the strip steel, the jet nozzle has a circular hole structure, and/or the radiation tube section, the connecting tube section and the heat exchange tube section of the radiant tube are provided in parallel.

32. The production line according to claim 10, wherein
(1) the jet direct fire preheating device comprises: a direct fire furnace and a preheating furnace; wherein
the direct fire furnace comprises:
a furnace housing, wherein a furnace top roller chamber and a furnace bottom roller chamber are provided at upper and lower ends thereof respectively; turning rollers are provided in the furnace top roller chamber and the furnace bottom roller chamber respectively; a plurality of direct fire heating zones are provided along a height direction in the furnace housing, and a plurality of direct fire burners are provided in the direct fire heating zone; at least two through holes are provided in an upper side wall of the furnace housing symmetrically on left and right;
the preheating furnace comprises:
a furnace body, wherein at least two connecting holes are provided in its upper side wall symmetrically on left and right, and are respectively connected to the through holes on an upper part of the furnace housing of the direct fire furnace through connecting pipes; a furnace throat corresponding to the top roller chamber of the direct fire furnace is provided at the top of the furnace body for the strip steel to pass through; a strip steel inlet, and correspondingly a sealing device and a turning roller are provided at the bottom of the furnace body; an upper baffle with a strip passing hole is provided in the upper part of the furnace body to form an upper collecting chamber for direct fire exhaust gas; a secondary combustion chamber for direct fire combustion exhaust gas is provided below the upper collecting chamber for direct fire combustion exhaust gas, and at least one open flame burner is provided in the secondary combustion chamber for direct fire combustion exhaust gas; a lower baffle with a strip passing hole is provided in the lower part of the furnace body to form a lower collecting chamber for direct fire exhaust gas, and is connected to an exhaust gas fan through an exhaust pipe; a control valve is provided on the exhaust pipe;
a plurality of heat exchange and jet bellows units provided on both sides below the secondary combustion chamber for direct fire combustion exhaust gas in the furnace body along a height direction of the furnace body, with a strip passing channel for the strip steel to pass through being formed in the middle; wherein each heat exchange and jet bellows unit comprises:
a bellows body, wherein a plurality of heat exchange tubes are provided vertically therein; a plurality of nozzles are provided on a side of the bellows body facing the strip passing channel; a secondary exhaust gas mixing chamber in communication with the heat exchange tube is provided between an upper bellows body and a lower bellows body; a nitrogen-hydrogen protective gas is introduced into the bellows body;
a circulating fan, wherein a port of its inlet pipe is provided in the strip passing channel, and a port of its outlet pipe is located in the bellows body;
a plurality of sealing devices through which the strip steel can pass, wherein they are respectively provided at upper and lower ports of the strip passing channel and the strip passing holes of the upper and lower baffles;
(2) the jet radiant tube preheating device comprises:
a radiant tube heating furnace, wherein a furnace top roller chamber is provided above the furnace body, and a turning roller is provided in the furnace top roller chamber;
a radiant tube exhaust gas collecting chamber connected to the furnace body of the radiant tube heating furnace via a connecting pipe;
a preheating furnace, comprising:
a preheating furnace body, wherein a connecting hole is provided through its upper side wall, and is communicated with the radiant tube exhaust gas collecting chamber through a connecting pipe; a furnace throat corresponding to the furnace top roller chamber of the radiant tube heating furnace is provided at the top of the preheating furnace body for strip steel to pass through; a strip steel inlet, an inlet sealing device and an inlet turning roller are provided at the bottom of the preheating furnace body; a preheating furnace gas collecting chamber is provided in an upper part of the preheating furnace body; a lower baffle with a strip passing hole is provided at a lower part of the furnace body of the preheating furnace to form an exhaust gas collecting chamber which is connected to an exhaust gas fan through an exhaust pipe; a control valve is provided on the exhaust pipe;
a plurality of heat exchange and jet bellows units provided on both sides below the preheating furnace gas collecting chamber in the preheating furnace body along a height direction of the furnace body, with a strip passing channel being formed in the middle for the strip steel to pass through, wherein each heat exchange and jet bellows unit comprises:
a bellows body, wherein a plurality of heat exchange tubes are vertically provided therein; a plurality of nozzles are provided on a side of the bellows body facing the strip passing channel; a secondary exhaust gas mixing chamber in communication with the heat exchange tube is provided between an upper bellows body and a lower bellows body; a protective gas is introduced into the bellows body;
a circulating fan, wherein a port of its inlet pipe is provided in the strip passing channel, and a port of its outlet pipe is located in the bellows body;
sealing devices through which the strip steel can pass, wherein they are respectively provided at a lower port of the strip passing channel and the strip passing hole of the lower baffle;
(3) the jet-radiation composite heating/soaking device comprises:
a furnace body provided therein with a composite heating body in a height direction; wherein the composite heating body comprises:
a heat insulated box having an insulating material provided on an inner wall of its housing body, wherein a mounting hole is provided at the center of a side face of the heat insulated box;
a circulating fan provided at the mounting hole of the heat insulated box, wherein a suction opening of the circulating fan aligns with an axis of the mounting hole, and a discharge opening is provided at a side face of a housing of the circulating fan;
a buffer cavity provided in the heat insulated box in alignment with the suction opening of the circulating fan, wherein a hot gas outlet is provided at a back side of the buffer cavity in alignment with the suction opening of the circulating fan, and a hot gas inlet is provided at a front side of the buffer cavity;
a pair of jet bellows provided vertically and symmetrically at opposite sides in front of the hot gas inlet at the front side of the buffer cavity in the heat insulated box, thereby forming therebetween a strip passing channel for strip steel to pass through; wherein a plurality of rows of jet nozzles are provided at intervals at a side of the pair of jet bellows located at both sides of the strip passing channel in a height direction, and a gap is provided between n rows of jet nozzles, wherein n≥1;
a plurality of radiant tubes symmetrically provided in the pair of jet bellows, wherein the radiant tube includes a connecting tube section connected to the nozzle, a radiation tube section extending sinuously from an end of the connecting tube section, and a heat exchange tube section extending sinuously from an end of the radiation tube section; the radiation tube section aligns with a gap provided between the n rows of jet nozzles in the jet bellows, thereby forming a structure with alternating jetting and radiation.

33. The production line according to claim 32, wherein:
in the furnace body of the jet direct fire preheating device in (1): a combustion exhaust gas thermometer is further provided in the secondary combustion chamber for direct fire combustion exhaust gas; and/or the sealing device is a nitrogen sealing structure, wherein a nitrogen sealing chamber provided with a nitrogen injection pipe is used;
in the bellows body of the jet radiant tube preheating device of (2), a nitrogen-hydrogen protective gas is introduced into the bellows body; and/or the inlet sealing device and the sealing devices through which the strip steel can pass have a nitrogen sealing structure, wherein a nitrogen sealing chamber provided with a nitrogen injection pipe is used;
in the jet-radiation composite heating/soaking device of (3): the buffer cavity and the jet bellows form an integrated structure, the jet nozzle has diameter that is 1/10 to ⅕ of a distance from the jet nozzle to the strip steel, the jet nozzle has a circular hole structure, and/or the radiation tube section, the connecting tube section and the heat exchange tube section of the radiant tube are provided in parallel.

34. The production line according to claim 18, wherein the washing stations are provided before and after the inlet looper station.

35. The production line according to claim 19, wherein in item (ii), a selectable flash plating section is provided after the pickling section and before the coiling station.

36. The production line according to claim 22, wherein:
in item (i), the mobile post-plating rapid cooling section is disposed within 10 meters above the air knife section;
in item (ii), the mobile post-plating rapid cooling section is disposed within 10 meters above the air knife section;
in item (iii), the mobile post-plating rapid cooling section device is disposed within 10 meters above the air knife section.
